(19) United States
(12) Patent Application Publication
(10) Pub. No.: US 2025/0270953 A1
(43) Pub. Date: Aug. 28, 2025

(54) GAS TURBINE ENGINE

(71) Applicants: General Electric Company, Evendale, OH (US); GE Avio S.r.l., Rivalta di Torino (IT)

(72) Inventors: Daniel Alan Niergarth, Norwood, OH (US); Jorge de Luis, Montgomery, OH (US); Douglas Downey Turner, West Chester, OH (US); Michael Macrorie, Winchester, MA (US); Keith W. Wilkinson, Portsmouth, NH (US); Arthur William Sibbach, Boxford, MA (US); Vincenzo Martina, Turin (IT)

(21) Appl. No.: 19/194,856

(22) Filed: Apr. 30, 2025

Related U.S. Application Data
(63) Continuation-in-part of application No. 18/976,748, filed on Dec. 11, 2024.
Application No. 18/976,748 is a continuation of application No. 18/650,586, filed on Apr. 30, 2024, now Pat. No. 12,196,131.
Application No. 18/650,586 is a continuation of application No. 18/500,517, filed on Nov. 2, 2023, now Pat. No. 12,078,107.
Application No. 18/500,517 is a continuation of application No. 18/481,515, filed on Oct. 5, 2023.
Application No. 18/481,515 is a continuation-in-part of application No. 17/978,629, filed on Nov. 1, 2022, now abandoned.

(51) Int. Cl. F02C 6/06; F02C 7/18

(52) U.S. Cl. CPC F02C 6/06; F02C 7/185; F05D 2260/213

(57) ABSTRACT

A gas turbine engine includes a turbomachine comprising compressor, combustion, and turbine sections. The gas turbine engine defines a maximum exhaust gas temperature, a maximum drive turbine shaft torque, and a corrected specific power. The gas turbine engine includes a controller configured to autonomously regulate performance of the gas turbine engine in response to at least one of: a thrust demand, an energy efficiency target, or a flight profile condition.

### CROSS-REFERENCE TO RELATED APPLICATIONS

This application is a continuation-in-part application of U.S. application Ser. No. 18/976,748 filed Dec. 11, 2024, which is a continuation application of U.S. application Ser. No. 18/650,586 filed Apr. 30, 2024, which is a continuation-in-part application of U.S. application Ser. No. 18/500,517 filed Nov. 2, 2023, which is a continuation patent application of U.S. application Ser. No. 18/481,515 filed Oct. 5, 2023, which is a continuation-in-part application of U.S. application Ser. No. 17/978,629 filed Nov. 1, 2022. Each of these applications are hereby incorporated by reference in their entirety.

### TECHNICAL FIELD

The present disclosure relates to a gas turbine engine.

### BACKGROUND

A gas turbine engine includes a turbomachine. The turbomachine generally includes an inlet, one or more compressors, a combustor, and at least one turbine. The compressors compress air which is channeled to the combustor where it is mixed with fuel. The mixture is then ignited for generating hot combustion gases. The combustion gases are channeled to the turbine(s) which extracts energy from the combustion gases for powering the compressor(s), as well as for producing useful work to, e.g., propel an aircraft in flight. The turbomachine is mechanically coupled to an output shaft to, in the case of a turboprop engine, drive a propeller assembly of the gas turbine engine during operation.

### BRIEF DESCRIPTION OF THE DRAWINGS

A full and enabling disclosure of the present disclosure, including the best mode thereof, directed to one of ordinary skill in the art, is set forth in the specification, which makes reference to the appended FIG.s, in which:

FIG. 1 is a schematic cross-sectional view of a gas turbine engine in the form of a three-stream engine in accordance with an exemplary embodiment of the present disclosure.

FIG. 2 is a close-up, schematic view of the exemplary three-stream engine of FIG. 1 with a cooled cooling air system in accordance with an exemplary embodiment of the present disclosure.

FIG. 3 is a close-up view of an aft-most stage of high pressure compressor rotor blades within the exemplary three-stream engine of FIG. 1.

FIG. 4 is a close-up, schematic view of the exemplary three-stream engine of FIG. 1 showing the cooled cooling air system of FIG. 2.

FIG. 5 is a schematic view of a thermal transport bus of the present disclosure.

FIG. 6 is a table depicting numerical values showing the relationships between various parameters in accordance with various example embodiments of the present disclosure.

FIG. 7 is a graph depicting a range of corrected specific thrust values and maximum exhaust gas temperature values of gas turbine engines in accordance with various example embodiments of the present disclosure.

FIG. 8 is a schematic view of a gas turbine engine in the form of a ducted turbofan engine in accordance with an exemplary aspect of the present disclosure.

FIG. 9 is a schematic, close-up view of a gas turbine engine having a cooled cooling air system in accordance with another exemplary aspect of the present disclosure.

FIG. 10 is a schematic, close-up view of a gas turbine engine having a cooled cooling air system in accordance with yet another exemplary aspect of the present disclosure.

FIG. 11 is a schematic, close-up view of a gas turbine engine having a cooled cooling air system in accordance with still another exemplary aspect of the present disclosure.

FIG. 12 is a schematic view of a gas turbine engine in the form of a turbofan engine in accordance with another exemplary aspect of the present disclosure.

FIG. 13 is a schematic view of a gas turbine engine in the form of a turboprop engine in accordance with an exemplary aspect of the present disclosure.

FIG. 14 is a schematic view of a turbomachine of the exemplary turboprop engine of FIG. 13 in accordance with an exemplary aspect of the present disclosure.

FIG. 15 is a schematic view of a thermal transport bus of the present disclosure.

FIG. 16 is a close-up view of an aft-most stage of high pressure compressor rotor blades within the exemplary turboprop engine of FIG. 13.

FIG. 17 is a close-up view of an aft-most stage of low pressure turbine rotor blades within the exemplary turboprop engine of FIG. 13.

FIG. 18 is a table depicting numerical values showing the relationships between various parameters in accordance with various example embodiments of the present disclosure.

FIG. 19 is a graph depicting a range of corrected specific power values and maximum exhaust gas temperature values of gas turbine engines in accordance with various example embodiments of the present disclosure.

FIG. 20 is a schematic view of a turbomachine of a gas turbine engine in accordance with another exemplary aspect of the present disclosure.

FIG. 21 is a schematic view of a turbomachine of a gas turbine engine in accordance with another exemplary aspect of the present disclosure.

FIG. 22 is a schematic view of a turbomachine of a gas turbine engine in accordance with another exemplary aspect of the present disclosure.

FIG. 23 is a schematic view of a turbomachine of a gas turbine engine in accordance with another exemplary aspect of the present disclosure.

FIG. 24 is a schematic view of a turbomachine of a gas turbine engine in accordance with another exemplary aspect of the present disclosure.

FIG. 25 is a schematic view of a turbomachine of a gas turbine engine in accordance with another exemplary aspect of the present disclosure.

FIG. 26 is a schematic view of a turbomachine of a gas turbine engine in accordance with another exemplary aspect of the present disclosure.

FIG. 27 is a schematic view of a turbomachine of a gas turbine engine in accordance with another exemplary aspect of the present disclosure.

FIG. 28 is a schematic view of a turbomachine of a gas turbine engine in accordance with another exemplary aspect of the present disclosure.

FIG. 29 is a schematic view of a gas turbine engine in the form of a turboprop engine in accordance with another exemplary aspect of the present disclosure.

FIG. 30 is a schematic view of a gas turbine engine in the form of a turboprop engine in accordance with another exemplary aspect of the present disclosure.

FIG. 31 is a schematic view of a turbomachine of a gas turbine engine in accordance with another exemplary aspect of the present disclosure.

FIG. 32 is a schematic view of a turbomachine of a gas turbine engine in accordance with another exemplary aspect of the present disclosure.

FIG. 33 is a schematic view of a gas turbine engine in accordance with another exemplary aspect of the present disclosure.

FIG. 34 is a schematic view of a high pressure turbine rotor blade in accordance with another exemplary aspect of the present disclosure.

FIG. 35 is a schematic view illustrating an example autothrottle control for a hybrid electric aircraft system including a gas turbine engine in accordance with another exemplary aspect of the present disclosure.

FIG. 36 is a schematic view of an example aspect of the autothrottle control for the hybrid electric aircraft system in a single engine aircraft with the gas turbine engine in accordance with an exemplary aspect of the present disclosure.

FIG. 37 is a schematic view of an example aspect of the autothrottle control for the hybrid electric aircraft system in a multiengine aircraft with the gas turbine engine in accordance with an exemplary aspect of the present disclosure.

FIG. 38 is a schematic view of an example method of autothrottle control for the hybrid electric aircraft system in accordance with an exemplary aspect of the present disclosure.

FIG. 39 is a schematic view of a computing device of the autothrottle control in accordance with an exemplary aspect of the present disclosure.

FIG. 40 a schematic view of a gas turbine engine in the form of a turboprop in accordance with another exemplary aspect of the present disclosure.

FIG. 41 is a block diagram of an example aircraft control system of an aircraft having the gas turbine engine of FIG. 40 in accordance with another exemplary aspect of the present disclosure.

FIG. 42 is a flowchart of an example method for autothrottle in the aircraft in accordance with another exemplary aspect of the present disclosure.

FIG. 43 is a graphical representation of an example relationship between requested power/requested propeller governing speed and power lever angle in accordance with another exemplary aspect of the present disclosure.

FIG. 44 is a graphical representation of an example relationship between requested power/PLA trim scheduling and power lever angle in accordance with another exemplary aspect of the present disclosure.

FIG. 45 is a schematic view of an autothrottle controller in accordance with another exemplary aspect of the present disclosure.

FIG. 46A is a schematic view of a representative example instrument panel of an aircraft including an integrated avionics system configured in accordance with another exemplary aspect of the present disclosure.

FIG. 46B is a block diagram of an aspect of the example integrated avionics system shown in FIG. 46A in accordance with another exemplary aspect of the present disclosure.

FIG. 47 is a block diagram of an example multi-product avionics control and display unit (CDU) suitable for use by the integrated avionics system shown in FIGS. 46A through 46B in accordance with another exemplary aspect of the present disclosure.

FIGS. 48A and 48B are schematic views of an avionics control and display unit (CDU) where various display attributes of navigational information are conveyed relating to routing of an aircraft during an emergency situation in accordance with another exemplary aspect of the present disclosure.

FIGS. 49A and 49B are schematic views of a primary flight display (PFD) where various display attributes of navigational information are conveyed relating to routing of an aircraft during an emergency situation in accordance with another exemplary aspect of the present disclosure.

FIGS. 50A and 50B are schematic views of a multifunction display (MFD) where various display attributes of navigational information are conveyed relating to routing of an aircraft during an emergency situation in accordance with another exemplary aspect of the present disclosure.

FIG. 51 is a table illustrating example status information and associated descriptions for conveying at a display screen, such as the display screens illustrated in FIGS. 50A, 50B, 52, 53, and 55A, in accordance with another exemplary aspect of the present disclosure.

FIGS. 52 and 53 are schematic views of a multifunction display (MFD) where various display attributes of status information, such as status information illustrated in FIG. 51, and instructional information to convey to a passenger in the event of an emergency in accordance with another exemplary aspect of the present disclosure.

FIG. 54 is a table illustrating instructional information relating to a next action to be taken during an emergency situation that can be conveyed to a passenger at a display screen, such as the display screens illustrated in FIGS. 50A, 50B, 52, 53, and 55A, in accordance with another exemplary aspect of the present disclosure.

FIGS. 55A and 55B are schematic views of a multifunction display (MFD) where various display attributes of status information conveying failure of autoland functionality in accordance with another exemplary aspect of the present disclosure.

FIG. 56 is a table illustrating example status updates that can be conveyed at a display screen, such as the display screens illustrated in FIGS. 50A, 50B, 52, 53, and 55A, in accordance with another exemplary aspect of the present disclosure.

FIG. 57 is a flowchart illustrating an example process for autolanding an aircraft in an emergency situation in accordance with another exemplary aspect of the present disclosure.

FIG. 58 is a flowchart illustrating an example process for determining an endurance of an aircraft in accordance with another exemplary aspect of the present disclosure.

FIG. 59 is a flowchart illustrating an example process for identifying one or more airports within a range of travel of the aircraft based upon the endurance of the aircraft, as described in FIG. 58, in accordance with another exemplary aspect of the present disclosure.

FIG. 60 is a flowchart illustrating an example process for selecting a destination airport based upon one or more suitability scores associated with the identified airports, such as the airports identified utilizing the process illustrated in FIG. 15, in accordance with another exemplary aspect of the present disclosure.

FIG. 61 is a flowchart illustrating an example process for creating a route from a current position of an aircraft to a destination airport, such as the destination airport determined utilizing the process described in FIG. 60, in accordance with another exemplary aspect of the present disclosure.

FIG. 62 is a schematic view of an example autoland control for a hybrid electric aircraft system having a gas turbine engine in accordance with another exemplary aspect of the present disclosure.

FIG. 63 is a schematic view of an example implementation of the autoland control for a hybrid electric aircraft system in a single engine aircraft including a gas turbine engine in accordance with another exemplary aspect of the present disclosure.

FIG. 64 is a schematic view of an example implementation of the autoland control for a hybrid electric aircraft system in a multiengine aircraft including a gas turbine engine in accordance with another exemplary aspect of the present disclosure.

FIG. 65 is a flowchart of an example method of autoland control for a hybrid electric aircraft system including a gas turbine engine in accordance with another exemplary aspect of the present disclosure.

FIG. 66 is a flowchart of an example method, up to and including approach, of autoland control for a hybrid electric aircraft system including a gas turbine engine in accordance with another exemplary aspect of the present disclosure.

FIG. 67 is a flowchart of an example method, after touchdown, of autoland control for a hybrid electric aircraft including a gas turbine engine in accordance with another exemplary aspect of the present disclosure.

FIG. 68 is a schematic view a device in accordance with another exemplary aspect of the present disclosure.

### DETAILED DESCRIPTION

Reference will now be made in detail to present embodiments of the disclosure, one or more examples of which are illustrated in the accompanying drawings. The detailed description uses numerical and letter designations to refer to features in the drawings. Like or similar designations in the drawings and description have been used to refer to like or similar parts of the disclosure.

The term “cooled cooling air system” is used herein to mean a system configured to provide a cooling airflow to one or more components exposed to a working gas flowpath of a turbomachine of a gas turbine engine at a location downstream of a combustor of the turbomachine and upstream of an exhaust nozzle of the turbomachine, the cooling airflow being in thermal communication with a heat exchanger for reducing a temperature of the cooling airflow at a location upstream of the one or more components.

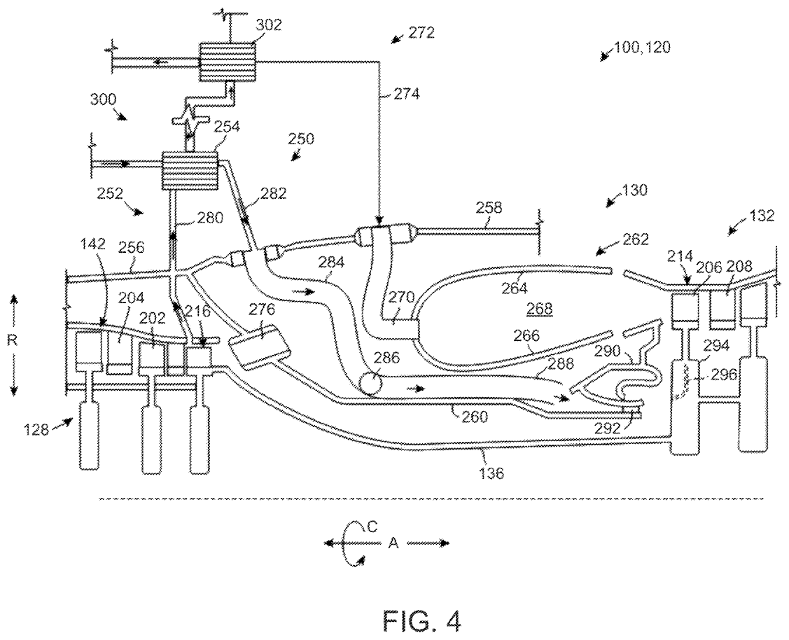

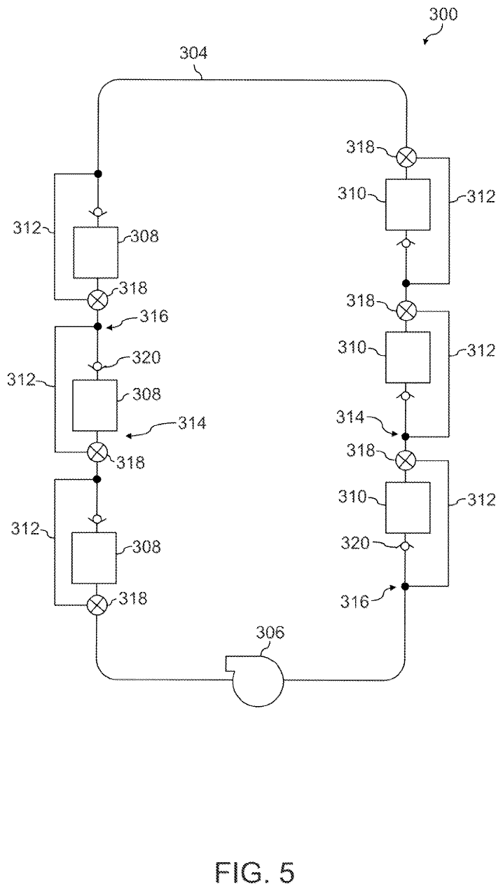

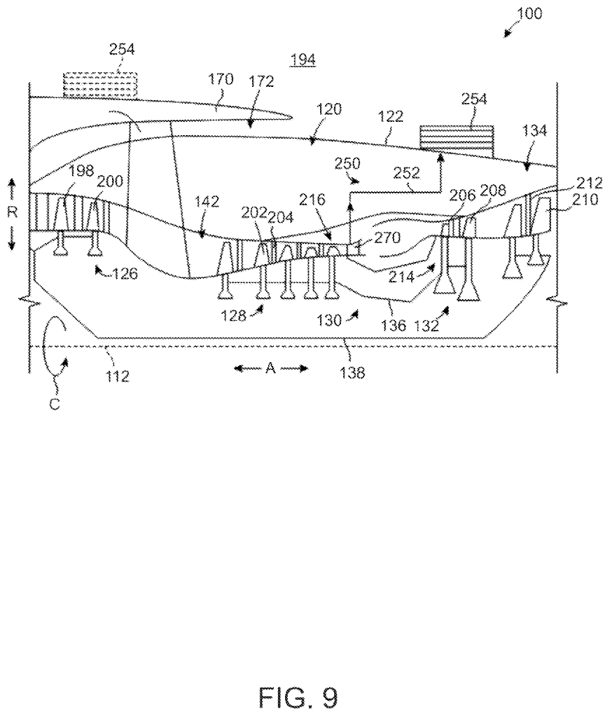

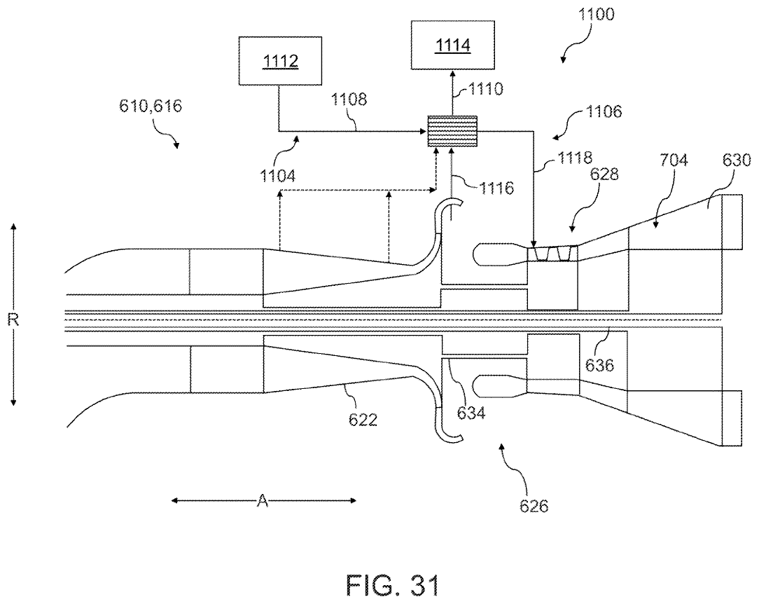

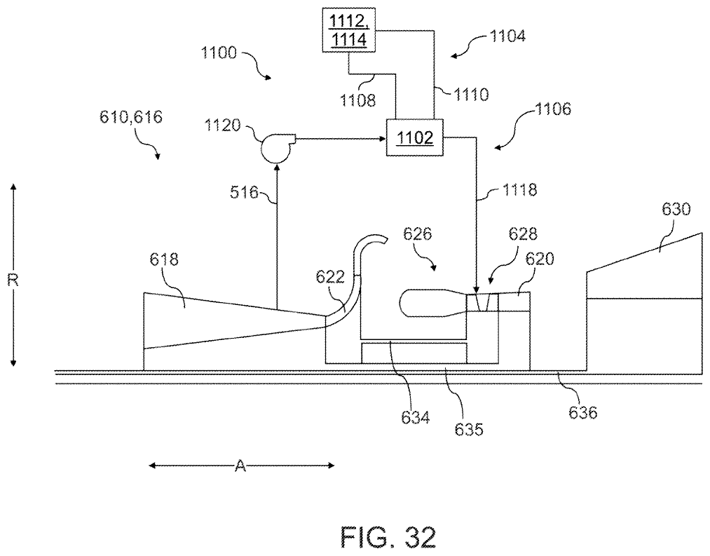

The cooled cooling air systems contemplated by the present disclosure can include a thermal bus cooled cooling air system (see, e.g., FIGS. 4 and 5) or a dedicated heat exchanger cooled cooling air system (i.e., a cooled cooling air system including a heat sink heat exchanger dedicated to the cooled cooling air system); a bypass heat exchanger cooled cooling air system having a heat sink heat exchanger thermally coupled to an airflow through a bypass passage (see, e.g., FIG. 9); an air-to-air cooled cooling air system (i.e., a cooled cooling air system having a heat sink heat exchanger configured to transfer heat to an airflow; see, e.g., FIG. 9); an oil-to-air cooled cooling air system (i.e., a cooled cooling air system having a heat sink heat exchanger configured to transfer heat to an oil flow); a fuel-to-air cooled cooling air system (i.e., a cooled cooling air system having a heat sink heat exchanger configured to transfer heat to a fuel flow, such as a Jet A fuel flow, a liquid hydrogen or hydrogen gas fuel flow, etc.; see, e.g., FIG. 4); or a combination thereof. Cooled cooling air systems contemplated by the present disclosure can be incorporated into turbofan engines, open rotor engines, turboprop engines (see FIGS. 31 and 32), and/or turboshaft engines.

In one or more of the exemplary cooled cooling air systems described herein, the cooled cooling air system can receive the cooling air from a downstream end of a high pressure compressor (i.e., a location closer to a last stage of the high pressure compressor), an upstream end of the high pressure compressor (i.e., a location closer to a first stage of the high pressure compressor), a downstream end of a low pressure compressor (i.e., a location closer to a last stage of the low pressure compressor), an upstream end of the low pressure compressor (i.e., a location closer to a first stage of the low pressure compressor), a location between compressors, a bypass passage, a combination thereof, or any other suitable airflow source.

The term “intercooler assembly” is used herein to mean a system configured to provide cooling to a gas flow through a compressor section of a turbomachine of a gas turbine engine, transferring heat from such gas flow to one or more heat sinks on the gas turbine engine and/or an aircraft incorporating the gas turbine engine. Exemplary intercooler assemblies of the present disclosure can include an intercooler heat exchanger positioned within a working gas flowpath through the compressor section, integrated into (or otherwise in thermal communication with) one or more liners or walls of the working gas flowpath through the compressor section, or located external to a turbomachine of the engine with all or a portion of the airflow through the compressor section being redirected to the intercooler heat exchanger.

The word “exemplary” is used herein to mean “serving as an example, instance, or illustration.” Any aspect described herein as “exemplary” is not necessarily to be construed as preferred or advantageous over other aspects. Additionally, unless specifically identified otherwise, all embodiments described herein should be considered exemplary.

As used herein, the terms “first,” “second,” and “third” can be used interchangeably to distinguish one component from another and are not intended to signify location or importance of the individual components.

The terms “forward” and “aft” refer to relative positions within a gas turbine engine or vehicle, and are based on a normal operational attitude of the gas turbine engine or vehicle. More particularly, forward and aft are used herein with reference to a direction of travel of the vehicle and a direction of propulsive thrust of the gas turbine engine.

The terms “upstream” and “downstream” refer to the relative direction with respect to fluid flow in a fluid pathway. For example, “upstream” refers to a direction opposite a fluid flow direction along a flow path, and “downstream” refers to the fluid flow direction along the flow path.

The terms “coupled,” “fixed,” “attached to,” and the like refer to both direct coupling, fixing, or attaching, as well as indirect coupling, fixing, or attaching through one or more intermediate components or features, unless otherwise specified herein.

The singular forms “a,” “an,” and “the” include plural references unless the context clearly dictates otherwise.

The phrases “from X to Y” and “between X and Y” each refers to a range of values inclusive of the endpoints (i.e., refers to a range of values that includes both X and Y).

A “third stream” as used herein means a non-primary air stream capable of increasing fluid energy to produce a minority of total propulsion system thrust. A pressure ratio of the third stream can be higher than that of the primary propulsion stream (e.g., a bypass or propeller driven propulsion stream). The thrust can be produced through a dedicated nozzle or through mixing of an airflow through the third stream with a primary propulsion stream or a core air stream, e.g., into a common nozzle.

In certain exemplary embodiments an operating temperature of the airflow through the third stream can be less than a maximum compressor discharge temperature for the engine, and more specifically can be less than 350 degrees Fahrenheit (such as less than 300 degrees Fahrenheit, such as less than 250 degrees Fahrenheit, such as less than 200 degrees Fahrenheit, and at least as great as an ambient temperature). In certain exemplary embodiments these operating temperatures can facilitate heat transfer to or from the airflow through the third stream and a separate fluid stream. Further, in certain exemplary embodiments, the airflow through the third stream can contribute less than 50% of the total engine thrust (and at least, e.g., 2% of the total engine thrust) at a takeoff condition, or more particularly while operating at a rated takeoff power at sea level, static flight speed, 86 degrees Fahrenheit ambient temperature operating conditions.

Furthermore in certain exemplary embodiments, aspects of the airflow through the third stream (e.g., airstream, mixing, or exhaust properties), and thereby the aforementioned exemplary percent contribution to total thrust, can passively adjust during engine operation or be modified purposefully through use of engine control features (such as fuel flow, electric machine power, variable stators, variable inlet guide vanes, valves, variable exhaust geometry, or fluidic features) to adjust or optimize overall system performance across a broad range of potential operating conditions.

The term “takeoff power level” refers to a power level of a gas turbine engine used during a maximum steady state permitted power level during a standard day operating condition, as can be documented in a Federal Aviation Administration (“FAA”)-type certificate data sheet (e.g., an FAA certification data sheet, a European Aviation Safety Agency (“EASA”) data sheet, or the like).

The term “output power” of a gas turbine engine, with respect to a turboprop or turboshaft gas turbine engine, refers to a brake horsepower providing to an output shaft (e.g., a propeller shaft of a propeller assembly, or an output drive shaft 1224 of a turboprop engine) when the during operation of the gas turbine engine at a takeoff power level. The output power of a gas turbine engine is sometimes also referred to as an output power of a turbomachine in the context of a turboprop or turboshaft gas turbine engine.

As used herein, the “maximum steady state permitted power level” refers to a maximum permitted power level for any steady state duration of time (e.g., a maximum take off power, a maximum 5 minute take off power, or other lowest duration permitted power). As used herein, the “maximum steady state permitted power level” does not refer to any transient operating conditions, one engine inoperable operating conditions, or the like.

The term “standard day operating condition” refers to ambient conditions of sea level altitude, 59 degrees Fahrenheit, and 60 percent relative humidity.

The term “overall pressure ratio” of a compressor section refers to a ratio of a pressure at an outlet of a last stage of compression (prior to combustion) to a pressure at an inlet of the compressor section (prior to any compression in the compressor section). Unless specified otherwise, the overall pressure ratio is defined when the engine is operated at a takeoff power level.

The term “propulsive efficiency” refers to an efficiency with which the energy contained in an engine's fuel is converted into kinetic energy for the vehicle incorporating the engine, to accelerate it, or to replace losses due to aerodynamic drag or gravity.

The term maximum exhaust gas temperature (referred to herein as “maximum EGT”) refers to a maximum permitted takeoff temperature (i.e., when operated at a maximum steady state permitted power level) documented in a Federal Aviation Administration (“FAA”)-type certificate data sheet (e.g., an FAA certification data sheet, a European Aviation Safety Agency (“EASA”) data sheet, or the like). For example, in certain exemplary embodiments, the term maximum EGT can refer to a maximum permitted takeoff temperature of an airflow after a first stage stator downstream of an HP turbine of an engine that the engine is rated to withstand.

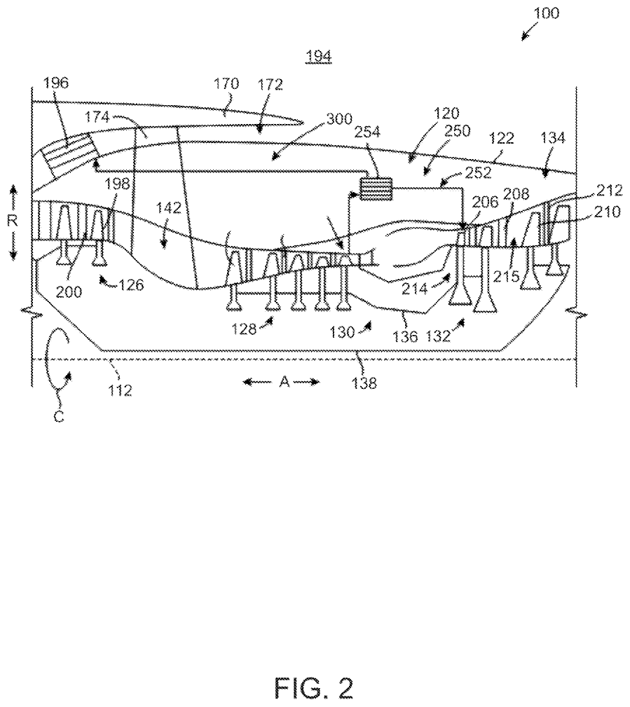

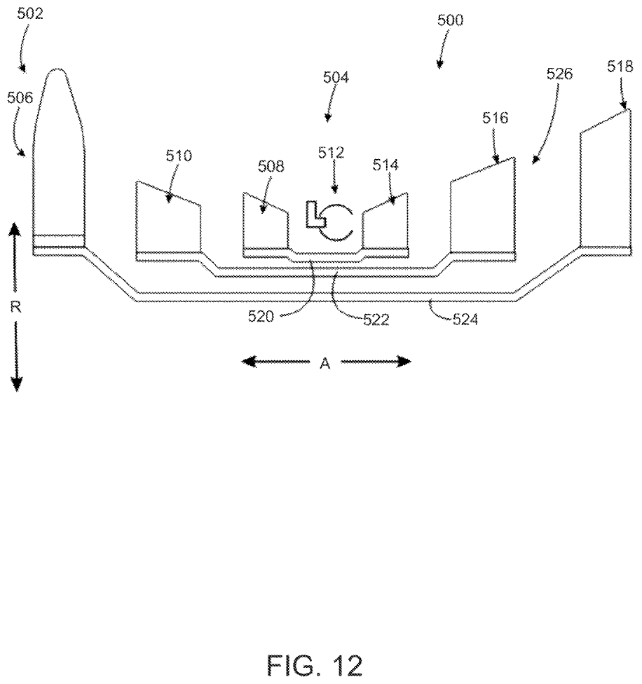

For example, with reference to the exemplary engine 100 discussed below with reference to FIG. 2, the term maximum EGT refers to a maximum permitted takeoff temperature of an airflow after the first stator 208 downstream of the last stage of rotor blades 206 of the HP turbine 132 (at location 215 into the first of the plurality of LP turbine rotor blades 210). In embodiments wherein the engine is configured as a three spool engine (as compared to the two spool engine of FIG. 2; see FIG. 12), the term maximum EGT refers to a maximum permitted takeoff temperature of an airflow after the first stator downstream of the last stage of rotor blades of the intermediate speed turbine (see intermediate speed turbine 516 of the engine 500 of FIG. 12).

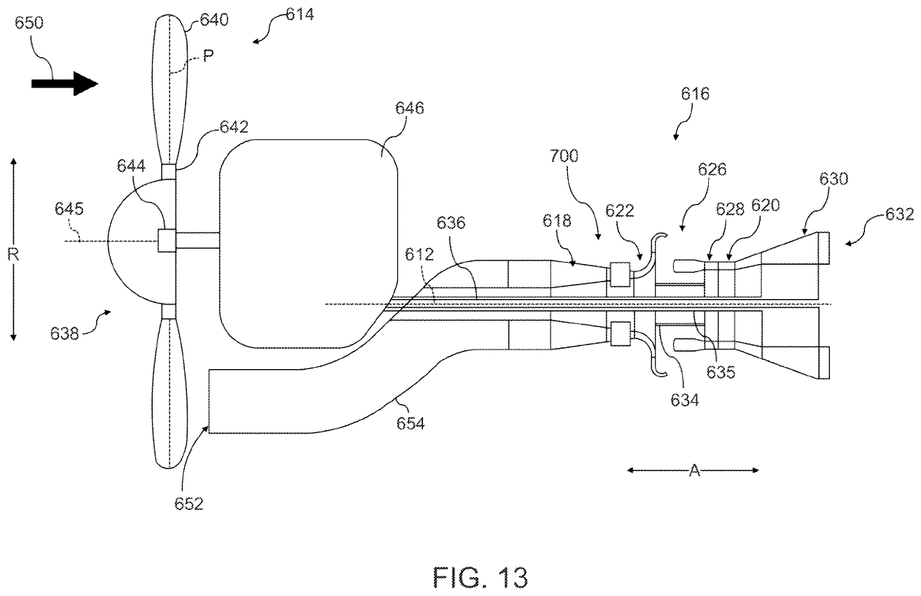

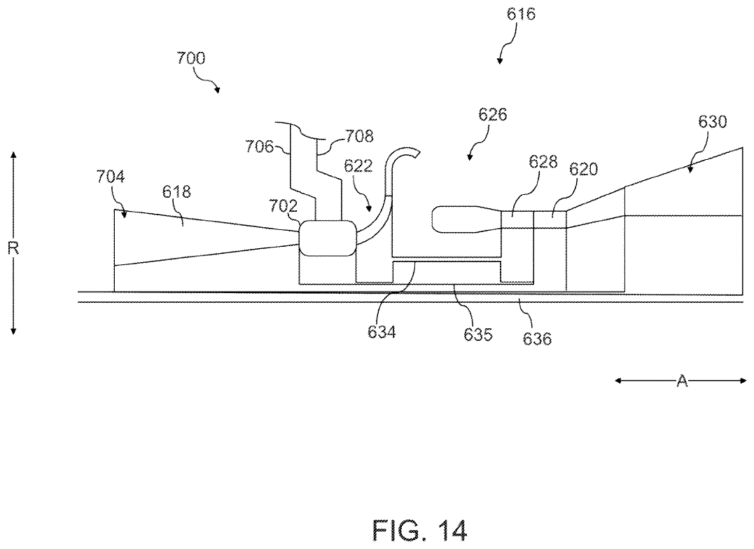

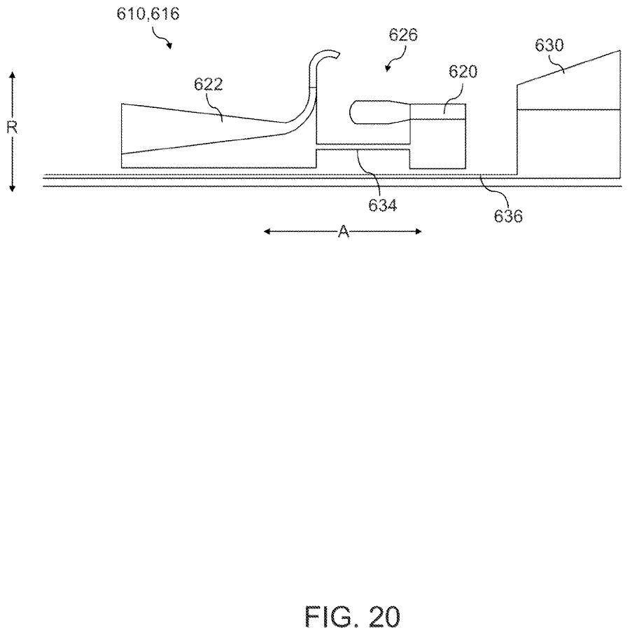

For example, with reference to the exemplary engine 610 discussed below with reference to FIGS. 13 and 14, the term maximum EGT refers to a maximum permitted takeoff temperature of an airflow after a first stator downstream of a last stage of rotor blades of the intermediate pressure turbine 620 (at a location into a first of the plurality of low pressure turbine rotor blades of the low pressure turbine 630). In embodiments wherein the engine is configured as a two spool engine (as compared to the three spool engine of FIGS. 13 and 14 see, e.g., FIG. 20), the term maximum EGT refers to a maximum permitted takeoff temperature of an airflow after a first stator downstream of the last stage of rotor blades of the high pressure turbine 628 (at a location into a first of the plurality of low pressure turbine rotor blades of the low pressure turbine 630).

The term EGT is sometimes also referred to as an indicated turbine exhaust gas temperature or indicated turbine temperature, and the term maximum EGT is sometimes also referred to as a redline EGT.

The term maximum drive turbine shaft torque (T_{OUT}) refers to a torque on a shaft of a gas turbine engine on a high speed side of a power gearbox of the gas turbine engine (which typically is the shaft coupled to the low pressure turbine) when the gas turbine engine is operated at a maximum steady state permitted power level documented in an FAA-type certificate data sheet (e.g., an FAA certification data sheet, a European Aviation Safety Agency (“EASA”) data sheet, or the like). As will be appreciated, the torque on the drive turbine shaft can be determined using an output power (P_{OUT}; in kilowatts, or “kW”) of a drive turbine (e.g., of a low pressure turbine in the embodiments described herein) coupled to the drive turbine shaft and rotational speed (N; in revolutions per minute, or “rpm”) of the drive turbine, using the equation: T_{OUT}=9,548.8×P_{OUT}/N.

Generally, a turbofan engine includes a fan and a turbomachine, with the turbomachine rotating the fan to generate thrust. The turbomachine includes a compressor section, a combustion section, a turbine section, and an exhaust section and defines a working gas flowpath therethrough. A relatively small amount of thrust can also be generated by an airflow exiting the working gas flowpath of the turbomachine through the exhaust section. In addition, certain turbofan engines can further include a third stream that contributes to a total thrust output of the turbofan engine, potentially allowing for a reduction in size of a core of the turbomachine for a given total turbofan engine thrust output.

Conventional turbofan engine design practice has limited a compressor pressure ratio based at least in part on the gas temperatures at the exit stage of a high pressure compressor. These relatively high temperatures at the exit of the high pressure compressor can also be avoided when they result in prohibitively high temperatures at an inlet to the turbine section, as well as when they result in prohibitively high exhaust gas temperatures through the exhaust section. For a desired turbofan engine thrust output produced from an increased pressure ratio across the high pressure compressor, there is an increase in the gas temperature at the compressor exit, at a combustor inlet, at the turbine section inlet, and through an exhaust section of the turbofan engine.

The inventors have recognized that there are generally three approaches to making a gas turbine engine capable of operating at higher temperatures while providing a net benefit to engine performance: reducing the temperature of a gas used to cool core components, utilizing materials capable of withstanding higher operating temperature conditions, or a combination thereof.

Referring to the case of an engine that utilizes cooled cooling air for operating at higher temperatures, the inventors of the present disclosure discovered, unexpectedly, that the costs associated with achieving a higher compression by reducing gas temperatures used to cool core components to accommodate higher core gas temperatures can indeed produce a net benefit, contrary to prior expectations in the art. The inventors discovered during the course of designing several engine architectures of varying thrust classes and mission requirements (including the engines illustrated and described in detail herein) a relationship exists among the exhaust gas passing through the exhaust section, the desired maximum thrust for the engine, and the size of the exit stage of the high pressure compressor, whereby including this technology produces a net benefit. Previously it was thought that the cost for including a technology to reduce the temperature of gas intended for cooling compressor and turbine components was too prohibitive, as compared to the benefits of increasing the core temperatures.

For example, the inventors of the present disclosure found that a cooled cooling air system can be included while maintaining or even increasing the maximum turbofan engine thrust output, based on this discovery. The cooled cooling air system can receive an airflow from the compressor section, reduce a temperature of the airflow using a heat exchanger, and provide the cooled airflow to one or more components of the turbine section, such as a first stage of high pressure turbine rotor blades. In such a manner, a first stage of high pressure turbine rotor blades can be capable of withstanding increased temperatures by using the cooled cooling air, while providing a net benefit to the turbofan engine, i.e., while taking into consideration the costs associated with accommodations made for the system used to cool the cooling air.

The inventors reached this conclusion after evaluating potentially negative impacts to engine performance brought on by introduction of a cooled cooling air system. For example, a cooled cooling air system can generally include a duct extending through a diffusion cavity between a compressor exit and a combustor within the combustion section, such that increasing the cooling capacity can concomitantly increase a size of the duct and thus increase a drag or blockage of an airflow through the diffusion cavity, potentially creating problems related to, e.g., combustor aerodynamics. Similarly, a dedicated or shared heat exchanger of the cooled cooling air system can be positioned in a bypass passage of the turbofan engine, which can create an aerodynamic drag or can increase a size of the shared heat exchanger and increase aerodynamic drag. Size and weight increases associated with maintaining certain risk tolerances were also taken into consideration. For example, a cooled cooling air system must be accompanied with adequate safeguards in the event of a burst pipe condition, which safeguards result in further increases in the overall size, complexity, and weight of the system.

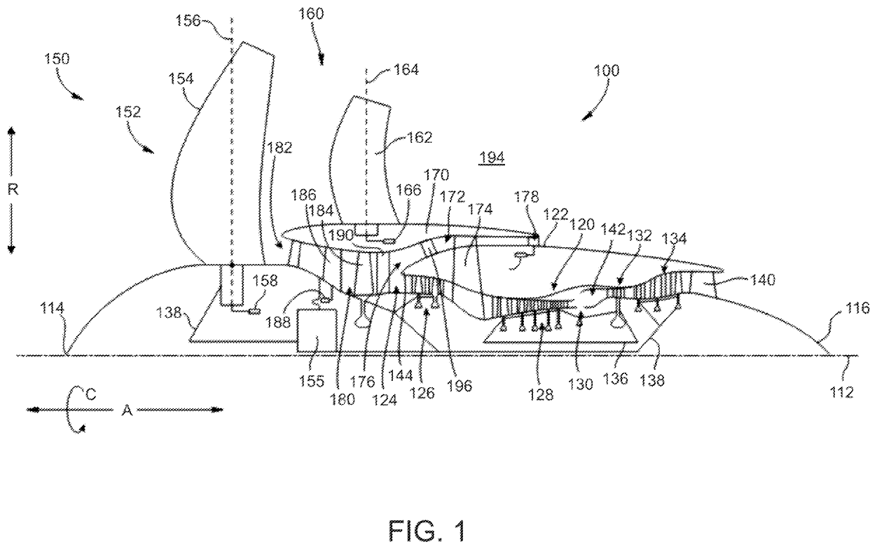

With a goal of arriving at an improved turbofan engine capable of operating at higher temperatures at the compressor exit and turbine inlet, the inventors have proceeded in the manner of designing turbofan engines having an overall pressure ratio, total thrust output, maximum exhaust gas temperature, and the supporting technology characteristics; checking the propulsive efficiency and qualitative turbofan engine characteristics of the designed turbofan engine; redesigning the turbofan engine to have higher or lower compression ratios based on the impact on other aspects of the architecture, total thrust output, maximum exhaust gas temperature, and supporting technology characteristics; rechecking the propulsive efficiency and qualitative turbofan engine characteristics of the redesigned turbofan engine; etc. during the design of several different types of turbofan engines, including the turbofan engines described below with reference to FIGS. 1 and 4 through 8 through 11, which will now be discussed in greater detail.

Referring now to FIG. 1, a schematic cross-sectional view of an engine 100 is provided according to an example embodiment of the present disclosure. Particularly, FIG. 1 provides a turbofan engine having a rotor assembly with a single stage of unducted rotor blades. In such a manner, the rotor assembly can be referred to herein as an “unducted fan,” or the entire engine 100 can be referred to as an “unducted turbofan engine.” In addition, the engine 100 of FIG. 1 includes a third stream extending from a location downstream of a ducted mid-fan to a bypass passage over the turbomachine, as will be explained in more detail below.

For reference, the engine 100 defines an axial direction A, a radial direction R, and a circumferential direction C. Moreover, the engine 100 defines an axial centerline or longitudinal axis 112 that extends along the axial direction A. In general, the axial direction A extends parallel to the longitudinal axis 112, the radial direction R extends outward from and inward to the longitudinal axis 112 in a direction orthogonal to the axial direction A, and the circumferential direction extends three hundred sixty degrees (360°) around the longitudinal axis 112. The engine 100 extends between a forward end 114 and an aft end 116, e.g., along the axial direction A.

The engine 100 includes a turbomachine 120 and a rotor assembly, also referred to a fan section 150, positioned upstream thereof. Generally, the turbomachine 120 includes, in serial flow order, a compressor section, a combustion section 130, a turbine section, and an exhaust section. Particularly, as shown in FIG. 1, the turbomachine 120 includes a core cowl 122 that defines an annular core inlet 124. The core cowl 122 further encloses at least in part a low pressure system and a high pressure system. For example, the core cowl 122 depicted encloses and supports at least in part a booster or low pressure (“LP”) compressor 126 for pressurizing the air that enters the turbomachine 120 through core inlet 124. A high pressure (“HP”), multi-stage, axial-flow compressor 128 receives pressurized air from the LP compressor 126 and further increases the pressure of the air. The pressurized air stream flows downstream to a combustor of the combustion section 130 where fuel is injected into the pressurized air stream and ignited to raise the temperature and energy level of the pressurized air.

It will be appreciated that as used herein, the terms “high/low speed” and “high/low pressure” are used with respect to the high pressure/high speed system and low pressure/low speed system interchangeably. Further, it will be appreciated that the terms “high” and “low” are used in this same context to distinguish the two systems, and are not meant to imply any absolute speed and/or pressure values.

The high energy combustion products flow from the combustion section 130 downstream to a high pressure turbine 132. The high pressure turbine 132 drives the high pressure compressor 128 through a high pressure shaft 136. In this regard, the high pressure turbine 132 is drivingly coupled with the high pressure compressor 128. As will be appreciated, the high pressure compressor 128, the combustion section 130, and the high pressure turbine 132 can collectively be referred to as the “core” of the engine 100. The high energy combustion products then flow to a low pressure turbine 134. The low pressure turbine 134 drives the low pressure compressor 126 and components of the fan section 150 through a low pressure shaft 138. In this regard, the low pressure turbine 134 is drivingly coupled with the low pressure compressor 126 and components of the fan section 150. The LP shaft 138 is coaxial with the HP shaft 136 in this example embodiment. After driving each of the turbines 132, 134, the combustion products exit the turbomachine 120 through a turbomachine exhaust nozzle 140.

Accordingly, the turbomachine 120 defines a working gas flowpath or core duct 142 that extends between the core inlet 124 and the turbomachine exhaust nozzle 140. The working gas flowpath 142 is an annular duct positioned generally inward of the core cowl 122 along the radial direction R. The working gas flowpath 142 (e.g., the working gas flowpath through the turbomachine 120) can be referred to as a second stream.

The fan section 150 includes a fan 152, which is the primary fan in this example embodiment. For the depicted embodiment of FIG. 1, the fan 152 is an open rotor or unducted fan 152. In such a manner, the engine 100 can be referred to as an open rotor engine.

As depicted, the fan 152 includes an array of fan blades 154 (only one shown in FIG. 1). The fan blades 154 are rotatable, e.g., about the longitudinal axis 112. As noted above, the fan 152 is drivingly coupled with the low pressure turbine 134 via the LP shaft 138. For the embodiments shown in FIG. 1, the fan 152 is coupled with the LP shaft 138 via a speed reduction gearbox 155, e.g., in an indirect-drive or geared-drive configuration.

Moreover, the array of fan blades 154 can be arranged in equal spacing around the longitudinal axis 112. Each fan blade 154 has a root and a tip and a span defined therebetween, and further defines a central blade axis 156. For this embodiment, each fan blade 154 of the fan 152 is rotatable about its respective central blade axis 156, e.g., in unison with one another. One or more actuators 158 are provided to facilitate such rotation and therefore can be used to change a pitch of the fan blades 154 about their respective central blades' axes 156.

The fan section 150 further includes a fan guide vane array 160 that includes fan guide vanes 162 (only one shown in FIG. 1) disposed around the longitudinal axis 112. For this embodiment, the fan guide vanes 162 are not rotatable about the longitudinal axis 112. Each fan guide vane 162 has a root and a tip and a span defined therebetween. The fan guide vanes 162 can be unshrouded as shown in FIG. 1 or, alternatively, can be shrouded, e.g., by an annular shroud spaced outward from the tips of the fan guide vanes 162 along the radial direction R or attached to the fan guide vanes 162.

Each fan guide vane 162 defines a central blade axis 164. For this embodiment, each fan guide vane 162 of the fan guide vane array 160 is rotatable about its respective central blade axis 164, e.g., in unison with one another. One or more actuators 166 are provided to facilitate such rotation and therefore can be used to change a pitch of the fan guide vane 162 about its respective central blade axis 164. However, in other embodiments, each fan guide vane 162 can be fixed or unable to be pitched about its central blade axis 164. The fan guide vanes 162 are mounted to a fan cowl 170. Notably, the engine 100 defines a bypass passage 194 over the fan cowl 170 and core cowl 122.

As shown in FIG. 1, in addition to the fan 152, which is unducted, a ducted fan 184 is included aft of the fan 152, such that the engine 100 includes both a ducted and an unducted fan which both serve to generate thrust through the movement of air without passage through at least a portion of the turbomachine 120 (e.g., without passage through the HP compressor 128 and combustion section for the embodiment depicted). The ducted fan 184 is rotatable about the same axis (e.g., the longitudinal axis 112) as the fan 152. The ducted fan 184 is, for the embodiment depicted, driven by the low pressure turbine 134 (e.g., coupled to the LP shaft 138). In the embodiment depicted, as noted above, the fan 152 can be referred to as the primary fan, and the ducted fan 184 can be referred to as a secondary fan. It will be appreciated that these terms “primary” and “secondary” are terms of convenience, and do not imply any particular importance, power, or the like.

The ducted fan 184 includes a plurality of fan blades (not separately labeled in FIG. 1) arranged in a single stage, such that the ducted fan 184 can be referred to as a single stage fan. The fan blades of the ducted fan 184 can be arranged in equal spacing around the longitudinal axis 112. Each blade of the ducted fan 184 has a root and a tip and a span defined therebetween.

The fan cowl 170 annularly encases at least a portion of the core cowl 122 and is generally positioned outward of at least a portion of the core cowl 122 along the radial direction R. Particularly, a downstream section of the fan cowl 170 extends over a forward portion of the core cowl 122 to define a fan duct flowpath, or simply a fan duct 172. According to this embodiment, the fan duct flowpath or fan duct 172 can be understood as forming at least a portion of the third stream of the engine 100.

Incoming air can enter through the fan duct 172 through a fan duct inlet 176 and can exit through a fan exhaust nozzle 178 to produce propulsive thrust. The fan duct 172 is an annular duct positioned generally outward of the working gas flowpath 142 along the radial direction R. The fan cowl 170 and the core cowl 122 are connected together and supported by a plurality of substantially radially-extending, circumferentially-spaced stationary struts 174 (only one shown in FIG. 1). The stationary struts 174 can each be aerodynamically contoured to direct air flowing thereby. Other struts in addition to the stationary struts 174 can be used to connect and support the fan cowl 170 and/or core cowl 122. In many embodiments, the fan duct 172 and the working gas flowpath 142 can at least partially co-extend (generally axially) on opposite sides (e.g., opposite radial sides) of the core cowl 122. For example, the fan duct 172 and the working gas flowpath 142 can each extend directly from a leading edge 144 of the core cowl 122 and can partially co-extend generally axially on opposite radial sides of the core cowl 122.

The engine 100 also defines or includes an inlet duct 180. The inlet duct 180 extends between an engine inlet 182 and the core inlet 124/fan duct inlet 176. The engine inlet 182 is defined generally at the forward end of the fan cowl 170 and is positioned between the fan 152 and the fan guide vane array 160 along the axial direction A. The inlet duct 180 is an annular duct that is positioned inward of the fan cowl 170 along the radial direction R. Air flowing downstream along the inlet duct 180 is split, not necessarily evenly, into the working gas flowpath 142 and the fan duct 172 by the leading edge 144 of the core cowl 122. The inlet duct 180 is wider than the working gas flowpath 142 along the radial direction R. The inlet duct 180 is also wider than the fan duct 172 along the radial direction R. The secondary fan 184 is positioned at least partially in the inlet duct 180.

Notably, for the embodiment depicted, the engine 100 includes one or more features to increase an efficiency of a third stream thrust, Fn3S (e.g., a thrust generated by an airflow through the fan duct 172 exiting through the fan exhaust nozzle 178, generated at least in part by the ducted fan 184). In particular, the engine 100 further includes an array of inlet guide vanes 186 positioned in the inlet duct 180 upstream of the ducted fan 184 and downstream of the engine inlet 182. The array of inlet guide vanes 186 are arranged around the longitudinal axis 112. For this embodiment, the inlet guide vanes 186 are not rotatable about the longitudinal axis 112. Each inlet guide vane 186 defines a central blade axis (not labeled for clarity), and is rotatable about its respective central blade axis, e.g., in unison with one another. In such a manner, the inlet guide vanes 186 can be considered a variable geometry component. One or more actuators 188 are provided to facilitate such rotation and therefore can be used to change a pitch of the inlet guide vanes 186 about their respective central blade axes. However, in other embodiments, each inlet guide vane 186 can be fixed or unable to be pitched about its central blade axis.

Further, located downstream of the ducted fan 184 and upstream of the fan duct inlet 176, the engine 100 includes an array of outlet guide vanes 190. As with the array of inlet guide vanes 186, the array of outlet guide vanes 190 are not rotatable about the longitudinal axis 112. However, for the embodiment depicted, unlike the array of inlet guide vanes 186, the array of outlet guide vanes 190 are configured as fixed-pitch outlet guide vanes.

Further, it will be appreciated that for the embodiment depicted, the fan exhaust nozzle 178 of the fan duct 172 is further configured as a variable geometry exhaust nozzle. In such a manner, the engine 100 includes one or more actuators 192 for modulating the variable geometry exhaust nozzle. For example, the variable geometry exhaust nozzle can be configured to vary a total cross-sectional area (e.g., an area of the nozzle in a plane perpendicular to the longitudinal axis 112) to modulate an amount of thrust generated based on one or more engine operating conditions (e.g., temperature, pressure, mass flowrate, etc. of an airflow through the fan duct 172). A fixed geometry exhaust nozzle can also be adopted.

The combination of the array of inlet guide vanes 186 located upstream of the ducted fan 184, the array of outlet guide vanes 190 located downstream of the ducted fan 184, and the fan exhaust nozzle 178 can result in a more efficient generation of third stream thrust, Fn3S, during one or more engine operating conditions. Further, by introducing a variability in the geometry of the inlet guide vanes 186 and the fan exhaust nozzle 178, the engine 100 can be capable of generating more efficient third stream thrust, Fn3S, across a relatively wide array of engine operating conditions, including takeoff and climb as well as cruise.

Moreover, referring still to FIG. 1, in exemplary embodiments, air passing through the fan duct 172 can be relatively cooler (e.g., lower temperature) than one or more fluids utilized in the turbomachine 120. In this way, one or more heat exchangers 196 can be positioned in thermal communication with the fan duct 172. For example, one or more heat exchangers 196 can be disposed within the fan duct 172 and utilized to cool one or more fluids from the core engine with the air passing through the fan duct 172, as a resource for removing heat from a fluid, e.g., compressor bleed air, oil, or fuel.

Although not depicted, the heat exchanger 196 can be an annular heat exchanger extending substantially 360 degrees in the fan duct 172 (e.g., at least 300 degrees, such as at least 330 degrees). In such a manner, the heat exchanger 196 can effectively utilize the air passing through the fan duct 172 to cool one or more systems of the engine 100 (e.g., a cooled cooling air system (described below), lubrication oil systems, compressor bleed air, electrical components, etc.). The heat exchanger 196 uses the air passing through duct 172 as a heat sink and correspondingly increases the temperature of the air downstream of the heat exchanger 196 and exiting the fan exhaust nozzle 178.

As will be appreciated, the engine 100 defines a total sea level static thrust output Fn_{Total}, corrected to standard day conditions, which is generally equal to a maximum total engine thrust. It will be appreciated that “sea level static thrust corrected to standard day conditions” refers to an amount of thrust an engine is capable of producing while at rest relative to the earth and the surrounding air during standard day operating conditions.

The total sea level static thrust output Fn_{Total} can generally be equal to a sum of: a fan stream thrust FnFan (i.e., an amount of thrust generated by the fan 152 through the bypass passage 194), the third stream thrust Fn3S (i.e., an amount of thrust generated through the fan duct 172), and a turbomachine thrust FnTM (i.e., an amount of thrust generated by an airflow through the turbomachine exhaust nozzle 140), each during the static, sea level, standard day conditions. The engine 100 can define a total sea level static thrust output Fn_{Total} greater than or equal to 15,000 pounds. For example, it will be appreciated that the engine 100 can be configured to generate at least 25,000 pounds and less than 80,000 pounds, such as between 25,000 and 50,000 pounds, such as between 35,000 and 45,000 pounds of thrust during a takeoff operating power, corrected to standard day sea level conditions.

As will be appreciated, the engine 100 defines a maximum exhaust gas temperature (referred to herein as “EGT”), which is defined above, and for the embodiment of FIG. 1 refers to a maximum permitted takeoff temperature of an airflow after the first stator 208 downstream of the last stage of rotor blades 206 of the HP turbine 132 (at location 215 into the first of the plurality of LP turbine rotor blades 210; see FIG. 2).

Referring now to FIG. 2, a close-up, simplified, schematic view of a portion of the engine 100 of FIG. 1 is provided. The engine 100, as noted above includes the turbomachine 120 having the LP compressor 126, the HP compressor 128, the combustion section 130, the HP turbine 132, and the LP turbine 134. The LP compressor 126 includes a plurality of stages of LP compressor rotor blades 198 and a plurality of stages of LP compressor stator vanes 200 alternatingly spaced with the plurality of stages of LP compressor rotor blades 198. Similarly, the HP compressor 128 includes a plurality of stages of HP compressor rotor blades 202 and a plurality of stages of HP compressor stator vanes 204 alternatingly spaced with the plurality of stages of HP compressor rotor blades 202. Moreover, within the turbine section, the HP turbine 132 includes at least one stage of HP turbine rotor blades 206 and at least one stage of HP turbine stator vanes 208, and the LP turbine 134 includes a plurality of stages of LP turbine rotor blades 210 and a plurality of stages of LP turbine stator vanes 212 alternatingly spaced with the plurality of stages of LP turbine rotor blades 210. With reference to the HP turbine 132, the HP turbine 132 includes at least a first stage 214 of HP turbine rotor blades 206.

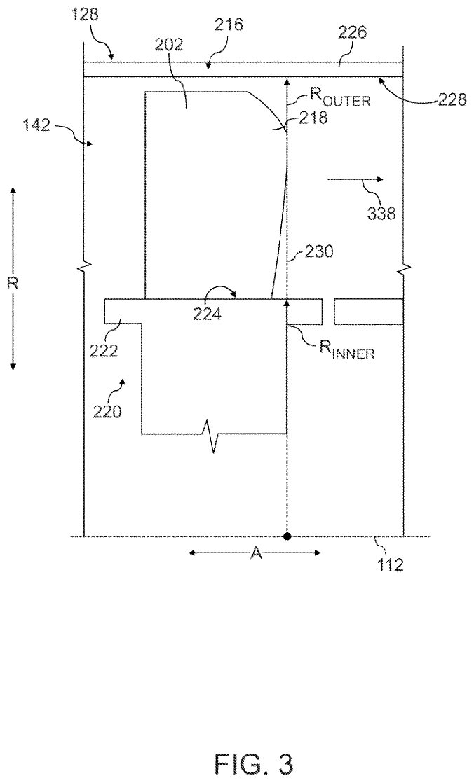

Referring particularly to the HP compressor 128, the plurality of stages of HP compressor rotor blades 202 includes an aftmost stage 216 of HP compressor rotor blades 202. Referring briefly to FIG. 3, a close-up view of an HP compressor rotor blade 202 in the aftmost stage 216 of HP compressor rotor blades 202 is provided. As will be appreciated, the HP compressor rotor blade 202 includes a trailing edge 218 and the aftmost stage 216 of HP compressor rotor blades 202 includes a rotor 220 having a base 222 to which the HP compressor rotor blade 202 is coupled. The base 222 includes a flowpath surface 224 defining in part the working gas flow path 142 through the HP compressor 128. Moreover, the HP compressor 128 includes a shroud or liner 226 located outward of the HP compressor rotor blade 202 along the radial direction R. The shroud or liner 226 also includes a flowpath surface 228 defining in part the working gas flow path 142 through the HP compressor 128.

The engine 100 (FIG. 3) defines a reference plane 230 intersecting with an aft-most point of the trailing edge 218 of the HP compressor rotor blade 202 depicted, the reference plane 230 being orthogonal to the axial direction A. Further, the HP compressor 128 defines a high pressure compressor exit area (A_{HPCExit}) within the reference plane 230. More specifically, the HP compressor 128 defines an inner radius (R_{INNER}) extending along the radial direction R within the reference plane 230 from the longitudinal axis 112 to the flowpath surface 224 of the base 222 of the rotor 220 of the aftmost stage 216 of HP compressor rotor blades 202, as well as an outer radius (R_{OUTER}) extending along the radial direction R within the reference plane 230 from the longitudinal axis 112 to the flowpath surface 228 of the shroud or liner 226. The HP compressor 128 exit area is defined according to Expression (1):

$${A}_{HPCExit} = π ( {{R}_{OUTER}}^{2} - {{R}_{INNER}}^{2} ) \qquad Expression ( 1 )$$

The inventors of the present disclosure have found that for a given total thrust output (Fn_{Total}), a decrease in size of the high pressure compressor exit area (A_{HPCExit}) can generally relate in an increase in a compressor exit temperature (i.e., a temperature of the airflow through the working gas flowpath 142 at the reference plane 230), a turbine inlet temperature (i.e., a temperature of the airflow through the working gas flowpath 142 provided to the first stage 214 of HP turbine rotor blades 206; see FIG. 2), and the maximum exhaust gas temperature (EGT). In particular, the inventors of the present disclosure have found that the high pressure compressor exit area (A_{HPCExit}) can generally be used as an indicator of the above temperatures to be achieved by the engine 100 during operation for a given total thrust output (Fn_{Total}) of the engine 100.

Referring back to FIG. 2, the exemplary engine 100 depicted includes one or more technologies to accommodate the relatively small high pressure compressor exit area (A_{HPCExit}) for the total thrust output (Fn_{Total}) of the engine 100. In particular, for the embodiment depicted, the exemplary engine 100 includes a cooled cooling air system 250. The exemplary cooled cooling air system 250 is in fluid communication with the HP compressor 128 and the first stage 214 of HP turbine rotor blades 206. More specifically, for the embodiment depicted, the cooled cooling air system 250 includes a duct assembly 252 and a cooled cooling air (CCA) heat exchanger 254. The duct assembly 252 is in fluid communication with the HP compressor 128 for receiving an airflow from the HP compressor 128 and providing such airflow to the first stage 214 of HP turbine rotor blades 206 during operation of the engine 100. The CCA heat exchanger 254 is in thermal communication with the airflow through the duct assembly 252 for reducing a temperature of the airflow through the duct assembly 252 upstream of the first stage 214 of HP turbine rotor blades 206.

Briefly, as will be explained in more detail below, the engine 100 depicted further includes a thermal transport bus 300, with the CCA heat exchanger 254 of the cooled cooling air system 250 in thermal communication with, or integrated into, the thermal transport bus 300. For the embodiment depicted, the engine 100 further includes the heat exchanger 196 in the fan duct 172 in thermal communication with, or integrated into, the thermal transport bus 300, such that heat from the CCA heat exchanger 254 of the cooled cooling air system 250 can be transferred to the heat exchanger 196 in the fan duct 172 using the thermal transport bus 300.

Referring now to FIG. 4, a close-up, schematic view of the turbomachine 120 of the engine 100 of FIG. 2, including the cooled cooling air system 250, is provided.

As is shown, the turbine section includes a compressor casing 256, and the combustion section 130 of the turbomachine 120 generally includes an outer combustor casing 258, an inner combustor casing 260, and a combustor 262. The combustor 262 generally includes an outer combustion chamber liner 264 and an inner combustion chamber liner 266, together defining at least in part a combustion chamber 268. The combustor 262 further includes a fuel nozzle 270 configured to provide a mixture of fuel and air to the combustion chamber 268 to generate combustion gases.

The engine 100 further includes a fuel delivery system 272 including at least a fuel line 274 in fluid communication with the fuel nozzle 270 for providing fuel to the fuel nozzle 270.

The turbomachine 120 includes a diffuser nozzle 276 located downstream of the aftmost stage 216 of HP compressor rotor blades 202 of the HP compressor 128, within the working gas flowpath 142. In the embodiment depicted, the diffuser nozzle 276 is coupled to, or integrated with the inner combustor casing 260, the outer combustor casing 258, or both. The diffuser nozzle 276 is configured to receive compressed airflow from the HP compressor 128 and straighten such compressed air prior to such compressed air being provided to the combustion section 130. The combustion section 130 defines a diffusion cavity 278 downstream of the diffuser nozzle 276 and upstream of the combustion chamber 268.

As noted above, the exemplary engine 100 further includes the cooled cooling air system 250. The cooled cooling air system 250 includes the duct assembly 252 and the CCA heat exchanger 254. More specifically, the duct assembly 252 includes a first duct 280 in fluid communication with the HP compressor 128 and the CCA heat exchanger 254. The first duct 280 more specifically extends from the HP compressor 128, through the compressor casing 256, to the CCA heat exchanger 254. For the embodiment depicted, the first duct 280 is in fluid communication with the HP compressor 128 at a location in between the last two stages of HP compressor rotor blades 202. In such a manner, the first duct 280 is configured to receive a cooling airflow from the HP compressor 128 and to provide the cooling airflow to the CCA heat exchanger 254.

It will be appreciated, however, that in other embodiments, the first duct 280 can additionally or alternatively be in fluid communication with the HP compressor 128 at any other suitable location, such as at any other location closer to a downstream end of the HP compressor 128 than an upstream end of the HP compressor 128, or alternatively at a location closer to the upstream end of the HP compressor 128 than the downstream end of the HP compressor 128.

The duct assembly 252 further includes a second duct 282 extending from the CCA heat exchanger 254 to the outer combustor casing 258 and a third duct 284 extending from the outer combustor casing 258 inwardly generally along the radial direction R. The CCA heat exchanger 254 can be configured to receive the cooling airflow and to extract heat from the cooling airflow to reduce a temperature of the cooling airflow. The second duct 282 can be configured to receive cooling airflow from the CCA heat exchanger 254 and provide the cooling airflow to the third duct 284. The third duct 284 extends through the diffusion cavity generally along the radial direction R.

Moreover, for the embodiment depicted, the duct assembly 252 further includes a manifold 286 in fluid communication with the third duct 284 and a fourth duct 288. The manifold 286 extends generally along the circumferential direction C of the engine 100, and the fourth duct 288 is more specifically a plurality of fourth ducts 288 extending from the manifold 286 at various locations along the circumferential direction C forward generally along the axial direction A towards the turbine section. In such a manner, the duct assembly 252 of the cooled cooling air system 250 can be configured to provide cooling airflow to the turbine section at a variety of locations along the circumferential direction C.

Notably, referring still to FIG. 4, the combustion section 130 includes an inner stator assembly 290 located at a downstream end of the inner combustion chamber liner 266, and coupled to the inner combustor casing 260. The inner stator assembly 290 includes a nozzle 292. The fourth duct 288, or rather, the plurality of fourth ducts 288, are configured to provide the cooling airflow to the nozzle 292. The nozzle 292 can include a plurality of vanes spaced along the circumferential direction C configured to impart a circumferential swirl to the cooling airflow provided through the plurality of fourth ducts 288 to assist with such airflow being provided to the first stage 214 of HP turbine rotor blades 206.

In particular, for the embodiment depicted, the HP turbine 132 further includes a first stage HP turbine rotor 294, with the plurality of HP turbine rotor blades 206 of the first stage 214 coupled to the first stage HP turbine rotor 294. The first stage HP turbine rotor 294 defines an internal cavity 296 configured to receive the cooling airflow from the nozzle 292 and provide the cooling airflow to the plurality of HP turbine rotor blades 206 of the first stage 214. In such a manner, the cooled cooling air system 250 can provide cooling airflow to the HP turbine rotor blades 206 to reduce a temperature of the plurality HP turbine rotor blades 206 at the first stage 214 during operation of the engine 100.

For example, in certain exemplary aspects, the cooled cooling air system 250 can be configured to provide a temperature reduction of the cooling airflow equal to at least 15% of the EGT and up to 45% of the EGT. Further, in certain exemplary aspects, the cooled cooling air system 250 can be configured to receive between 2.5% and 35% of an airflow through the working gas flowpath 142 at an inlet to the HP compressor 128, such as between 3% and 20%, such as between 4% and 15%.

In addition, as briefly mentioned above, the cooled cooling air system 250 can utilize the thermal transport bus 300 to reject heat from the cooling air extracted from the compressor section of the turbomachine 120. In particular, for the embodiment shown the CCA heat exchanger 254 is in thermal communication with or integrated into the thermal transport bus 300. Notably, the thermal transport bus 300 further includes a fuel heat exchanger 302 in thermal communication with the fuel line 274. In such a manner, the thermal transport bus 300 can extract heat from the cooling air extracted from the compressor section through the cooled cooling air system 250 and provide such heat to a fuel flow through the fuel line 274 upstream of the fuel nozzle 270.

For the embodiment depicted, the thermal transport bus 300 includes a conduit having a flow of thermal transport fluid therethrough. More specifically, referring now briefly to FIG. 5, a schematic view of a thermal transport bus 300 as can be utilized with the exemplary engine 100 described above with reference to FIGS. 1 through 4 is provided.

The thermal transport bus 300 includes an intermediary heat exchange fluid flowing therethrough and is formed of one or more suitable fluid conduits 304. The heat exchange fluid can be an incompressible fluid having a high temperature operating range. Additionally, or alternatively, the heat exchange fluid can be a single phase fluid, or alternatively, can be a phase change fluid. In certain exemplary embodiments, the heat exchange fluid can be a supercritical fluid, such as a supercritical CO₂.

The exemplary thermal transport bus 300 includes a pump 306 in fluid communication with the heat exchange fluid in the thermal transport bus 300 for generating a flow of the heat exchange fluid in/through the thermal transport bus 300.

Moreover, the exemplary thermal transport bus 300 includes one or more heat source exchangers 308 in thermal communication with the heat exchange fluid in the thermal transport bus 300. Specifically, the thermal transport bus 300 depicted includes a plurality of heat source exchangers 308. The plurality of heat source exchangers 308 are configured to transfer heat from one or more of the accessory systems of an engine within which the thermal transport bus 300 is installed (e.g., engine 100 of FIGS. 1 through 4) to the heat exchange fluid in the thermal transport bus 300. For example, in certain exemplary embodiments, the plurality of heat source exchangers 308 can include one or more of: a CCA heat source exchanger (such as CCA heat exchanger 254 in FIGS. 2 and 4); a main lubrication system heat source exchanger for transferring heat from a main lubrication system; an advanced clearance control (ACC) system heat source exchanger for transferring heat from an ACC system; a generator lubrication system heat source exchanger for transferring heat from the generator lubrication system; an environmental control system (ECS) heat exchanger for transferring heat from an ECS; an electronics cooling system heat exchanger for transferring heat from the electronics cooling system; a vapor compression system heat source exchanger; an air cycle system heat source exchanger; and an auxiliary system(s) heat source exchanger.

For the embodiment depicted, there are three heat source exchangers 308. The heat source exchangers 308 are each arranged in series flow along the thermal transport bus 300. However, in other exemplary embodiments, any other suitable number of heat source exchangers 308 can be included and one or more of the heat source exchangers 308 can be arranged in parallel flow along the thermal transport bus 300 (in addition to, or in the alternative to the serial flow arrangement depicted). For example, in other embodiments there can be a single heat source exchanger 308 in thermal communication with the heat exchange fluid in the thermal transport bus 300, or alternatively, there can be at least two heat source exchangers 308, at least four heat source exchangers 308, at least five heat source exchangers 308, or at least six heat source exchangers 308, and up to twenty heat source exchangers 308 in thermal communication with heat exchange fluid in the thermal transport bus 300.

Additionally, the exemplary thermal transport bus 300 of FIG. 5 further includes one or more heat sink exchangers 310 permanently or selectively in thermal communication with the heat exchange fluid in the thermal transport bus 300. The one or more heat sink exchangers 310 are located downstream of the plurality of heat source exchangers 308 and are configured for transferring heat from the heat exchange fluid in the thermal transport bus 300, e.g., to atmosphere, to fuel, to a fan stream, etc. For example, in certain embodiments the one or more heat sink exchangers 310 can include at least one of a RAM heat sink exchanger, a fuel heat sink exchanger, a fan stream heat sink exchanger, a bleed air heat sink exchanger, an engine intercooler heat sink exchanger, a bypass passage heat sink exchanger, or a cold air output heat sink exchanger of an air cycle system. The fuel heat sink exchanger is a “fluid to heat exchange fluid” heat exchanger wherein heat from the heat exchange fluid is transferred to a stream of liquid fuel (see, e.g., fuel heat exchanger 302 of the engine 100 of FIG. 4). Moreover, the fan stream heat sink exchanger is generally an “air to heat exchange fluid” heat exchanger which transfers heat from the heat exchange fluid to an airflow through the fan stream (see, e.g., heat exchanger 196 of FIGS. 1 and 2). Further, the bleed air heat sink exchanger is generally an “air to heat exchange fluid” heat exchanger which flows, e.g., bleed air from the LP compressor 126 over the heat exchange fluid to remove heat from the heat exchange fluid.

For the embodiment of FIG. 5, the one or more heat sink exchangers 310 of the thermal transport bus 300 depicted includes a plurality of individual heat sink exchangers 310. More particularly, for the embodiment of FIG. 5, the one or more heat sink exchangers 310 include three heat sink exchangers 310 arranged in series. The three heat sink exchangers 310 are configured as a bypass passage heat sink exchanger, a fuel heat sink exchanger, and a fan stream heat sink exchanger. However, in other exemplary embodiments, the one or more heat sink exchangers 310 can include any other suitable number and/or type of heat sink exchangers 310. For example, in other exemplary embodiments, a single heat sink exchanger 310 can be provided, at least two heat sink exchangers 310 can be provided, at least four heat sink exchangers 310 can be provided, at least five heat sink exchangers 310 can be provided, or up to twenty heat sink exchangers 310 can be provided. Additionally, in still other exemplary embodiments, two or more of the one or more heat sink exchangers 310 can alternatively be arranged in parallel flow with one another.

Referring still to the exemplary embodiment depicted in FIG. 5, one or more of the plurality of heat sink exchangers 310 and one or more of the plurality of heat source exchangers 308 are selectively in thermal communication with the heat exchange fluid in the thermal transport bus 300. More particularly, the thermal transport bus 300 depicted includes a plurality of bypass lines 312 for selectively bypassing each heat source exchanger 308 and each heat sink exchanger 310 in the plurality of heat sink exchangers 310. Each bypass line 312 extends between an upstream juncture 314 and a downstream juncture 316—the upstream juncture 314 located just upstream of a respective heat source exchanger 308 or heat sink exchanger 310, and the downstream juncture 316 located just downstream of the respective heat source exchanger 308 or heat sink exchanger 310.

Additionally, each bypass line 312 meets at the respective upstream juncture 314 with the thermal transport bus 300 via a three-way valve 318. The three-way valves 318 each include an inlet fluidly connected with the thermal transport bus 300, a first outlet fluidly connected with the thermal transport bus 300, and a second outlet fluidly connected with the bypass line 312. The three-way valves 318 can each be a variable throughput three-way valve, such that the three-way valves 318 can vary a throughput from the inlet to the first and/or second outlets. For example, the three-way valves 318 can be configured for providing anywhere between zero percent (0%) and one hundred percent (100%) of the heat exchange fluid from the inlet to the first outlet, and similarly, the three-way valves 318 can be configured for providing anywhere between zero percent (0%) and one hundred percent (100%) of the heat exchange fluid from the inlet to the second outlet.

Notably, the three-way valves 318 can be in operable communication with a controller of an engine including the thermal transport bus 300 (e.g., engine 100 of FIGS. 1 through 4).

Further, each bypass line 312 also meets at the respective downstream juncture 316 with the thermal transport bus 300. Between each heat source exchanger 308 or heat sink exchanger 310 and downstream juncture 316, the thermal transport bus 300 includes a check valve 320 for ensuring a proper flow direction of the heat exchange fluid. More particularly, the check valve 320 prevents a flow of heat exchange fluid from the downstream juncture 316 towards the respective heat source exchanger 308 or heat sink exchanger 310.

As alluded to earlier, the inventors discovered, unexpectedly during the course of gas turbine engine design—i.e., designing gas turbine engines having a variety of different high pressure compressor exit areas, total thrust outputs, maximum exhaust gas temperatures, and supporting technology characteristics and evaluating an overall engine performance and other qualitative turbofan engine characteristics—a significant relationship between a total sea level static thrust output, a compressor exit area, and a maximum exhaust gas temperature that enables increased engine core operating temperatures and overall engine propulsive efficiency. The relationship can be thought of as an indicator of the ability of a turbofan engine to have a reduced weight or volume as represented by a high pressure compressor exit area, while maintaining or even improving upon an overall thrust output, and without overly detrimentally affecting overall engine performance and other qualitative turbofan engine characteristics. The relationship applies to an engine that incorporates a cooled cooling air system, builds portions of the core using material capable of operating at higher temperatures, or a combination of the two. Significantly, the relationship ties the core size (as represented by the exit area of the higher pressure compressor) to the desired thrust and exhaust gas temperature associated with the desired propulsive efficiency and practical limitations of the engine design, as described below.

Referring to the case of an engine that utilizes cooled cooling air for operating at higher temperatures, the inventors discovered, unexpectedly, that the costs associated with achieving a higher compression, enabled by reducing gas temperatures used to cool core components to accommodate higher core gas temperatures, can indeed produce a net benefit, contrary to expectations in the art. Referring to the case of utilizing more temperature-resistant material, such as a Carbon Matrix Composite (CMC), it was found that certain aspects of the engine size, weight and operating characteristics can be positively affected while taking into account the complexities and/or drawbacks associated with such material. In either case, the relationship now described can apply to identify the interrelated operating conditions and core size—i.e., total sea level static thrust, maximum exhaust gas temperature, and compressor exit area, respectively.

The inventors of the present disclosure discovered bounding the relationship between a product of total thrust output and maximum exhaust gas temperature at a takeoff power level and the high pressure compressor exit area squared (corrected specific thrust) can result in a higher power density core. This bounded relationship, as described herein, takes into due account the amount of overall complexity and cost, and/or a low amount of reliability associated with implementing the technologies required to achieve the operating temperatures and exhaust gas temperature associated with the desired thrust levels. The amount of overall complexity and cost can be prohibitively high for gas turbine engines outside the bounds of the relationship as described herein, and/or the reliability can prohibitively low outside the bounds of the relationship as described herein. The relationship discovered, infra, can therefore identify an improved engine configuration suited for a particular mission requirement, one that takes into account efficiency, weight, cost, complexity, reliability, and other factors influencing the optimal choice for an engine configuration.

In addition to yielding an improved gas turbine engine, as explained in detail above, utilizing this relationship, the inventors found that the number of suitable or feasible gas turbine engine designs capable of meeting the above design requirements could be greatly diminished, thereby facilitating a more rapid down selection of designs to consider as a gas turbine engine is being developed. Such a benefit provides more insight to the requirements for a given gas turbine engine well before specific technologies, integration and system requirements are developed fully. Such a benefit avoids late-stage redesign.

The desired relationship providing for the improved gas turbine engine, discovered by the inventors, is expressed as:

$$CST = {Fn}_{Total} \times EGT / ( {{A}_{HPCExit}}^{2} \times 1000 ) , \qquad Expression ( 2 )$$

where CST is corrected specific thrust; Fn_{Total} is a total sea level static thrust output of the gas turbine engine in pounds; EGT is maximum exhaust gas temperature in degrees Celsius; and A_{HPCExit} is a high pressure compressor exit area in square inches.

CST values of an engine defined by Expression (2) in accordance with various embodiments of the present disclosure are from 42 to 90, such as from 45 to 80, such as from 50 to 80. The units of the CST values can be pounds-degrees Celsius over square inches.

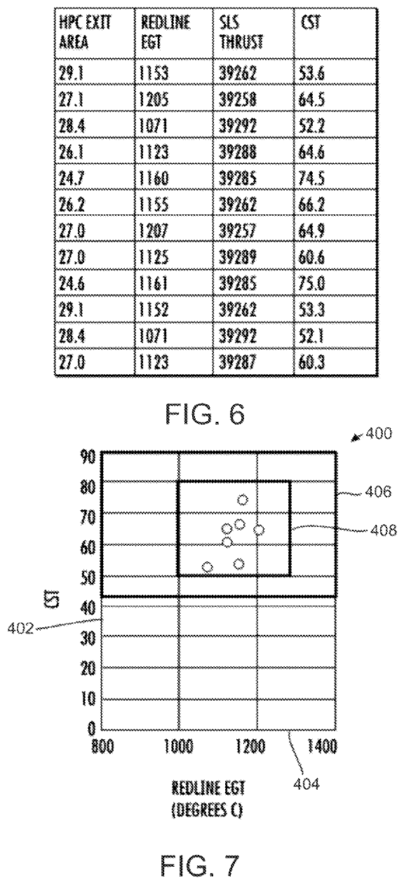

Referring now to FIGS. 6 and 7, various exemplary gas turbine engines are illustrated in accordance with one or more exemplary embodiments of the present disclosure. In particular, FIG. 6 provides a table including numerical values corresponding to several of the plotted gas turbine engines in FIG. 7. FIG. 7 is a plot 400 of gas turbine engines in accordance with one or more exemplary embodiments of the present disclosure, showing the CST on a Y-axis 402 and the EGT on an X-axis 404.

As shown, the plot 400 in FIG. 7 depicts a first range 406, with the CST values between 42 and 90 and EGT values from 800 degrees Celsius to 1400 degrees Celsius. FIG. 7 additionally depicts a second range 408, with the CST values between 50 and 80 and EGT values from 1000 degrees Celsius to 1300 degrees Celsius. It will be appreciated that in other embodiments, the EGT value can be greater than 1100 degree Celsius and less than 1250 degrees Celsius, such as greater than 1150 degree Celsius and less than 1250 degrees Celsius, such as greater than 1000 degree Celsius and less than 1300 degrees Celsius.

It will be appreciated that although the discussion above is generally related to an open rotor engine having a particular cooled cooling air system 250 (FIG. 2), in various embodiments of the present disclosure, the relationship outlined above with respect to Expression (2) can be applied to any other suitable engine architecture, including any other suitable technology(ies) to allow the gas turbine engine to accommodate higher temperatures to allow for a reduction in the high pressure compressor exit area, while maintaining or even increasing the maximum turbofan engine thrust output without, e.g., prematurely wearing various components within the turbomachine exposed the working gas flowpath.

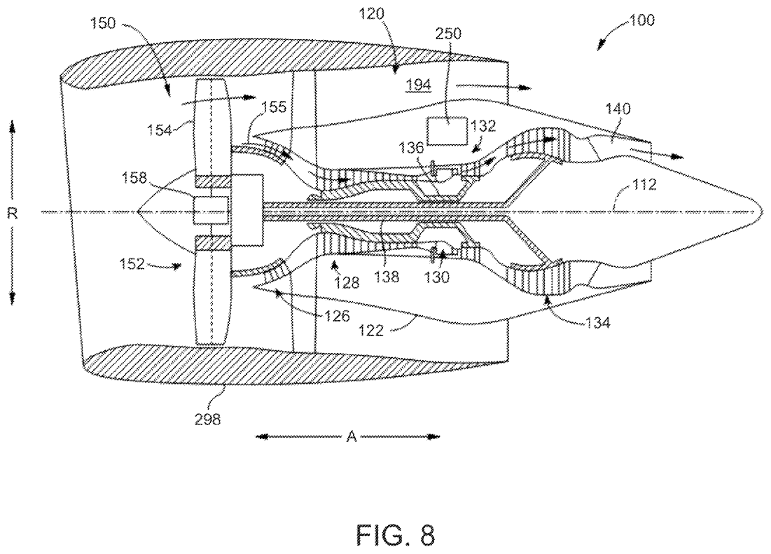

For example, reference will now be made to FIG. 8. FIG. 8 provides a schematic view of an engine 100 in accordance with another exemplary embodiment of the present disclosure. The exemplary embodiment of FIG. 8 can be configured in substantially the same manner as the exemplary engine 100 described above with respect to FIGS. 1 through 4, and the same or similar reference numerals can refer to the same or similar parts. However, as will be appreciated, for the embodiment shown, the engine 100 further includes an outer housing or nacelle 298 circumferentially surrounding at least in part a fan section 150 and a turbomachine 120. The nacelle 298 defines a bypass passage 194 between the nacelle 298 and the turbomachine 120.

Briefly, it will be appreciated that the exemplary engine 100 of FIG. 8 is configured as a two-stream engine, i.e., an engine without a third stream (e.g., fan stream 172 in the exemplary engine 100 of FIG. 2). With such a configuration, a total sea level static thrust output Fn_{Total} of the engine 100 can generally be equal to a sum of: a fan stream thrust Fn_{Fan} (i.e., an amount of thrust generated by a fan 152 through a bypass passage 194) and a turbomachine thrust Fn_{TM} (i.e., an amount of thrust generated by an airflow through a turbomachine exhaust nozzle 140), each during the static, sea level, standard day conditions.

Further, for the exemplary embodiment of FIG. 8, the engine 100 additionally includes a cooled cooling air system 250 configured to provide a turbine section with cooled cooling air during operation of the engine 100, to allow the engine 100 to accommodate higher temperatures to allow for a reduction in a high pressure compressor exit area, while maintaining or even increasing a maximum turbofan engine thrust output.

It will be appreciated that in other exemplary embodiments of the present disclosure, the cooled cooling air system 250 of the engine 100 can be configured in any other suitable manner. For example, the exemplary cooled cooling air system 250 described above with reference to FIGS. 2 and 3 is generally configured as a thermal bus cooled cooling air system. However, in other embodiments, the cooled cooling air system 250 can instead be a dedicated heat exchanger cooled cooling air system (i.e., a cooled cooling air system including a heat exchanger that transfers heat directly to a cooling medium). Additionally, in other embodiments, the cooled cooling air system 250 can be a bypass heat exchanger cooled cooling air system having a heat sink heat exchanger thermally coupled to an airflow through a bypass passage (see, e.g., FIG. 9, discussed below). Additionally, or alternatively, in other embodiments, the cooled cooling air system 250 can be one of an air-to-air cooled cooling air system (a cooled cooling air system having a heat sink heat exchanger configured to transfer heat to an airflow; see, e.g., FIG. 9, discussed below); an oil-to-air cooled cooling air system (a cooled cooling air system having a heat sink heat exchanger configured to transfer heat to an oil flow); or a fuel-to-air cooled cooling air system (a cooled cooling air system having a heat sink heat exchanger configured to transfer heat to a fuel flow, such as a Jet A fuel flow, a liquid hydrogen or hydrogen gas fuel flow, etc.; see, e.g., FIG. 4).

More particularly, referring generally to FIGS. 9 through 11, in other exemplary embodiments, the cooled cooling air system 250 of the engine 100 can be configured in any other suitable manner. The exemplary engines 100 depicted in FIGS. 9 through 11 can be configured in a similar manner as exemplary engine 100 described above with reference to FIGS. 1 through 4, and the same or similar numbers can refer to the same or similar parts.

For example, each of the exemplary engines 100 depicted in FIGS. 9 through 11 generally includes a turbomachine 120 having an LP compressor 126, an HP compressor 128, a combustion section 130, an HP turbine 132, and an LP turbine 134 collectively defining at least in part a working gas flowpath 142 and arranged in serial flow order. The exemplary turbomachine 120 depicted additionally includes a core cowl 122, and the engine 100 includes a fan cowl 170. The engine 100 includes or defines a fan duct 172 positioned partially between the core cowl 122 and the fan cowl 170. Moreover, a bypass passage 194 is defined at least in part by the core cowl 122, the fan cowl 170, or both and extends over the turbomachine 120.

Moreover, the exemplary engines 100 depicted in FIGS. 9 to 11 additionally include a cooled cooling air system 250. The cooled cooling air system 250 generally includes a duct assembly 252 and a CCA heat exchanger 254.

However, referring particular to FIG. 9, it will be appreciated that for the exemplary embodiment depicted, the CCA heat exchanger 254 is positioned in thermal communication with the bypass passage 194, and more specifically, it is exposed to an airflow through or over the bypass passage 194. For the embodiment of FIG. 9, the CCA heat exchanger 254 is positioned on the core cowl 122. In such a manner, the CCA heat exchanger 254 can be an air-to-air CCA heat exchanger configured to exchange heat between an airflow extracted from the HP compressor 128 and the airflow through the bypass passage 194.

As is depicted in phantom, the cooled cooling air system 250 can additionally or alternatively be positioned at any other suitable location along the bypass passage 194, such as on the fan cowl 170. Further, although depicted in FIG. 9 as being positioned on the core cowl 122, in other embodiments, the CCA heat exchanger 254 can be embedded into the core cowl 122, and airflow through the bypass passage 194 can be redirected from the bypass passage 194 to the CCA heat exchanger 254.

As will be appreciated, a size of the CCA heat exchanger 254 can affect the amount of drag generated by the CCA heat exchanger 254 being positioned within or exposed to the bypass passage 194. Accordingly, sizing the cooled cooling air system 250 in accordance with the present disclosure can allow for a desired reduction in a HP compressor 128 exit area, while maintaining or even increasing a total thrust output for the engine 100, without creating an excess amount of drag on the engine 100 in the process.

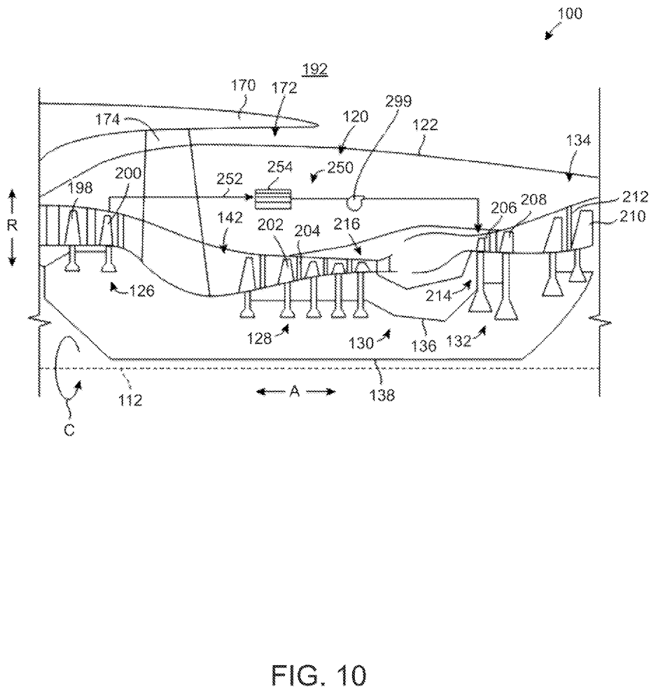

Referring now particular to FIG. 10, it will be appreciated that for the exemplary embodiment depicted, the cooled cooling air system 250 is configured to receive the cooling airflow from an air source upstream of a downstream half of the HP compressor 128. In particular, for the exemplary embodiment of FIG. 10, the exemplary cooled cooling air system 250 is configured to receive the cooling airflow from a location upstream of the HP compressor 128, and more specifically, still, from the LP compressor 126. In order to allow for a relatively low pressure cooling airflow to be provided to a first stage 214 of HP turbine rotor blades 206 of the HP turbine 132, the cooled cooling air system 250 further includes a pump 299 in airflow communication with the duct assembly 252 to increase a pressure of the cooling airflow through the duct assembly 252. For the exemplary aspect depicted, the pump 299 is positioned downstream of the CCA heat exchanger 254. In such a manner, the pump 299 can be configured to increase the pressure of the cooling airflow through the duct assembly 252 after the cooling airflow has been reduced in temperature by the CCA heat exchanger 254. Such can allow for a reduction in wear on the pump 299.

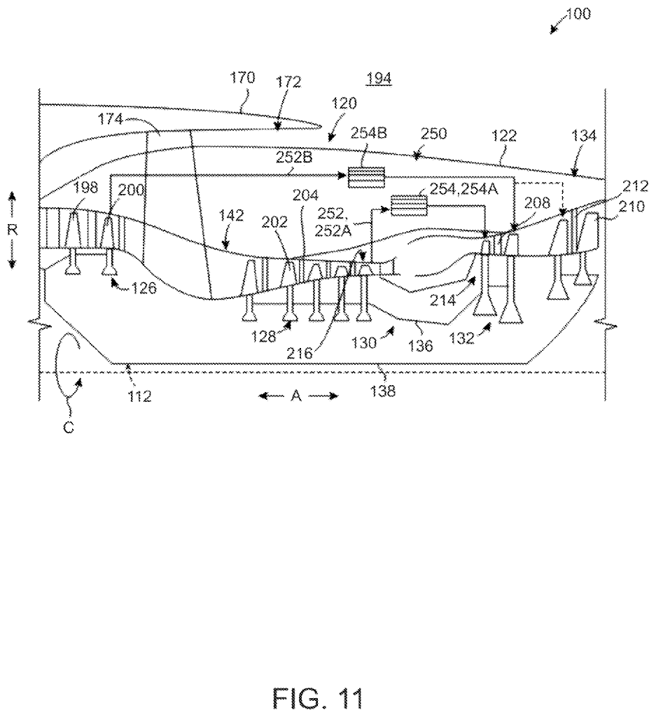

Referring now particularly to FIG. 11, it will be appreciated that the cooled cooling air system 250 includes a high-pressure portion and a low-pressure portion operable in parallel. In particular, the duct assembly 252 includes a high-pressure duct assembly 252A and a low-pressure duct assembly 252B, and the CCA heat exchanger 254 includes a high-pressure CCA heat exchanger 254A and a low-pressure CCA heat exchanger 254B.

The high-pressure duct assembly 252A is in fluid communication with the HP compressor 128 at a downstream half of the high-pressure compressor and is further in fluid communication with a first stage 214 of HP turbine rotor blades 206. The high-pressure duct assembly 252A can be configured to receive a high-pressure cooling airflow from the HP compressor 128 through the high-pressure duct assembly 252A and provide such high-pressure cooling airflow to the first stage 214 of HP turbine rotor blades 206. The high-pressure CCA heat exchanger 254A can be configured to reduce a temperature of the high-pressure cooling airflow through the high-pressure duct assembly 252A at a location upstream of the first stage 214 of HP turbine rotor blades 206.

The low-pressure duct assembly 252B is in fluid communication with a location upstream of the downstream half of the high-pressure compressor 128 and is further in fluid communication with the HP turbine 132 and a location downstream of the first stage 214 of HP turbine rotor blades 206. In particular, for the embodiment depicted, the low-pressure duct assembly 252B is in fluid communication with the LP compressor 126 and a second stage (not labeled) of HP turbine rotor blades 206. The low-pressure duct assembly 252B can be configured to receive a low-pressure cooling airflow from the LP compressor 126 through the low-pressure duct assembly 252B and provide such low-pressure cooling airflow to the second stage of HP turbine rotor blades 206. The low-pressure CCA heat exchanger 254B can be configured to reduce a temperature of the low-pressure cooling airflow through the low-pressure duct assembly 252B upstream of the second stage of HP turbine rotor blades 206.

Inclusion of the exemplary cooled cooling air system 250 of FIG. 11 can reduce an amount of resources utilized by the cooled cooling air system 250 to provide a desired amount of cooling for the turbomachine 120.

Further, for the exemplary embodiment of FIG. 11, it will be appreciated that the cooled cooling air system 250 can further be configured to provide cooling to one or more stages of LP turbine rotor blades 210, and in particular to a first stage (i.e., upstream-most stage) of LP turbine rotor blades 210. Such can further allow for, e.g., the higher operating temperatures described herein.

Reference will now be made briefly to FIG. 12. FIG. 12 provides a schematic view of an engine 500 in accordance with another exemplary embodiment of the present disclosure. The exemplary embodiment of FIG. 12 can be configured in substantially the same manner as the exemplary engine 100 described above with respect to FIGS. 1 through 4, and the same or similar reference numerals can refer to the same or similar parts. However, as will be appreciated, for the embodiment shown, the engine 500 is configured as a three-spool engine, instead of a two-spool engine.

For example, the exemplary engine 500 includes a fan section 502 and a turbomachine 504. The fan section includes a fan 506. The turbomachine includes a first compressor 508, a second compressor 510, a combustion section 512, a first turbine 514, a second turbine 516, and a third turbine 518. The first compressor 508 can be a high pressure compressor, the second compressor 510 can be a medium pressure compressor (or intermediate pressure compressor), the first turbine 514 can be a high pressure turbine, the second turbine 516 can be a medium pressure turbine (or intermediate pressure turbine), and the third turbine 518 can be a low pressure turbine. Further, the engine 500 includes a first shaft 520 extending between, and rotatable with both of, the first compressor 508 and first turbine 514; a second shaft 522 extending between, and rotatable with both of, the second compressor 510 and second turbine 516; and a third shaft 524 extending between, and rotatable with both of, the third turbine 518 and fan 506. In such a manner, it will be appreciated that the engine 500 can be referred to as a three-spool engine.

For the embodiment of FIG. 12, the term maximum EGT refers to a maximum temperature of an airflow after the first stator downstream of the last stage of rotor blades of the intermediate speed turbine, e.g., at location 526 in FIG. 12 (assuming the intermediate speed turbine 516 includes a stage of stator vanes downstream of the last stage of rotor blades).

It will further be appreciated that the exemplary cooled cooling air systems 250 described hereinabove are provided by way of example only. In other exemplary embodiments, aspects of one or more of the exemplary cooled cooling air systems 250 depicted can be combined to generate still other exemplary embodiments. For example, in still other exemplary embodiments, the exemplary cooled cooling air system 250 of FIGS. 2 through 4 may not be utilized with a thermal transport bus (e.g., thermal transport bus 300), and instead can directly utilize a CCA heat exchanger 254 positioned within the fan duct 172. Similarly, in other example embodiment, the exemplary cooled cooling air systems 250 of FIGS. 9 through 11 can be utilized with a thermal transport bus (e.g., thermal transport bus 300 of FIG. 2, 4 or 5) to reject heat for the CCA heat exchanger 254. Additionally, although the exemplary cooled cooling air systems 250 depicted schematically in FIGS. 9 through 11 depict the duct assembly 252 as positioned outward of the working gas flow path 142 along the radial direction R, in other exemplary embodiments, the duct assemblies 252 can extend at least partially inward of the working gas flow path 142 along the radial direction R (see, e.g., FIG. 4). In still other exemplary embodiments, the cooled cooling air system 250 can include duct assemblies 252 positioned outward of the working gas flow path 142 along the radial direction R and inward of the working gas flow path 142 along the radial direction R (e.g., in FIG. 11, the high-pressure duct assembly 252A can be positioned inwardly of the working gas flow path 142 along the radial direction R and the low-pressure duct assembly 252B can be positioned outwardly of the working gas flow path 142 along the radial direction R).

Moreover, it will be appreciated that in still other exemplary aspects, the gas turbine engine can include additional or alternative technologies to allow the gas turbine engine to accommodate higher temperatures while maintaining or even increasing the maximum turbofan engine thrust output, as can be indicated by a reduction in the high pressure compressor exit area, without, e.g., prematurely wearing on various components within the turbomachine exposed to the working gas flowpath.

For example, in additional or alternative embodiments, a gas turbine engine can incorporate advanced materials capable of withstanding the relatively high temperatures at downstream stages of a high pressure compressor exit (e.g., at a last stage of high pressure compressor rotor blades), and downstream of the high pressure compressor (e.g., a first stage of an HP turbine, downstream stages of the HP turbine, an LP turbine, an exhaust section, etc.).

In particular, in at least certain exemplary embodiments, a gas turbine engine of the present disclosure can include an airfoil (e.g., rotor blade or stator vane) in one or more of the HP compressor, the first stage of the HP turbine, downstream stages of the HP turbine, the LP turbine, the exhaust section, or a combination thereof formed of a ceramic-matrix-composite or “CMC.” As used herein, the term CMC refers to a class of materials that include a reinforcing material (e.g., reinforcing fibers) surrounded by a ceramic matrix phase. Generally, the reinforcing fibers provide structural integrity to the ceramic matrix. Some examples of matrix materials of CMCs can include, but are not limited to, non-oxide silicon-based materials (e.g., silicon carbide, silicon nitride, or mixtures thereof), oxide ceramics (e.g., silicon oxycarbides, silicon oxynitrides, aluminum oxide (Al₂O₃), silicon dioxide (SiO₂), aluminosilicates, or mixtures thereof), or mixtures thereof. Optionally, ceramic particles (e.g., oxides of Si, Al, Zr, Y, and combinations thereof) and inorganic fillers (e.g., pyrophyllite, wollastonite, mica, talc, kyanite, and montmorillonite) can also be included within the CMC matrix.

Some examples of reinforcing fibers of CMCs can include, but are not limited to, non-oxide silicon-based materials (e.g., silicon carbide, silicon nitride, or mixtures thereof), non-oxide carbon-based materials (e.g., carbon), oxide ceramics (e.g., silicon oxycarbides, silicon oxynitrides, aluminum oxide (Al₂O₃), silicon dioxide (SiO₂), aluminosilicates such as mullite, or mixtures thereof), or mixtures thereof.

Generally, particular CMCs can be referred to as their combination of type of fiber/type of matrix. For example, C/SiC for carbon-fiber-reinforced silicon carbide; SiC/SiC for silicon carbide-fiber-reinforced silicon carbide, SiC/SiN for silicon carbide fiber-reinforced silicon nitride; SiC/SiC—SiN for silicon carbide fiber-reinforced silicon carbide/silicon nitride matrix mixture, etc. In other examples, the CMCs can include a matrix and reinforcing fibers comprising oxide-based materials such as aluminum oxide (Al₂O₃), silicon dioxide (SiO₂), aluminosilicates, and mixtures thereof. Aluminosilicates can include crystalline materials such as mullite (3Al2O3 2SiO2), as well as glassy aluminosilicates.

In certain embodiments, the reinforcing fibers can be bundled and/or coated prior to inclusion within the matrix. For example, bundles of the fibers can be formed as a reinforced tape, such as a unidirectional reinforced tape. A plurality of the tapes can be laid up together to form a preform component. The bundles of fibers can be impregnated with a slurry composition prior to forming the preform or after formation of the preform. The preform can then undergo thermal processing, such as a cure or burn-out to yield a high char residue in the preform, and subsequent chemical processing, such as melt-infiltration with silicon, to arrive at a component formed of a CMC material having a desired chemical composition.

Such materials, along with certain monolithic ceramics (i.e., ceramic materials without a reinforcing material), are particularly suitable for higher temperature applications. Additionally, these ceramic materials are lightweight compared to superalloys, yet can still provide strength and durability to the component made therefrom. Therefore, such materials are currently being considered for many gas turbine components used in higher temperature sections of gas turbine engines, such as airfoils (e.g., turbines, and vanes), combustors, shrouds, and other like components, which would benefit from the lighter-weight and higher temperature capability these materials can offer.

One or more of these components formed of a CMC material can include an environmental-barrier-coating or “EBC.” The term EBC refers to a coating system including one or more layers of ceramic materials, each of which provides specific or multi-functional protections to the underlying CMC. EBCs generally include a plurality of layers, such as rare earth silicate coatings (e.g., rare earth disilicates such as slurry or APS-deposited yttrium ytterbium disilicate (YbYDS)), alkaline earth aluminosilicates (e.g., including barium-strontium-aluminum silicate (BSAS), such as having a range of BaO, SrO, Al2O3, and/or SiO2 compositions), hermetic layers (e.g., a rare earth disilicate), and/or outer coatings (e.g., comprising a rare earth monosilicate, such as slurry or APS-deposited yttrium monosilicate (YMS)). One or more layers can be doped as desired, and the EBC can also be coated with an abradable coating.

In such a manner, it will be appreciated that the EBCs can generally be suitable for application to “components” found in the relatively high temperature environments noted above. Examples of such components can include, for example, combustor components, turbine blades, shrouds, nozzles, heat shields, and vanes.

Additionally, or alternatively still, in other exemplary embodiments, a gas turbine engine of the present disclosure can include an airfoil (e.g., rotor blade or stator vane) in one or more of an HP compressor, a first stage of an HP turbine, downstream stages of the HP turbine, an LP turbine, an exhaust section, or a combination thereof formed in part, in whole, or in some combination of materials including but not limited to titanium, nickel, and/or cobalt based superalloys (e.g., those available under the name Inconel® available from Special Metals Corporation). One or more of these materials are examples of materials suitable for use in an additive manufacturing processes.

Further, it will be appreciated that in at least certain exemplary embodiments of the present disclosure, a method of operating a gas turbine engine is provided. The method can be utilized with one or more of the exemplary gas turbine engines discussed herein, such as in FIGS. 1 through 4 and 8 through 11. The method includes operating the gas turbine engine at a takeoff power level, the gas turbine engine having a turbomachine with a high pressure compressor defining a high pressure compressor exit area (A_{HPCExit}) in square inches. The gas turbine engine further defines a maximum exhaust gas temperature (EGT) in degrees Celsius, a total sea level static thrust output (Fn_{Total}) in pounds, and a corrected specific thrust. The corrected specific thrust is greater than or equal to 42 and less than or equal to 90, the corrected specific thrust determined as follows: Fn_{Total}×EGT/(A_{HPCExit} 2×1000).

In certain exemplary aspects, operating the gas turbine engine at the takeoff power level further includes reducing a temperature of a cooling airflow provided to a high pressure turbine of the gas turbine engine with a cooled cooling air system. For example, in certain exemplary aspects, reducing the temperature of the cooling airflow provided to the high pressure turbine of the gas turbine engine with the cooled cooling air system comprises providing a temperature reduction of the cooling airflow equal to at least 15% of the EGT and up to 45% of the EGT.

As will be appreciated from the description herein, various embodiments of a gas turbine engine are provided. Certain of these embodiments can be an unducted, single rotor gas turbine engine (see FIG. 1), a turboprop engine, or a ducted turbofan engine (see FIG. 8). Another example of a ducted turbofan engine can be found in U.S. patent application Ser. No. 16/811,368 (Published as U.S. Patent Application Publication No. 2021/0108597), filed Mar. 6, 2020 (FIG. 10, Paragraph [0062], et al.; including an annular fan case 13 surrounding the airfoil blades 21 of rotating element 20 and surrounding vanes 31 of stationary element 30; and including a third stream/fan duct 73 (shown in FIG. 10, described extensively throughout the application)). Various additional aspects of one or more of these embodiments are discussed below. These exemplary aspects can be combined with one or more of the exemplary gas turbine engine(s) discussed above with respect to the FIGS.

For example, in some embodiments of the present disclosure, the engine can include a heat exchanger located in an annular duct, such as in a third stream. The heat exchanger can extend substantially continuously in a circumferential direction of the gas turbine engine (e.g., at least 300 degrees, such as at least 330 degrees).

In one or more of these embodiments, a threshold power or disk loading for a fan (e.g., an unducted single rotor or primary forward fan) can range from 25 horsepower per square foot (hp/ft2) or greater at cruise altitude during a cruise operating mode. In particular embodiments of the engine, structures and methods provided herein generate power loading between 80 hp/ft2 and 160 hp/ft2 or higher at cruise altitude during a cruise operating mode, depending on whether the engine is an open rotor or ducted engine.

In various embodiments, an engine of the present disclosure is applied to a vehicle with a cruise altitude up to approximately 65,000 ft. In certain embodiments, cruise altitude is between approximately 28,000 ft and approximately 45,000 ft. In still certain embodiments, cruise altitude is expressed in flight levels based on a standard air pressure at sea level, in which a cruise flight condition is between FL280 and FL650. In another embodiment, cruise flight condition is between FL280 and FL450. In still certain embodiments, cruise altitude is defined based at least on a barometric pressure, in which cruise altitude is between approximately 4.85 psia and approximately 0.82 psia based on a sea level pressure of approximately 14.70 psia and sea level temperature at approximately 59 degrees Fahrenheit. In another embodiment, cruise altitude is between approximately 4.85 psia and approximately 2.14 psia. It should be appreciated that in certain embodiments, the ranges of cruise altitude defined by pressure can be adjusted based on a different reference sea level pressure and/or sea level temperature.

In various exemplary embodiments, the fan (or rotor) can include twelve (12) fan blades. From a loading standpoint, such a blade count can allow a span of each blade to be reduced such that the overall diameter of the primary fan can also be reduced (e.g., to twelve feet in one exemplary embodiment). That said, in other embodiments, the fan can have any suitable blade count and any suitable diameter. In certain suitable embodiments, the fan includes at least eight (8) blades. In another suitable embodiment, the fan can have at least twelve (12) blades. In yet another suitable embodiment, the fan can have at least fifteen (15) blades. In yet another suitable embodiment, the fan can have at least eighteen (18) blades. In one or more of these embodiments, the fan includes twenty-six (26) or fewer blades, such as twenty (20) or fewer blades. Alternatively, in certain suitable embodiments, the fan can only include at least four (4) blades, such as with a fan of a turboprop engine.

Further, in certain exemplary embodiments, the rotor assembly can define a rotor diameter (or fan diameter) of at least 10 feet, such as at least 11 feet, such as at least 12 feet, such as at least 13 feet, such as at least 15 feet, such as at least 17 feet, such as up to 28 feet, such as up to 26 feet, such as up to 24 feet, such as up to 18 feet.

In various embodiments, it will be appreciated that the engine includes a ratio of a quantity of vanes to a quantity of blades that could be less than, equal to, or greater than 1:1. For example, in particular embodiments, the engine includes twelve (12) fan blades and ten (10) vanes. In other embodiments, the vane assembly includes a greater quantity of vanes to fan blades. For example, in particular embodiments, the engine includes ten (10) fan blades and twenty-three (23) vanes. For example, in certain embodiments, the engine can include a ratio of a quantity of vanes to a quantity of blades between 1:2 and 5:2. The ratio can be tuned based on a variety of factors including a size of the vanes to ensure a desired amount of swirl is removed for an airflow from the primary fan.

Additionally, in certain exemplary embodiments, where the engine includes the third stream and a mid-fan (a ducted fan aft of the primary, forward fan), a ratio R1/R2 can be between 1 and 10, or 2 and 7, or at least 3.3, at least 3.5, at least 4 and less than or equal to 7, where R1 is the radius of the primary fan and R2 is the radius of the mid-fan.

It should be appreciated that various embodiments of the engine, such as the single unducted rotor engine depicted and described herein, can allow for normal subsonic aircraft cruise altitude operation at or above Mach 0.5. In certain embodiments, the engine allows for normal aircraft operation between Mach 0.55 and Mach 0.85 at cruise altitude. In still particular embodiments, the engine allows for normal aircraft operation between Mach 0.75 and Mach 0.85. In certain embodiments, the engine allows for rotor blade tip speeds at or less than 750 feet per second (fps). In other embodiments, the rotor blade tip speed at a cruise flight condition can be 650 to 900 fps, or 700 to 800 fps. Alternatively, in certain suitable embodiments, the engine allows for normal aircraft operation of at least Mach 0.3, such as with turboprop engines.

A fan pressure ratio (FPR) for the primary fan of the fan assembly can be 1.04 to 2.20, or in some embodiments 1.05 to 1.2, or in some embodiments less than 1.08, as measured across the fan blades of the primary fan at a cruise flight condition.

In order for the gas turbine engine to operate with a fan having the above characteristics to define the above FPR, a gear assembly can be provided to reduce a rotational speed of the fan assembly relative to a driving shaft (such as a low pressure shaft coupled to a low pressure turbine). In some embodiments, a gear ratio of the input rotational speed to the output rotational speed is between 3.0 and 4.0, between 3.2 and 3.5, or between 3.5 and 4.5. In some embodiments, a gear ratio of the input rotational speed to the output rotational speed is greater than 4.1. For example, in particular embodiments, the gear ratio is within a range of 4.1 to 14.0, within a range of 4.5 to 14.0, or within a range of 6.0 to 14.0. In certain embodiments, the gear ratio is within a range of 3.2 to 12 or within a range of 4.5 to 11.0.

With respect to a turbomachine of the gas turbine engine, the compressors and/or turbines can include various stage counts. As disclosed herein, the stage count includes the number of rotors or blade stages in a particular component (e.g., a compressor or turbine). For example, in some embodiments, a low pressure compressor can include 1 to 8 stages, a high-pressure compressor can include 4 to 15 stages, a high-pressure turbine can include 1 to 2 stages, and/or a low pressure turbine (LPT) can include 1 to 7 stages. In particular, the LPT can have 4 stages, or between 4 and 6 stages. For example, in certain embodiments, an engine can include a one stage low pressure compressor, an 11 stage high pressure compressor, a two stage high pressure turbine, and 4 stages, or between 4 and 7 stages for the LPT. As another example, an engine can include a three stage low-pressure compressor, a 10 stage high pressure compressor, a two stage high pressure turbine, and a 7 stage low pressure turbine.

A core engine is generally encased in an outer casing defining one half of a core diameter (Dcore), which can be thought of as the maximum extent from a centerline axis (datum for R). In certain embodiments, the engine includes a length (L) from a longitudinally (or axial) forward end to a longitudinally aft end. In various embodiments, the engine defines a ratio of L/Dcore that provides for reduced installed drag. In one embodiment, L/Dcore is at least 2. In another embodiment, L/Dcore is at least 2.5. In some embodiments, the L/Dcore is less than 5, less than 4, and less than 3. In various embodiments, it should be appreciated that the L/Dcore is for a single unducted rotor engine.

The reduced installed drag can further provide for improved efficiency, such as improved specific fuel consumption. Additionally, or alternatively, the reduced installed drag can provide for cruise altitude engine and aircraft operation at the above describe Mach numbers at cruise altitude. Still particular embodiments can provide such benefits with reduced interaction noise between the blade assembly and the vane assembly and/or decreased overall noise generated by the engine by virtue of structures located in an annular duct of the engine.

Additionally, it should be appreciated that ranges of power loading and/or rotor blade tip speed can correspond to certain structures, core sizes, thrust outputs, etc., or other structures of the core engine. However, as previously stated, to the extent one or more structures provided herein can be known in the art, it should be appreciated that the present disclosure can include combinations of structures not previously known to combine, at least for reasons based in part on conflicting benefits versus losses, desired modes of operation, or other forms of teaching away in the art.

Although depicted above as an unshrouded or open rotor engine, it should be appreciated that aspects of the disclosure provided herein can be applied to shrouded or ducted engines, partially ducted engines, aft-fan engines, or other gas turbine engine configurations, including those for marine, industrial, or aero-propulsion systems. Certain aspects of the disclosure can be applicable to turbofan, turboprop, or turboshaft engines. However, it should be appreciated that certain aspects of the disclosure can address issues that can be particular to unshrouded or open rotor engines, such as, but not limited to, issues related to gear ratios, fan diameter, fan speed, length (L) of the engine, maximum diameter of the core engine (Dcore) of the engine, L/Dcore of the engine, desired cruise altitude, and/or desired operating cruise speed, or combinations thereof.

The discussion above is primarily directed to gas turbine engines configured as a turbofan engine or open rotor engine. After additional research and testing, it was discovered that the concepts outlined above can similarly apply to produce improvements in gas turbine engines configured to function as a turboprop or turboshaft engine.

Turboshaft and turboprop engines generally include a turbomachine, the turbomachine including a compressor section, a combustion section, a turbine section, and defining a working gas flowpath therethrough. The power generated by the turbomachine is transmitted to a load, e.g., a propeller in the case of a turboprop engine, through an output shaft. In such a manner, for turboprop engines, output shaft causes the propeller rotor blades to rotate and generate a thrust output. A turboshaft engine is configured in a similar manner, but without the propeller assembly. With a turboshaft engine, the load driven by the output shaft can be a number of different aeronautical vehicle loads, including a vertical thrust propeller (driven through one or more gears), an electric machine, etc. Efficiency and power density of the gas turbine engine (or simply “engine”) are important factors in the performance of an aeronautical vehicle incorporating the engine.

Conventional turboprop and turboshaft engine design has been constrained by the thermal efficiency limits imposed by the temperatures and pressures at an exit of a high pressure compressor (HPC) of the compressor section and as well as an exhaust gas temperature (EGT). For example, for a desired engine power output produced from an increased pressure ratio across the HPC, there is an increase in the gas temperature at the exit of the HPC, at a combustor inlet, at the turbine section inlet, through the turbine section, and through an exhaust section of the engine. These constraints have historically dictated a size of a core (the core being, e.g., the HPC, combustor, and a high pressure turbine) of the turbomachine of the engine and, consequently, an overall power output and efficiency of the engine.

The inventors found that there are approaches to making an engine capable of operating at higher temperatures while providing a net benefit to engine performance: intercooling a compressor section of a turbomachine of the engine, reducing the temperature of a gas used to cool core components, utilizing advanced materials capable of withstanding higher operating temperature conditions, or combinations thereof. As thermal efficiency increases, the size of the core can be reduced for a given power output, resulting in a turbomachine that is physically smaller for a given power output. This improved power density is of significant value. The inventors discovered that improvements in power density can be achieved without having to pay unacceptable costs in other aspects of the engine design, such as complexity, reliability, diminished engine cycles requiring part replacement or integration with airframes having different requirements for engine size, shape, and power transfers.

In the context of a turboprop or turboshaft engine that utilizes these advanced technologies, the inventors discovered, unexpectedly and contrary to conventional expectations, that the benefits of operating at higher temperatures and pressures, while maintaining or reducing the core size, can indeed outweigh the associated costs of incorporation these advanced technologies. This discovery was made during the course of designing various engine architectures with different power classes and mission requirements. In particular, the inventors discovered a significant relationship between engine power output, core size, and the conditions exiting the HPC and through the turbine section, whereby including the noted technologies produces a net benefit. Previously it was thought that the cost for including one or more of these advanced technologies was too prohibitive, as compared to the benefits of increasing the temperatures through the core (e.g., EGT).

For example, the inventors of the present disclosure found that a cooled cooling air system can be included while maintaining or even increasing the maximum engine power output, based on this discovery. The cooled cooling air system can receive an airflow from, e.g., the compressor section, reduce a temperature of the airflow using a heat exchanger, and provide the cooled airflow to one or more components of the turbine section, such as a first stage of high pressure turbine rotor blades. In such a manner, the first stage of high pressure turbine rotor blades can be capable of withstanding increased temperatures by using the cooled cooling air, providing a net benefit to the engine, i.e., providing an increase in thermal efficiency of the engine, taking into consideration the costs associated with accommodations made for the system used to cool the cooling air.

The inventors reached this conclusion after evaluating potentially negative impacts to engine performance brought on by introduction of a cooled cooling air system. For example, a cooled cooling air system can generally include a duct extending through a diffusion cavity between a compressor exit and a combustor within the combustion section, such that increasing the cooling capacity can concomitantly increase a size of the duct and thus increase a drag or blockage of an airflow through the diffusion cavity, potentially creating problems related to, e.g., combustor aerodynamics. Similarly, a dedicated or shared heat exchanger of the cooled cooling air system can be positioned external to the turbomachine (e.g., downstream of a propeller in a propeller stream), which can create an aerodynamic drag or can increase a size of the shared heat exchanger and increase aerodynamic drag. Size and weight increases associated with maintaining certain risk tolerances were also taken into consideration. For example, a cooled cooling air system must be accompanied with adequate safeguards in the event of a burst pipe condition, which safeguards result in further increases in the overall size, complexity, and weight of the system.

Similarly, the inventors of the present disclosure found that an intercooler assembly could additionally or alternatively be included for engines within the bounds disclosed herein while maintaining or even increasing the maximum engine power output, based on this discovery. The intercooler assembly can enable higher overall pressure ratios by reducing a temperature of a gas flow through one or more stages of the compressor section, such that for a given overall pressure ratio, the gas temperature at the exit of the HPC is reduced. The inventors reached this conclusion after similarly evaluating potentially negative impacts to engine performance brought on by introduction of an intercooler assembly. For example, in order to provide increases in temperature reduction of an airflow through the compressor section an intercooler assembly can generally require a corresponding increases in pressure drop across a heat exchanger of the intercooler assembly. Therefore, in order to achieve a higher temperature reductions by the intercooler assembly, the intercooler assembly traditionally causes a reduction in efficiency and overall compressor pressure ratio.

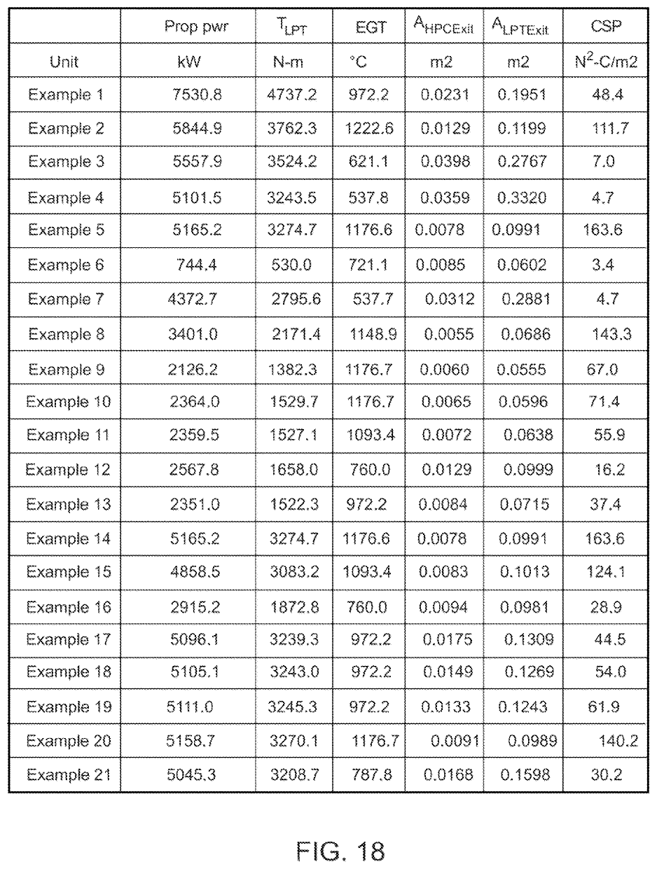

With a goal of arriving at an improved turboprop or turboshaft engine capable of operating at higher temperatures, e.g., through the turbine section, the inventors have proceeded in the manner of designing turboprop and turboshaft engines having an overall pressure ratio (and associated HPC exit area), a maximum output power, maximum exhaust gas temperature, and the supporting technology characteristics; checking the propulsive/thermal efficiency and qualitative engine characteristics of the designed engine; redesigning the engine to have higher or lower compression ratios (and associated HPC exit areas) based on the impact on other aspects of the architecture, total power output, maximum exhaust gas temperature, and supporting technology characteristics; rechecking the propulsive/thermal efficiency and qualitative engine characteristics of the redesigned engine; etc. during the design of several different types of turboprop or turboshaft engines, including the turboprop and turboshaft engines described below with reference to FIGS. 13 through 17, FIGS. 20 through 34, and the embodiments listed in the Table of FIG. 18.

Referring now to the drawings, wherein identical numerals indicate the same elements throughout the figures, FIG. 13 is a schematic cross-sectional view of a gas turbine engine in accordance with an exemplary embodiment of the present disclosure. More particularly, for the embodiment of FIG. 13, the gas turbine engine is a turboprop engine 610. As shown in FIG. 13, turboprop engine 610 defines an axial direction A (extending parallel to a longitudinal centerline or central axis 612 provided for reference), a radial direction R, and a circumferential direction C (not shown) disposed about the axial direction A. Turboprop engine 610 generally includes a propeller section 614 and a turbomachine 616 disposed aft of the propeller section 614 from an aircraft perspective, the propeller section 614 being operable with, and driven by, turbomachine 616.

The turbomachine 616 includes, in a serial flow relationship, a booster compressor 618, a high pressure (HP) compressor 622, a combustion section 626, a high pressure (HP) turbine 628, an intermediate pressure (IP) turbine 620, a low pressure (LP) turbine 630, and an exhaust section 632. An air flow path generally extends through booster compressor 618, HP compressor 622, combustion section 626, HP turbine 628, IP turbine 620, LP turbine 630, and exhaust section 632 which are in fluid communication with each other.

In at least certain exemplary embodiments, the HP turbine 628 can include at least two stages of HP turbine rotor blades. Such a configuration can ensure a sufficient amount of power is provided to the HP compressor 622.

An HP shaft or spool 634 drivingly connects the HP turbine 628 to the HP compressor 622. An IP shaft 635 drivingly connects the IP turbine 620 to the booster compressor 618. An LP shaft or spool 636 drivingly connects the LP turbine 630 to propeller section 614 of the turboprop engine 610. The turbomachine 616 includes a drive turbine drivingly coupled to a drive turbine shaft configured to provide an output torque to, e.g., the fan assembly 614 in the embodiment shown. For the embodiment depicted, the drive turbine is the LP turbine 630 and the drive turbine shaft is the LP shaft 636.

For the embodiment depicted, propeller section 614 includes a variable pitch propeller 638 having a plurality of propeller blades 640 coupled to a disk 642 in a spaced apart manner. As depicted, the propeller blades 640 extend outwardly from disk 642 generally along the radial direction R. Each propeller blade 640 is rotatable relative to the disk 642 about a pitch axis P by virtue of the propeller blades 640 being operatively coupled to a suitable actuation member 644 configured to collectively vary the pitch of the propeller blades 640, e.g., in unison. The propeller blades 640, disk 642, and actuation member 644 are together rotatable about a fan centerline 645 by LP shaft 636 across a power gear box 646. The power gear box 646 includes a plurality of gears for stepping down the rotational speed of the LP shaft 636 to a more efficient rotational fan speed and is attached to one or both of a core frame or a fan frame through one or more coupling systems. Additionally, for the embodiment shown, the power gear box 646 is an offset gear box, such that the fan axis 645 is offset from the longitudinal centerline 612 of the turbomachine 616.

During operation of the turboprop engine 610, a volume of air 650 (also referred to as a free stream flow of air prior to its encounter with the propeller 638) passes through blades 640 of propeller 638 and is urged toward an inlet 652 of turbomachine 616. More specifically, turboprop engine 610 includes an intake channel 654 that extends from the inlet 652, which is non-axisymmetric with respect to longitudinal centerline 612, to the booster compressor 618, where the channel 654 is axisymmetric with respect to longitudinal centerline 612.

The booster compressor 618 and HP compressor 622 each include one or more sequential stages of compressor stator vanes, one or more sequential stages of compressor rotor blades, an impeller, or combinations thereof. In particular, the booster compressor 618 is depicted as an axial compressor (having multiple stages of compressor stator vanes and rotor blades) and the HP compressor 622 is depicted as a centrifugal compressor (having an impeller).

Though the illustrated embodiment includes both axial and centrifugal flow compressors, in some forms the turboprop engine 610 can include just an axial flow compressor(s) or centrifugal flow compressor(s).

The HP compressor 622 directs compressed air into combustion section 626 where the air mixes with fuel. Combustion section 626 includes a combustor which combusts the air/fuel mixture to provide combustion gases. The combustion gases flow through HP turbine 628, IP turbine 620, and LP turbine 630. Each of these HP, IP, and LP turbines 628, 620, 630 includes one or more sequential stages of turbine stator vanes and one or more sequential stages of turbine rotor blades. The turbine rotor blades are coupled to a respective one of the HP shaft 634, IP shaft 635, or LP shaft 636 to extract thermal and/or kinetic energy from the combustion gases flowing therethrough. The energy extraction from HP turbine 628 supports operation of HP compressor 622 through HP shaft 634, the energy extraction from IP turbine 620 supports operation of booster compressor 618 through IP shaft 635, and the energy extraction from LP turbine 630 supports operation of propeller section 614 through LP shaft 636 (across the power gear box 646). Combustion gases exit turboprop engine 610 through exhaust section 632.

In other exemplary embodiments, the turbine engine can include any suitable number of compressors, turbines, shafts, etc. For example, as will be appreciated, HP shaft 634 and LP shaft 636 can further be coupled to any suitable device for any suitable purpose. For example, in certain exemplary embodiments, turboprop engine 610 of FIG. 13 can be utilized in aeroderivative applications. Additionally, in other exemplary embodiments, turboprop engine 610 can include any other suitable type of combustor, such as a reverse flow combustor.

The embodiment of turboprop engine 610 illustrated in FIG. 13 further includes an intercooler assembly 700. In particular, referring now to FIG. 14, providing a close-up view of a portion of the turbomachine 616 of FIG. 13, the intercooler assembly 700 includes an intercooler heat exchanger 702 in thermal communication with the compressor section of the turbomachine 616. For the embodiment depicted, the intercooler heat exchanger 702 is positioned in thermal communication with the compressor section at a location downstream of the booster compressor 618 and upstream of the HP compressor 622.

It will be appreciated, however, that in other exemplary embodiments, the intercooler heat exchanger 702 can additionally or alternatively be positioned in thermal communication with the compressor section at a location within the booster compressor 618 and/or within the HP compressor 622 (e.g., an inter-stage heat exchanger).

Referring still to the embodiment of FIG. 14, it will be appreciated that the turbomachine 616 defines a working gas flowpath 704 extending from the inlet 652 (see FIG. 13), through the compressor section, combustion section 626, turbine section, and exhaust section 632 (see FIG. 13). More specifically, for the embodiment depicted, the intercooler heat exchanger 702 is positioned within the working gas flowpath 704 through the compressor section at a location downstream of the booster compressor 618 and upstream of the HP compressor 622.

The intercooler assembly 700 is configured to cool the airflow through the compressor section, allowing the compressor section to define a higher overall pressure ratio without a compressor exit temperature (and downstream temperatures such as turbine inlet temperature and exhaust gas temperature) exceeding operability thresholds. The intercooler heat exchanger 702 is accordingly in fluid communication with a cooling fluid source through an inlet line 706 and an outlet line 708. The inlet line 706 can provide a cooling fluid to the intercooler heat exchanger 702, whereby the cooling fluid can accept heat from the airflow through the working gas flowpath 704 between the booster compressor 618 and HP compressor 622. The outlet line 708 can provide the heated cooling fluid away from the intercooler heat exchanger 702.

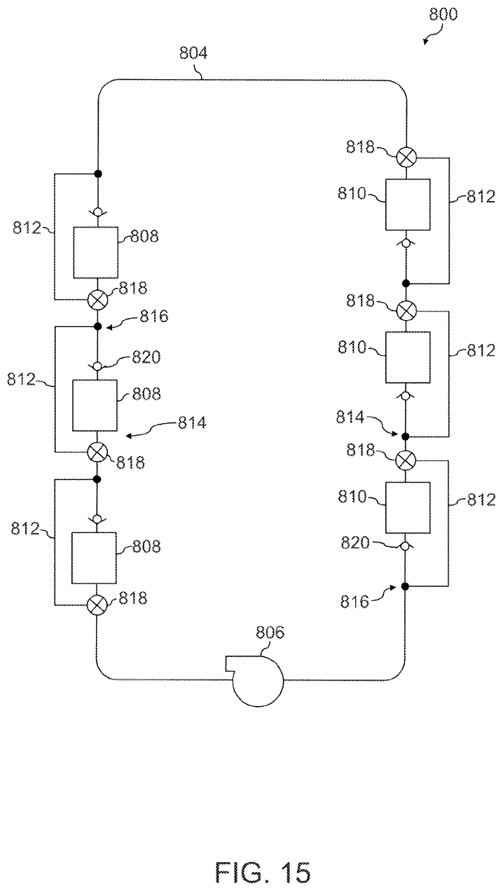

The cooling fluid source can be a thermal transport bus (see thermal transport bus 800 of FIG. 15, below) utilizing a supercritical thermal fluid (such as supercritical CO₂, supercritical N₂, or a commercial refrigerant/transfer fluid).

Additionally, or alternatively, the cooling fluid source can be any other suitable cooling fluid source, such as a cooled cooling air, a pressurized bypass or freestream airflow, a fuel flow, or the like.

For example, in at least certain exemplary embodiments, the cooling fluid source can be a fuel flow. For example, the turboprop engine 610 can include a fuel system that is a cryogenic fuel system, such as a cryogenic hydrogen fuel (i.e., configured to store a liquid hydrogen). With such an exemplary embodiment, the intercooler heat exchanger 702 can be in thermal communication with a liquid hydrogen, creating a large temperature differential between the cooling fluid (liquid hydrogen) and the airflow through the compressor section to be cooled. Such can allow for a relatively compact intercooler heat exchanger 702 with a relatively low pressure drop for a given amount of desired temperature reduction of the airflow through the compressor section. At the same time, the heat extracted from the airflow through the compressor section can be used to help vaporize the liquid hydrogen prior to combustion.

In particular, in certain exemplary embodiments, the cooling fluid source for the intercooler heat exchanger 702 can be a thermal transport bus having a conduit with a flow of thermal transport fluid therethrough. More specifically, referring now briefly to FIG. 15, a schematic view of a thermal transport bus 800 as can be utilized with the turboprop engine 610 described above with reference to FIGS. 13 and 14 is provided.

The thermal transport bus 800 includes an intermediary heat exchange fluid flowing therethrough and is formed of one or more suitable fluid conduits 804. The heat exchange fluid can be an incompressible fluid having a high temperature operating range.

Additionally, or alternatively, the heat exchange fluid can be a single phase fluid, or alternatively, can be a phase change fluid. In certain exemplary embodiments, the heat exchange fluid can be a supercritical fluid, such as a supercritical N₂, or a supercritical CO₂. Utilizing a supercritical fluid can allow for an intercooler assembly 700 to include an intercooler heat exchanger 702 that has a relatively low pressure drop for a given amount of heat transfer, allowing in a more efficient compressor section while still achieving a desirably low compressor exit temperature.

The exemplary thermal transport bus 800 includes a pump 806 in fluid communication with the heat exchange fluid in the thermal transport bus 800 for generating a flow of the heat exchange fluid in/through the thermal transport bus 800.

Moreover, the exemplary thermal transport bus 800 includes one or more heat source exchangers 808 in thermal communication with the heat exchange fluid in the thermal transport bus 800. Specifically, the thermal transport bus 800 depicted includes a plurality of heat source exchangers 808. The plurality of heat source exchangers 808 are configured to transfer heat from, e.g., one or more of accessory systems of the turboprop engine 610 to the heat exchange fluid in the thermal transport bus 800. For example, in certain exemplary embodiments, the plurality of heat source exchangers 808 can include one or more of: an intercooler heat exchanger (such as the exemplary intercooler heat exchanger 702 of FIG. 14); a main lubrication system heat source exchanger for transferring heat from a main lubrication system; an advanced clearance control (ACC) system heat source exchanger for transferring heat from an ACC system; a generator lubrication system heat source exchanger for transferring heat from the generator lubrication system; an environmental control system (ECS) heat exchanger for transferring heat from an ECS; an electronics cooling system heat exchanger for transferring heat from the electronics cooling system; a vapor compression system heat source exchanger; an air cycle system heat source exchanger; and an auxiliary system(s) heat source exchanger.

For the embodiment depicted, there are three heat source exchangers 808. The heat source exchangers 808 are each arranged in series flow along the thermal transport bus 800. However, in other exemplary embodiments, any other suitable number of heat source exchangers 808 can be included and one or more of the heat source exchangers 808 can be arranged in parallel flow along the thermal transport bus 800 (in addition to, or in the alternative to the serial flow arrangement depicted). For example, in other embodiments there can be a single heat source exchanger 808 in thermal communication with the heat exchange fluid in the thermal transport bus 800, or alternatively, there can be at least two heat source exchangers 808, at least four heat source exchangers 808, at least five heat source exchangers 808, or at least six heat source exchangers 808, and up to twenty heat source exchangers 808 in thermal communication with heat exchange fluid in the thermal transport bus 800.

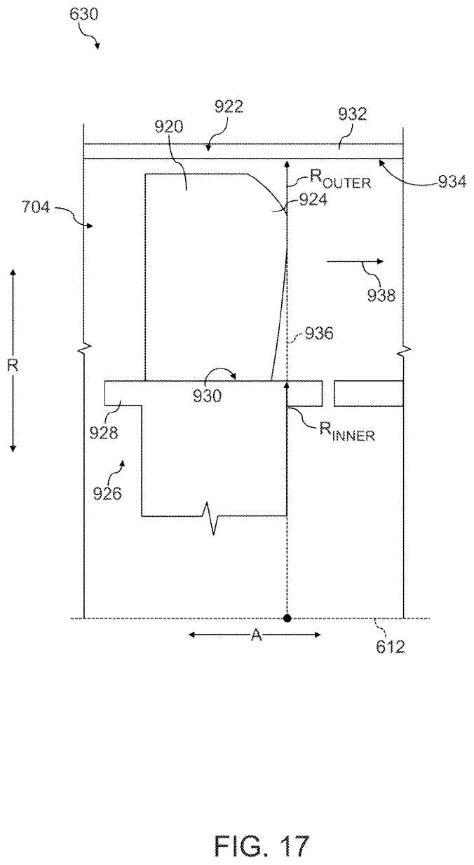

Additionally, the exemplary thermal transport bus 800 of FIG. 17 further includes one or more heat sink exchangers 810 permanently or selectively in thermal communication with the heat exchange fluid in the thermal transport bus 800. The one or more heat sink exchangers 810 are located downstream of the plurality of heat source exchangers 808 and are configured for transferring heat from the heat exchange fluid in the thermal transport bus 800, e.g., to atmosphere, to fuel, to a fan stream, etc. For example, in certain embodiments the one or more heat sink exchangers 810 can include at least one of a RAM heat sink exchanger, a fuel heat sink exchanger, a bypass passage heat sink exchanger, a bleed air heat sink exchanger, or a cold air output heat sink exchanger of an air cycle system. The fuel heat sink exchanger is a “fluid to heat exchange fluid” heat exchanger wherein heat from the heat exchange fluid is transferred to a stream of liquid fuel. As noted above, the fuel can be a cryogenic fuel, such as a liquid hydrogen fuel.

Moreover, the other heat sink exchanger can generally be an “air to heat exchange fluid” heat exchanger which transfers heat from the heat exchange fluid to an airflow.

For the embodiment of FIG. 15, the one or more heat sink exchangers 810 of the thermal transport bus 800 depicted includes a plurality of individual heat sink exchangers 810. More particularly, for the embodiment of FIG. 17, the one or more heat sink exchangers 810 include three heat sink exchangers 810 arranged in series. The three heat sink exchangers 810 are configured as a bypass passage heat sink exchanger, a fuel heat sink exchanger, and a fan stream heat sink exchanger. However, in other exemplary embodiments, the one or more heat sink exchangers 810 can include any other suitable number and/or type of heat sink exchangers 810. For example, in other exemplary embodiments, a single heat sink exchanger 810 can be provided, at least two heat sink exchangers 810 can be provided, at least four heat sink exchangers 810 can be provided, at least five heat sink exchangers 810 can be provided, or up to twenty heat sink exchangers 810 can be provided. Additionally, in still other exemplary embodiments, two or more of the one or more heat sink exchangers 810 can alternatively be arranged in parallel flow with one another.

Referring still to the exemplary embodiment depicted in FIG. 15, one or more of the plurality of heat sink exchangers 810 and one or more of the plurality of heat source exchangers 808 are selectively in thermal communication with the heat exchange fluid in the thermal transport bus 800. More particularly, the thermal transport bus 800 depicted includes a plurality of bypass lines 812 for selectively bypassing each heat source exchanger 808 and each heat sink exchanger 810 in the plurality of heat sink exchangers 810. Each bypass line 812 extends between an upstream juncture 814 and a downstream juncture 816—the upstream juncture 814 located just upstream of a respective heat source exchanger 808 or heat sink exchanger 810, and the downstream juncture 816 located just downstream of the respective heat source exchanger 808 or heat sink exchanger 810.

Additionally, each bypass line 812 meets at the respective upstream juncture 814 with the thermal transport bus 800 via a three-way valve 818. The three-way valves 818 each include an inlet fluidly connected with the thermal transport bus 800, a first outlet fluidly connected with the thermal transport bus 800, and a second outlet fluidly connected with the bypass line 812. The three-way valves 818 can each be a variable throughput three-way valve, such that the three-way valves 818 can vary a throughput from the inlet to the first and/or second outlets. For example, the three-way valves 818 can be configured for providing anywhere between zero percent (0%) and one hundred percent (100%) of the heat exchange fluid from the inlet to the first outlet, and similarly, the three-way valves 818 can be configured for providing anywhere between zero percent (0%) and one hundred percent (100%) of the heat exchange fluid from the inlet to the second outlet.

Notably, the three-way valves 818 can be in operable communication with a controller of an engine including the thermal transport bus 800 (e.g., turboprop engine 610 of FIGS. 13 and 14).

Further, each bypass line 812 also meets at the respective downstream juncture 816 with the thermal transport bus 800. Between each heat source exchanger 808 or heat sink exchanger 810 and downstream juncture 816, the thermal transport bus 800 includes a check valve 820 for ensuring a proper flow direction of the heat exchange fluid. More particularly, the check valve 820 prevents a flow of heat exchange fluid from the downstream juncture 816 towards the respective heat source exchanger 808 or heat sink exchanger 810.

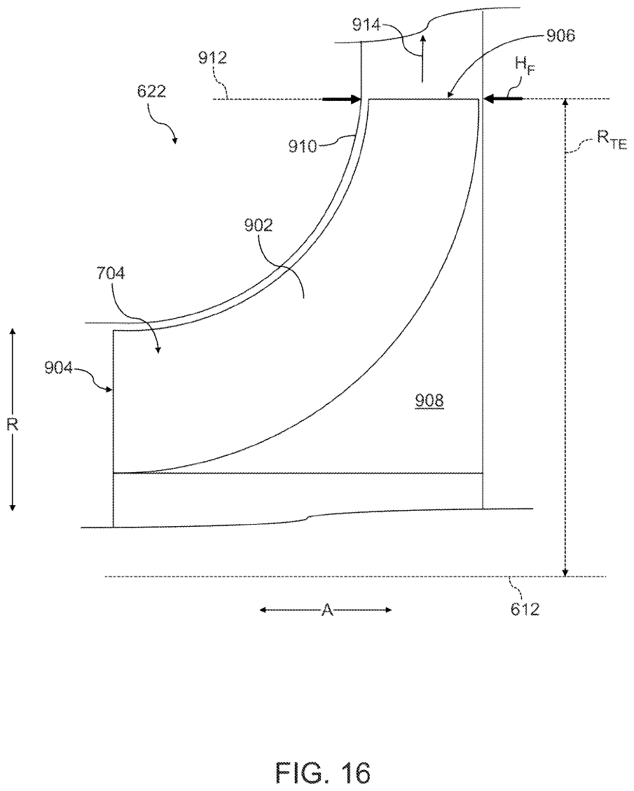

Referring now to FIG. 16, a close-up view of an aft-most compression stage of the exemplary HP compressor 622 of FIGS. 13 and 14 is provided.

As will be appreciated, the HP compressor 622 is a centrifugal compressor, such that the aft-most compression stage is an impeller 902. The impeller 902 includes a leading edge 904 and a trailing edge 906 and a base 908 to which the impeller 902 is coupled. The base 908 can be coupled to the HP shaft 634 to drive rotation of the impeller 902.

The impeller 902 extends into the working gas flowpath 704. At the trailing edge 906 of the impeller 902, the working gas flowpath 704 is defined between the base 908 and a liner 910.

The turboprop engine 610 further defines a reference plane 912 intersecting with an aft-most point of the trailing edge 906 of the impeller 902 depicted, the reference plane 230 being orthogonal to an airflow direction 914 out of the HP compressor 622. In the embodiment depicted, the airflow direction 914 is along the radial direction R.

Further, the HP compressor 622 defines a high pressure compressor exit area (A_{HPCExit}) within the reference plane 912. More specifically, the HP compressor 622 defines a flowpath height (HF) in a direction orthogonal to the airflow direction 914, and more specifically within the reference plane 912 and parallel to the axial direction A for the embodiment shown. The flowpath height (HF) is defined between the liner 910 and the base 908 at the downstream-most portion of the trailing edge 906. Notably, the downstream-most portion of the trailing edge 906 further defines a radius RTE. The HP compressor 622 exit area is defined for the embodiment depicted according to Expression (3):

$${A}_{HPCExit} = 2 π {R}_{TE} \times {H}_{F} . \qquad Expression ( 3 )$$

Briefly, it will be appreciated that in certain exemplary embodiments, the HP compressor 622 can be configured as an axial compressor, such that a compressor rotor blade is positioned at an exit of the HP compressor 622. In such an embodiment the high pressure compressor exit area (A_{HPCExit}) can be define according to an equation similar to Expression (4), below.

The inventors of the present disclosure have found that for a given total output power of the turboprop engine 610, a decrease in size of the high pressure compressor exit area (A_{HPCExit}) can generally relate in an increase in a compressor exit temperature (i.e., a temperature of the airflow through the working gas flowpath 704 at the reference plane 912), a turbine inlet temperature (i.e., a temperature of the airflow through the working gas flowpath 704 provided to a first stage of rotor blades of the HP turbine 628; see FIG. 13), and the maximum exhaust gas temperature (EGT). In particular, the inventors of the present disclosure have found that the high pressure compressor exit area (A_{HPCExit}) can generally be used as an indicator of the above temperatures to be achieved by the engine 700 during operation for a given power output of the engine 700.

As will further be appreciated, a total, or rather a maximum, power output of the turboprop engine 610 can generally be determined as a function of a maximum drive turbine shaft torque (T_{OUT}) in Newton meters (N-m) and a maximum rotational speed of the LP turbine 630, in revolutions per minute (rpm). The maximum rotational speed of the LP turbine 630 is limited by a drive turbine exit area (A_{DTExit}) in square inches, as the higher drive turbine exit areas (A_{DTExit}) push the bounds of the strength to weight properties forming the LP turbine 630 (measured as a function of area (A) times speed (N) squared; AN²).

In particular, referring now to FIG. 17, it will be appreciated that the LP turbine 630 defines the drive turbine exit areas (A_{DTExit}). FIG. 17 provides a close-up view of an LP turbine rotor blade 920 in an aftmost stage 922 of LP turbine rotor blades 920. As will be appreciated, the LP turbine rotor blade 920 includes a trailing edge 924 and the aftmost stage 922 of LP turbine rotor blades 920 includes a rotor 926 having a base 928 to which the LP turbine rotor blade 920 is coupled. The base 928 includes a flowpath surface 930 defining in part the working gas flow path 704 through the LP turbine 630. Moreover, the LP turbine 630 includes a shroud or liner 932 located outward of the LP turbine rotor blade 920 along the radial direction R. The shroud or liner 932 also includes a flowpath surface 934 defining in part the working gas flow path 704 through the LP turbine 630.

The turboprop engine 610 (FIG. 13) defines a reference plane 936 intersecting with an aft-most point of the trailing edge 924 of the LP turbine rotor blade 920 depicted, the reference plane 936 being orthogonal to an airflow direction 938 out the LP turbine 630. The airflow direction 938 out the LP turbine 630 is parallel to the axial direction A in the embodiment depicted. Further, the LP turbine 630 defines the drive turbine exit area (A_{DTExit}) within the reference plane 936. More specifically, the LP turbine 630 defines an inner radius (R_{INNER}) extending along the radial direction R within the reference plane 936 from the longitudinal axis 612 to the flowpath surface 930 of the base 928 of the rotor 926 of the aftmost stage 922 of LP turbine rotor blades 920, as well as an outer radius (R_{OUTER}) extending along the radial direction R within the reference plane 936 from the longitudinal axis 612 to the flowpath surface 934 of the shroud or liner 932. The LP turbine 630 exit area is defined according to Expression (4):

$${A}_{DTExit} = π ( {R}_{OUTER}^{2} - {R}_{INNER}^{2} ) . \qquad Expression ( 4 )$$

As alluded to earlier, the inventors discovered, unexpectedly during the course of gas turbine engine design—i.e., designing gas turbine engines having a variety of different high pressure compressor exit areas, total power outputs (which is a function of a maximum drive turbine shaft torque and maximum rotational speed; the maximum rotational speed being limited by a drive turbine exit area), maximum exhaust gas temperatures, and supporting technology characteristics and evaluating an overall engine performance and other qualitative turbofan engine characteristics—a significant relationship between a high pressure compressor exit area, total power output (and drive turbine exit area and maximum low pressure torque), and maximum exhaust gas temperature that enables increased engine core operating temperatures and overall engine propulsive/thermal efficiency. The relationship can be thought of as an indicator of the ability of a turboprop or turboshaft engine to have a reduced weight or volume as represented by a high pressure compressor exit area, while maintaining or even improving upon an overall power output as represented by drive turbine exit area and maximum drive turbine shaft torque, and without overly detrimentally affecting overall engine performance and other qualitative engine characteristics. The relationship applies to an engine that incorporates an intercooler assembly, incorporates a cooled cooling air system, builds portions of the core using material capable of operating at higher temperatures, or a combinations thereof. Significantly, the relationship ties the core size (as represented by the exit area of the higher pressure compressor) to the desired output power and exhaust gas temperature associated with the desired propulsive/thermal efficiency and practical limitations of the engine design, as described below.

During the design and evaluation of various turboprop and turboshaft engines, the inventors unexpectedly discovered that the integration of these advanced technologies could lead to a net benefit in engine performance, despite the anticipated costs. This discovery was made while exploring different engine architectures, power classes, and mission requirements, and assessing the impact on overall engine performance and qualitative characteristics. The inventors found that the benefits of operating at higher temperatures and pressures, which were previously thought to be cost-prohibitive, could indeed outweigh the costs when the core size is maintained or reduced.

Referring to the case of an engine that utilizes cooled cooling air for operating at higher temperatures, the inventors discovered, unexpectedly, that the costs associated with achieving a higher compression, enabled by reducing gas temperatures used to cool core components to accommodate higher core gas temperatures, can indeed produce a net benefit, contrary to expectations in the art. Similar results were discovered with the introduction of an intercooler assembly. Referring to the case of utilizing more temperature-resistant material, such as a Ceramic Matrix Composite (CMC), it was found that certain aspects of the engine size, weight, and operating characteristics can be positively affected while taking into account the complexities and/or drawbacks associated with such material. Regardless of the technology, however, the relationship now described can apply to identify the interrelated operating conditions and core size—i.e., maximum drive turbine shaft torque, drive turbine exit area, maximum exhaust gas temperature, and high pressure compressor exit area.

The inventors of the present disclosure discovered bounding the relationship between a product of total power output (which is a function of a maximum drive turbine shaft torque and maximum rotational speed; the maximum rotational speed being limited by a drive turbine exit area) squared and maximum exhaust gas temperature, divided by the high pressure compressor exit area (corrected specific power) can result in a higher power density core. This bounded relationship, as described herein, takes into due account the amount of overall complexity and cost, and/or a low amount of reliability associated with implementing the technologies required to achieve the operating temperatures and exhaust gas temperature associated with the desired output power levels. The amount of overall complexity and cost can be prohibitively high for gas turbine engines outside the bounds of the relationship as described herein, and/or the reliability can prohibitively low outside the bounds of the relationship as described herein. The relationship discovered, infra, can therefore identify an improved engine configuration suited for a particular mission requirement, one that takes into account efficiency, weight, cost, complexity, reliability, and other factors influencing the optimal choice for an engine configuration.

In addition to yielding an improved gas turbine engine, as explained in detail above, utilizing this relationship, the inventors found that the number of suitable or feasible gas turbine engine designs capable of meeting the above design requirements could be greatly diminished, thereby facilitating a more rapid down selection of designs to consider as a gas turbine engine is being developed. Such a benefit provides more insight into the requirements for a given gas turbine engine well before specific technologies, integration and system requirements are developed fully. Such a benefit avoids late-stage redesign.

The desired relationship, referred to herein as a Corrected Specific Power (CSP) of a gas turbine engine, providing for the improved gas turbine engine, discovered by the inventors, is expressed as:

$${( \frac{{T}_{OUT}}{\sqrt{{A}_{DTExit}}} )}^{2} * \frac{EGT}{{A}_{HPCExit}} * {10}^{- 11} . \qquad Expression ( 5 )$$

where T_{OUT} is maximum drive turbine shaft torque in Newton meters; EGT is maximum exhaust gas temperature in degrees Celsius; A_{HPCExit} is the high pressure compressor exit area in square meters; and A_{DTExit} is the drive turbine exit area in square meters. As mentioned earlier, the maximum power output of the gas turbine engine is a function of the maximum drive turbine shaft torque (T_{OUT}) and a rotational speed of the LP shaft. The rotational speed of the LP shaft is limited by a size of the LP turbine, as the materials forming the LP turbine have a strength to weight relationship that limits how big the LP turbine can be and how fast the LP turbine can rotate (measured as a function of area (A) times speed (N) squared; AN2). Expression (5), above, and the limits of CSP identified herein identify a design space where an improved power output is sufficiently high to justify the means for accommodating the increased energy in the flow. The improved power output is more specifically realized through increases in overall pressure ratio and/or EGT, which results in more energy in a flow through the turbine section, allowing for more power extraction by the turbine section for a given engine size. Said another way, application of Expression (5) yields an engine that allows for more maximum drive turbine shaft torque (T_{OUT}) for a give LP turbine size (represented by the drive turbine exit area (A_{DTExit})).

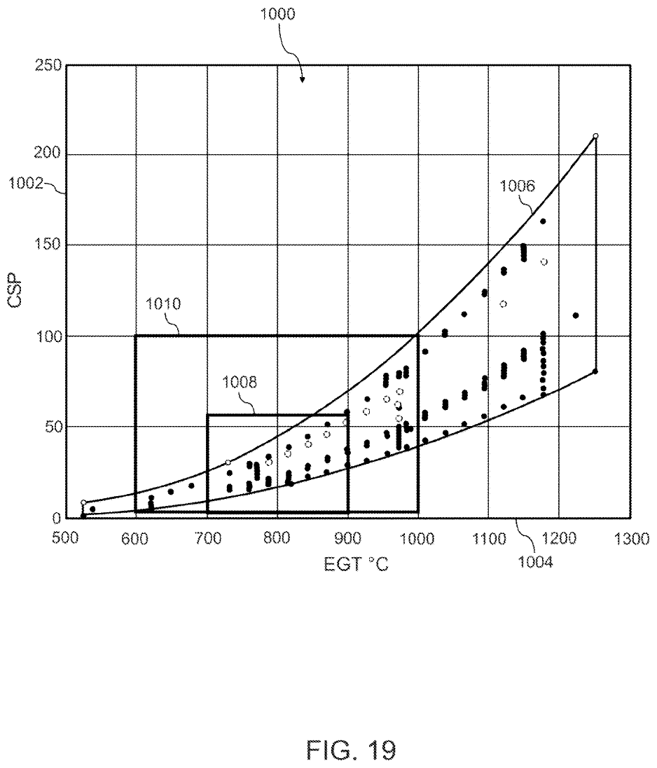

Referring now to FIGS. 18 and 19, various exemplary gas turbine engines are illustrated in accordance with one or more exemplary embodiments of the present disclosure. In particular, FIG. 18 provides a table including numerical values corresponding to several of the plotted gas turbine engines in FIG. 19. FIG. 19 is a plot 1000 of gas turbine engines in accordance with one or more exemplary embodiments of the present disclosure, showing the CSP on a Y-axis 1002 and the EGT on an X-axis 1004.

As shown, the plot 1000 in FIG. 19 depicts a first range 1006, wherein CSP is greater than 0.0001194×EGT2−0.103×EGT+22.14 and less than 0.0003294×EGT2−0.3061×EGT+77.91. The stated advantages of CSP are valid only when the engine design falls within these upper and lower bounds and the EGT is between 525 and 1250. The units of the CSP values are Newtons squared times degrees Celsius over meters squared. These values represent the optimized range for achieving the desired thermal efficiency and power density. An engine with a CSP within this range is expected to exhibit higher thermal efficiency, as indicated by a lower specific fuel consumption (SFC).

In addition, FIG. 19 depicts a second range 1010 where CSP is greater than 3.3 and less than 101 and EGT is greater than 600 degrees Celsius and less than 1,000 degrees Celsius; and a third range 1008 where CSP is greater than or equal to 4 and less than or equal to 69 and EGT is greater than 700 degrees Celsius and less than 900 degrees Celsius. For this second range 1010 and third range 1008, the gas turbine engines can be of a lower thrust class (e.g., a turbomachine of the gas turbine engine providing an output power of at least 550 horsepower and up to 2,000 horsepower when operated at a takeoff power level), while also having a compressor section of the turbomachine defining an increased overall pressure ratio (OPR; e.g., greater than 14:1 and less than 22:1). Such an arrangement can allow for the increased power output for a given engine size. For example, an increased torque output of the LP turbine of the turbomachine can be achieved with such an increased OPR by incorporating an intercooling assembly. Designing a gas turbine engine having a CSP and EGT within the second range 1010 or third range 1008, can allow the gas turbine engines in the noted thrust class and defining the noted OPRs to provide improved overall performance and thermal efficiencies.

It will be appreciated that although the discussion above is generally related to a turboprop engine having a particular intercooler assembly and a particular engine architecture, in various embodiments of the present disclosure, the relationship outlined above with respect to Expression (5) can be applied to any other suitable engine architecture, including any other suitable technology(ies) to allow the gas turbine engine to accommodate higher temperatures to allow for a reduction in the high pressure compressor exit area and high pressure turbine exit area, while maintaining or even increasing the maximum engine power output without, e.g., prematurely wearing various components within the turbomachine exposed the working gas flowpath.

For example, reference will now be made to FIG. 20. FIG. 20 provides a schematic view of a turbomachine 616 in accordance with another exemplary embodiment of the present disclosure. The turbomachine 616 of FIG. 20 can be configured in substantially the same manner as the exemplary turbomachine 616 described above with reference to FIGS. 13 and 14. Accordingly, the same or similar numbers can refer to the same or similar parts.

For example, the turbomachine 616 generally includes a compressor section, a combustion section 626, and a turbine section arranged in serial flow order. However, for the embodiment of FIG. 20, the compressor includes a single, HP compressor 622 (i.e., no booster compressor 618) and the turbine section does not include an intermediate pressure turbine 620. Notably, with the exemplary embodiment of FIG. 20, the HP compressor 622 is configured as an axial-centrifugal compressor, including stages of compressor rotor blades and stator vanes and an impeller.

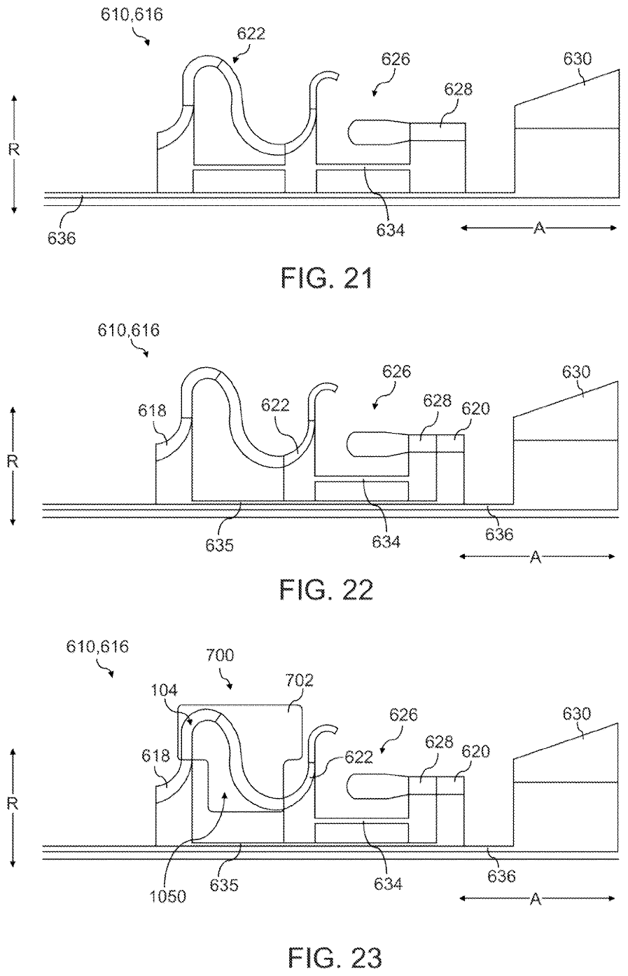

Further by way of example, reference will now be made to FIGS. 21 through 23. FIGS. 21 through 23 provide schematic views of three additional turbomachines 616 in accordance with exemplary embodiments of the present disclosure. Each of these turbomachines 616 can be configured in substantially the same manner as the exemplary turbomachine 616 described above with reference to FIGS. 13 and 14. Accordingly, the same or similar numbers can refer to the same or similar parts.

For example, each turbomachine 616 generally includes a compressor section, a combustion section 626, and a turbine section arranged in serial flow order. However, referring particularly to the embodiment of FIG. 21, the compressor section again includes a single HP compressor 622 (i.e., no booster compressor 618) and the turbine section does not include an intermediate pressure turbine 620. Notably, with the exemplary embodiment of FIG. 21, the HP compressor 622 is configured as a multi-stage, centrifugal compressor, including two stages of impellers (each driven by an HP turbine 628).

Referring to FIGS. 22 and 23, the compressor sections each include a booster compressor 618 in addition to the HP compressor 622, with both the booster compressor 618 and HP compressor 622 each configured as a centrifugal compressor. The turbine section of each of the turbomachines 616 of FIGS. 22 and 23 further includes an intermediate pressure turbine 620 drivingly coupled to the respective booster compressor 618 through a respective intermediate pressure shaft 635.

Further, for the embodiment of FIG. 23, the gas turbine engine 610 further includes an intercooler assembly 700, the intercooler assembly 700 having an intercooler heat exchanger 702 in thermal communication with the compressor section. For the embodiment of FIG. 23, the compressor section defines a transition zone 1050 downstream of the booster compressor 618 and upstream of the HP compressor 622. The transition zone 1050 defines a portion of a working gas flowpath 704 of the turbomachine 616 extending between the booster compressor 618 and the HP compressor 622. The intercooler heat exchanger 702 can be incorporated into the transition zone 1050, such as into one or more of the lines, frames, or the like of the transition zone 1050. The intercooler assembly 700 of FIG. 23, and in particular the intercooler heat exchanger 702, can include or otherwise be in thermal communication with a cooling fluid source.

However, in other embodiments, the intercooler heat exchanger 702 can be positioned within the working gas flowpath 704, e.g., having one or more fins, plates, or other heat transfer structures within the working gas flowpath 704. The intercooler heat exchanger 702 can extend in the circumferential direction, arranged as a 360 degree, axi-symmetric heat exchanger.

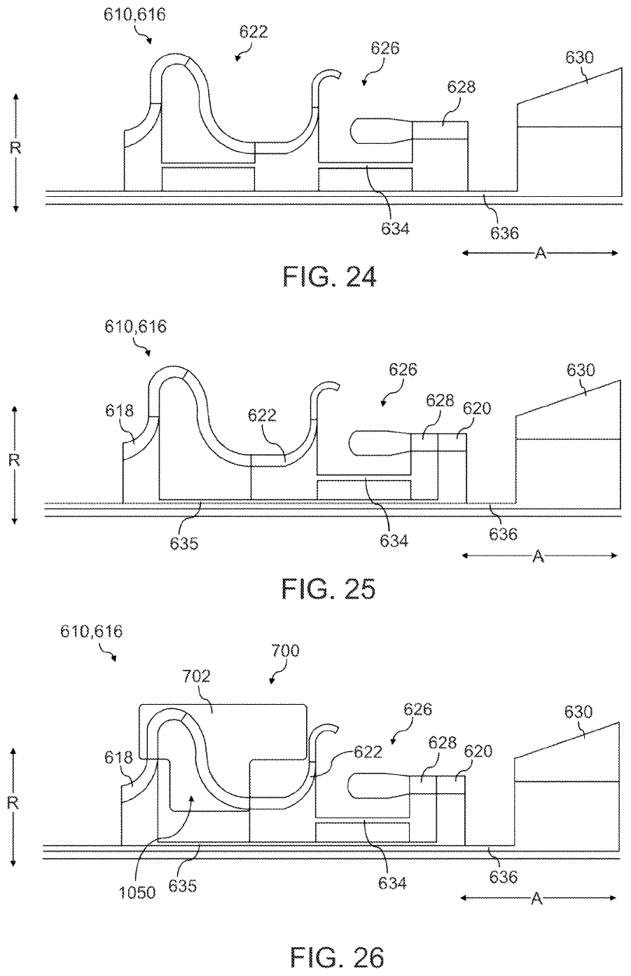

Further by way of example, reference will now be made to FIGS. 24 through 26. FIGS. 24 through 26 provide schematic views of three additional turbomachines 616 in accordance with exemplary embodiments of the present disclosure. Each of these turbomachines 616 can be configured in substantially the same manner as the exemplary turbomachine 616 described above with reference to FIGS. 21 through 23, respectively. Accordingly, the same or similar numbers can refer to the same or similar parts.

For example, each turbomachine 616 generally includes a compressor section, a combustion section 626, and a turbine section arranged in serial flow order. However, by contrast to the exemplary turbomachines 616 of FIGS. 21 through 23, for the embodiments of FIGS. 24 through 26, the HP compressor 622 is an axial-centrifugal compressor, including stages of compressor rotor blades and stator vanes and an impeller. Briefly, referring particularly to FIG. 24, the HP compressor 622 includes a first stage impeller, one or more intermediate stages of compressor rotor blades and stator vanes, and an aft-most stage impeller.

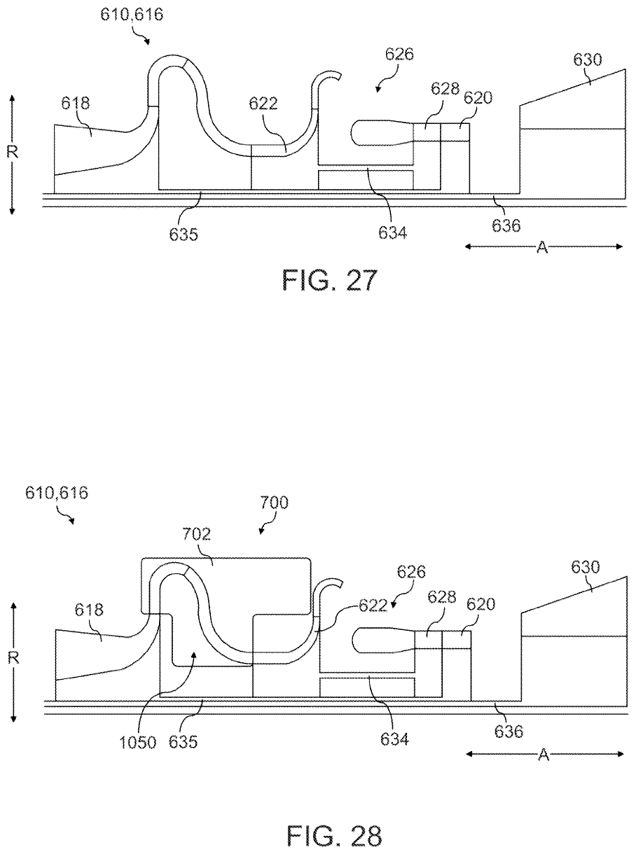

Further by way of example, reference will now be made to FIGS. 27 and 28. FIGS. 27 and 28 provide schematic views of two additional turbomachines 616 in accordance with exemplary embodiments of the present disclosure. Each of these turbomachines 616 can be configured in substantially the same manner as the exemplary turbomachines 616 described above with reference to FIGS. 22 and 23, respectively. Accordingly, the same or similar numbers can refer to the same or similar parts.

For example, each turbomachine 616 generally includes a compressor section, a combustion section 626, and a turbine section arranged in serial flow order. However, by contrast to the exemplary turbomachines 616 of FIGS. 22 through 23, for the embodiments of FIGS. 27 and 28, the booster compressor 618 is an axial-centrifugal compressor, including stages of compressor rotor blades and stator vanes and an impeller.

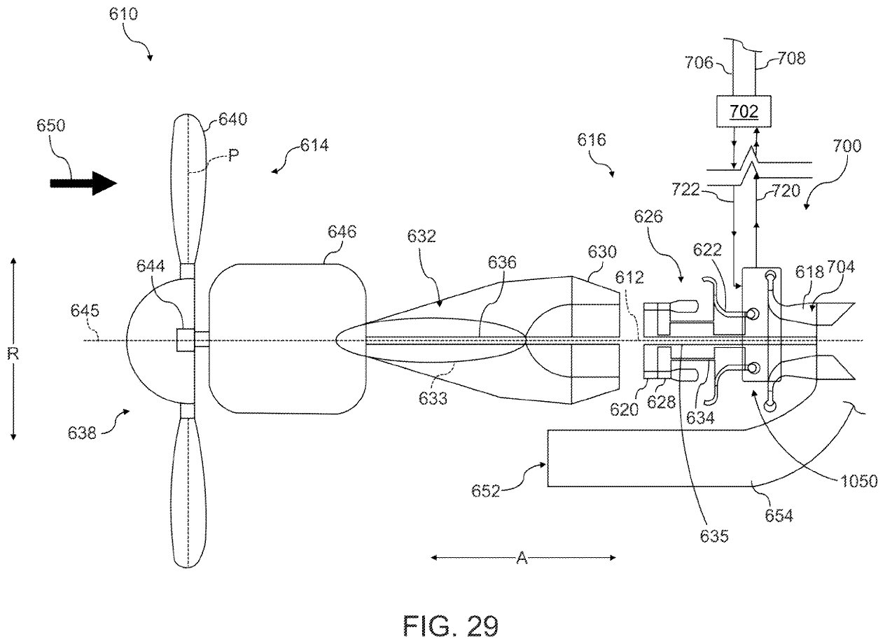

Referring now to FIG. 29, a turboprop engine 610 in accordance with another exemplary embodiment of the present disclosure is provided. The exemplary turboprop engine 610 of FIG. 29 can be configured in a similar manner as the exemplary turboprop engine 610 of FIGS. 13 and 14, and accordingly, the same or similar numbers can refer to the same or similar parts.

For example, the turboprop engine 610 of FIG. 29 generally includes a fan assembly 614 and a turbomachine 616, with the fan assembly 614 being driven by the turbomachine 616 across a power gear box 646. However, for the embodiment of FIG. 29, the turboprop engine 610 is configured as a reverse flow engine. In such a manner, it will be appreciated that the turboprop engine 610 is characterized by a general relationship between the direction of the flow of incoming air 650 (such direction can be used to characterize the relative motion of air during a mode of operation of the engine 610 such as a forward thrust mode) and that of a flow of air axially through the turboprop engine 610. The flow of air through the turbomachine 616 is generally reverse to that of the flow of incoming air 650. Turning the flow from the direction of the incoming flow of air 650 to the axial direction through the turbomachine 616 is usually performed by an intake channel 654. The change of direction is reversed in that the bulk direction of the flow of air 650 (itself having a circumferential swirl component imparted by the propeller blades 640 in addition to a longitudinal component) is opposite, or reverse, to the bulk direction of air flow axially through the turbomachine 616 (which itself also includes a longitudinal component but also include radial and circumferential components owing to the shape of the flow path and swirl induced by rotating turbomachinery components) during one or more phases of operation of the turbomachine 616. Thus, it will also be appreciated that the term “reverse” is a relative comparison of the longitudinal components of the bulk flow of air 650 and bulk flow of air axially within the engine 610. Though the longitudinal direction of the flow of air 650 may not be perfectly parallel with the axial flow of air through the engine 610, it will be appreciated that the longitudinal components of the directions the flow of air 650 and the axial flow are reversed.

Moreover, it will be appreciated that for the embodiment depicted, an exhaust section 632 is not axi-symmetric, and instead include one or more exhaust outlets 633 oriented on, e.g., one or more sides of the turboprop engine 610, such as opposing sides as in the embodiment depicted in FIG. 29.

Further, for the embodiment of FIG. 29, the power gear box 646 is not an offset power gear box, such that a fan axis 645 is aligned with a longitudinal centerline 612 of the turbomachine 616.

In addition, the exemplary turboprop engine 610 of FIG. 29 includes an intercooler assembly 700, the intercooler assembly 700 having an intercooler heat exchanger 702 in thermal communication with the compressor section. For the embodiment of FIG. 29, the compressor section defines a transition zone 1050 downstream of the booster compressor 618 and upstream of the HP compressor 622. The transition zone 1050 defines a portion of a working gas flowpath 704 of the turbomachine 616 extending between the booster compressor 618 and the HP compressor 622. The intercooler heat exchanger 702 is, however, for the embodiment shown located externally from the turbomachine 616 (e.g., in a pylon, wing, or fuselage of an aircraft incorporating the turboprop engine 610). The intercooler assembly 700 includes an outflow duct 720 extending from the compressor section to the externally-located intercooler heat exchanger 702, and an inflow duct 722 extending from the intercooler heat exchanger 702 back to the compressor section. In the embodiment depicted, the outflow duct 720 and the inflow duct 722 are each in airflow communication with the compressor section and the transition zone 1050.

The intercooler assembly 700 of FIG. 29, and in particular the intercooler heat exchanger 702, can include or otherwise be in thermal communication with a cooling fluid source (e.g., through inlet and outlet lines 706, 708). Including the intercooler heat exchanger 702 at the location external to the turbomachine 616 can allow the intercooler heat exchanger 702 to be positioned closer to the cooling fluid source. In situations where the cooling fluid source is a flow of cryogenic fuel, such as liquid hydrogen, it can be more efficient to redirect the airflow with less redirecting of the fuel.

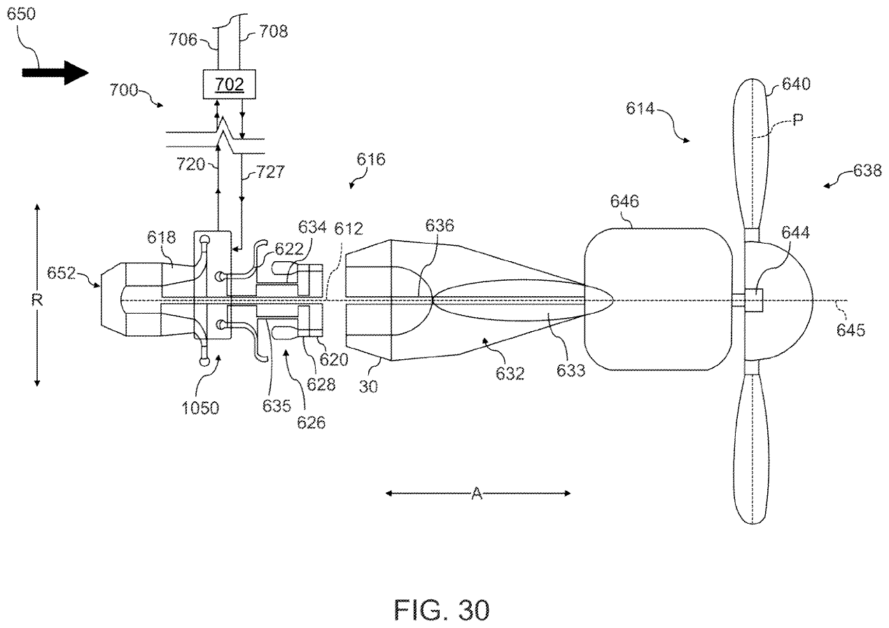

Further, still, referring now to FIG. 30, a turboprop engine 610 in accordance with yet another exemplary embodiment of the present disclosure is provided. The exemplary turboprop engine 610 of FIG. 30 can be configured in a similar manner as the exemplary turboprop engine 610 of FIGS. 13 and 14, and accordingly, the same or similar numbers can refer to the same or similar parts.

However, for the embodiment of FIG. 30, the turboprop engine 610 is arranged in a “pusher” configuration, such that a fan assembly 614 is positioned aft of a turbomachine 616 of the turboprop engine 610. With such an exemplary aspect, a low pressure shaft 636 of the turbomachine 616 need not extend concentrically with, e.g., a high pressure shaft 634, and instead can extend aft directly to a power gear box 646 and the fan assembly 614. Such a configuration can allow for more desirably mechanical properties of the turboprop engine 610.

Referring now to FIG. 31, a turboprop engine 610 in accordance with still another exemplary embodiment of the present disclosure is provided. The turbomachine 616 of FIG. 31 can be configured in a similar manner as the exemplary turboprop engine 610 of FIGS. 13 and 14, and accordingly, the same or similar numbers can refer to the same or similar parts.

However, it will be appreciated that for the embodiment of FIG. 31, the turbomachine 616 does not include an intercooler assembly 700, and instead the turbomachine 616 includes a Cooled Cooling Air (“CCA”) system 1100. The CCA system 1100 generally includes a CCA heat exchanger 1102, a cold fluid delivery assembly 1104, and a hot air bleed assembly 1106.

The cold fluid delivery assembly 1104 generally includes a cold fluid inlet duct 1108 and a cold fluid outlet duct 1110. The cold fluid inlet duct 1108 is in airflow communication with a cold fluid source 1112 and the cold fluid outlet duct 1110 is in airflow communication with a cold fluid sink 1114. The cold fluid inlet duct 1108 is configured to provide a cooling fluid, such as a cooling airflow, from the cold fluid source 1112 to the CCA heat exchanger 1102, and the cold fluid outlet duct 1110 is configured to receive the cooling fluid, such as the cooling airflow, from the CCA heat exchanger 1102 and exhaust it to the cold fluid sink 1114. In certain exemplary embodiments, the cold fluid source 1112 can be an airflow over the turbomachine 616 (e.g., a propeller stream), a bleed airflow from the compressor section, a fuel flow, etc.

It will be appreciated that as used herein, the term “cold fluid” in the context of the cold fluid delivery assembly 1104 refers to a fluid at a temperature lower than a temperature of an airflow received through the hot air bleed assembly 1106. Accordingly, the term is a relative term and does not imply or require any absolute temperature.

The hot air bleed assembly 1106 includes a hot air bleed duct 1116 in airflow communication with a working gas flowpath 704 through the turbomachine 616 at a downstream end of the compressor section, or a location downstream of the compressor section and upstream of a combustor of the combustion section 626. The hot air bleed assembly 1106 further includes a CCA delivery duct 1118 in thermal communication with a hot component of the turbomachine 616. In particular, in the embodiment depicted, the CCA delivery duct 1118 is in thermal communication with a first stage of turbine rotor blades of the HP turbine 628 of the turbomachine 616.

Additionally, or alternatively, in other exemplary embodiments, the CCA delivery duct 1118 can be in thermal communication with an aft-most stage of the HP compressor 622, a rotor at the aft-most stage of the HP compressor 622, a sump within the turbine section, a rotor of the HP turbine 628, one or more airfoils through the HP turbine 628, or other hot components of the turbomachine 616.

During operation, high pressure airflow is bled through the hot air bleed duct 1116 and provided to the CCA heat exchanger 1102, where heat from the high pressure airflow is transferred to the cooling airflow through the cold fluid delivery assembly 1104. The cooled high pressure airflow from the CCA heat exchanger 1102 is then provided through the CCA delivery duct 1118 to the hot component, to cool the hot component.

As is depicted in phantom, in certain exemplary embodiments, the hot air bleed assembly 1106, and in particular the hot air bleed duct 1116, can be configured to receive bleed air from one or more locations upstream of the location between the HP compressor 622 and the combustor.

In at least certain exemplary embodiments, when the gas turbine engine 610 is operated at a takeoff power level, the CCA system 1100 is configured to provide a temperature reduction of the cooling airflow (i.e., the airflow through the hot air bleed assembly 1106) equal to at least 15% of the EGT and up to 45% of the EGT. Further, when the gas turbine engine 610 is operated at the takeoff power level, the CCA system 1100 is configured to receive between 2.5% and 35% of an airflow through a working gas flowpath 704 of the turbomachine 616 at an inlet to a first compressor of the compressor section (the HP compressor 622 in the embodiment depicted).

Inclusion of the CCA system 1100 can allow for the turbomachine 616 to operate with a higher EGT, higher overall pressure ratios through the compressor section, or both, to define a CSP within one or more of the ranges described above.

Notably, however, in other exemplary embodiments, one or more turbomachines 616 of the present disclosure can have other suitable configurations. For example, referring now to FIG. 32, a CCA system 1100 is provided where a hot air bleed duct 1116 of the CCA system 1100 is in airflow communication with a booster compressor 618 upstream of an HP compressor 622. The hot air bleed duct 1116 includes a pump 1120 to increase a pressure of the airflow through the hot air bleed duct 1116 to enable the airflow to be provided, e.g., to the first stage of turbine rotor blades of the HP turbine 628.

Moreover, it will be appreciated that the exemplary turbomachine architectures described herein are by way of example only, and that in other embodiments, other suitable architectures can be provided. Further, in other exemplary embodiments, the CCA systems 1100, intercooler assemblies 700, etc. can be incorporated into any suitable turbomachine 616 architecture of the present disclosure. Moreover, although the turbomachines 616 described herein have been described in the context of turboprop engines 610, in other exemplary embodiments, the gas turbine engines may not include a propeller assembly 614 and accordingly can instead be configured as a turboshaft engine, usable for any suitable turboshaft application.

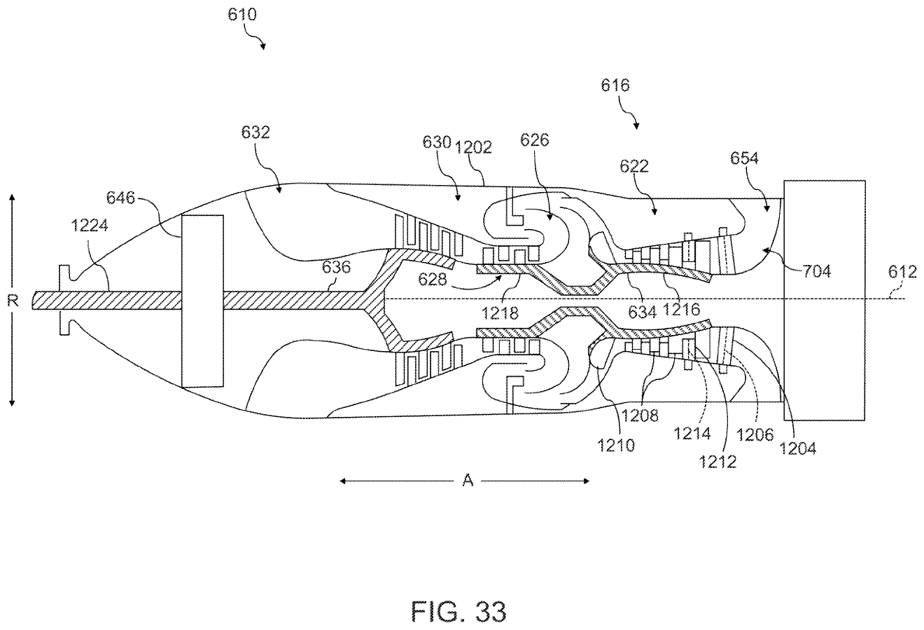

Referring now to FIG. 33, a turbomachine 616 in accordance with still another exemplary embodiment of the present disclosure is provided. The turbomachine 616 of FIG. 33 can be configured in a similar manner as the exemplary turboprop engine 610 of FIGS. 13 and 14, and accordingly, the same or similar numbers can refer to the same or similar parts.

The exemplary turbomachine 616 depicted in FIG. 33 generally includes a substantially tubular outer casing 1202 that partially encloses an annular inlet duct 654. The inlet duct 654 includes at least a portion extending generally along the radial direction R, and is further configured to turn a direction of an air flow therethrough, such that the resulting airflow is generally along the axial direction A. Additionally, the outer casing 1202 encases, in serial flow relationship, a compressor section including a single compressor 622; a combustion section 626 including a reverse flow combustor; a turbine section including a high pressure (HP) turbine 628 and a low pressure (LP) turbine 630; and an exhaust section 6634. Moreover, the turboshaft engine 610 depicted is a dual-spool engine, including a first, high pressure (HP) shaft or spool 634 coupling the HP turbine 628 to the compressor 622, and a low pressure (LP) shaft or spool 636 coupled to the LP turbine 630, and drivingly connecting the LP turbine 630 to a gearbox 646 (which can drive, e.g., a fan assembly (not shown)).

Notably, for the embodiment depicted, the turbomachine 616 further includes a stage of inlet guide vanes 1204 at a forward end of a working gas flowpath 704. Specifically, the inlet guide vanes 1204 are positioned at least partially within the inlet duct 654, the inlet duct 654 located upstream of the compressor section, including the compressor 622. More specifically, for the embodiment depicted the compressor section, including the compressor 622, is located downstream of the stage of inlet guide vanes 1204. Further, the exemplary stage of inlet guide vanes 1204 of FIG. 33 are configured as variable inlet guide vanes 1204. The variable inlet guide vanes 1204 are each rotatable about a pitch axis 1206, allowing for the guide vanes 1204 to direct an airflow through the inlet duct 654 into the compressor 622 of the compressor section in a desired direction. In certain embodiments, each of the variable inlet guide vanes 1204 can be configured to rotate about the respective pitch axis 1206, or alternatively, each of the plurality of variable inlet guide vanes 1204 can include a flap or tail configured to rotate about a respective pitch axis 1206. It should be appreciated, however, that in still other exemplary embodiments, each of the plurality of guide vanes may not be configured to rotate about a respective pitch axis 1206, and instead can include any other suitable geometry or configuration allowing for a variance in a direction of the airflow over the variable guide vanes 1204. Additionally, in other exemplary embodiments, the stage of inlet guide vanes 1204 can instead be located at any other suitable location within the inlet duct 654.

Furthermore, the compressor 622 of the compressor section includes at least three stages of compressor rotor blades. More specifically, for the embodiment depicted, the compressor 622 of the compressor section includes at least four stages of compressor rotor blades. More specifically still, for the embodiment depicted, the compressor 622 of the compressor section includes four stages of radially oriented compressor rotor blades 1208, and an additional centrifugal compressor stage 1210.

Additionally, between each stage of compressor rotor blades 1208, the compressor section includes a stage of compressor stator vanes. Notably, the first stage of compressor stator vanes is configured as a stage of variable compressor stator vanes 1212, such that each of the variable compressor stator vanes 1212 can rotate about a respective pitch axis 1214. By contrast, the remaining stages of compressor stator vanes are configured as fixed compressor stator vanes 1216. Such a configuration can assist with increasing an overall pressure ratio of the compressor 622. For example, the compressor 622 having the multiple number of stages of compressor rotor blades 1208, and optionally including a stage of variable compressor stator vanes 1212, in addition to being located downstream of a stage of variable inlet guide vanes 1204, can allow for the compressor 622 of the compressor section to operate in a more efficient manner. More specifically, for the embodiment depicted, the compressor section configured in accordance with one or more exemplary aspects of the present disclosure defines an overall pressure ratio of at least 14:1, such as at least 15:1. For example, in certain exemplary embodiments, the overall pressure ratio of the compressor section can be at least 16:1, and up to 22:1, such as up to 20:1.

Notably, for the embodiment depicted, the HP turbine 628 includes at least two stages of HP turbine rotor blades 1218 and up to three stages of HP turbine rotor blades 1218. In particular, the HP turbine 628 includes two stages of HP turbine rotor blades 1218. Such a configuration can ensure a sufficient amount of power is provided to the compressor 622 through the HP shaft 634. For the embodiment depicted, the HP turbine rotor blades 58 of the at least two stages of HP turbine rotor blades 58 are formed of a ceramic matrix composite material. Accordingly, the HP turbine rotor blades 58 can be capable of withstanding the relatively elevated temperatures within the HP turbine 628 without requiring a flow of cooling air to cool the HP turbine rotor blades 58.

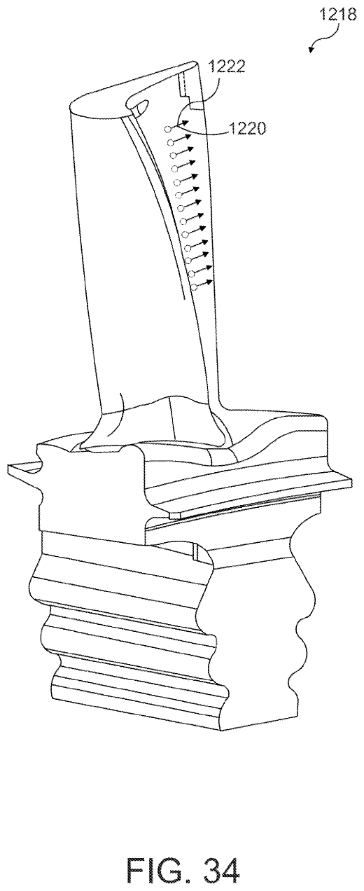

It should be appreciated, however, that in other exemplary embodiments, the HP turbine rotor blades 1218 can be air cooled HP turbine rotor blades. For example, referring briefly to FIG. 34 providing a perspective view of an HP turbine rotor blade 1218 in accordance with an exemplary embodiment of the present disclosure, the HP turbine rotor blade 1218 can include a plurality of cooling holes 1220 through which a cooling airflow 1222 is provided during operation of the turboshaft engine 610 to maintain a temperature of the HP turbine rotor blade 1218 below a predetermined temperature threshold. The cooling airflow 1222 can be received from, e.g., one or more of the CCA systems described herein above.

Referring again to FIG. 33, it will be appreciated that the turboshaft engine 610 depicted in FIG. 33 is a relatively small turboshaft engine 610. For example, the turbomachine 616 can be configured to provide an output power of at least 550 horsepower and less than 2,000 horsepower when operated at a takeoff power level. With such a configuration, the compressor section (including the compressor 622) can have a nominal design of less than about 10.5 pounds per second of airflow when operated at a takeoff power level. Notably, as used herein, “horsepower” refers to brake horsepower during standard day operating conditions, i.e., a horsepower delivered to an output drive shaft assembly 1224 by the LP shaft 636 (across the power gear box 646) during operation of the turboshaft engine at a takeoff power level.

Moreover, it will be appreciated that in still other exemplary aspects, the gas turbine engine can include additional or alternative technologies to allow the gas turbine engine to accommodate higher temperatures while maintaining or even increasing the maximum turbofan engine thrust output, as can be indicated by a reduction in the high pressure compressor exit area, without, e.g., prematurely wearing on various components within the turbomachine exposed to the working gas flowpath.

For example, as discussed in more detail above, in additional or alternative embodiments, a gas turbine engine, such as a turboprop or turboshaft engine, can incorporate advanced materials capable of withstanding the relatively high temperatures at downstream stages of a high pressure compressor (e.g., at a last stage of high pressure compressor rotor blades), and downstream of the high pressure compressor (e.g., a first stage of an HP turbine, downstream stages of the HP turbine, an LP turbine, an exhaust section, etc.). In particular, in at least certain exemplary embodiments, a gas turbine engine of the present disclosure can include an airfoil (e.g., rotor blade or stator vane) in one or more of the HP compressor, the first stage of the HP turbine, downstream stages of the HP turbine, the LP turbine, the exhaust section, or a combination thereof formed of a ceramic-matrix-composite or “CMC.”

Additionally, or alternatively still, in other exemplary embodiments, a gas turbine engine of the present disclosure can include an airfoil (e.g., rotor blade or stator vane) in one or more of an HP compressor, a first stage of an HP turbine, downstream stages of the HP turbine, an LP turbine, an exhaust section, or a combination thereof formed in part, in whole, or in some combination of materials including but not limited to titanium, nickel, and/or cobalt based superalloys (e.g., those available under the name Inconel® available from Special Metals Corporation). One or more of these materials are examples of materials suitable for use in an additive manufacturing processes.

Further, it will be appreciated that in at least certain exemplary embodiments of the present disclosure, a method of operating a gas turbine engine is provided. The method can be utilized with one or more of the exemplary gas turbine engines discussed herein, such as in FIGS. 13 through 17 and 20 through 32. The method includes operating the gas turbine engine at a takeoff power level, wherein operating the gas turbine engine at the takeoff power level includes driving a propeller of a propeller assembly across a propeller shaft of the propeller assembly, the gas turbine engine further including a turbomachine with a high pressure compressor defining a high pressure compressor exit area (A_{HPCExit}) in square inches and a low pressure turbine defining a drive turbine exit area (A_{DTExit}) in square inches, the gas turbine engine defining a maximum exhaust gas temperature (EGT) in degrees Celsius, a maximum drive turbine shaft torque (T_{OUT}) in Newton meters, and a corrected specific power in Newtons squared times degrees Celsius over meters squared. The corrected specific power is determined in accordance with Expression (3) and is greater than 0.0001194×EGT²−0.103×EGT+22.14 and less than 0.0003294×EGT²−0.3061×EGT+77.91.

In certain exemplary aspects, operating the gas turbine engine at the takeoff power level further includes reducing a temperature of a cooling airflow provided to a high pressure turbine of the gas turbine engine with a cooled cooling air system. Additionally, or alternatively, operating the gas turbine engine at the takeoff power level further includes reducing a temperature of an airflow through the compressor section with an intercooler assembly.

### Autothrottle

In various embodiments, the present system addresses limitations of conventional autothrottle implementations by enabling intelligent, real-time control of hybrid propulsion systems using both a turbomachine and an electric machine. As used herein, an “electric machine” refers to a component of the propulsion system that is operable as an electric motor, a generator, or both. For example, an electric machine can include a starter-generator configured to deliver torque during propulsion or recover electrical energy during regenerative operation. The electric machine is configured to provide mechanical torque to a propulsor by converting electrical energy from onboard storage or generation systems, or to recover electrical energy during regenerative operation. The electric machine can include associated electronics such as inverters, motor controllers, and drive systems. As used herein, a “turbomachine” refers to an engine that converts thermal energy from fuel combustion into mechanical energy to drive a propulsor, such as a propeller or fan. In various aspects of the present disclosure, the turbomachine is a gas turbine engine, such as a turboprop or turbofan, and can include components such as a compressor, combustor, turbine, and shaft for delivering rotational power.

Unlike traditional autothrottle systems designed for single-source propulsion, this system provides coordinated thrust control across multiple energy sources, optimizing fuel usage, electrical energy consumption, and overall performance based on real-time aircraft conditions. The autothrottle controller described herein supports hybrid thrust allocation, failure compensation, energy reserve management, and seamless operation with both legacy multi-lever and modern single-lever cockpit configurations to provide a technically distinct solution for hybrid electric turboprop aircraft.

The autothrottle controller system described herein addresses the technical problem associated with conventional autothrottle systems, which are typically designed for single-source propulsion and are not configured to manage multiple power sources in hybrid electric aircraft. In conventional systems, dynamically allocating thrust is challenging, and not achievable to allocate among a turbomachine and an electric machine based on real-time operational conditions. The disclosed autothrottle control system provides a technological improvement by enabling coordinated control of both fuel-based and electric propulsion sources, which enables improved energy usage, reduced fuel consumption, increased operational flexibility, and the ability to maintain propulsion in the event of partial system failure. The system further supports both single and multi-throttle configurations, enabling integration with legacy aircraft designs or future single-lever cockpit architectures.

As used herein, a “propulsion system” is a subsystem of the autothrottle controller system, which includes a turbomachine, an electric machine, and a propulsor (e.g., a propeller, a fan, or other rotating aerodynamic device configured to generate thrust) configured to provide propulsion using fuel-based, electric, or hybrid mechanical power.

In various aspects of the present disclosure, the autothrottle control system manages hybrid thrust delivery by adjusting turbomachine throttle position, electric machine output, and propeller pitch to meet a selected thrust or airspeed. The system compares speed or thrust measurements from the propulsion system with pilot or system-defined targets and dynamically allocates power among available sources.

The autothrottle controller can receive energy from multiple sources, including turbomachine fuel and electrical energy provided by fuel cells, solar panels, or batteries. Battery charging can occur via an electrical generator powered by the turbomachine, preferably during efficient engine operation to reduce parasitic losses.

In various aspects of the present disclosure, the autothrottle controller can respond to system demands by coordinating output from both fuel-based and electric power sources. Throttle positions and power settings are adjusted to optimize energy usage while satisfying total thrust requirements. Control actions can be based on pilot inputs or autonomous system commands.

The autothrottle controller can also respond to failures within the propulsion system. For example, in the event of a turbomachine or propulsor failure, the controller can increase electric machine output to maintain thrust. Such reallocation is dynamically adjusted based on real-time aircraft conditions, including speed, altitude, and ambient environment.

The system supports sourcing electrical energy from onboard storage elements, such as batteries, fuel cells, solar panels, or auxiliary power units (APUs). Batteries can be charged by a generator coupled to the gas turbine engine, with power extraction prioritized during periods of optimal engine efficiency.

In various aspects of the present disclosure, the autothrottle controller governs whether propulsion is provided by the turbomachine, electric machine, or both. The controller dynamically selects the power mode depending on flight phase, energy reserves, and performance requirements. The propulsor can be a propeller or fan.

The autothrottle system is adaptable to various aircraft architectures. In single-lever configurations, the pilot provides a unified input for both engine power and propeller pitch. In multi-lever setups, separate controls can govern the turbomachine, electric machine, and propulsor pitch, enabling compatibility with legacy and advanced cockpit layouts.

Optimization objectives can include reducing emissions, minimizing contrail formation, conserving fuel, managing power system thermal loads, and maintaining minimum energy reserves. The system dynamically manages throttle settings to meet these goals across various mission profiles.

The controller can operate cooperatively with other engines in a multi-propulsor configuration, including APUs or distributed propulsion units. The controller can synchronize or decouple engine control based on thrust demands, power availability, or energy efficiency considerations.

Energy usage optimization can take into account multiple constraints, such as propulsion system health, ambient conditions, and mission phase. For example, electric machine operation is curtailed to prevent overheating, or fuel consumption is prioritized during battery depletion.

The system can integrate multivariate efficiency models for each thrust-producing component. Inputs to these models can include throttle position, ambient pressure, aircraft altitude, and air speed, and outputs can represent thrust-to-energy ratios or other performance metrics used to guide control decisions.

In multi-propulsor aircraft, the autothrottle system can adjust each engine's output independently or coordinate them through a unified command. This flexibility allows for asymmetric thrust handling, redundancy during engine degradation, or optimized energy distribution based on available reserves.

These adaptive behaviors allow the autothrottle system to enhance flight safety, operational flexibility, and energy efficiency, particularly in missions that require varying thrust demands, such as takeoff, cruise, loiter, or emergency descent profiles.

In various aspects of the present disclosure, thrust control is performed using one or more engine parameters, including N1 speed, torque output, or exhaust gas temperature (EGT). As used herein, “N1 speed” refers to the rotational speed of the engine's low-pressure spool, including the low-pressure compressor and turbine. N1 speed is typically expressed as a percentage of maximum revolutions per minute (RPM) and is used as a primary control parameter for regulating engine thrust. Torque output can represent the rotational force generated at the shaft and can be used as a proxy for thrust when driving a propulsor. EGT is monitored to ensure thermal limits are not exceeded and can also indicate changes in engine performance or efficiency, which influence how much thrust can safely be commanded under current operating conditions.

In various aspects of the present disclosure, thrust is adjusted to maintain a constant airspeed.

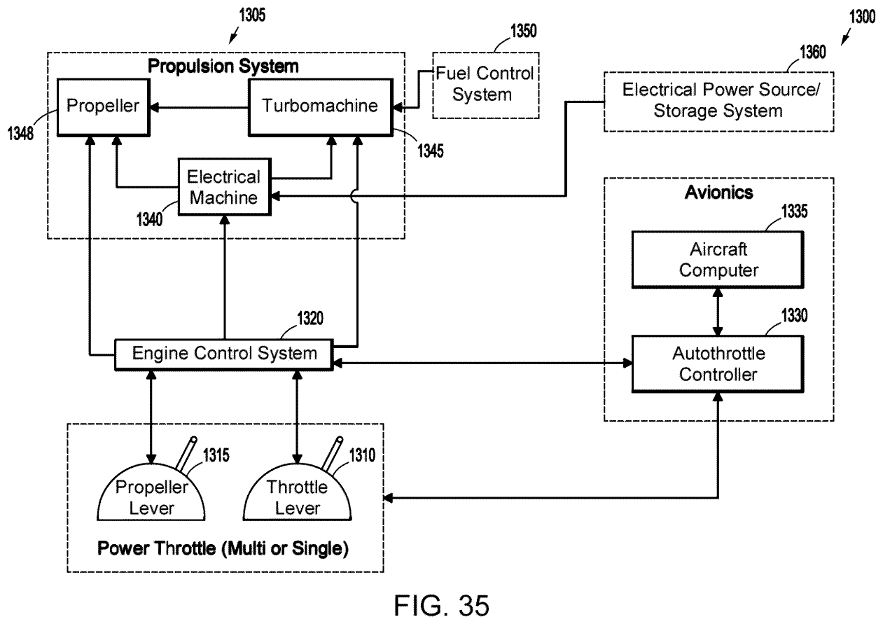

FIG. 35 illustrates an example autothrottle control for hybrid electric aircraft system 1300, in accordance with an exemplary aspect. The hybrid electric aircraft system 1300 includes a propulsion system 1305, a throttle lever 1310, a propulsor 1346, and a propulsor lever 1315. In some aspects of the present disclosure, throttle lever 1310 and propulsor lever 1315 can collectively be a power throttle for a multi or single engine aircraft. The throttle lever 1310 can control thrust to the propulsion system 1305, and the propulsor lever 1315 can control the pitch of blades on the propulsor 1346. In various aspects of the present disclosure, a single throttle lever 1310 can control power/speed and propulsor pitch angle.

The hybrid electric aircraft system 1300 also includes an engine control system 1320, an autothrottle controller 1330, an aircraft computer 1335, a fuel control system 1350, and an electrical power source/storage system 1360.

The propulsion system 1305 is a hybrid propulsion system, which includes an electric machine 1340, a turbomachine 1345, and the propulsor 1346. The propulsion system 1305 provides the benefit of controlling both electrical power and mechanical power supplied to throttle lever 1310 and a propulsor lever 1315, thereby controlling the mode and/or amount of power provided, e.g., electricity from electrical power source/storage system 1360 and fuel from fuel control system 1350.

Thus, in general, the autothrottle controller 1330 and the aircraft computer 1335 are part of an avionics system of the aircraft, and the electric machine 1340, turbomachine 1345, and propulsor 1346 are part of the propulsion system 1305 of an aircraft. In various aspects of the present disclosure, the turbomachine 1345 is a gas turbine engine (e.g., turboprop), which operates the turbomachine 1345 by converting thermal energy from fuel combustion into mechanical energy to drive the propulsor.

Briefly, turbomachine 1345 is similar to turbomachine 616 detailed above with respect to FIG. 33 such that gas turbine engine or turbomachine 1345 likewise define a maximum exhaust gas temperature (EGT) in degrees Celsius, a maximum drive turbine shaft torque (T_{OUT}) in Newton meters, a high pressure compressor exit area (A_{HPCExit}) in square inches and a drive turbine exit area (A_{DTExit}) in square inches, and a corrected specific power (CSP) in Newtons squared times degrees Celsius over meters squared.

The corrected specific power of the gas turbine engine is determined as follows:

$${( \frac{{T}_{OUT}}{\sqrt{{A}_{DTExit}}} )}^{2} * \frac{EGT}{{A}_{HPCExit}} * {10}^{- 11} ;$$

wherein CSP is greater than 0.0001194×EGT²−0.103×EGT+22.14 and less than 0.0003294×EGT²−0.3061×EGT+77.91; wherein EGT is greater than 525 degrees Celsius and less than 1250 degrees Celsius; wherein a maximum EGT is greater than 600 degrees Celsius and less than 1000 degrees Celsius, and/or wherein CSP is greater than 3.3 and less than 101. In aspects, the gas turbine engine Y defines an output power of at least 550 horsepower and up to 2,000 horsepower when operated at a rated speed.

In various aspects of the present disclosure, the throttle lever 1310 and the propulsor lever 1315 are in communication with the engine control system 1320 and the autothrottle controller 1330. The autothrottle controller 1330 is in communication with the engine control system 1320 and the aircraft computer 1335.

In various aspects of the present disclosure, the engine control system 1320 is in communication with the electric machine 1340, the turbomachine 1345 and the propulsor 1346. The electric machine 1340 is also in communication with the turbomachine 1345 and the propulsor 1346.

In various aspects of the present disclosure, the fuel control system 1350 provides fuel to the turbomachine 1345 and the electrical power source/storage system 1360 provides electrical power/energy to the electric machine 1340. As mentioned above, the electrical power source/storage system 1360 can be in the form of batteries, APU, Fuel Cell, etc.

As shown in FIG. 35, the autothrottle controller 1330 provides control to the engine control system 1320 by receiving input from the power throttle (e.g., throttle lever 1310 and propulsor lever 1315), in addition to data received from the aircraft computer 1335, which in various aspects of the present disclosure, can include information to aid the autothrottle controller 1330 to select a thrust mode such as fuel, electrical or a hybrid fuel/electric thrust.

The engine control system 1320 can include one or more processors, memory elements, and control logic configured to regulate operation of the turbomachine 1345. The engine control system 1320 can receive input from the autothrottle controller 1330 and the throttle lever 1310, and can generate control signals for fuel flow, ignition timing, and/or torque modulation. In various aspects of the present disclosure, the engine control system 1320 controls the electric machine 1340 and the turbomachine 1345 to provide power to the propulsor 1346 (e.g., to rotate the shaft of the propulsor 1346 and/or to adjust the pitch of blades of the propulsor 1346).

The autothrottle controller 1330 can utilize a combination of propulsion system parameters to guide these control actions. For example, the controller can monitor N1 speed from the turbomachine 1345 to assess current gas turbine performance, torque output from the electric machine 1340 to estimate available supplemental thrust, and EGT to verify thermal operating limits are not exceeded. These parameters are processed within an internal control model to determine an energy-optimal thrust distribution between the turbomachine and electric machine. In some aspects of the present disclosure, the controller can prioritize lower EGT operating points for emissions or engine life considerations, or use real-time torque feedback to balance electrical power demand against battery state-of-charge.

In various aspects of the present disclosure, the autothrottle controller 1330 receives input from the throttle lever 1310 and/or the propulsor lever 1315 and determines a selected thrust level. Based on this input, along with real-time data from the aircraft computer 1335 (e.g., current speed, altitude, air temperature, and/or engine health), the autothrottle controller 1330 can determine how to achieve the requested thrust using one or more available power sources. For example, the autothrottle controller 1330 can command the engine control system 1320 to increase fuel flow to the turbomachine 1345, increase output from the electric machine 1340, and/or engage both systems in a coordinated manner to deliver hybrid thrust to the propulsor.

The autothrottle controller 1330 dynamically balances energy efficiency, thermal constraints, and performance goals to achieve the commanded thrust in a way that reduces total energy usage across the system. In various aspects of the present disclosure, separate levers can be employed. For example, the propulsor lever 1315 can command a change in propulsor pitch angle, which the autothrottle controller 1330 can factor into energy optimization logic. As used herein, propulsor pitch angle refers to the angular orientation of the blades of a propulsor (e.g., propeller or fan) relative to the plane of rotation. Adjusting the pitch angle changes the aerodynamic loading of the blades, thereby affecting thrust output and efficiency at different airspeeds and engine power settings. In various aspects of the present disclosure, a single power lever is employed. For example, the controller can manage both thrust and propulsor pitch angle using an internal control model.

In response to a failure of the turbomachine or electric machine, the autothrottle controller 1330 can adjust the propulsor pitch angle to compensate for changes in available torque or to maintain aircraft performance and controllability. For example, in a single-engine-out condition in a multi-engine aircraft, the controller can reduce the pitch angle of the affected propulsor to decrease drag, while increasing pitch angle and torque from the remaining functional propulsion system to maintain symmetric thrust and directional control. In single-propulsor configurations, the pitch angle can be adjusted to improve propulsor efficiency under reduced power conditions, maximizing residual thrust from the available propulsion source.

In various aspects of the present disclosure, the aircraft computer 1335 includes one or more processors, memory elements, and software modules configured to manage flight-related functions and provide data to the autothrottle controller 1330. The aircraft computer 1335 can monitor and/or calculate values such as altitude, air speed, ambient temperature, engine health, power source status, and/or flight phase. This information is used by the autothrottle controller 1330 to determine how to allocate power among available propulsion sources.

In various aspects of the present disclosure, the electric machine 1340 includes an electric machine and associated control electronics, such as an inverter or motor controller. In some aspects of the present disclosure, the electric machine 1340 is coupled to the propulsor shaft directly or through a geartrain. The electric machine 1340 receives electrical power from the electrical power source/storage system 1360 and delivers mechanical torque to the propulsor 1346 to assist or supplement the turbomachine 1345.

The fuel control system 1350 provides fuel to the turbomachine 1345, while the electrical power source/storage system 1360 provides electrical power/energy to the electric machine (e.g., motor/engine) to power the propulsor 1346. The fuel control system 1350 can include components such as a fuel pump, one or more flow control valves, pressure sensors, and/or embedded control circuitry. In various aspects of the present disclosure, the fuel control system 1350 receives control signals from the engine control system 1320 and modulates fuel delivery to the turbomachine 1345 based on commanded thrust or power output. The electrical power source/storage system 1360 can include one or more energy storage devices and/or generators, such as batteries, a fuel cell, an auxiliary power unit (APU), and/or a gas turbine-driven generator. In various aspects of the present disclosure, the electrical power source/storage system 1360 provides electrical power to the electric machine 1340 and is monitored and/or managed by the aircraft computer 1335 and the engine control system 1320.

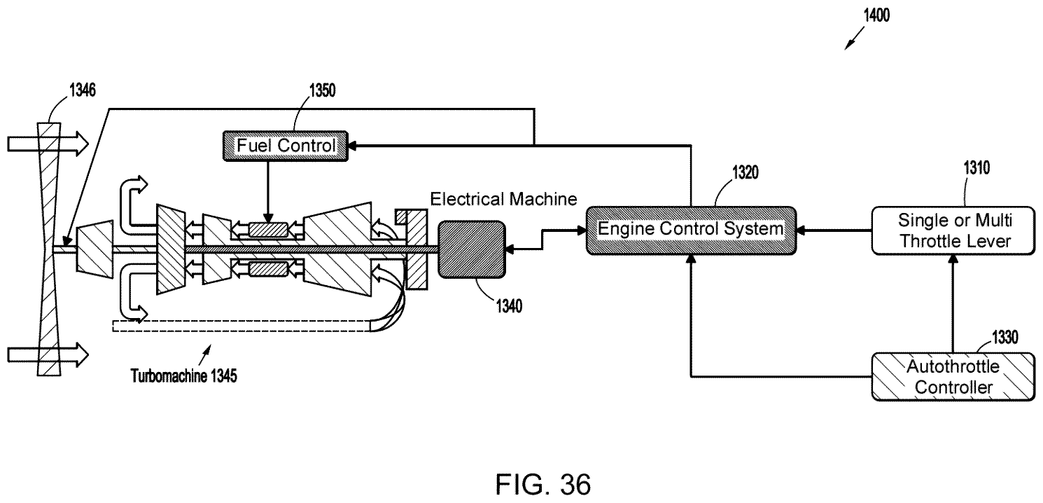

FIG. 36 is a schematic diagram of an example implementation of the autothrottle control for hybrid electric aircraft system 1400 in a single engine aircraft, in accordance with an exemplary aspect. In various aspects of the present disclosure, the components shown in FIG. 36 can correspond to the components described above in FIG. 35. As shown, the system includes a throttle lever 1310, which is a single or multi throttle lever used by the pilot to command overall thrust, such as thrust by fuel, electric and/or a hybrid fuel/electric energy. The throttle lever 1310 is in communication with the engine control system 1320 and the autothrottle controller 1330. The autothrottle controller 1330 receives pilot input (e.g., input from the single or multi throttle lever 1310), and/or data from onboard systems (e.g., aircraft computer, environmental sensors), and determines how to achieve the requested thrust using available power sources. The engine control system 1320 then modulates operation of both the fuel control system 1350 and the electric machine 1340 accordingly.

As shown in FIG. 36, the electric machine 1340 is mechanically coupled to the shaft that drives propulsor P, allowing it to deliver torque directly. The fuel control system 1350 adjusts fuel flow to the turbomachine 1345 based on commands from the engine control system 1320. The engine control system 1320 coordinates operation of both the electric machine 1340 and the turbomachine 1345 according to thrust commands generated by the autothrottle controller 1330. In various aspects of the present disclosure, the autothrottle controller 1330 determines the appropriate contribution from the electric machine 1340 and the turbomachine 1345 to achieve the commanded thrust level based on pilot input, operating conditions, and/or available energy reserves. As used herein, an “appropriate contribution” refers to a distribution of power between the electric machine 1340 and the turbomachine 1345 that satisfies the thrust demand while optimizing energy usage, respecting system constraints (e.g., thermal limits, battery state-of-charge), and maintaining system health.

In various aspects of the present disclosure, during a cruise condition at moderate altitude and power setting, the autothrottle controller 1330 can determine that electric propulsion is more energy efficient than fuel-based propulsion alone, based on current battery state-of-charge, aircraft performance metrics, and system operating conditions. In such cases, the controller can identify that allocating most or all of the thrust to the electric machine 1340 (while reducing or suspending fuel flow to the turbomachine 1345) constitutes an appropriate contribution to achieve the commanded thrust level. This determination is based on internal control models (described above), which analyze propulsion system parameters such as N1 speed, torque output, and EGT to continuously update energy-optimal thrust distribution. In such a case, the autothrottle controller 1330 can command the electric machine 1340 to supply most or all of the torque to the propulsor P, while reducing or suspending fuel flow via the fuel control system 1350. During a high-power climb or takeoff condition, the autothrottle controller 1330 can operate in a hybrid fuel-electric power mode by commanding the engine control system 1320 to increase fuel flow to the turbomachine 1345 and also directing the electric machine 1340 to contribute torque.

As used herein, battery state-of-charge refers to the available electrical energy stored in the aircraft's battery system, expressed as a percentage of total capacity. When the state-of-charge is high, the controller can prioritize electric propulsion to reduce fuel consumption. Engine efficiency characteristics refer to the performance curves of the turbomachine, which can vary with throttle position, altitude, and airspeed. For example, the controller can recognize that the turbomachine operates less efficiently at low power settings, and therefore can assign a larger proportion of thrust to the electric machine under those conditions. Thermal operating limits refer to constraints on system temperature, such as the maximum allowable exhaust gas temperature (EGT) for the turbomachine or temperature limits on electric motor windings and power electronics. If these thresholds are approached, the controller can reduce power from the affected subsystem and shift thrust to the other. Finally, mission profile refers to the intended operational phase or sequence, such as takeoff, climb, cruise, loiter, descent, or emergency conditions. For example, during cruise, the system can emphasize efficiency and minimal noise, while during takeoff it can prioritize maximum available thrust from both propulsion sources.

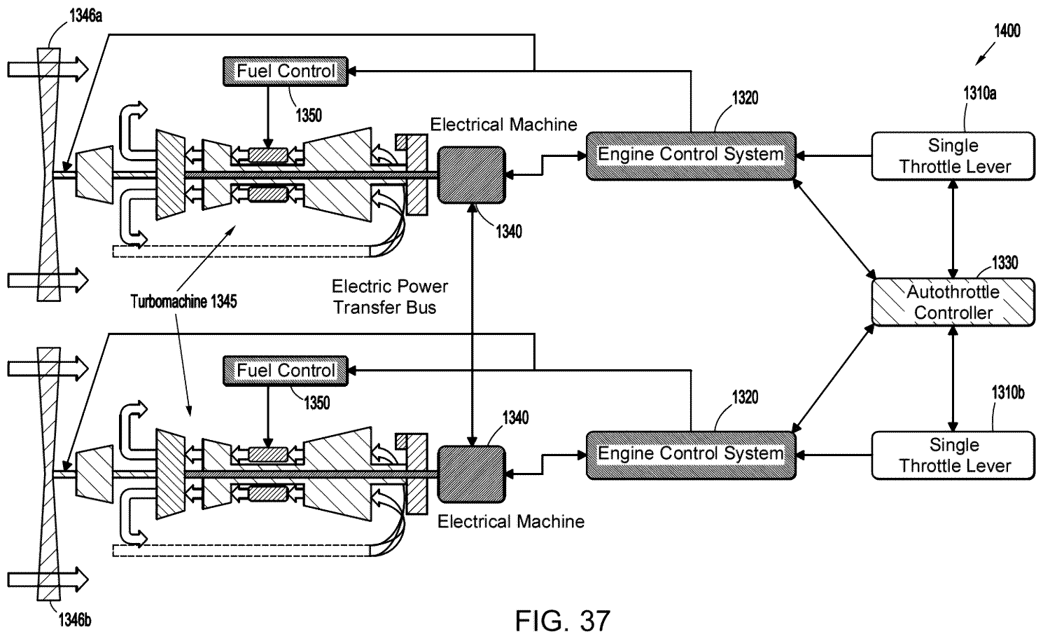

FIG. 37 is a schematic diagram of an example implementation of the autothrottle control for hybrid electric aircraft system 1500 in a multiengine aircraft, in accordance with an exemplary aspect. In various aspects of the present disclosure, the components shown in FIG. 37 can correspond to the components described above in FIG. 35.

In the aspect shown in FIG. 37, the aircraft includes two independent propulsion assemblies: one associated with propulsor P1 and the other with propulsor P2. Each propulsion assembly includes a dedicated turbomachine 1345, an electric machine 1340, a fuel control system 1350, and a propulsor.

In various aspects of the present disclosure, a single throttle lever 1310a provides input from a pilot that is communicated to the engine control system 1320 and the autothrottle controller 1330 to provide thrust by fuel, electric or a hybrid fuel/electric energy for propulsor P1, while a second single throttle lever 1310b provides input from a pilot that is communicated to the engine control system 1320 and the autothrottle controller 1330 to provide thrust by fuel, electric or a hybrid fuel/electric energy for propulsor P2.

Throttle lever 1310a and throttle lever 1310b are each in communication with the engine control system 1320 and the autothrottle controller 1330. In various aspects of the present disclosure, either single throttle lever 1310a or single throttle lever 1310b is utilized to provide control for both propulsors P1 and P2.

The engine control system 1320 is responsible for coordinating fuel delivery and electrical output across both propulsion assemblies. The autothrottle controller 1330 receives position data from each throttle lever and determines the required thrust for each propulsor, based on aircraft state and pilot input. As used herein, aircraft state can include one or more of the current altitude, airspeed, rate of climb or descent, attitude, power system availability, engine temperature, and environmental conditions such as ambient pressure or temperature. For example, if the aircraft is operating at high altitude with reduced air density, the controller can increase thrust commands to maintain airspeed or compensate for aerodynamic drag.

Pilot input can include the position of a single or multi-throttle lever, a requested airspeed, or a commanded climb/descent rate. The controller interprets this input to calculate a required thrust level. For instance, if the pilot advances the throttle lever to a high-power setting during takeoff, the controller can command both the turbomachine and electric machine to operate at maximum safe power levels to meet the thrust requirement. Conversely, in cruise, if the throttle lever remains steady and battery reserves are high, the controller can reduce fuel flow and rely primarily on electric power to maintain efficient forward thrust.

The autothrottle controller 1330 can combine these inputs using a control algorithm that maps aircraft state variables and pilot commands to a desired thrust vector. In some aspects of the present disclosure, this control logic includes a thrust estimation model that computes the current available thrust from each power source and allocates power accordingly to meet the target. The algorithm can include performance lookup tables, multivariate regression models, or optimization routines that reduce energy usage while satisfying thrust demand and system constraints. The autothrottle controller 1330 then commands the engine control system 1320 to allocate thrust production between the turbomachine 1345 and the electric machine 1340 associated with each propulsor.

In the aspect shown in FIG. 37, the electric machine 1340 associated with propulsor P1 is mechanically coupled to the same shaft as the turbomachine 1345, allowing either or both to deliver torque to the propulsor. The same configuration applies to the second propulsion assembly associated with propulsor P2. The fuel control systems 1350 regulate fuel flow to their respective turbomachines 1345 under the direction of the engine control system 1320, which in turn receives high-level control instructions from the autothrottle controller 1330.

As an example, during a takeoff condition where maximum available thrust is required, the autothrottle controller 1330 commands both the turbomachines 1345 and the electric machines 1340 to deliver torque to their respective propulsors. During cruise flight, the autothrottle controller 1330 evaluates system inputs including aircraft airspeed, altitude, battery state-of-charge, and current energy conversion efficiency of both the turbomachine 1345 and electric machine 1340. If the controller determines that the electric machine 1340 can independently generate sufficient thrust to maintain commanded airspeed with lower energy consumption per unit of thrust compared to the turbomachine 1345, the controller commands a throttle-down or shutdown state for the turbomachine 1345. This decision can be further supported by operational conditions that favor electric propulsion, such as sufficient battery reserves (e.g., state-of-charge above 40% of capacity), acceptable thermal margins for the electric machine (e.g., motor temperature below a defined threshold, such as 80 degrees Celsius in one example implementation), or flight phases where reduced emissions or noise are prioritized (e.g., descent over populated areas or cruise through environmentally sensitive airspace). In such a case, the controller adjusts the electric machine 1340 to maintain required torque, improving energy efficiency without compromising aircraft performance.

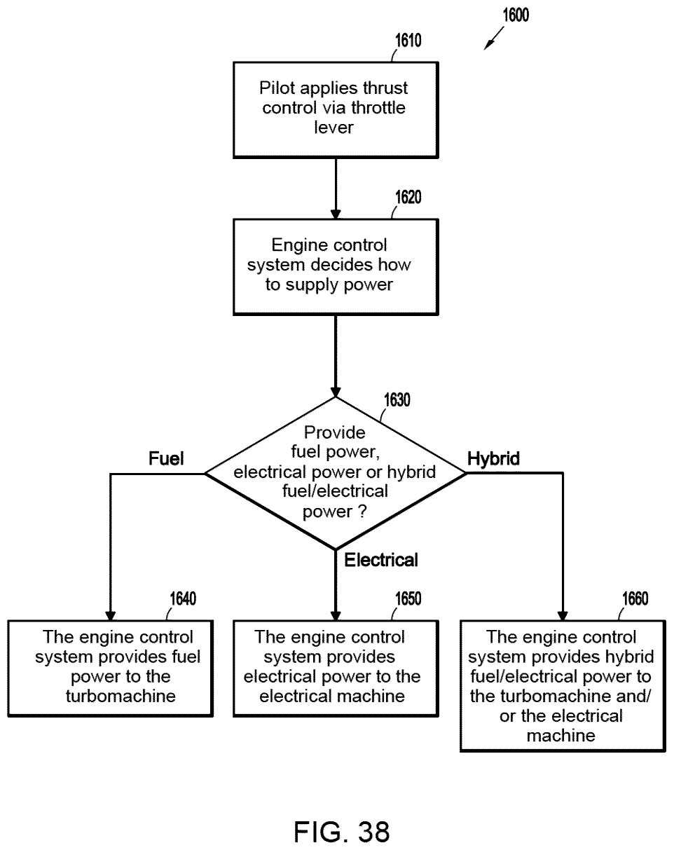

FIG. 38 is a flow diagram of an example method 1600 of autothrottle control for hybrid electric aircraft system, in accordance with an exemplary aspect.

At block 1610, a pilot applies thrust control via a throttle lever. As described above, in various aspects of the present disclosure, the aircraft can include either a single throttle lever 1310 or a multi-throttle lever configuration.

In a single-lever arrangement, the throttle lever 1310 is used by the pilot to command both engine power output and propulsor pitch. For example, the autothrottle controller 1330 interprets the position of the throttle lever 1310 to determine the appropriate combination of fuel flow through the fuel control system 1350, electrical output from the electric machine 1340, and propulsor pitch angle adjustments for the propulsor 1346.

In a multi-throttle configuration, the aircraft can include separate levers that are each configured to independently control different aspects of the propulsion system. For example, multi-throttle lever configurations can include a throttle lever 1310 for regulating engine power, a propulsor lever 1315 for adjusting propulsor pitch angle, a mixture control lever for setting the air-fuel ratio, a condition lever for managing propulsor governor settings, and/or a dedicated electric assist lever for modulating power output from the electric machine 1340 based on thrust demand or energy management objectives.

The throttle lever 1310 can control the output of the turbomachine 1345, while the propulsor lever 1315 can directly control propulsor pitch angle. For example, during takeoff, the pilot can advance the throttle lever 1310 to increase engine power and independently adjust the propulsor lever 1315 to reduce propulsor pitch angle, which increases RPM for improved acceleration. During cruise, the pilot can reduce engine power via the throttle lever 1310 and increase propulsor pitch angle using the propulsor lever 1315 to improve efficiency.

Additional levers can be used to influence the power split between the turbomachine 1345 and the electric machine 1340, or to manage energy usage from the electrical power source/storage system 1360. For example, the aircraft can include an electric boost lever that allows the pilot to request supplemental torque from the electric machine 1340 during high-demand phases of flight, or a regenerative braking lever that enables selective charging of the power source/storage system 1360 during descent or over-speed conditions.

The autothrottle controller 1330 can receive inputs from one or more of these levers and, in coordination with data from the aircraft computer 1335 and the engine control system 1320, generate commands that allocate thrust across available power sources. Multi-throttle configurations can provide a benefit of increased control authority for the pilot or support compatibility with conventional cockpit layouts, while single-lever configurations can provide a benefit of simplified interface that reduces pilot workload and enables automated optimization of propulsion resources.

At block 1620, the engine control system 1320 decides how to supply propulsion power (e.g., via the turbomachine 1345 and/or the electric machine 1340) based on commands from the autothrottle controller 1330. In various aspects of the present disclosure, the autothrottle controller (e.g., autothrottle controller 1330 above) determines how to supply power based on the multiple data inputs. In various aspects of the present disclosure, data input can include input from the throttle lever 1310 as well as real-time operating data relating to, for example, speed, altitude, conditions, etc., and/or due to deterioration of the propulsion system 1305 (e.g., the turbomachine 1345, propulsor 1346, and/or electric machine 1340) over time, as described above. Data can be provided to the autothrottle controller 1330 from an aircraft computer (e.g., aircraft computer 1335 of FIG. 35). The autothrottle controller 1330 processes the inputs to evaluate current operating conditions and generate thrust commands used to determine the power mode at block 1630.

For instance, the autothrottle controller 1330 processes the inputs by executing one or more control algorithms that correlate current input values to system state classifications and performance maps. For example, inputs such as throttle lever position, airspeed, altitude, battery state-of-charge, and turbine N1 speed are provided to an internal thrust requirement model that estimates required propulsive output. In various aspects of the present disclosure, the internal thrust requirement model is a computational model implemented within the autothrottle controller 1330 that estimates the amount of thrust required to maintain or achieve a commanded airspeed, climb rate, or other flight condition based on current and predicted operating parameters. The model receives as inputs one or more of throttle lever position, aircraft weight, airspeed, altitude, rate of climb or descent, battery state-of-charge, ambient conditions (e.g., temperature and pressure), and propulsion system performance metrics such as N1 speed, torque output, and exhaust gas temperature (EGT). The model can include a combination of lookup tables, physics-based equations, and predictive algorithms that account for aerodynamic drag, propulsor efficiency, and changes in aircraft performance across different flight phases. The output of the model is a target thrust value, which is then used by the autothrottle controller 1330 to allocate power across the turbomachine 1345 and electric machine 1340 in accordance with energy optimization objectives and operational constraints.

Simultaneously, subsystem efficiency models evaluate the energy cost of generating that thrust using the turbomachine 1345 versus the electric machine 1340, under current environmental and system conditions. Based on these calculations, the controller classifies the current operating condition (e.g., cruise, climb, descent) and determines an optimal power mode (electric-only, fuel-only, or hybrid) to satisfy the thrust demand while minimizing energy consumption or satisfying mission-specific constraints (e.g., reduced emissions or thermal load). Accordingly, based upon the inputs and operating parameters evaluated at block 1620, at block 1630, the autothrottle controller 1330 determines whether to provide propulsion using fuel power, electrical power, or a hybrid fuel/electrical power. The autothrottle controller 1330 can consider factors such as throttle lever position, altitude, air speed, engine temperature, battery state-of-charge, and overall power demand. An internal control algorithm can compare these parameters to system constraints, energy availability, and efficiency targets. For example, if electrical energy is sufficient and the aircraft is in cruise, the autothrottle controller 1330 can prioritize electric propulsion. In a high-power climb or when battery reserves are low, the autothrottle controller 1330 can rely on fuel-based or hybrid propulsion. In various aspects of the present disclosure, considerations can include engine wear, thermal limits, and flight phase.

Based on the determinations at block 1620, if at block 1630 the autothrottle controller 1330 selects fuel-based propulsion, at block 1640, the engine control system 1320 commands the fuel control system 1350 to supply fuel power to the turbomachine 1345. The turbomachine 1345 can generate mechanical power to drive the propulsor 1346 directly. For example, during a takeoff phase or initial climb, when maximum sustained thrust is needed and the electrical energy reserves are being conserved, the autothrottle controller 1330 can prioritize fuel power to ensure continuous and high-output operation from the turbomachine 1345.

Based on the determinations at block 1620, if at block 1630 the autothrottle controller 1330 selects electrical propulsion, at block 1650, the engine control system 1320 coordinates with the electrical power source/storage system 1360 to deliver electrical power to the electric machine 1340. In various aspects of the present disclosure, the electric machine 1340 can drive the propulsor 1346 without input from the turbomachine 1345. For example, during a descent or low-power phase when thrust demands are minimal and/or fuel economy or emission reduction is prioritized, the autothrottle controller 1330 can disable fuel delivery and rely solely on the electric machine 1340 to provide propulsor torque.

Based on the determinations at block 1620, if at block 1630 the autothrottle controller 1330 selects to provide hybrid power, at block 1660, the engine control system 1320 provides hybrid fuel/electrical power from both the turbomachine 1345 and the electric machine 1340. The turbomachine 1345 can be controlled via the fuel control system 1350 while the electric machine 1340 receives electrical energy from the electrical power source/storage system 1360. For example, during a climb at high altitude when maximum thrust and system redundancy are targeted, the autothrottle controller 1330 can engage both the turbomachine 1345 and the electric machine 1340 to deliver combined torque to the propulsor 1346. If a failure is detected, the autothrottle controller 1330 can select a hybrid or degraded power mode and adjust the propulsor pitch angle in conjunction with power reallocation to preserve flight performance or manage asymmetric thrust effects.

As used herein, a “power mode” refers to an operational configuration of the propulsion system that determines which energy sources are used to generate thrust. The autothrottle controller 1330 selects a power mode based on throttle inputs, real-time operating data, system health, and mission objectives.

In various aspects, the autothrottle system supports multiple power modes, including fuel-only power mode, electric-only mode, hybrid power mode, and/or degraded power mode. In fuel-only power mode, thrust is provided solely by the turbomachine 1345. This mode can be preferred during high-demand phases such as takeoff or when battery reserves are insufficient. In electric-only power mode, thrust is provided solely by the electric machine 1340. This mode can be selected during cruise to conserve fuel or reduce acoustic and emission signatures, provided sufficient battery charge is available. In hybrid power mode, both the turbomachine 1345 and electric machine 1340 contribute torque to the propulsor 1346. This allows blending power sources to meet thrust demands while balancing fuel consumption, thermal limits, and battery charge. The degraded power mode refers to fallback operation when one power source is partially or fully unavailable. For example, in the event of a turbomachine 1345 failure, the controller 1330 can enter a degraded electric-only power mode to maintain reduced thrust. Similarly, in the event of battery depletion or electric machine 1340 thermal limits, the controller 1330 can reduce or eliminate electric contribution and rely on fuel-only operation.

The selected power mode directly affects how the controller 1330 allocates fuel flow, electrical output, and propulsor pitch settings. In hybrid mode, the controller 1330 dynamically distributes torque based on propulsion efficiency models and current flight conditions. In degraded mode, thrust delivery is prioritized for flight safety and controllability, even if energy efficiency is reduced.

Transitions between power modes can occur during flight in response to changing conditions. The autothrottle controller 1330 continuously evaluates propulsion system parameters (e.g., torque, N1 speed, EGT), energy availability (e.g., battery state-of-charge), and environmental factors (e.g., altitude, temperature) to determine the appropriate power mode for each phase of flight. This adaptive control strategy enables robust, energy-aware, and fault-tolerant operation in hybrid electric turboprop aircraft.

Although various blocks of the method 1600 are shown in an order, it should be noted that not all blocks are implemented in any order and can be applied in any sequence to the blocks of method 1600.

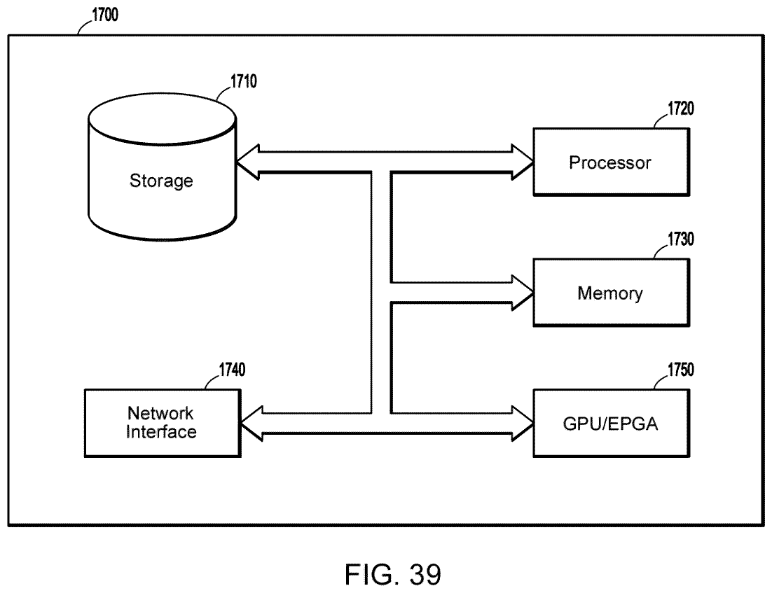

FIG. 39 is a block diagram of a computing device 1700 of the system of FIG. 35, in accordance with one aspect. In various aspects of the present disclosure, computing device 1700 is implemented in the engine control system 1320 and/or the autothrottle controller 1330 of FIG. 35. Referring now to FIG. 39, exemplary components in the computing device 1700 in accordance with aspects of the present disclosure include, for example, a database 1710, one or more processors 1720, at least one memory 1730, and a network interface 1740. In aspects, the computing device 1700 can include a graphical processing unit (GPU) 1750, which can be used for processing machine learning network models. Various components of computing device 1700 are utilized to carry out instructions to perform the operations described in blocks 1610-1660 of FIG. 38.

Database 1710 can be located in storage. The term “storage” can refer to any device or material from which information is capable of being accessed, reproduced, and/or held in an electromagnetic or optical form for access by a computer processor. Storage can be, for example, volatile memory such as RAM, non-volatile memory, which permanently holds digital data until purposely erased, such as flash memory, magnetic devices such as hard disk drives, and optical media such as a CD, DVD, Blu-ray Disc™, or the like.

In some aspects of the present disclosure, data can be stored on computing device 1700, including, for example, user preferences, historical data, and/or other data. The data can be stored in database 1710 and sent via the system bus to processor 1720.

As described above, processor 1720 can execute various processes based on instructions that can be stored in the server memory 1730 and utilizing the data from database 1710. The illustration of FIG. 39 is exemplary, and persons skilled in the art will be understood by other components that can exist in the computing device 1700. Such other components are not illustrated in FIG. 39 for clarity of illustration.

In various aspects of the present disclosure, hydrocarbon fuel usage can be reduced based on flight plan and electrical energy available, where the turbomachine 1345 is a turboprop engine or a turbofan engine.

In some aspects of the present disclosure, various energy sources can include a combustion fuel for turbomachine 1345, fuel for a fuel cell to produce electricity for electric machine 1340, and/or batteries.

In certain aspects, the autothrottle system can also include a propulsor or fan pitch setting, and an efficiency model of each thrust producer.

In various aspects of the present disclosure, each efficiency model is a multivariate table and inputs to each efficiency model can include throttle position, ambient pressure/altitude, air speed of the aircraft, and can output a thrust-to-energy ratio for the given device or other similar output.

In some aspects of the present disclosure, the autothrottle system and efficiency models can include minimum settings for the turbomachine 1345 or electric machines of electric machine 1340 to provide the required airflow and pressure to a cabin environment system, minimum settings for the turbomachine 1345 or electric machines of electric machine 1340 to provide the required hydraulic system power for the aircraft, and/or minimum/maximum settings for the turbomachine 1345 or electric machines of electric machine 1340 to provide the required electrical power to the aircraft, taking into account all loads on the available electrical power sources.

The disclosed system provides enhanced control, energy optimization, and resilience for hybrid electric turboprop aircraft. It enables dynamic allocation of power sources, integrates seamlessly with modern cockpit controls, and supports safe operation under a variety of mission conditions and fault scenarios.

Accordingly, the present disclosure provides an autothrottle control system for hybrid electric turboprop aircraft that dynamically allocates fuel-based and electric propulsion resources based on throttle input, propulsion system data, and aircraft operating conditions. The system uses targeted power allocations derived from real-time analyses to improve energy efficiency, maintain thrust, and support safe operation across varying mission profiles. Conventional autothrottle systems do not support real-time thrust coordination across hybrid propulsion sources. These systems are typically limited to controlling a single fuel-based engine and do not consider the dynamic interplay between electric power availability, battery state-of-charge, engine thermal constraints, and energy optimization objectives. The present system addresses these deficiencies by providing a unified autothrottle controller capable of evaluating operational conditions, determining a propulsion power mode, and allocating fuel-based and electric power in a way that optimizes performance, reduces energy consumption, and maintains safe aircraft operation, even under failure or degraded conditions.

The disclosed system provides enhanced control, energy optimization, and resilience for hybrid electric turboprop aircraft. It enables dynamic allocation of power sources, integrates seamlessly with modern cockpit controls, and supports safe operation under a variety of mission conditions and fault scenarios.

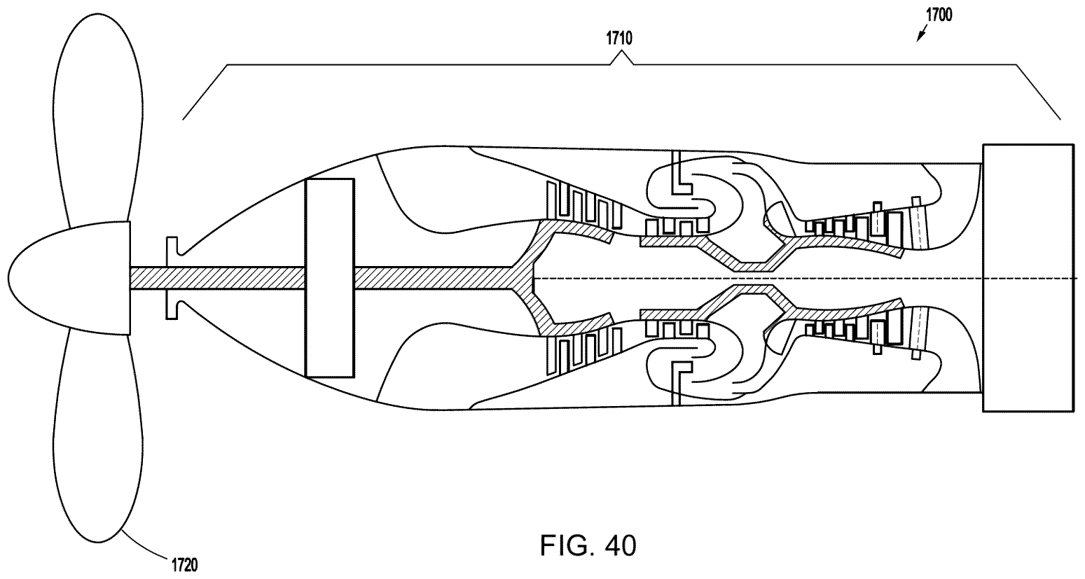

With reference to FIG. 40, there is illustrated a gas turbine engine 1800 for a propeller-driven aircraft, generally comprising a turbomachine 1810 and a propeller 1820.

Briefly, turbomachine 1810 is similar to turbomachine 616 detailed above with respect to FIG. 33 such that gas turbine engine or turbomachine 1810 likewise define a maximum exhaust gas temperature (EGT) in degrees Celsius, a maximum drive turbine shaft torque (TOUT) in Newton meters, a high pressure compressor exit area (AHPCExit) in square inches and a drive turbine exit area (ADTExit) in square inches, and a corrected specific power (CSP) in Newtons squared times degrees Celsius over meters squared.

The corrected specific power of the gas turbine engine Y is determined as follows:

$${( \frac{{T}_{OUT}}{\sqrt{{A}_{DTExit}}} )}^{2} * \frac{EGT}{{A}_{HPCExit}} * {10}^{- 11} ;$$

wherein CSP is greater than 0.0001194×EGT2−0.103×EGT+22.14 and less than 0.0003294×EGT2−0.3061×EGT+77.91; wherein EGT is greater than 525 degrees Celsius and less than 1250 degrees Celsius; wherein a maximum EGT is greater than 600 degrees Celsius and less than 1000 degrees Celsius, and/or wherein CSP is greater than 3.3 and less than 101.

With continued reference to FIG. 40, the propeller 1820 of gas turbine engine 1800 converts rotary motion from a shaft of the turbomachine 1810 to provide propulsive force, i.e. thrust, for the aircraft. The thrust generated by the gas turbine engine 1800 can be broken down into two contributors: the propeller thrust (FNP) and the engine jet thrust (FENJ). For a turboprop engine, about 95% to 97% of the total thrust is attributable to FNP while 5% to 3% of the total thrust is attributable to FENJ. The propeller thrust is a function of many factors, such as ambient temperature, ambient pressure/altitude, airspeed, propeller rotational speed, and power input to the propeller by the engine, and the airfoil design of the propeller blades.

The gas turbine engine 1800 of FIG. 40 is a turboprop engine, but it could also be any other type of engine comprising a propeller 1820, such as a piston engine, a turboshaft engine, and the like.

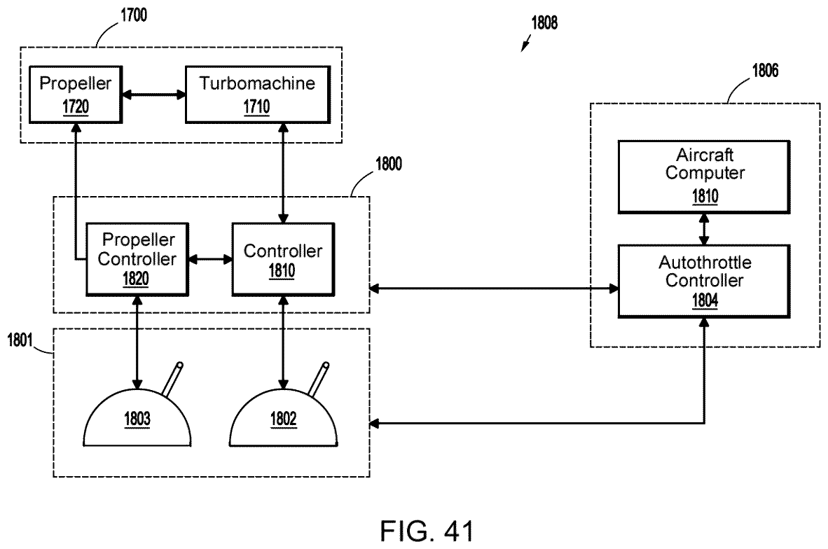

In regular operation, the turbomachine 1810 and the propeller 1820 are regulated by a pilot or other operator by way of various control inputs. With reference to FIG. 41, there is illustrated an example aircraft control system 1908 comprising a powerplant control system (PCS) 1900. The PCS 1900 is configured for controlling operation of the gas turbine engine 1800, comprising turbomachine 1810 and propeller 1820. An engine controller 1910 regulates fuel flow to the turbomachine 1810 in order to generate a desired engine output power. A propeller controller 1920 sets blade pitch angle and/or propeller rotational speed of the propeller 1820, so as to convert the engine output power from the turbomachine 1810 into thrust.

A power throttle 1901 is controlled by the pilot or other operator in order to provide engine and propeller settings to the gas turbine engine 1800 via the PCS 1900. In some embodiments, the power throttle comprises a throttle lever 1902 to regulate the output power of the turbomachine 1810 and a condition lever 1903 to regulate the thrust produced by the propeller 1820. In other embodiments, the power throttle comprises a single lever 1902 to control both the turbomachine 1810 and the propeller 1820.

An autothrottle controller 1904 is operatively connected to the PCS 1900 and the power throttle 1901. The autothrottle controller 1904 modulates engine power without pilot input. It can be used, for example, when the aircraft is set to autopilot, but can also be used outside of the autopilot mode. In some embodiments, the autothrottle controller 1904 is integrated into aircraft avionics 1906, for example as part of an aircraft computer. Alternatively, the autothrottle controller communicates with the aircraft avionics 1906 but is provided externally thereto, such as in the PCS 1900 or as another separate component of the aircraft control 1908.

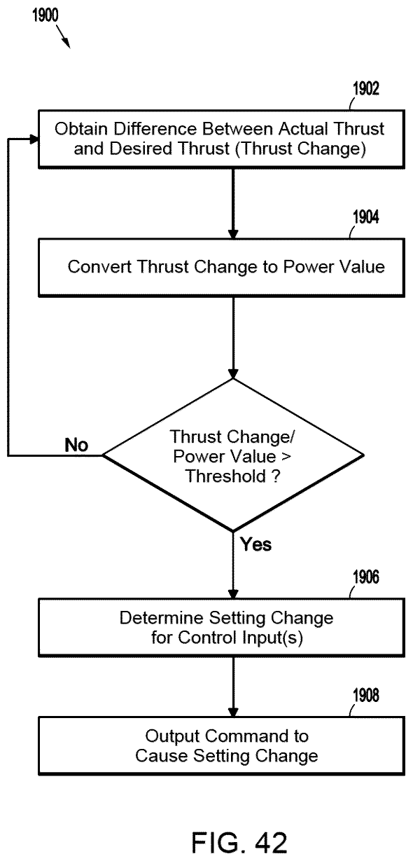

Referring to FIG. 42, there is illustrated a flowchart of an example method 2000 for autothrottle as performed by the autothrottle controller 1904. At 2002, a required thrust change is obtained. The thrust change corresponds to a difference between an actual thrust generated by the gas turbine engine 1800 and a desired thrust in accordance with the inputs provided to the gas turbine engine 1800. For example, in a single lever configuration, the current position of the power throttle 1901, also referred to as the power lever angle (PLA), will dictate a requested engine power and a corresponding reference propeller governing speed, which can be used to determine the desired thrust. Similarly, the actual thrust can be determined using a measured engine output power and a measured propeller speed. It should be understood that all thrust determinations are estimated thrust as thrust has no measurement system per se on an aircraft.

In some embodiments, the autothrottle controller 1904 receives the thrust change as already determined, for example from an aircraft computer 1910. Alternatively, the autothrottle controller 1904 calculates the thrust change based on various parameters as received from the aircraft computer 1910, the PCS 1900, the power throttle 1901, and/or various sensors on the aircraft and/or gas turbine engine 1800. For example, the actual thrust is determined from the measured engine output power and the measured propeller speed as received from sensors provided on the turbomachine 1810 and/or propeller 1820. The desired thrust is determined from the requested engine power and the corresponding reference propeller governing speed, as determined from the PLA. In yet another embodiment, the autothrottle controller 1904 receives the actual thrust and the desired thrust and determines the difference in order to obtain the thrust change.

In some embodiments, the autothrottle controller 1904 receives as input one or more aircraft operating condition, such as aircraft speed, ambient temperature, ambient temperature, altitude, and the like. The operating conditions can also be used to calculate an estimated thrust, for example using the following equation:

Thrust=(power/airspeed)ηₚᵣₒₚ

Where ηₚᵣₒₚ is the propeller efficiency, which is determined by the propeller supplier and can vary as a function of flight phase and speed of the aircraft. Other factors that can affect propeller efficiency are aircraft angle of attack, propeller speed, power, altitude, and ambient temperature. Other factors can also apply. For example, ηₚᵣₒₚ can be in the order of 60% at takeoff power and typical V1 speed of the aircraft, in the range of 80% to 83% in climb rotational speed and power, and 85% to 87% in cruise rotational speed and power. Other values can also apply, as propeller efficiency is specific to propeller blade design and the design points that the propeller blade has been optimized for.

Referring back to method 2000, optionally at 2004, the thrust change is converted to a power value. In other words, a conversion is made to determine what difference in input power is needed to cause the thrust change. Indeed, while the output of the engine can be measured via the propulsion force, what is input to the engine is measured in terms of power. The power generated by the turbomachine 1810 is then converted into thrust by the propeller 1820. Therefore in order to speak to the turbomachine 1810, the autothrottle controller 1904 communicates in terms of power. Note that method 2000 can be performed without step 2004. The conversion from thrust to power allows for an easier determination of a setting change at step 2006, due to the mapping of engine power and throttle position.

At 2006, a setting change is determined for at least one control input of the gas turbine engine 1800 when the thrust change or power value is greater than a threshold. The setting change corresponds to a change in one or more powerplant input control so as to cause a change in engine power proportional to the thrust change or power value. The setting change can cause an increase or a decrease to a currently requested engine power.

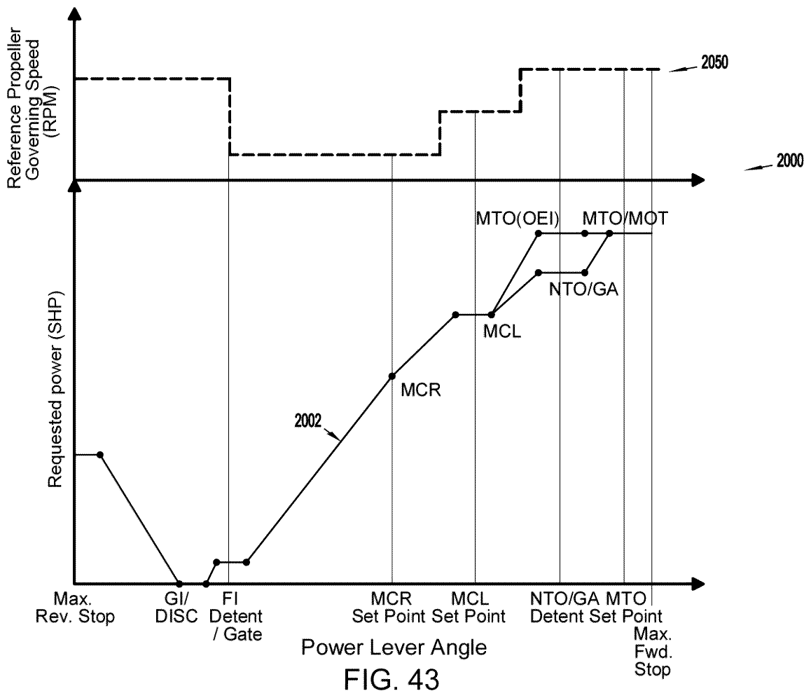

In some embodiments, the input control is for the power throttle 1901 associated with the PCS 1900. For example, the input control can be the position of the power throttle, i.e. the PLA. FIG. 43 illustrates an example lookup 2100 for mapping requested engine power to PLA. A curve 2102 shows a relationship between the PLA (horizontal axis) and the requested power (vertical axis). Another curve 2150 shows the relationship between the lever angle (horizontal axis) and the reference propeller governing speed (vertical axis). The curve 2102 is aligned with the curve 2150, which share a common horizontal axis, and points on the curve 2102 can be mapped with points on the curve 2150.

As defined above, the power value as converted from the thrust change corresponds to a change in requested power to be applied to the engine. For a given power value, a new requested power is found by adding the power value to the current requested power. For example, if the power value is +50 hp and the current requested engine power is 650 hp, then the new requested power used in the 2100 to determine PLA is 700 hp. If the power value is −35 hp and the current requested engine power is 650 hp, then the new requested power used in the 2100 to determine PLA is 615 hp. The corresponding PLA is found on the horizontal axis using the curve 2102.

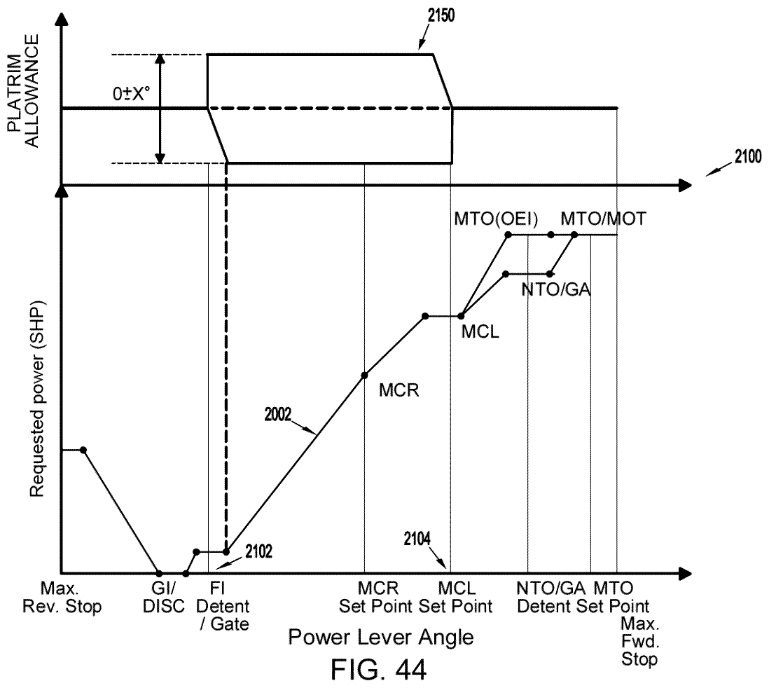

In some embodiments, the input control corresponds to a PLA trim, which is a fine adjustment of the PLA sent to the controller PCS 1900 that does not require a physical change in the position of the throttle 1902. PLA trim is used for small adjustments in commanded power in order to achieve the requested engine power. FIG. 44 illustrates an example lookup table 2200 for mapping PLA trim to PLA. In this example, the autothrottle controller 1904 can adjust PLA trim only when the PLA is between two defined settings, identified as 2202 and 2204 on the horizontal axis, for example Flight Idle (FI) and maximum climb (MCL). These settings can be customizable. In some embodiments, PLA trim can be enabled/disabled by a pilot or other operator through a cockpit command. PLA trim can also be disabled in circumstances where fault accommodation is activated for loss of inputs.

In some embodiments, the input control corresponds to both PLA and PLA trim. In other embodiments, the input control corresponds to engine fuel flow and/or propeller pitch angle. Any control input that affects the amount of power generated by the turbomachine 1810 and converted into thrust by the propeller 1820 can be varied in accordance with the power value. If the power value is lower than the threshold, the method 2000 returns to 2002 where a new thrust change is determined.

Once the setting change is determined, at least one command is output by the autothrottle controller 1904 to cause the setting change, as per 2008. The command can be one or more of a PLA command, a PLA trim command, a fuel flow valve command, a propeller speed command, a propeller blade pitch angle command, and the like.

The autothrottle controller 1904 can be configured to output a PLA command directly to a throttle quadrant controller (TQC) comprising a servo-motor and a rotary variable differential transformer (RVDT), which in turn controls the power throttle 1901. The servo-motor physically moves the power throttle 1901 to a given position in accordance with the control command. The RVDT sends electrical signals of the throttle position to the engine controller 1910.

A PLA trim command can be sent to the PCS 1900, for example to the engine controller 1910. The use of the PLA trim added to the physical PLA position modulated with servo-motors is to minimize the throttle movement to accommodate for the uncertainties and variability related to the propeller efficiency ηprop determination. In some embodiments, the autothrottle controller 1904 only interfaces with the engine controller 1910 and no direct communication is needed with the propeller controller 1920. In some embodiments, the PLA trim is added to the electrical signals sent by RVDT containing the PLA position. The resulting signal is used to determine a power request command to the engine controller 1910. The PLA setting will also set the propellers to govern at a corresponding reference rotational speed.

In some embodiments, the autothrottle controller 1904 is activated by the pilot upon confirmation that the system is capable of operating in an autothrottle mode. System capability can be dictated by various conditions. For example, the local throttle position is within specified boundaries, such as flight idle and maximum climb. Local and remote throttles are within a specified tolerance of each other, and the take-off phase of the aircraft is complete and the aircraft is safely in the air. In some embodiments, certain functionalities are also tested before the system is deemed capable of operating in autothrottle mode, such as the data input interface with the aircraft, the channels of the engine controller 1910 (in a multi-channel controller), and the throttle position signal to the engine controller 1910.

The pilot can set aircraft operating targets for autothrottle. These commands are sent from the pilot interface to the autothrottle controller 1904. In some embodiments, this is done through the aircraft avionics. Alternatively, the autothrottle controller 1904 can be connected directly to the pilot interface. Once operating targets are set, the pilot can enable autothrottle through an autothrottle request signal sent from the pilot interface to the autothrottle controller 1904.

Additional indications provided by the engine controller 1910 can be used to dictate whether the autothrottle controller 1904 is limited by either an engine limitation or a trim limitation. An engine limitation prevents an increase and/or decrease of requested engine power due to a high/low end engine limit being attained. A trim limitation prevents an increase and/or decrease of requested engine power due to a high/low end trim limit being attained.

In some embodiments, the PLA trim value is set to a default value of 0° when autothrottle is not enabled or when the system is not capable of operating in an autothrottle mode.

In some embodiments, the PLA trim value is frozen, i.e. held constant to a last value, during propeller reference speed setting changes when the autothrottle is engaged, or if the PLA signal is moving at a rate greater than a predetermined amount.

In some embodiments, the PLA trim value is rate limited to a rate deemed necessary to maintain a smooth aircraft operation when transitioning to/from an engaged to a disengaged autothrottle mode, or when unfrozen following propeller speed reference changes or following the PLA signal moving at rate greater than a predetermined amount.

In some embodiments, the engine controller 1910 is implemented as a single-channel or dual-channel full-authority digital engine controls (FADEC), an electronic engine controller (EEC), an engine control unit (ECU), or any other suitable engine controller. In some embodiments, the propeller controller 1920 is implemented as a propeller electronic control (PEC) unit.

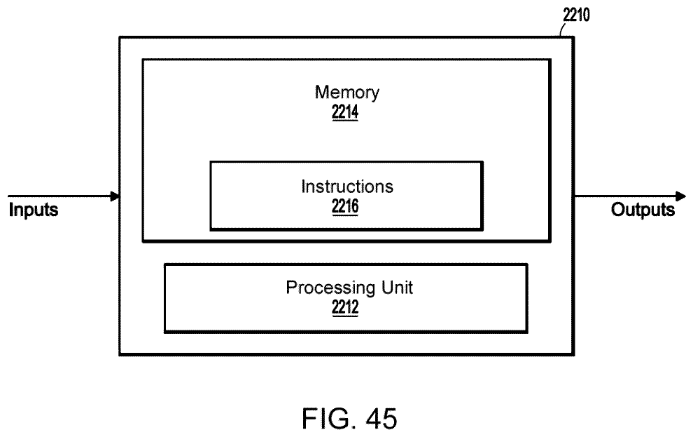

FIG. 45 illustrates an example embodiment to implement the autothrottle controller 1904, so as to perform the method 2000. A computing device 2310 comprises a processing unit 2312 and a memory 2314 which has stored therein computer-executable instructions 2316. The processing unit 2312 can comprise any suitable devices configured to implement the autothrottle controller 1904 such that instructions 2316, when executed by the computing device 2310 or other programmable apparatus, can cause the functions/acts/steps attributed to the autothrottle controller 1904 as described herein to be executed. The processing unit 2312 can comprise, for example, any type of general-purpose microprocessor or microcontroller, a digital signal processing (DSP) processor, a central processing unit (CPU), an integrated circuit, a field programmable gate array (FPGA), a reconfigurable processor, other suitably programmed or programmable logic circuits, or any combination thereof.

The memory 2314 can comprise any suitable known or other machine-readable storage medium. The memory 2314 can comprise non-transitory computer readable storage medium, for example, but not limited to, an electronic, magnetic, optical, electromagnetic, infrared, or semiconductor system, apparatus, or device, or any suitable combination of the foregoing. The memory 2314 can include a suitable combination of any type of computer memory that is located either internally or externally to device, for example random-access memory (RAM), read-only memory (ROM), compact disc read-only memory (CDROM), electro-optical memory, magneto-optical memory, erasable programmable read-only memory (EPROM), and electrically-erasable programmable read-only memory (EEPROM), Ferroelectric RAM (FRAM) or the like. Memory 2314 can comprise any storage means (e.g., devices) suitable for retrievably storing machine-readable instructions 2316 executable by processing unit 2312. The methods and systems for autothrottle in a propeller-driven aircraft described herein can be implemented in a high level procedural or object oriented programming or scripting language, or a combination thereof, to communicate with or assist in the operation of a computer system, for example the computing device 2310. Alternatively, the methods and systems for autothrottle in a propeller-driven aircraft can be implemented in assembly or machine language. The language can be a compiled or interpreted language. Program code for implementing the methods and systems for controlling operation of aircraft engines can be stored on a storage media or a device, for example a ROM, a magnetic disk, an optical disc, a flash drive, or any other suitable storage media or device. The program code can be readable by a general or special-purpose programmable computer for configuring and operating the computer when the storage media or device is read by the computer to perform the procedures described herein. Embodiments of the methods and systems for autothrottle in a propeller-driven aircraft can also be considered to be implemented by way of a non-transitory computer-readable storage medium having a computer program stored thereon. The computer program can comprise computer-readable instructions which cause a computer, or more specifically the processing unit 2312 of the computing device 2310, to operate in a specific and predefined manner to perform the functions described herein.

### Autoland

Electronic devices, such as integrated avionics systems, are typically utilized by one or more members of a flight crew (e.g., the pilot and/or the co-pilot) to navigate an aircraft. Integrated avionics systems can employ primary flight display(s) (PFDs) and multifunction display(s) (MI-Ds) to furnish primary flight control, navigational, and other information to the flight crew of the aircraft. Additionally, the integrated avionics systems can also employ an avionics control and display unit (CDU) that is configured to provide control functionality to the PFD and/or the MED and to convey navigation information representing an area the aircraft is traversing. While integrated avionics systems can provide the functionality flight crew and/or autopilot navigation of the aircraft, these systems lack the ability to land the aircraft without pilot and/or co-pilot intervention (e.g., in an emergency situation).

Accordingly, autoland systems and processes for landing an aircraft without pilot intervention are described. In aspects, the autoland system includes a memory operable to store one or more modules and at least one processor coupled to the memory. The processor is operable to execute the one or more modules to identify a plurality of potential destinations for an aircraft. The processor can also calculate a suitability score for each potential destination identified; select a destination based upon the suitability score; receive terrain data and/or obstacle data, the including terrain characteristic(s) and/or obstacle characteristic(s); and create a route from a current position of the aircraft to an approach fix associated with the destination, the route accounting for the terrain characteristic(s) and/or obstacle characteristic(s). The processor can also cause the aircraft to traverse the route, and cause the aircraft to land at the destination without requiring pilot intervention.

In another aspect, the autoland system includes a memory operable to store one or more modules, and at least one processor coupled to the memory and operably coupled to at least one of an engine of the aircraft, a braking system of the aircraft, or a control column of the aircraft. The processor is operable to execute the one or more modules to cause the processor to identify potential destinations for an aircraft. The processor can also calculate a suitability score for each destination identified, select a destination based upon the suitability score; receive terrain data and/or obstacle data, the including terrain characteristic(s) and/or obstacle characteristic(s); and create a route from a current position of the aircraft to an approach fix associated with the destination, the route accounting for the terrain characteristic(s) and/or obstacle characteristic(s). The processor can also cause the aircraft to traverse the route by actuating at least one of the engine or the control column in accordance with the route, and cause the aircraft to land on a at the destination without requiring pilot intervention.

In one or more aspects, a process for autolanding an aircraft includes identifying potential destinations for an aircraft. The process also includes calculating a suitability score for each destination identified; selecting a destination based upon the suitability score; receive terrain data and/or obstacle data, the including terrain characteristic(s) and/or obstacle characteristic(s); and create a route from a current position of the aircraft to an approach fix associated with the destination, the route accounting for the terrain characteristic(s) and/or obstacle characteristic(s). The process also includes causing the aircraft to traverse the route, and causing the aircraft to land at the destination without requiring pilot intervention.

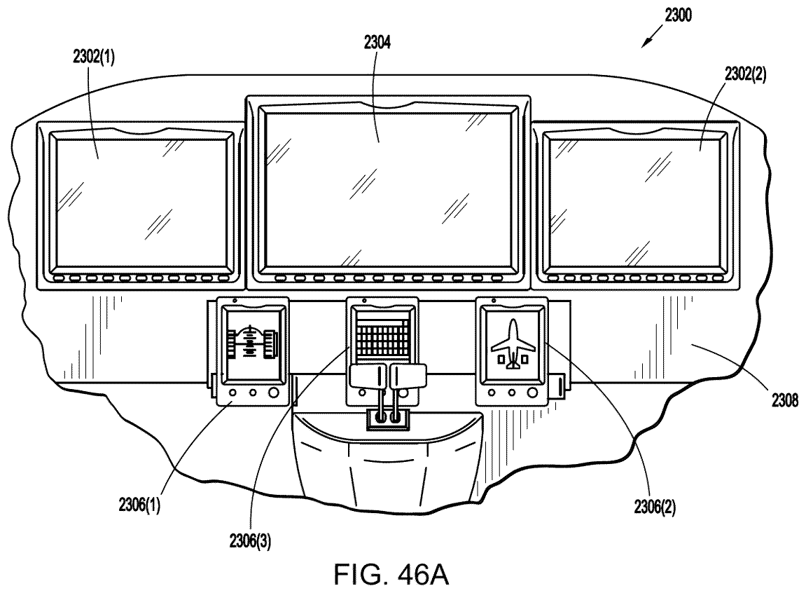

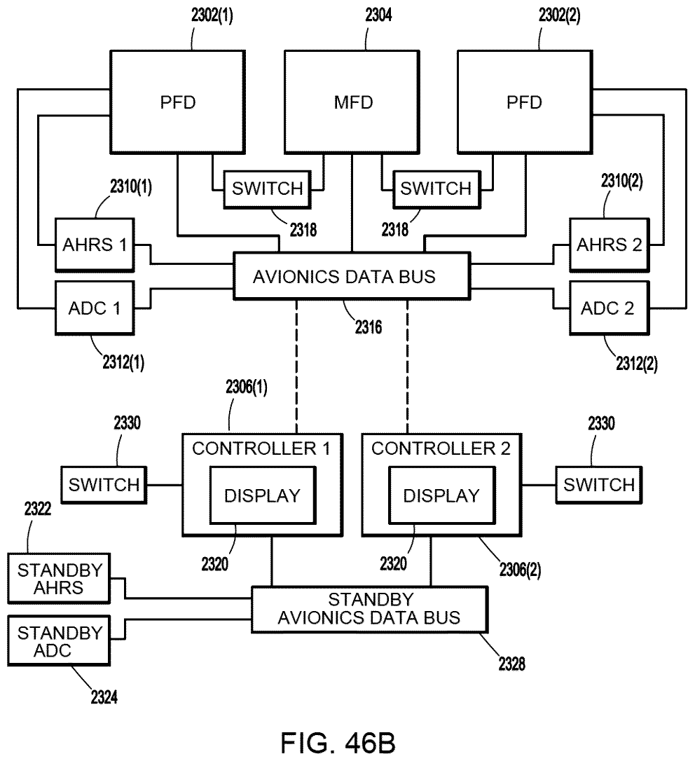

FIGS. 46A and 46B illustrate an example aspect of an integrated avionics system 2400 within an aircraft having a gas turbine engine including a turbomachine similar to turbomachine 616 detailed above with respect to FIG. 33 such that such gas turbine engine likewise defines a maximum exhaust gas temperature (EGT) in degrees Celsius, a maximum drive turbine shaft torque (TOUT) in Newton meters, a high pressure compressor exit area (AHPCExit) in square inches and a drive turbine exit area (ADTExit) in square inches, and a corrected specific power (CSP) in Newtons squared times degrees Celsius over meters squared.

The corrected specific power of the gas turbine engine Y is determined as follows:

$${( \frac{{T}_{OUT}}{\sqrt{{A}_{DTExit}}} )}^{2} * \frac{EGT}{{A}_{HPCExit}} * {10}^{- 11} ;$$

wherein CSP is greater than 0.0001194×EGT2−0.103×EGT+22.14 and less than 0.0003294×EGT2−0.3061×EGT+77.91; wherein EGT is greater than 525 degrees Celsius and less than 1250 degrees Celsius; wherein a maximum EGT is greater than 600 degrees Celsius and less than 1000 degrees Celsius, and/or wherein CSP is greater than 3.3 and less than 101.

The integrated avionics system 2400 can include one or more primary flight displays (PI-Ds) 2402, one or more multifunction displays (MFD) 2404, and one or more multi-product avionics control and display units (CDU) 2406. For instance, in the aspect illustrated in FIG. 46A, the integrated avionics system 2400 can be configured for use in an aircraft that is flown by two pilots (e.g., a pilot and a copilot). In this aspect, the integrated avionics system 2400 can include a first PFD 2402(1), a second PFD 2402(2), an MFD 2404, a first CDU 2406(1), a second CDU 2406(2), and a third CDU 2406(3) that are mounted in the aircraft's instrument panel 2408. As shown, the MFD 2404 is mounted generally in the center of the instrument panel 2408 so that it can be accessed by either pilot (e.g., by either the pilot or the copilot). The first PFD 2402(1) and the first CDU 2406(1) are mounted in the instrument panel 2408 generally to the left of the MFD 2404 for viewing and access by the pilot. Similarly, the second PFD 2402(2) and the second CDU 2406(2) are mounted in the instrument panel 2408 generally to the right of the MFD 2404 for viewing and access by the aircraft's copilot or other crew member or passenger. The third CDU 2406(3) can be mounted between the first and second CDUs 2406(1), 2406(2). In aspects, the CDUs 2406 can be positioned within the instrument panel 2408 so that they can be readily viewed and/or accessed by the pilot flying the aircraft (which could be either the pilot or copilot). The PFDs 2402 can be configured to display primary flight information, such as aircraft attitude, altitude, heading, vertical speed, and so forth. In aspects, the PFDs 2402 can display primary flight information via a graphical representation of basic flight instruments such as an attitude indicator, an airspeed indicator, an altimeter, a heading indicator, a course deviation indicator, and so forth. The PFDs 2402 can also display other information providing situational awareness to the pilot such as terrain information, ground proximity warning information, and so forth.

As shown in FIG. 46B, primary flight information can be generated by one or more flight sensor data sources including, for example, one or more attitude, heading, angular rate, and/or acceleration information sources such as attitude and heading reference systems (AHRS) 2410, one or more air data information sources such as air data computers (ADCs) 2412, and/or one or more angle of attack information sources. For instance, the AHRSs 2410 can be configured to provide information such as attitude, rate of turn, slip and skid; while the ADCs 2412 can be configured to provide information including airspeed, altitude, vertical speed, and outside air temperature. Other configurations are possible.

Integrated avionics units (IAUs) can aggregate the primary flight information from the AHRS 2410 and ADC 2412 and, in one example configuration, provide the information to the PFDs 2402 via an avionics data bus 2416. In other examples, the various IAUs can directly communicate with either other and other system components. The IAUs can also function as a combined communications and navigation radio. For example, the IAUs can include a two-way VHF communications transceiver, a VHF navigation receiver with glide slope, a global positioning system (GPS) receiver, and so forth. As shown, each integrated avionics unit can be paired with a primary flight display, which can function as a controlling unit for the integrated avionic unit. In aspects, the avionics data bus 2416 can comprise a high speed data bus (HSDB), such as data bus complying with ARINC 429 data bus standard promulgated by the Airlines Electronic Engineering Committee (AEEC), a MIL-STD-1553 compliant data bus, and so forth. A radar altimeter can be associated with one or more of the IAUs, such as via data bus 2416 or a direct connection, to provide precise elevation information (e.g., height above ground) for autoland functionality. For example, in some configurations, the system 2400 includes a radar altimeter to assist the autoland module 2514 in various functions of the landing sequence, such as timing and maintaining the level-off and/or flare.

The MFD 2404 displays information describing operation of the aircraft such as navigation routes, moving maps, engine gauges, weather radar, ground proximity warning system (GPWS) warnings, traffic collision avoidance system (TCAS) warnings, airport information, and so forth, that are received from a variety of aircraft systems via the avionics data bus 2416.

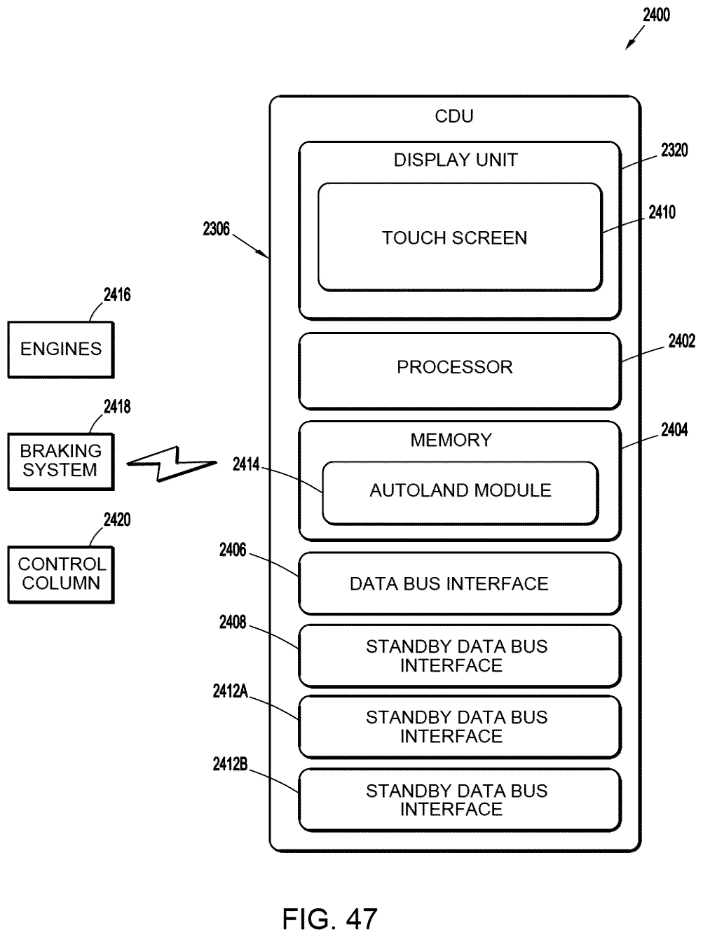

In aspects, the integrated avionics system 2400 employs redundant sources of primary flight information to assure the availability of the information to the pilot, and to allow for cross-checking of the sources of the information. For example, the integrated avionics system 2400 illustrated in FIGS. 46A through 47 employs two PFDs 2402 that receive primary flight information from redundant AHRSs 2410 and ADCs 2412 via redundant IAUs. The integrated avionics system 2400 is configured so that the first PFD 2402(1) receives a first set of primary flight information aggregated by a first IAU from a first AHRS 2410(1) and ADC 2412(1). Similarly, the second PFD 2402(2) receives a second set of primary flight information aggregated by a second IAU from a second AHRS 2410(2) and ADC 2412(2). Additionally, although a single avionics data bus 2416 is illustrated in FIG. 46B, it is contemplated that redundant data buses can be employed for communication between the various components of the integrated avionics system 2400.

In aspects, primary flight information provided by either the first AHRS 2410(1) and ADC 2412(1) or the second AHRS 2410(2) and ADC 2412(2) can be displayed on either PFD 2402(1) or 2402(2), or on the MFD 2404 upon determining that the primary flight information received from either AHRS 2410 and ADC 2412 is in error or unavailable. Reversionary switches 2418 can be selected by the pilot to configure the PFDs 2402 or MFD 2404 to display primary flight information from either the first AHRS 2410(1) and ADC 2412(1) or the second AHRS 2410(2) and ADC (2). One or both of the PFDs 2402 can also be configured to display information shown on the MFD 2404 (e.g., engine gauges and navigational information), such as in the event of a failure of the MFD 2404.

The integrated avionics system 2400 can employ cross-checking of the primary flight information (e.g., attitude information, altitude information, etc.) to determine if the primary flight information to be furnished to either of the PFDs 2402 is incorrect. In aspects, cross-checking can be accomplished through software-based automatic continual comparison of the primary flight information provided by the AHRS 2410 and ADC 2412. In this manner, a “miss-compare” condition can be explicitly and proactively annunciated to warn the pilot when attitude information displayed by either PFD 2402 sufficiently disagrees. The CDUs 2406 can furnish a general purpose pilot interface to control the aircraft's avionics. For example, the CDUs 2406 allow the pilots to control various systems of the aircraft such as the aircraft's autopilot system, flight director (FD), electronic stability and protection (ESP) system, autothrottle, navigation systems, communication systems, engines, and so on, via the avionics data bus 2416. In aspects, the CDUs 2406 can also be used for control of the integrated avionics system 2400 including operation of the PFD 2402 and MFD 2404. In aspects, one or both of the CDUs 2406 can include a display 2420. The display 2420 of the CDU 2406 can be used for the display of information suitable for use by the pilot of the aircraft to control a variety of aircraft systems. Further, as discussed in greater detail herein below, the display 2420 of the CDU can be configured to display a cursor control area to facilitate manipulation of indicia displayed by a display device of the avionics system (e.g., a PFD 2402 or MFD 2404) via touch input to the touch screen over the displayed cursor control area.

The CDUs 2406 can be operable to provide independent standby primary flight information to the pilot. The CDUs 2406 can be configurable to operate in a reversionary mode to provide standby primary flight information to the pilot(s) of the aircraft. When operating in reversionary mode, the display 2420 of the CDU 2406 is used to display standby primary flight information. As shown in FIG. 46B, standby primary flight information, which can include information such as attitude, altitude, heading, vertical speed, and so forth, can be generated by a standby attitude and heading reference system (AHRS) 2422 and a standby air data computer (ADC) 2424. Data generated by AHRS 2422 and ADC 2424 can be provided to one or more of the CDUs 2406 via a standby avionics data bus 2428. In aspects, one or more mode switches 2430 can be selected by the pilot to cause any number of the CDUs 2406 to operate in the first mode to display standby primary flight information. While operating in the reversionary mode, the CDUs 2406 can be disconnected from the avionics data bus 2416 so that the CDUs 2406 operate independently of and communicatively isolated from the primary components of the integrated avionics system 2400 (e.g., the PFDs 2402, the MFD 2404, the AHRS 2410, the ADCs 2412, and so forth). For example, the CDUs 2406 may not communicate with the avionics data bus 2416 while in the first mode or can be physically disconnected from the avionics data bus 2416 (e.g., via the mode switch 2430, and so on).

FIG. 47 illustrates a system 2500 in an example aspect showing a representative CDU 2406 of FIGS. 46A and 46B in greater detail. The CDU 2406 is illustrated as including a processor 2502, a memory 2504, one or more avionics data bus interfaces 2506, 2508 and the display 2420.

The processor 2502 provides processing functionality for the CDU 2406 and can include any number of processors, micro-controllers, or other processing systems and resident or external memory for storing data and other information accessed or generated by the CDU 2406. The processor 2502 can execute one or more software programs which implement techniques described herein. The processor 2502 is not limited by the materials from which it is formed or the processing mechanisms employed therein, and as such, can be implemented via semiconductor(s) and/or transistors (e.g., electronic integrated circuits (ICs)), and so forth.

The memory 2504 is an example of computer-readable media that provides storage functionality to store various data associated with the operation of the CDU 2406, such as the software programs and code segments mentioned above, or other data to instruct the processor 2502 and other elements of the CDU 2406 to perform the functionality described herein. Although a single memory 2504 is shown, a wide variety of types and combinations of memory can be employed. The memory 2504 can be integral with the processor 2502, stand-alone memory, or a combination of both. The memory 2504 can include, for example, removable and non-removable memory elements such as RAM, ROM, Flash (e.g., SD Card, mini-SD card, micro-SD Card), magnetic, optical, USB memory devices, and so forth.

The avionics data bus interface 2506 and the standby avionics data bus interface 2508 furnish functionality to enable the CDU 2406 to communicate with one or more avionics data buses such as the avionics data bus 2416 and standby avionics data bus 2428, respectively, illustrated in FIG. 46B. In various aspects, the avionics data bus interface 2506 and standby avionics data bus interface 2508 can include a variety of components, such as processors, memory, encoders, decoders, and so forth, and any associated software employed by these components (e.g., drivers, configuration software, etc.).

The display 2420 displays information to the pilot of the aircraft. In aspects, the display 2420 can comprise an LCD (Liquid Crystal Diode) display, a TFT (Thin Film Transistor) LCD display, an LEP (Light Emitting Polymer or PLED (Polymer Light Emitting Diode)) display, a cathode ray tube (CRT), and so forth, capable of displaying text and/or graphical information, such as a graphical user interface. The display 2420 can be backlit via a backlight such that it can be viewed in the dark or other low-light environments.

The display 2420 can include a touch interface, such as a touch screen 2510, that can detect a touch input within a specified area of the display 2420 for entry of information and commands. In aspects, the touch screen 2510 can employ a variety of technologies for detecting touch inputs. For example, the touch screen 2510 can employ infrared optical imaging technologies, resistive technologies, capacitive technologies, surface acoustic wave technologies, and so forth. In aspects, buttons, softkeys, keypads, knobs and so forth, can be used for entry of data and commands instead of or in addition to the touch screen 2510.

As shown in FIG. 47, the system 2500 (i.e., a CDU 2406) includes a power source 2512, such as a back-up power source, that is configured to furnish power to at least partially power the system 2500 in the event the aircraft loses primary power (e.g., primary power sources are no longer furnishing power to the PFDs 2402, the MFD 2404, the CDUs 2406, and the instrument panel 2408 of the aircraft). For example, the power source 2512 is configured to at least substantially power the system 2500 when the aircraft is not powered by the primary power source during operation of the aircraft. In an aspect, the power source 2512 comprises a battery that is configured to provide power to the CDU 2406 when a loss of primary power is detected. For example, the power source 2512 can be configured to furnish power automatically to the CDU 2406 once the primary power ceases, or at least substantially ceases, to power the CDU 2406 and/or the aircraft. In another example, the power source 2512 can be configured to power the CDU 2406 upon the pilot/co-pilot manually causing the power source 2512 to power the CDU 2406. The back-up power source is configured to furnish power to a CDU 2406 for a predetermined amount of time to allow the pilot/co-pilot to utilize the CDU 2406 for a limited amount of time while the primary power is not available within the aircraft.

As shown, the system 2400 includes an autoland module 2514, which is storable in the memory 2504 and executable by the processor 2502. The autoland module 2514 is representative of functionality that provides automatic landing functionality for an aircraft. In one or more aspects, the autoland module 2514 provides functionality that provides automatic landing functionality pertaining to airport/runway/approach selection, navigation to an approach while avoiding terrain, obstacles, and/or weather having undesirable characteristics, automatic aircraft speed control, flare processes (e.g., vertical and lateral), braking and/or ground steering, and/or engine shutdown.

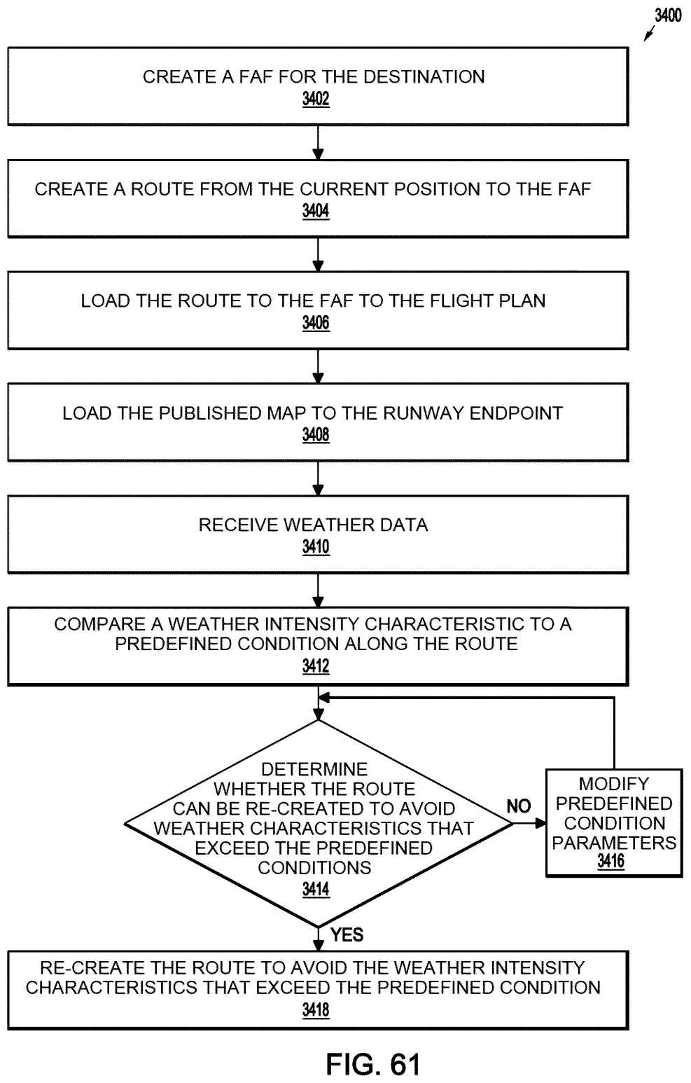

In one or more aspects, the autoland module 2514 provides functionality to automatically engage (e.g., activate) an emergency autoland process (see FIG. 61). For example, the autoland module 2514 continuously monitors whether a pilot has engaged (e.g., interfaced, actuated, interacted, etc.) with the CDUs 2406 and/or a control wheel and can automatically activate the emergency autoland process based upon one or more engagement characteristics. In an aspect, the autoland module 2514 activates the autoland process once a pilot has not engaged with the CDUs 2406 and/or the control wheel after a defined time period. The one or more engagement characteristics can comprise a pilot actuating one or more of the avionics equipment, continued engagement of the aircraft's autopilot system after a specified event (e.g., emergency descent, predetermined length of time, etc.), continued activation of ESP such that the autopilot system has automatically engaged, and so forth.

In one or more aspects, the autoland module 2514 can automatically activate the emergency autoland process based upon the engagement characteristics and/or one or more flight characteristics (e.g., altitude of the aircraft, cabin altitude, cabin pressure, airspeed of the aircraft, flight plan, Winds and Temperature Aloft Forecast, time of night, length of flight, terrain height, a navigational input of the aircraft, etc.). For example, the autoland module 2514 can detect when the cabin depressurizes below a predetermined pressure threshold and can automatically activate emergency autoland processes. In some aspects, the flight characteristics can be furnished to the system 2400 by a user (e.g., pilot). The flight characteristics can also be furnished to the autoland module 2514 by other components internal to the system 2400 (e.g., AHRS, ADCs, IDUs, other modules, etc.). In one or more aspects, the flight characteristics are stored within flight profile information 2516, which is storable in the memory 2504 of the CDU 2406.

In some aspects, the system 2400 can issue an electronic communication notification based upon the engagement characteristics and/or the flight characteristics. For example, the autoland module 2514 can cause the processor 2502 to issue one or more notifications via the display 2420. Notifications can be displayed in text (e.g., “Awake?”), displayed with images, haptic (e.g., vibration alerts), aural (e.g., beeps or spoken text), or communicated via another appropriate means to the user.

In some aspects, the system 2400 can receive feedback from the pilot(s) in response to the electronic communication notification. For instance, the autoland module 2514 can cause the processor 2502 to issue an electronic communication notification that can be dismissed by the pilot. In an example aspect, the processor can issue a text notification asking if the pilot is awake. If the pilot is awake, he can dismiss the alert. The autoland module 2514 can then determine whether to engage emergency autoland processes based on the feedback received. For example, if the pilot dismisses the notification, the autoland module 2514 can withhold activation of emergency autoland processes. In another example, if the pilot fails to dismiss the notification within a predetermined time period (e.g., approximately 0.5 seconds to 2 minutes), the autoland module 2514 can engage emergency autolanding processes as described herein. In some aspects, the system 2400 can issue escalating levels of electronic communication notifications. For example, the autoland module 2514 can cause the processor 2502 to issue a first notification (e.g., a text notification). If the pilot fails to dismiss the notification within a predetermined time period (e.g., approximately 0.5 seconds to approximately 2 minutes), the autoland module 2514 can cause the processor 2502 to issue one or more additional notifications (e.g., aural, haptic, etc.). If the pilot fails to dismiss the notification after a predetermined time period (e.g., approximately 0.5 seconds to approximately 2 minutes), the autoland module 2514 can engage emergency autoland processes.

In one or more aspects, the user (e.g., pilot, crew member) can activate the emergency autoland processes manually. For example, the pilot can manually activate the emergency autoland processes in an emergency situation (e.g., emergency descent, depressurization, pilot incapacitation, etc.). The system 2400 can include a switch (e.g., guarded switch) or button configured for manually engaging the emergency autoland processes.

Upon engagement of emergency autoland processes, the autoland module 2514 can cause the CDU 2406 to engage one or more systems (e.g., autopilot system, flight director, autothrottle, ESP, EDM, etc.) for automatically landing the aircraft. For example, the CDU 2406 can cause the autopilot system to guide the aircraft to the nearest airport, the highest ranked airport based on predetermined suitability score weighting, and/or on a calculated route. The autoland module 2514 can cause the processor 2502 to execute one or more processes to determine a destination and/or a route. In some embodiments, the processor 2502 can execute an endurance process to determine the aircraft's endurance based on usable fuel onboard the aircraft (endurance=current fuel/current total fuel flow). In example aspects, if the aircraft has manually selected tanks for fuel usage and the avionics does not know which tank is selected, the processor 2502 can utilize the tank with the least fuel for the endurance calculation. In another aspect, if the avionics can identify which tank is selected, then the CDU 2406 can utilize the selected tank for the endurance calculation.

The autoland module 2514 can use one or more destination selection processes to identify potential destinations for the aircraft. Potential destinations can include an airport location, terrain features (e.g., fields, landing fields, other open areas), bodies of water (e.g., lakes, seaports, etc.), and so forth. In some embodiments, airports within a range of travel of the aircraft are identified based upon a determined endurance of the aircraft. For example, the module 2514 can identify airports within the range of travel of the aircraft. The autoland module 2514 can cause the processor 2502 to identify any airports within a preselected distance from the aircraft. In some aspects, the potential airports can be those within approximately 2400 to 500 miles (depending on plane type). If there are no potential destinations within the range of travel of the aircraft, the processor 2502 can identify potential destinations outside of the range of travel, and the autoland module 2514 can select the best available potential destination outside of the range of travel. For example, the module 2514 can select the closest potential destination (e.g., the closest airport), the last loaded origin, the last loaded destination, previously available destinations, and so forth. In some aspects, the autoland module 2514 can cause the processor 2502 to eliminate any airports that are not appropriate candidates for landing. For example, the processor 2502 can eliminate airports that have one or more configurable adverse landing characteristics. Adverse landing characteristics can include, but are not necessarily limited to: airports that do not have at least one hard surface runway, airports that are heliports only, airports that do not have at least one acceptable approach (e.g., GPS approach to a runway with vertical guidance), and so forth.

In some aspects, the system 2400 can also incorporate weather data (e.g., METAR, Terminal Doppler Weather Radar (TDWR), terminal aerodrome forecast (TAF), etc.) received from each airport (or from a nearby airport should weather data not be available) in selecting potential airports. For example, the autoland module 2514 can receive METAR data from one or more of the components internal to the system 2400 (e.g., AHRS, ADCs, IDUs, other modules, etc.). The autoland module 2514 can cause the processor 2502 to eliminate airports with unfavorable weather conditions. For example, the processor 2502 can treat unfavorable weather conditions as an adverse landing characteristic and eliminate those airports from the potential airports.

As used herein, “favorable weather conditions” refer to environmental conditions that meet predefined thresholds suitable for automated landing operations. These can include, for example, wind speeds below a maximum crosswind or tailwind limit (e.g., crosswind less than 15 knots), visibility greater than a minimum value (e.g., greater than 1 statute mile or 1600 meters), cloud ceiling above a minimum altitude (e.g., 200 feet AGL), absence of severe turbulence or microbursts, and acceptable runway surface conditions (e.g., no reported ice or standing water). Conversely, “unfavorable weather conditions” refer to any conditions that exceed these thresholds and can compromise safe automated landing, such as wind shear, low visibility, thunderstorms within a proximity threshold (e.g., 5 nautical miles), or braking action reports below a defined minimum (e.g., “poor” or NIL braking action).

The autoland module 2514 can then execute one or more suitability score processes to determine a suitability score for each potential destination. For example, the autoland module 2514 can cause processor 2502 to calculate one or more suitability scores for each airport runway based on a variety of runway attributes. Runway attributes can include, but are not necessarily limited to: final approach course alignment with the runway, runway characteristics (e.g., runway length, runway width, approach vertical angle (e.g., flight path angle), gradient, etc.), weather conditions (e.g., weather rating (e.g., instrument flight rules (IFR), visual flight rules (VFR), etc.), gust, precipitation level, precipitation type, etc.), attributes specific to the airport (e.g., airport with a tower, airports that anchor class B airspace, exclusively military airports, etc.), travel time to airport (e.g., estimated time enroute (ETE)), and so forth. The autoland module 2514 can cause the processor 2502 to calculate a suitability score value for each attribute. For example, the processor 2502 can assign each attribute a suitability score value in the range of −1.0 to 1.0, with 1.0 representing an ideal runway. Negative suitability score values can be considered to be out of limits. In some aspects, the processor 2502 can determine a final approach course alignment runway suitability score for a runway corresponding to each potential destination airport. For example, the processor 2502 can calculate the degrees of misalignment of the aircraft with the runway. In some aspects, the processor 2502 can eliminate runways that exceed a preselected maximum misalignment threshold (e.g., 25 degrees to 35 degrees of misalignment). The processor 2502 can also determine an airport attribute runway suitability score for each potential destination airport. For example, the processor 2502 can assign a high suitability score value to airports with towers, as the presence of a tower can indicate that the airport has emergency facilities. The processor 2502 can assign low suitability score values to airports that anchor class B airspace and/or exclusively military airports. The processor 2502 can also determine a travel time runway suitability score for a runway corresponding to each potential destination airport. In example aspects, the processor 2502 can calculate time to runway using groundspeed along a selected path from the wind triangle based on wind speed and/or wind direction. The processor 2502 can also calculate a runway suitability score based on one or more runway characteristics. For example, the processor 2502 can assign higher suitability score values corresponding to wider and/or longer runways. The processor 2502 can also calculate a runway suitability score based on the weather conditions at each potential destination airport. For example, the processor 2502 can assign low suitability score values to airports with low visibility, high wind speeds, and so forth.

The autoland module 2514 can then determine the total suitability score for each airport. In aspects, the autoland module 2514 can cause the processor 2502 to apply a predetermined weighting factor (K) to each runway suitability score (M) and calculate a weighted runway suitability score (KM). The sum of all weighting factors (ΣK) represents the maximum possible suitability score value. The sum of the weighted values (Σ(KM)) for a runway represents the total suitability score for the runway. The processor 2502 can also assign penalties to attributes that are out of limits (e.g., the suitability score is negative). For example, the processor can subtract a penalty equal to the maximum possible suitability score value (ΣK) from the overall suitability score of the runway (Σ(KM)−ΣK). This ensures that the runway is only selected if there are no available runways where all attributes are within limits. The processor 2502 can then determine which runway has the highest total suitability score (e.g., highest Σ(KM)).

In some aspects, the autoland module 2514 can incorporate route weather data in determining the total suitability score for each destination. The autoland module 2514 can receive weather data (e.g., weather radar, XM, datalink weather, icing data) and/or forecast data (e.g., Winds and Temperatures Aloft Forecast data, turbulence data, windshear data, NEXRAD data, etc.) from one or more of the components internal to the system 2400 (e.g., AHRS, ADCs, IDUS, other modules, etc.). Datalink weather can include satellite radio sources, FIS-B (ADS-B), Garmin Connext, and/or other datalinks. The module 2514 can cause the processor 2502 to analyze the weather data and/or forecast data for one or more weather intensity characteristics. Weather intensity characteristics can include, but are not necessarily limited to: precipitation level, precipitation type (e.g., rain, snow, sleet, etc.), atmospheric conditions (e.g., wind speed, wind direction, temperature, etc.), storm attributes (e.g., storm top elevation, reflectivity, vertically integrated water, probability of hail, probability of severe hail, maximum hail stone diameter size, speed and/or direction of storm movement, tornadic activity, etc.), weather conditions (e.g., weather severity, visibility, etc.), and so forth. The autoland module 2514 can cause the processor 2502 to compare the weather intensity characteristics to a predefined condition (e.g., a predefined severity and/or intensity threshold). For example, the autoland module 2514 can cause the processor 2502 to compare weather severity to predefined weather severity levels (e.g., low, medium, high, etc.), and identify weather severity areas. If the weather severity of a weather area exceeds one or more of the predefined severity levels, the autoland module 2514 can cause the processor 2502 to adjust the runway suitability score accordingly. For example, the processor 2502 can create a buffer area around weather areas of predefined severity levels, and downgrade runways that require passing through those areas. The processor 2502 can downgrade (e.g., assess a penalty) to runways that require a route passing through a preselected radius (e.g., approximately five miles to approximately 15 miles) of a high severity weather area (e.g., areas depicted on a NEXRAD map as red areas). The processor 2502 can also eliminate (e.g., assign negative M) to runways that require a route passing through a preselected radius (e.g., approximately two miles to approximately four miles) of a high severity weather area (e.g., NEXRAD red areas). In some aspects, the processor 2502 can increase the minimum distance (e.g., increase the preselected radius) from a high severity weather area (e.g., NEXRAD red areas) based on the size of the area. The processor 2502 can also be configured to identify gradient changes in weather intensity characteristics. For example, the processor 2502 can identify areas that change from a low severity area to a medium severity area within a specified distance (e.g., approximately one mile) and treat those areas as high severity areas. If a route cannot be determined through the weather and/or no routes can be determined due to weather (e.g., all routes contain weather that prohibits routing), the processor 2502 can expand the tolerance for the predefined condition (e.g., expand the tolerance for weather severity) until a route can be determined.

In some embodiments, the autoland module 2514 can select a destination based on the total suitability score. For example, the autoland module 2514 can cause the processor 2502 to select the airport with the highest runway total suitability score as the destination airport. The processor 2502 can determine an approach fix based on the runway with the highest total suitability score. The approach fix can include, but is not necessarily limited to: a final approach fix (FAF), an initial approach fix from a published approach (IAF), a point on a published approach, an arbitrary fix point that the system 2400 selects to enable the aircraft to land on the selected runway (e.g., a visual approach fix, etc.), and so forth. If the processor 2502 is unable to identify an optimal runway (e.g., a runway with positive total suitability score), the processor 2502 can select the runway with the highest negative suitability score. In another aspect, the user can manually select a destination airport and/or runway from the potential airports via the touch screen 2510. In some embodiments, when no destinations are within range of the aircraft (e.g., based on determined aircraft endurance), the module 2514 will assign the highest suitability score to the potential destination with the shortest ETE, ignoring all other suitability scores.

The autoland module 2514 can create a route from the current position of the aircraft to the destination. For example, the autoland module 2514 can cause the processor 2502 to create a route from the current position of the aircraft to the approach fix. In some embodiments, the processor 2502 can determine a lateral position for the approach fix that reflects the position of an existing published approach fix. The processor 2502 can execute one or more aircraft route calculation processes to determine a route between the current aircraft position and the approach fix. In some aspects, the processor 2502 can determine a direct route between the current position and the destination airport. For example, the processor 2502 can create a direct route at the present altitude between the current position and the FAF. The processor 2502 can then create a hold at the approach fix. For example, the processor 2502 can create a standard (e.g., right turn) or non-standard (e.g., left turn) holding pattern at the FAF (e.g., based on which holding pattern is free of terrain and/or obstacle intrusion), at the FAF altitude, with minimum leg length, where the inbound course of the hold equals the outbound course from the FAF. In embodiments, the hold pattern can be based on one or more of the speed of the aircraft, the altitude of the aircraft, and/or the course of the aircraft. For example, a hold pattern can be traversed if one or more of the following conditions are met: 1) a speed of the aircraft is within a defined tolerance relative to the approach speed, 2) the course of the aircraft is within a defined tolerance relative to the FAF (e.g., within a defined tolerance of the FAF to an FAF+1), and the altitude of the aircraft is within a defined tolerance relative to the altitude of the FAF. The processor 2502 can also create a waypoint associated with the runway (e.g., at the start of the runway) to allow for navigation of the runway (e.g., alignment). In one or more aspects, the aircraft route calculation process can be performed to determine and/or analyze a route in view of predefined characteristics (e.g., distance, terrain characteristics, obstacle characteristics, weather characteristics, etc.). In some embodiments, the route can be created based on the approach fix and an FAF. For example, the route can comprise a FAF−1, where the FAF−1 is a distance back from the FAF in the direction of a missed approach point (MAP) to FAF course such that the path is under the glide path.

The autoland module 2514 can also determine a vertical path to the destination. For example, the autoland module 2514 can cause the processor 2502 to calculate a descent path from the aircraft's current altitude to the FAF altitude or another appropriate altitude to intercept the glide path. The vertical path can be calculated to ensure stable approach criteria are met, such as a constant descent angle and rate, sufficient distance to descend, and avoidance of terrain and obstacles. The processor 2502 can consider aircraft configuration constraints (e.g., gear and flap extension altitudes and speeds), wind conditions, and descent rate limitations. In some embodiments, the vertical path can include step-down fixes, level-off segments, or be a continuous descent approach (CDA). The vertical path can be modified in real-time to accommodate updated weather, terrain, or traffic information. The autoland module 2514 can also cause the processor 2502 to calculate the required top-of-descent (TOD) point and ensure the aircraft initiates descent at the appropriate location.

In some aspects, the processor 2502 can determine whether the lateral and vertical routes are viable by checking against aircraft performance data, terrain data, obstacle databases, and weather information. If a route is determined to be unviable (e.g., terrain conflict, weather severity, insufficient performance margins), the processor 2502 can iterate route generation using alternative fixes, altitudes, or speeds until a viable solution is found. If no viable route exists, the processor can alert the pilot, initiate a hold, or expand tolerances as described above. The module 2514 can prioritize routes requiring minimal course and altitude changes from the current aircraft state to expedite navigation to the destination.

Once a viable route is determined, the autoland module 2514 can cause the processor 2502 to initiate automatic navigation along the route. This can include engaging the autopilot and autothrottle systems, commanding lateral and vertical modes (e.g., LNAV/VNAV), and sequencing waypoints. The processor 2502 can control the flight director and/or autopilot servos to track the defined route and altitude path. The autothrottle system can manage engine power settings to maintain desired speeds during descent and approach. The processor 2502 can monitor deviation from the route or path and apply corrective actions to maintain course. In some embodiments, if deviations exceed predefined limits, the system can execute a missed approach or alert the pilot.

During approach, the autoland module 2514 can command gear and flap deployment according to predefined altitude and speed schedules. The processor 2502 can reference aircraft-specific configurations (e.g., VLO, VLE, VFE speeds) and initiate configuration changes to ensure the aircraft is stabilized on approach. In some embodiments, the system can verify gear down and locked indication and correct flap positions before continuing past the final approach fix. If configuration is incorrect or unsafe, the system can delay descent below minimums, hold at the FAF, or execute a go-around.

The autoland module 2514 can also command flare and landing processes. For example, the processor 2502 can initiate a flare maneuver by commanding a pitch-up attitude as the aircraft descends below a preselected radar altitude threshold (e.g., 50 feet AGL). The flare profile can be tailored to aircraft type, weight, and wind conditions to reduce vertical speed and achieve a smooth touchdown. After touchdown, the processor 2502 can command engine idle, deploy speedbrakes or thrust reversers if available, and apply automatic braking according to a braking schedule. The system can also command steering inputs to maintain runway centerline tracking and bring the aircraft to a stop. Once stopped, the autoland module 2514 can initiate shutdown procedures or await further pilot instruction.

If one or more of the systems (e.g., autopilot system, flight director, autothrottle, ESP, FD, EDM, etc.) become disengaged, the autoland module 2514 can cause the CDU 2406 to attempt to re-engage the system. For example, if the autopilot system, autothrottle, and/or flight director become disengaged via abnormal disengagement, the CDU 2406 can attempt to re-engage the system(s) approximately every one (1) second while emergency autoland processes are engaged. Upon re-engagement, the autoland module 2514 can re-initiate the autopilot system, autothrottle, and/or flight director to traverse to the selected approach fix.

As shown, the system 2400 includes an engine 2516, and the autoland module 2514 can engage one or more components and/or systems of the aircraft that are internal and/or external to the system 2400 for autolanding the aircraft. For example, the autoland module 2514 can cause the processor 2502 to actuate one or more systems and/or modes of operation of the engine 2516. For example, the processor 2502 can actuate the autothrottle system to control power of the engine 2516. The autothrottle system can maintain predetermined speed and/or thrust during different phases of flight (e.g., cruise, descent, hold, near destination, approach, landing flare, inside the approach fix, etc.). For example, the autothrottle system can control the power of the engine 2516 to maintain a predetermined minimum speed inside the approach fix. Upon landing, the processor 2502 can also cause the engine 2516 to transition from an operational state to a non-operational state.

For example, the processor 2502 can actuate one or more fuel shutoff valves, digital controls, and/or ignition switches to stop the engine 2516. In some aspects, the autoland module 2514 can be configured to transition the engine 2516 to a non-operational state only after the aircraft has been on the ground for a predetermined period of time. For example, the autoland module 2514 can actuate a plurality of switches at different points after landing. The autoland module 2514 can actuate a first switch after the aircraft has been on the ground for a predetermined time interval. The module 2514 can actuate a second switch when the aircraft is decelerating and/or when the wheel speed and/or airspeed is above a predefined threshold speed. The autoland module 2514 can actuate a third switch when the pressure in one or more of the brake lines exceeds a predetermined pressure threshold for a predetermined period of time. The use of a plurality of switches, shutoff valves, and/or digital controls can prevent inadvertent engine shutdowns and can ensure that fuel is removed from the engine shortly after the aircraft is on the ground.

In other aspects, the autoland module 2514 can shut down the engines 2516 only after the aircraft has come to a stop (e.g., aircraft with braking maintained by engine-driven pump(s)). In one or more aspects, the autoland module 2514 can also cause the processor 2502 to actuate the braking system 2518 of the aircraft to decelerate and/or stop the aircraft. For example, the processor 2502 can actuate the braking system 2518 for decelerating the aircraft during landing and/or stopping the aircraft on the runway. In embodiments, the braking system can comprise a mechanical braking system and/or a non-mechanical braking system (e.g., reverse thrust, reverse prop, retracting gear, etc.).

In one or more aspects, the autoland module 2514 can also cause the processor 2502 to actuate one or more aerodynamic controls 2520 (e.g., yokes, cyclics, side-sticks, etc.) of the aircraft. For example, the processor 2502 can actuate the aerodynamic controls 2520 to control directional movements of the aircraft while traversing the route and/or during landing.

Generally, any of the functions described herein can be implemented using software, firmware, hardware (e.g., fixed logic circuitry), or a combination of these aspects. The terms “module” and “functionality” as used herein generally represent software, firmware, hardware, or a combination thereof. The communication between modules in the integrated avionics system 2400 of FIGS. 46A and 46B and the CDU of FIG. 47 can be wired, wireless, or some combination thereof. In the case of a software aspect, for instance, the module represents executable instructions that perform specified tasks when executed on a processor, such as the processor 2502 of the CDU shown in FIG. 47. The program code can be stored in one or more device-readable storage media, an example of which is the memory 2504 associated with the CDU 2406 of FIG. 47.

It is contemplated that in some aspects, the autoland module 2514 can provide functionality to engage processes other than an emergency autoland process. One or more of the endurance processes, the airport selection processes, the suitability score processes, and/or the aircraft route calculation processes can be utilized for navigating and/or landing the aircraft in a non-emergency autoland situation. In some embodiments, the system can operate on one or more of the processes to locate a suitable place to hold at the bottom of an emergency descent that is below the safe altitude for flight without oxygen and is clear of terrain. An approach to an airport can be commenced from that hold location.

In some embodiments, the system can operate on one or more of the processes to select a suitable airport and/or runway, and/or develop a glide path to that airport and/or runway within gliding distance in the event of an engine failure. In some embodiments, the system can operate on one or more of the processes (e.g., the selection process) to navigate to a selected location (e.g., locate fuel stops, lunch break locations, maintenance facilities, etc.) based on pilot selectable weighting parameters. Pilot selectable weighting parameters can include, but are not necessarily limited to: fuel price, on-airport restaurant, availability of a crew car, etc. The route calculation processes can then be utilized to create a route to the selected location that avoids potential threats (e.g., terrain, obstacles, weather, traffic, etc.).

The system 2400 can also operate on one or more of the processes to create a route to a predetermined location that avoids potential threats (e.g., terrain, obstacles, weather, traffic, etc.). The route calculation processes can also be used to determine an optimized route based on predetermined factors such as time, fuel, aircraft endurance, and so forth. For example, the processor 2502 can utilize weather data to generate a route with the most favorable winds or other weather conditions.

In some embodiments, the system 2400 can operate on the route calculation processes to ensure clearance of the aircraft and/or create a route for the aircraft. For example, the route calculation processes can be utilized to ensure terrain clearance when instrument approaches are created. The route calculation processes can also be utilized to determine a route through mountainous terrain based on a predetermined altitude cap. In some embodiments, the route calculation processes can be utilized to create curved approaches and/or close-in approaches to avoid preselected areas (e.g., noise-sensitive areas, high-security areas, wildlife areas, etc.).

In embodiments, the system 2400 can operate on the route calculation processes to re-create a route for the aircraft. For example, the processor 2502 can automatically re-create a predetermined route of the aircraft (e.g., computed flight plan, track vector, etc.) to avoid potential threats (e.g., terrain, obstacles, weather, traffic, etc.). The route calculation processes can also be used to create suggested route modifications. For example, the processor 2502 can suggest a recreated route to avoid potential threats (e.g., terrain, obstacles, weather, traffic, etc.). The system 2400 may notify the user of the suggested re-created route, which can be accepted or dismissed by the user.

In some embodiments, the system 2400 can operate on one or more of the processes to remotely activate and/or navigate an aircraft. The module 2514 can be activated from a remote location (e.g., support center) for autopiloting and/or autolanding the aircraft. For example, the module 2514 can be remotely activated to return unmanned aircraft to a base location. Remote activation can also be utilized to control erratic and/or unresponsive aircraft that are unable to engage the module 2514 automatically.

In some embodiments, the system 2400 can operate on one or more of the processes to suggest autopilot modes based on a current flight plan and/or flight characteristics (e.g., altitude of the aircraft, cabin altitude, cabin pressure, airspeed of the aircraft, flight plan, Winds and Temperature Aloft Forecast, time of night, length of flight, terrain height, a navigational input of the aircraft, etc.). The module 2514 can cause the processor 2502 to activate the most suitable autopilot mode based on the flight plan and/or flight characteristics. For example, the module 2514 can activate FLC mode to climb or rejoin a descent path that is below the current altitude.

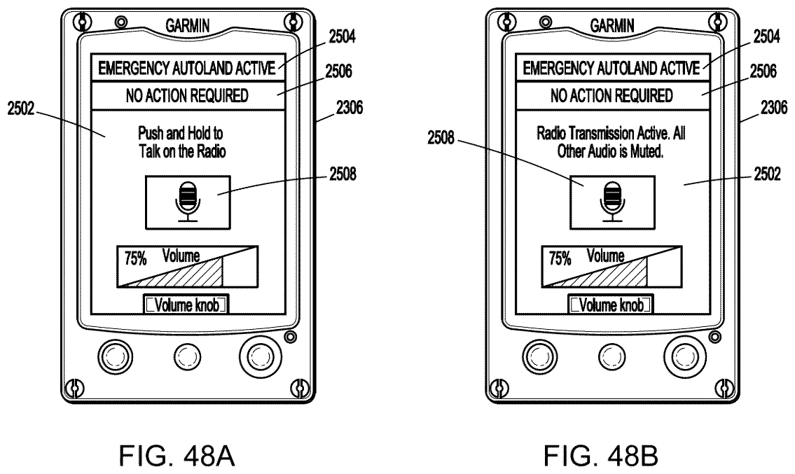

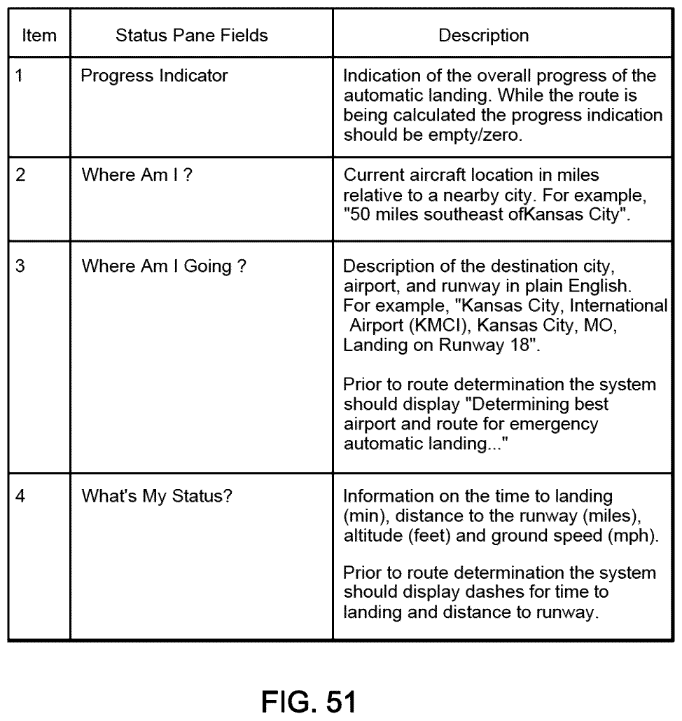

In some instances, the autoland module 2514 is configured to cause the generation of one or more displays at a display screen, such as the display 2420 of the CDU 2406. FIGS. 48A through 55B illustrate example display screens 2602, 2702, 2802 of the display 2420 of the CDU 2406, the PFD 2402, and/or the MFD 2404. As described above, the autoland module 2514 is configured to cause the display of information related to routing the aircraft to the FAF, which is described in greater detail herein.

As shown in FIGS. 48A and 48B, the display screen 2602 can display one or more textual notification banners configured to provide notifications to the user. For example, a first notification banner 2604 can be configured to convey whether or not the autoland module 2514 is active. A second notification banner 2606 can be configured to convey whether or not a user action is required. The display screen 2602 can also display one or more softkeys. For example, the display screen 2602 can display a softkey 2608 for activating a microphone for radio transmission. The display screen 2602 can also display text and/or graphic user instructions for operating the microphone (e.g., volume control, push and hold to talk, etc.), as illustrated in FIG. 48B.

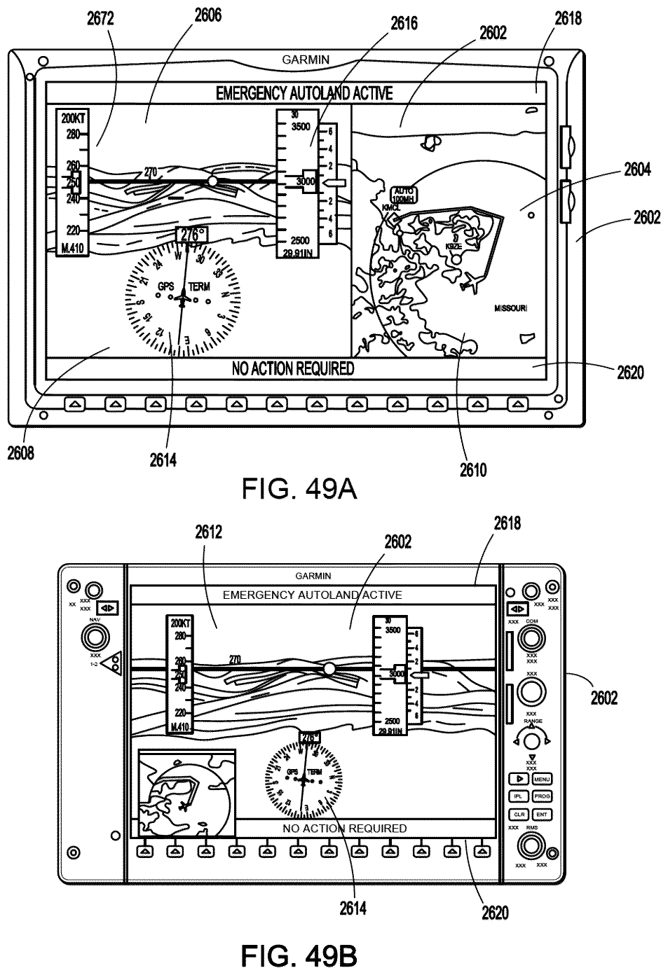

As shown in FIGS. 49A and 49B, the display screen 2702 can display navigation information, which can be retrieved via the integrated avionics systems components, that represent information describing operation of the aircraft (e.g., navigation routes, moving maps, engine gauges, weather radar, ground proximity warning system (GPWS) warnings, traffic collision avoidance system (TCAS) warnings, airport information, and so forth). In aspects, the navigation information can be displayed as one or more maps. In one or more aspects, the navigation information can include a first map 2710 (e.g., map graphic) that is configured to convey the route (e.g., flight plan) of the aircraft to the FAF. For example, the first map 2710 can display a topographical representation of the route the aircraft can traverse to reach the FAF. The first map 2710 can be configured to continually update at predetermined time intervals such that the graphical representation reflects the aircraft's location relative to the FAF. In some aspects, the first map 2710 can be configured to convey landmarks (e.g., state lines, roads/highways, cities, etc.) located on the route. The first map 2710 can also display the route of the aircraft relative to weather radar data WRD1.

The navigation information can also include a second map 2712 (e.g., map graphic) that is configured to convey a map region pertinent to navigation of the aircraft. For example, the second map 2712 can display graphical representations of an area that the aircraft is traversing. The second map 2712 can be configured to continually update at predetermined time intervals such that the graphical representations reflect the area being traversed with respect to movement of the aircraft (i.e., a moving map).

In some embodiments, the maps 2710, 2712 can be displayed on different display panes 2714, 2716, as illustrated in FIG. 49A. In other embodiments one or more of the maps 2710, 2712 can be displayed on a display insert panel, as illustrated in FIG. 49B.

In one or more aspects, the display screen 2702 can display one or more graphic and/or text indicators configured to convey information describing the route and/or operation of the aircraft. Indicators can include, but are not necessarily limited to: airspeed tape 2718, altimeter 2720, horizontal situation indicator 2722, and so forth. The display screen 2702 can also display textual notification banners configured to provide notifications to the user. For example, a first notification banner 2724 can be configured to convey whether or not the autoland module 2514 is active. A second notification banner 2726 can be configured to convey whether or not a user action is required.

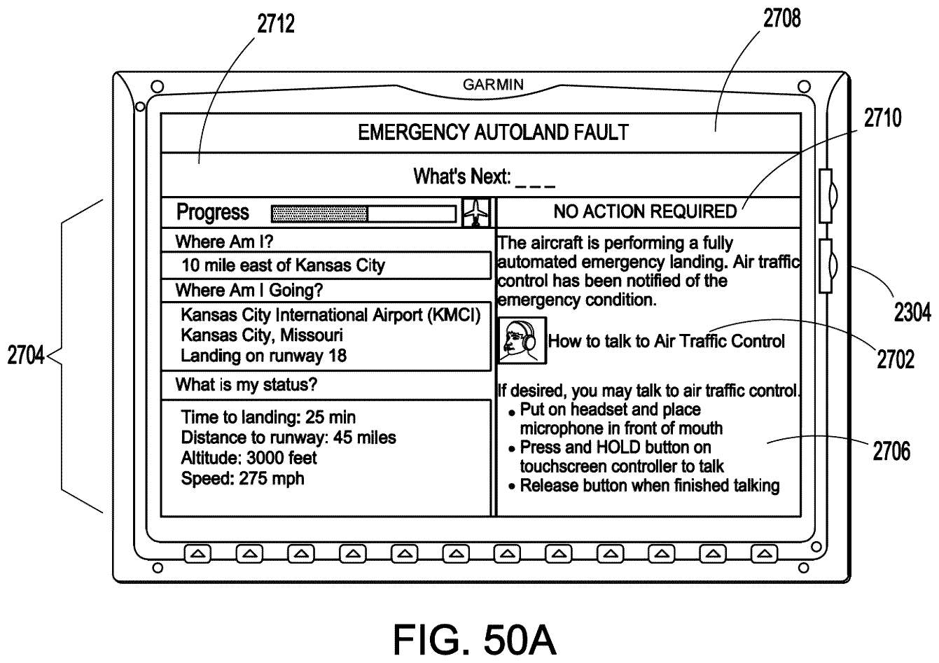

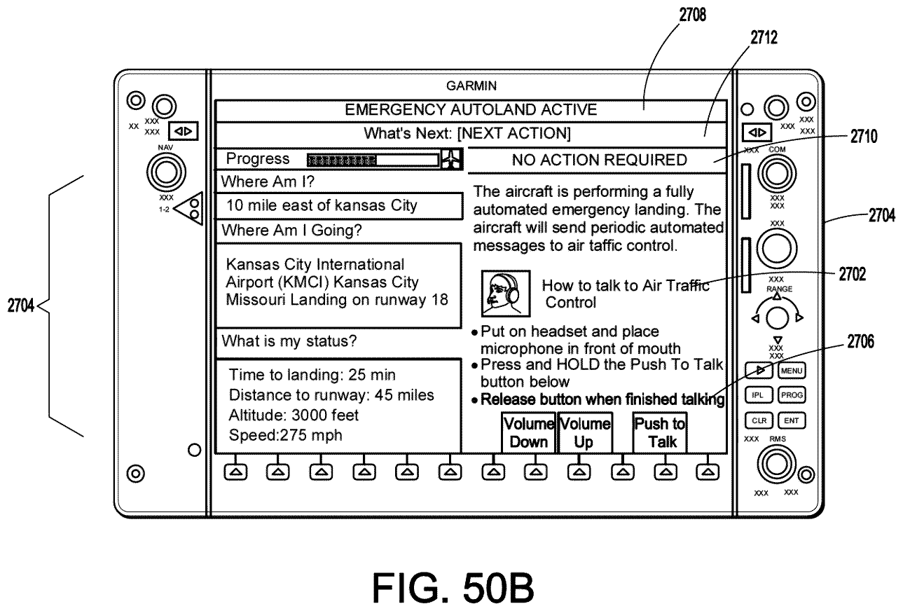

As shown in FIGS. 50A through 55B, the display screen 2802 can display graphics and/or text that represent information describing the operation of the aircraft. For example, the text can include status information 2804, which can be retrieved via the integrated avionics systems components, that represent information describing operation of the aircraft (e.g., navigation routes, moving maps, engine gauges, weather radar, ground proximity warning system (GPWS) warnings, traffic collision avoidance system (TCAS) warnings, airport information, and so forth). In one or more aspects, the status information 2804 can include text configured to convey dynamic information about the route of the aircraft, the FAF (e.g., name of airport, location of airport, runway number), and/or the status of the aircraft (e.g., speed, altitude, distance to runway, time to landing, etc.), as illustrated in FIGS. 50A and 50B.

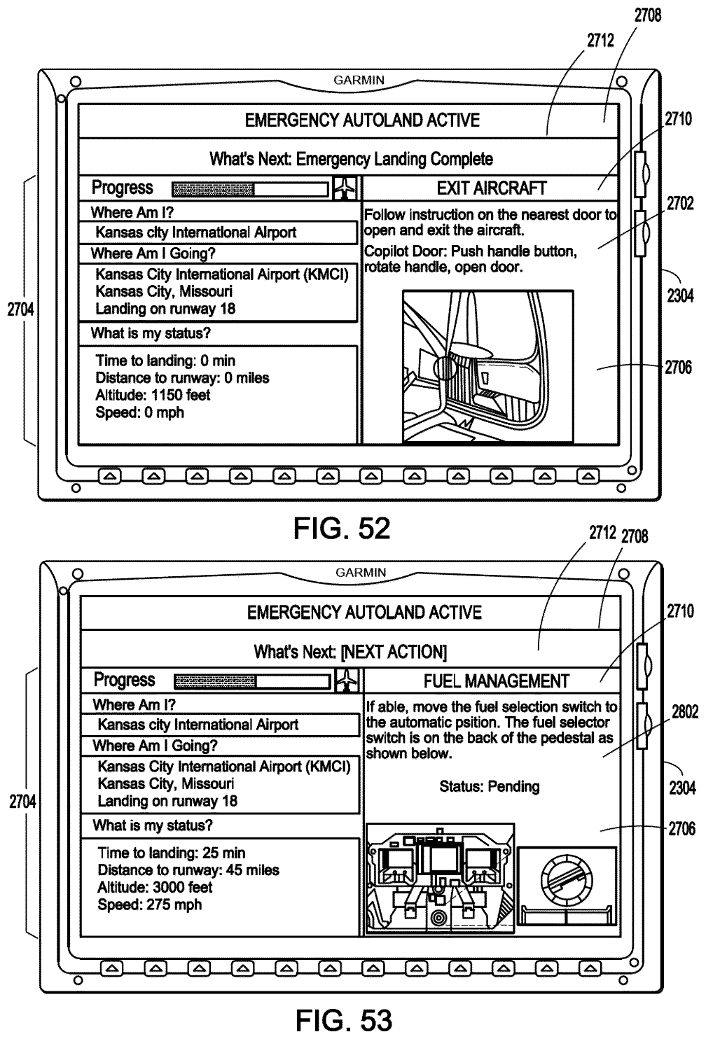

The display screen 2802 can also include text and/or graphics representing dynamic instructions 2806 for the user. For example, the text and/or graphical instructions 2806 can assist the user in communicating with air traffic control (e.g., as described with reference to FIGS. 50A and 50B), exiting the aircraft upon landing (e.g., as described with reference to FIG. 52), fuel management instructions (e.g., as described with reference to FIG. 53), and so forth.

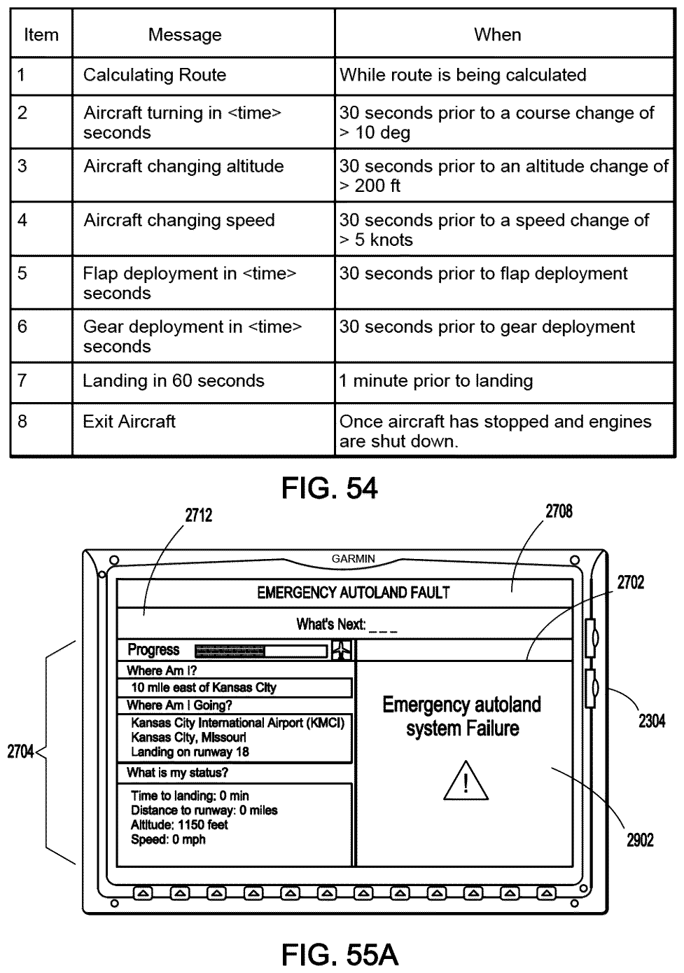

The display screen 2802 can also display one or more textual notification banners configured to provide notifications to the user. For example, a first notification banner 2808 can be configured to convey whether or not the autoland module 2514 is active. A second notification banner 2810 can be configured to convey whether or not a user action is required. A third notification banner 2812 can be configured to convey the next action that the aircraft can take. Example next actions (e.g., instructional information) that can be conveyed by the third textual banner 2812 are illustrated in FIG. 54.

The notifications can be accompanied by haptic (e.g., vibration alerts) notifications, aural (e.g., beeps or spoken text) notifications, or communicated via another appropriate means to the user. In aspects, one or more of the notification banners 2808, 2810, 2812 can be configured to correspond with the dynamic instructions 2806. For example, upon autoland module 2514 activation, an instruction to the user can indicate that emergency autoland is active and that air traffic control has been notified of the emergency, while a corresponding second notification banner can be configured to convey that no user action is required (as described with reference to FIGS. 50A and 50B).

In one or more aspects, the dynamic instructions 2806 can represent fuel management instructions (e.g., as described with reference to FIG. 53). Example fuel management instructions 2814 can include, but are not necessarily limited to: a one-time instruction to set the fuel selector to auto mode, periodic instructions to switch fuel tanks, and so forth. The fuel management instructions 2814 can be accompanied by the second notification banner 2810 configured to convey that fuel management is required. The display screen 2802 can also display graphic and/or text configured to convey the status of the fuel management instruction (e.g., pending, satisfactorily completed, etc.) to the user.

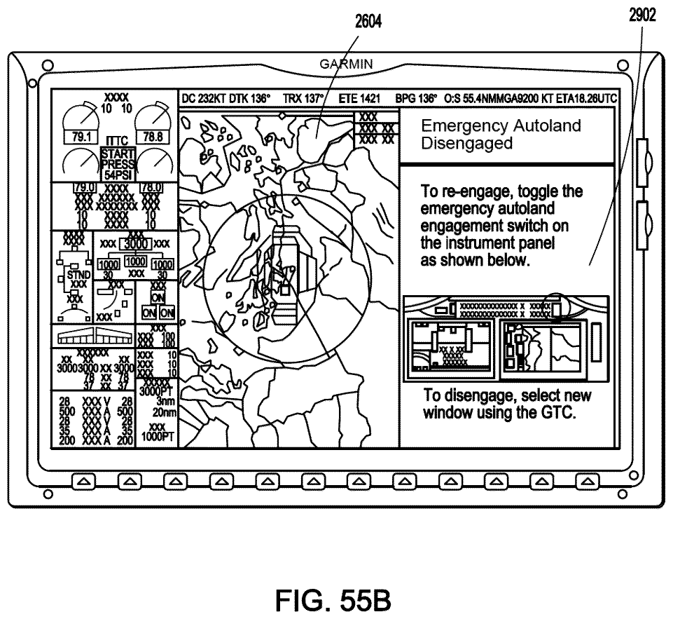

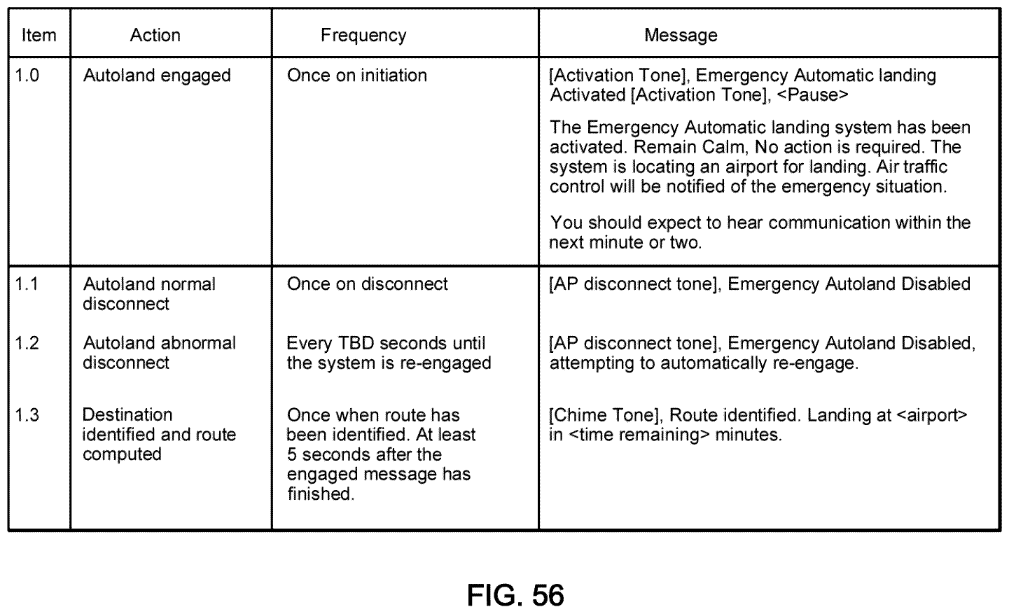

As shown in FIGS. 55A and 55B, the display screen 2802 can display graphical and/or text alerts 2816 configured to convey failure and/or disengagement of the autoland module 2514. FIG. 55A includes an example screen shot of display screen 2802 indicating emergency failure of the autoland module 2514. FIG. 55B includes an example screen shot of display screen 2802 indicating normal disengagement of the autoland module 2514. The alert 2816 can be accompanied by text and/or graphics configured to convey an instruction to the user (e.g., instructions for re-engaging the autoland module 2514), as illustrated in FIG. 55A.

In exemplary aspects, display screen 2702, 2802 comprise exemplary display screens of the CDU 2406, the PFD 2402, and the MFD 2404, respectively. However, it is contemplated that any of display screens 2702, 2802, and/or the text and/or graphics generated thereon, can be generated at any of the CDU 2406, the PFD 2402, and/or the MFD 2404. The display screens 2702, 2802 can comprise a single display plane (as described with reference to FIGS. 48A and 48B), a plurality of display panes 2714, 2716 (e.g., as described with reference to FIG. 49A) and/or include one or more display insert panels (e.g., as described with reference to FIG. 49B).

In one or more aspects, the system 2400 can be configured to issue one or more aural communications to the user and/or the air traffic controller. In one or more aspects, the autoland module 2514 can configure an audio system of the aircraft to a predefined configuration. For example, the autoland module 2514 can actuate and/or disable one or more audio system components (e.g., audio sources, radio sources, transponder, speakers, intercom, etc.) to allow automated (e.g., text to speech) communication with the user(s) and/or air traffic control.

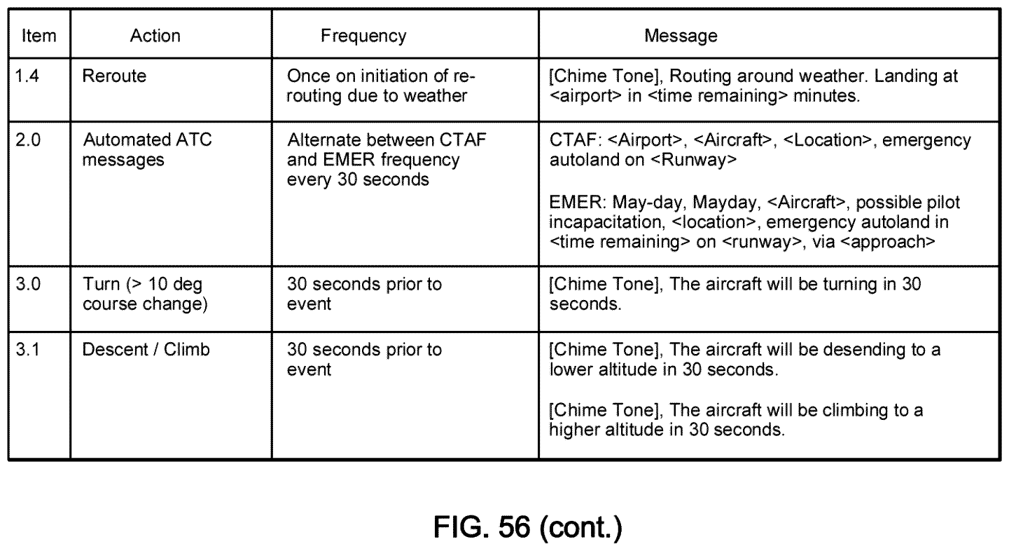

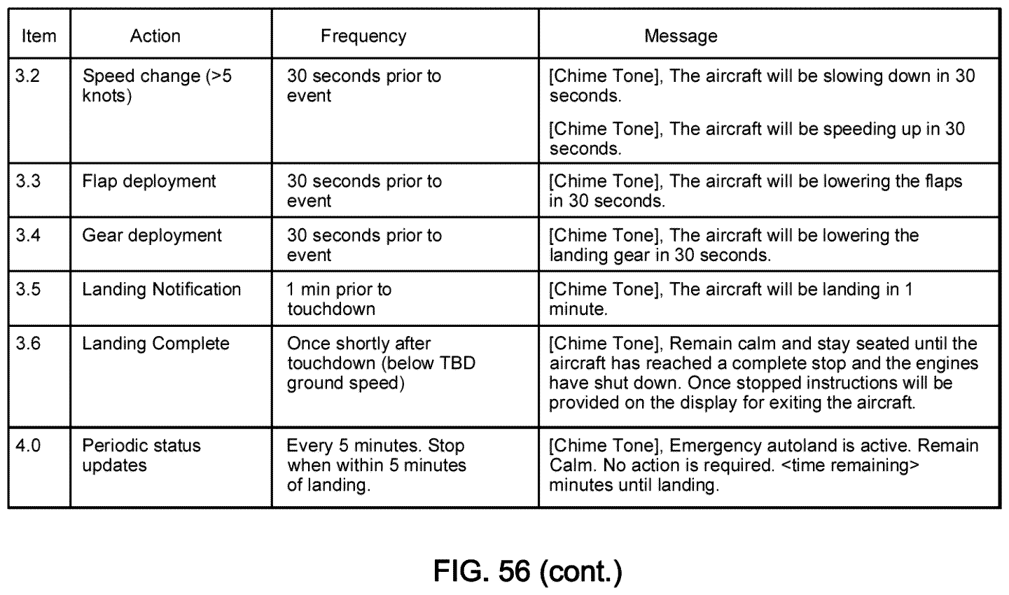

In aspects, the autoland module 2514 can cause the audio system to issue one or more automated aural communications to provide status updates to the user. FIG. 56 illustrates example status updates in accordance with one or more aspects of the present disclosure. The autoland module 2514 can also configure the audio system for automated and/or user-initiated communication with air traffic control.

For example, the autoland module 2514 can select a radio for communication over an emergency frequency. The autoland module 2514 can be configured to cause display (e.g., via one or more of the display screens of the CDU 2406, the PFD 2402, and the MFD 2404, as described above) of the appropriate air traffic control frequency to the user, allowing the user to manually contact and communicate with air traffic control.

In another aspect, if no action is taken by the user, the autoland module 2514 can cause the processor 2502 to automatically tune the radio and broadcast on the universal emergency frequency and/or the local traffic frequency for the FAF. The autoland module 2514 can also be configured to cause display of instructions to the user for disabling the automatic broadcasting to allow for manual communication.

The autoland module 2514 can also disengage one or more audio controls (e.g., bezels, softkeys, audio panel reversion switches, etc.) to enable automated communication. Upon landing, the autoland module 2514 can control the radio to broadcast on one or more appropriate frequencies (tower, approach, center, emergency, etc.) that the aircraft has landed, that the aircraft is on the runway, that the runway is closed, combinations thereof, and the like.

In one or more aspects, the autoland module 2514 can actuate the transponder to alert air traffic control that the aircraft is experiencing an emergency. For example, the autoland module 2514 can adjust the transponder code from a standard code (e.g., 23200) to an emergency code (e.g., 7700, a code specific to autoland use, Automatic Dependent Surveillance Broadcast (ADSB) subfields populated with emergency priority status, etc.).

The transponder can remain on the emergency code for a predetermined time interval (e.g., 15 seconds). During the predetermined time interval, the user can manually change the code. If the user does not manually change the code within the predetermined time interval, the autoland module 2514 can cause the transponder to adjust back to the previously entered code.

If the transponder was previously set to the standard code (e.g., 23200), then the autoland module 2514 can cause the transponder to adjust to the lost communication code (e.g., 7600), following the predetermined time interval, unless the user manually selects a code.

In aspects, the transmission of the emergency code can be manually disabled by a user prior to engaging the autoland module 2514. The user can then manually select the transponder codes as desired.

In some embodiments, the autoland module 2514 can make a satellite connection to allow for communication during an emergency situation. For example, the module 2514 can make a satellite connection with a support center that can communicate with the aircraft cabin. In some situations, the autoland module 2514 can be configured to automatically activate the satellite connection based upon the engagement of the emergency autoland module 2514 and/or detection of an emergency event (e.g., cabin depressurization, loss of altitude, etc.).

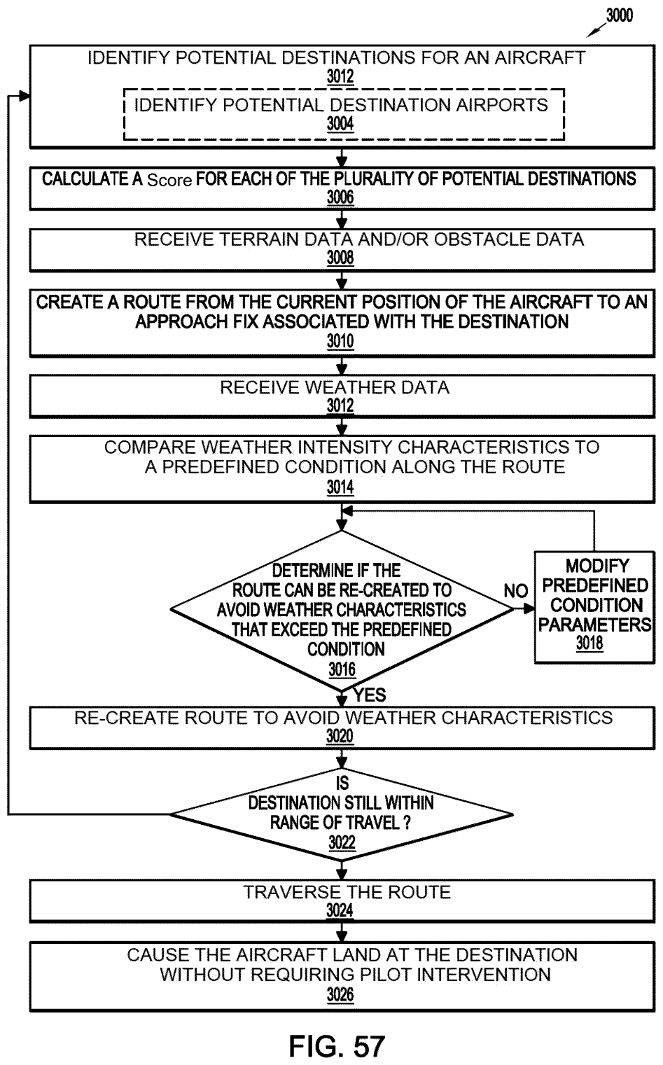

FIG. 57 depicts an example process 25200 for autolanding an aircraft in an emergency situation utilizing an integrated avionics system, such as the integrated avionics system 2400 described above. As shown in FIG. 57, a plurality of potential destinations for an aircraft are identified (Block 3002). In some embodiments, a plurality of potential destination airports are identified (Block 3004).

However, potential destinations can also include an airport location, terrain features (e.g., fields, landing fields, other open areas), bodies of water (e.g., lakes, seaports, etc.), and so forth. In some embodiments, airports within a range of travel of the aircraft are identified based upon a determined endurance of the aircraft.

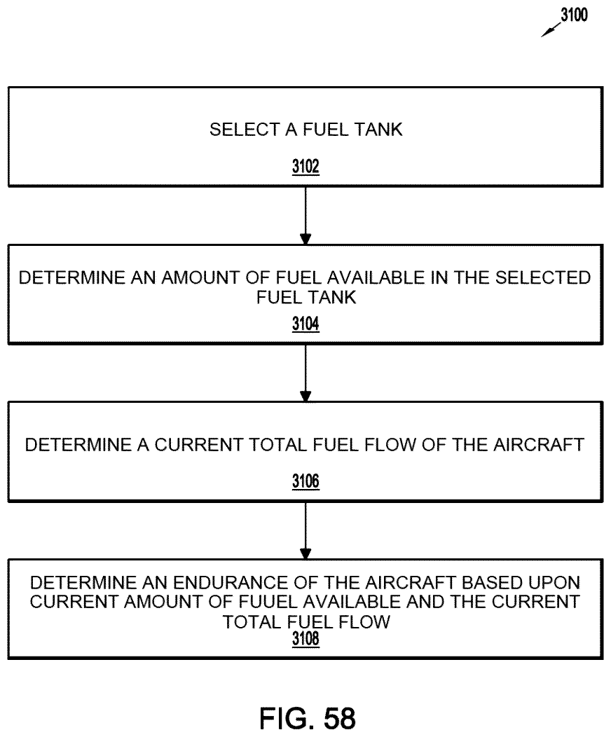

For example, the autoland module 2514 can cause the processor 2502 to execute an endurance process (e.g., as described with reference to FIG. 58) to determine the aircraft's endurance based on usable fuel onboard the aircraft (endurance=current fuel/current total fuel flow).

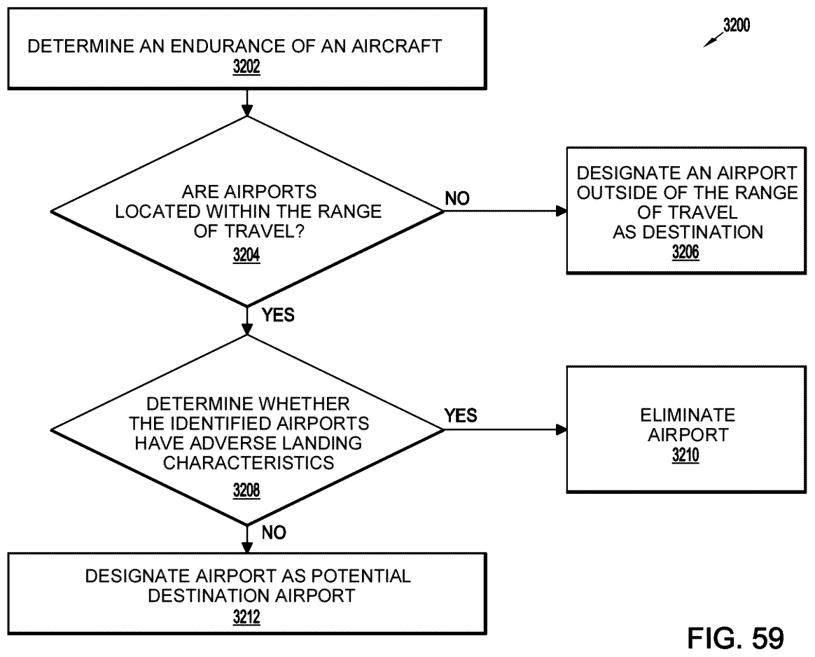

The autoland module 2514 can then use one or more airport selection processes (e.g., as described with reference to FIG. 59) to identify potential airports within the range of travel of the aircraft, as described. For example, the autoland module 2514 can cause the processor 2502 to identify any airports within a preselected distance (e.g., 2400 to 500 miles) from the aircraft.

If there are no potential destinations within the range of travel of the aircraft, the processor 2502 can identify and select potential destinations outside of the range of travel such as the closest potential destination (e.g., the closest airport), the last loaded origin, the last loaded destination, previously available destinations, and so forth.

In some aspects, the autoland module 2514 can cause the processor 2502 to eliminate any airports that are not appropriate candidates for landing based on one or more adverse landing characteristics. Adverse landing characteristics can include, but are not necessarily limited to: airports that do not have at least one hard surface runway, airports that are heliports only, airports that do not have at least one acceptable approach (e.g., GPS approach to a runway with vertical guidance), and so forth.

In some aspects, the system 2400 can also incorporate weather data (e.g., METAR, Terminal Doppler Weather Radar (TDWR), terminal aerodrome forecast (TAF), etc.) received from each airport (or from a nearby airport should weather data not be available) in selecting potential airports.

For example, the autoland module 2514 can receive METAR data from one or more of the components internal to the system 2400 (e.g., AHRS, ADCs, IDUs, other modules, etc.). The autoland module 2514 can cause the processor 2502 to eliminate airports with unfavorable weather conditions.

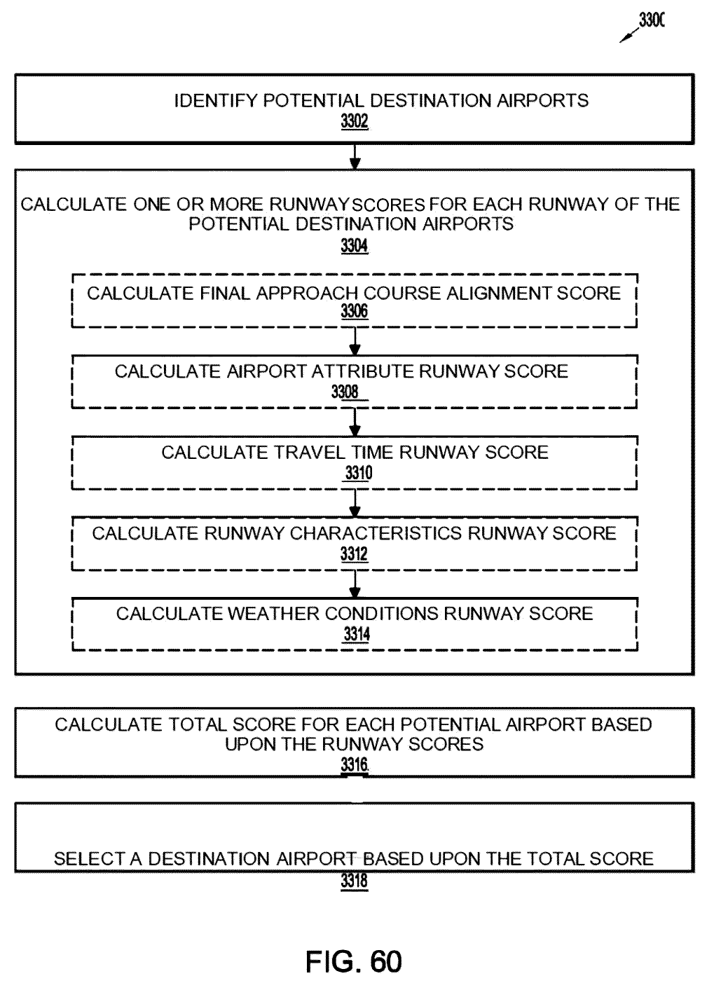

For example, the processor 2502 can treat unfavorable weather conditions as an adverse landing suitability score is calculated for each of the plurality of potential destinations (Block 3006). For example, the autoland module 2514 can cause the processor 2502 to identify a suitability score value for each airport runway using one or more suitability score processes (e.g., as described with reference to FIG. 60).

In some aspects, the processor can identify one or more runway suitability score values for a runway corresponding with each airport. For example, the autoland module 2514 can cause the processor 2502 to calculate one or more suitability scores for each runway based on a variety of runway attributes, as described above.

Runway attributes can include, but are not necessarily limited to: final approach course alignment with the runway, runway characteristics (e.g., runway length, runway width, approach vertical angle (e.g., flight path angle), gradient, etc.), weather conditions (e.g., weather rating (e.g., IFR, VFR), gust, precipitation level, precipitation type, etc.), attributes specific to the airport (e.g., airport with a tower, airports that anchor class B airspace, exclusively military airports, etc.), travel time to airport (e.g., estimated time enroute (ETE)), and so forth.

The autoland module 2514 can cause the processor 2502 to calculate a suitability score value for each attribute. For example, the processor 2502 can assign each attribute a suitability score value in the range of −1.0 to 1.0, with 1.0 representing an ideal runway. Negative suitability score values can be considered to be out of limits.

In some aspects, the processor 2502 can determine a final approach course alignment runway suitability score for a runway corresponding to each potential destination airport. For example, the processor 2502 can calculate the degrees of misalignment of the aircraft with the runway.

In some aspects, the processor 2502 can eliminate runways that exceed a preselected maximum misalignment threshold (e.g., 25 degrees to 35 degrees of misalignment). The processor 2502 can also determine an airport attribute runway suitability score for each potential destination airport.

For example, the processor 2502 can assign a high suitability score value to airports with towers, as the presence of a tower can indicate that the airport has emergency facilities. The processor 2502 can assign low suitability score values to airports that anchor class B airspace and/or exclusively military airports.

The processor 2502 can also determine a travel time runway suitability score for a runway corresponding to each potential destination airport. In example aspects, the processor 2502 can calculate time to runway using groundspeed along a selected path from the wind triangle based on wind speed and/or wind direction.

The processor 2502 can also calculate a runway suitability score based on one or more runway characteristics. For example, the processor 2502 can assign higher suitability score values corresponding to wider and/or longer runways.

The processor 2502 can also calculate a runway suitability score based on the weather conditions at each potential destination airport. For example, the processor 2502 can assign low suitability score values to airports with low visibility, high wind speeds, and so forth. haracteristic and eliminate those airports from the potential airports.

The autoland module 2514 can then determine the total suitability score for each airport. In aspects, the autoland module 2514 can cause the processor 2502 to apply a predetermined weighting factor (K) to each runway suitability score (M) and calculate a weighted runway suitability score (K*M).

The sum of all weighting factors (ΣK) represents the maximum possible suitability score value. The sum of the weighted values (Σ(K*M)) for a runway represents the total suitability score for the runway.

The processor 2502 can also assign penalties to attributes that are out of limits (e.g., the suitability score is negative). For example, the processor can subtract a penalty equal to the maximum possible suitability score value (ΣK) from the overall suitability score of the runway (Σ(K*M)−ΣK).

This ensures that the runway is only selected if there are no available runways where all attributes are within limits. The processor 2502 can then determine which runway has the highest total suitability score (e.g., highest Σ(K*M)).

In some aspects, the autoland module 2514 can incorporate route weather data in determining the total suitability score for each destination. The autoland module 2514 can receive weather data (e.g., weather radar, XM, datalink weather, icing data) and/or forecast data (e.g., Winds and Temperatures Aloft Forecast data, turbulence data, windshear data, NEXRAD data, etc.) from one or more of the components internal to the system 2400.

The autoland module 2514 can cause the processor 2502 to analyze the weather data and/or forecast data for one or more weather intensity characteristics. Weather intensity characteristics can include, but are not necessarily limited to: precipitation level, precipitation type (e.g., rain, snow, sleet, etc.), atmospheric conditions (e.g., wind speed, wind direction, temperature, etc.), storm attributes (e.g., storm top elevation, reflectivity, vertically integrated water, probability of hail, probability of severe hail, maximum hail stone diameter size, speed and/or direction of storm movement, tornadic activity, etc.), weather conditions (e.g., weather severity, visibility, etc.), and so forth.

The autoland module 2514 can cause the processor 2502 to compare the weather intensity characteristics to a predefined condition (e.g., a predefined severity and/or intensity threshold).

For example, the autoland module 2514 can cause the processor 2502 to compare weather severity to predefined weather severity levels (e.g., low, medium, high, etc.), and identify weather severity areas.

If the weather severity of a weather area exceeds one or more of the predefined severity levels, the autoland module 2514 can cause the processor 2502 to adjust the runway suitability score accordingly.

For example, the processor 2502 can create a buffer area around weather areas of predefined severity levels, and downgrade runways that require passing through those areas.

The processor 2502 can downgrade (e.g., assess a penalty) to runways that require a route passing through a preselected radius (e.g., approximately five miles to approximately 15 miles) of a high severity weather area (e.g., areas depicted on a NEXRAD map as red areas).

The processor 2502 can also eliminate (e.g., assign negative M) to runways that require a route passing through a preselected radius (e.g., approximately two miles to approximately four miles) of a high severity weather area (e.g., NEXRAD red areas).

In some aspects, the processor 2502 can increase the minimum distance (e.g., increase the preselected radius) from a high severity weather area (e.g., NEXRAD red areas) based on the size of the area.

The processor 2502 can also be configured to identify gradient changes in weather intensity characteristics. For example, the processor 2502 can identify areas that change from a low severity area to a medium severity area within a specified distance (e.g., approximately one mile) and treat those areas as high severity areas.

If a route cannot be determined through the weather and/or no routes can be determined due to weather (e.g., all routes contain weather that prohibits routing), the processor 2502 can expand the tolerance for the predefined condition (e.g., expand the tolerance for weather severity) until a route can be determined.

In some embodiments, the autoland module 2514 can select a destination based on the total suitability score. For example, the autoland module 2514 can cause the processor 2502 to select the airport with the highest runway total suitability score as the destination airport.

The processor 2502 can determine an approach fix based on the runway with the highest total suitability score. The approach fix can include, but is not necessarily limited to: a final approach fix (FAF), an initial approach fix from a published approach (IAF), a point on a published approach, an arbitrary fix point that the system 2400 selects to enable the aircraft to land on the selected runway (e.g., a visual approach fix, etc.), and so forth.

If the processor 2502 is unable to identify an optimal runway (e.g., a runway with positive total suitability score), the processor 2502 can select the runway with the highest negative suitability score.

In another aspect, the user can manually select a destination airport and/or runway from the potential airports via the touch screen 2510.

In some embodiments, when no destinations are within range of the aircraft (e.g., based on determined aircraft endurance), the module 2514 will assign the highest suitability score to the potential destination with the shortest ETE, ignoring all other suitability scores.

The autoland module 2514 can create a route from the current position of the aircraft to the destination. For example, the autoland module 2514 can cause the processor 2502 to create a route from the current position of the aircraft to the approach fix.

In some embodiments, the processor 2502 can determine a lateral position for the approach fix that reflects the position of an existing published approach fix.

The processor 2502 can execute one or more aircraft route calculation processes to determine a route between the current aircraft position and the approach fix.

In some aspects, the processor 2502 can determine a direct route between the current position and the destination airport. For example, the processor 2502 can create a direct route at the present altitude between the current position and the FAF.

The processor 2502 can then create a hold at the approach fix. For example, the processor 2502 can create a standard (e.g., right turn) or non-standard (e.g., left turn) holding pattern at the FAF (e.g. based on which holding pattern is free of terrain and/or obstacle intrusion), at the FAF altitude, with minimum leg length, where the inbound course of the hold equals the outbound course from the FAF.

In embodiments, the hold pattern can be based on one or more of the speed of the aircraft, the altitude of the aircraft, and/or the course of the aircraft.

For example, a hold pattern can be traversed if one or more of the following conditions are met: 1) a speed of the aircraft is within a defined tolerance relative to the approach speed, 2) the course of the aircraft is within a defined tolerance relative to the FAF (e.g., within a defined tolerance of the FAF to an FAF+1), and 3) the altitude of the aircraft is within a defined tolerance relative to the altitude of the FAF.

The processor 2502 can also create a waypoint associated with the runway (e.g., at the start of the runway) to allow for navigation of the runway (e.g., alignment).

In one or more aspects, the aircraft route calculation process can be performed to determine and/or analyze a route in view of predefined characteristics (e.g., distance, terrain characteristics, obstacle characteristics, weather characteristics, etc.).

In some embodiments, the route can be created based on the approach fix and an FAF. For example, the route can comprise a FAF−1, where the FAF−1 is a distance back from the FAF in the direction of a missed approach point (MAP) to FAF course such that the path is under the glide path.

In some embodiments, the system 2400 can operate on one or more of the processes to remotely activate and/or navigate an aircraft. The module 2514 can be activated from a remote location (e.g., support center) for autopiloting and/or autolanding the aircraft. For example, the module 2514 can be remotely activated to return unmanned aircraft to a base location. Remote activation can also be utilized to control erratic and/or unresponsive aircraft that are unable to engage the module 2514 automatically.

In some embodiments, the system 2400 can operate on one or more of the processes to suggest autopilot modes based on a current flight plan and/or flight characteristics (e.g., altitude of the aircraft, cabin altitude, cabin pressure, airspeed of the aircraft, flight plan, Winds and Temperature Aloft Forecast, time of night, length of flight, terrain height, a navigational input of the aircraft, etc.). The module 2514 can cause the processor 2502 to activate the most suitable autopilot mode based on the flight plan and/or flight characteristics. For example, the module 2514 can activate FLC mode to climb or rejoin a descent path that is below the current altitude.

In some instances, the autoland module 2514 is configured to cause the generation of one or more displays at a display screen, such as the display 2420 of the CDU 2406. FIGS. 48A through 55B illustrate example display screens 2602, 2702, 2802 of the display 2420 of the CDU 2406, the PFD 2402, and/or the MFD 2404. As described above, the autoland module 2514 is configured to cause the display information related to routing the aircraft to the FAF, which is described in greater detail herein.

As shown in FIGS. 48A and 48B, the display screen 2602 can display one or more textual notification banners configured to provide notifications to the user. For example, a first notification banner 2604 can be configured to convey whether or not the autoland module 2514 is active. A second notification banner 2606 can be configured to convey whether or not a user action is required. The display screen 2602 can also display one or more softkeys. For example, the display screen 2602 can display a softkey 2608 for activating a microphone for radio transmission. The display screen 2602 can also display text and/or graphic user instructions for operating the microphone (e.g., volume control, push and hold to talk, etc.), as illustrated in FIG. 48B.

As shown in FIGS. 49A and 49B, the display screen 2702 can display navigation information, which can be retrieved via the integrated avionics systems components, that represent information describing operation of the aircraft (e.g., navigation routes, moving maps, engine gauges, weather radar, ground proximity warning system (GPWS) warnings, traffic collision avoidance system (TCAS) warnings, airport information, and so forth). In aspects, the navigation information can be displayed as one or more maps. In one or more aspects, the navigation information can include a first map 2704 (e.g., map graphic) that is configured to convey the route (e.g., flight plan) of the aircraft to the FAF. For example, the first map 2704 can display a topographical representation of the route the aircraft can traverse to reach the FAF. The first map 2704 can be configured to continually update at predetermined time intervals such that the graphical representation reflects the aircraft's location relative to the FAF. The first map 2704 can be configured to convey landmarks (e.g., state lines, roads/highways, cities, etc.) located on the route. The first map 2704 can also display the route of the aircraft relative to weather radar data WRD1.

The navigation information can also include a second map 2706 (e.g., map graphic) that is configured to convey a map region pertinent to navigation of the aircraft. For example, the second map 2706 can display graphical representations of an area that the aircraft is traversing. The second map 2706 can be configured to continually update at predetermined time intervals such that the graphical representations reflect the area being traversed with respect to movement of the aircraft (i.e., a moving map).

In some embodiments, the maps 2704, 2706 can be displayed on different display panes 2708, 2710, as illustrated in FIG. 49A. In other embodiments one or more of the maps 2704, 2706, can be displayed on a display insert panel, as illustrated in FIG. 49B.

In one or more aspects, the display screen 2702 can display one or more graphic and/or text indicators configured to convey information describing the route and/or operation of the aircraft. Indicators can include, but are not necessarily limited to: airspeed tape 2712, altimeter 2714, horizontal situation indicator 2716, and so forth. The display screen 2702 can also display textual notification banners configured to provide notifications to the user. For example, a first notification banner 2718 can be configured to convey whether or not the autoland module 2514 is active. A second notification banner 2720 can be configured to convey whether or not a user action is required.

As shown in FIGS. 50A through 55B, the display screen 2802 can display graphics and/or text that represent information describing the operation of the aircraft. For example, the text can include status information 2804, which can be retrieved via the integrated avionics systems components, that represent information describing operation of the aircraft (e.g., navigation routes, moving maps, engine gauges, weather radar, ground proximity warning system (GPWS) warnings, traffic collision avoidance system (TCAS) warnings, airport information, and so forth). In one or more aspects, the status information 2804 can include text configured to convey dynamic information about the route of the aircraft, the FAF (e.g., name of airport, location of airport, runway number), and/or the status of the aircraft (e.g., speed, altitude, distance to runway, time to landing, etc.), as illustrated in FIGS. 50A and 50B.

The display screen 2802 can also include text and/or graphics representing dynamic instructions 2806 for the user. For example, the text and/or graphical instructions 2806 can assist the user in communicating with air traffic control (e.g., as described with reference to FIGS. 50A and 50B), exiting the aircraft upon landing (e.g., as described with reference to FIG. 52), fuel management instructions (e.g., as described with reference to FIG. 53), and so forth.

The display screen 2802 can also display one or more textual notification banners configured to provide notifications to the user. For example, a first notification banner 2808 can be configured to convey whether or not the autoland module 2514 is active. A second notification banner 2810 can be configured to convey whether or not a user action is required. A third notification banner 2812 can be configured to convey the next action that the aircraft can take.

In one or more aspects, the dynamic instructions 2806 can represent fuel management instructions. Example fuel management instructions 2814 can include, but are not necessarily limited to: a one-time instruction to set the fuel selector to auto mode, periodic instructions to switch fuel tanks, and so forth. The fuel management instructions 2814 can be accompanied by the second notification banner 2810 configured to convey that fuel management is required. The display screen 2802 can also display graphic and/or text configured to convey the status of the fuel management instruction (e.g., pending, satisfactorily completed, etc.) to the user.

The processor 2502 can also create a waypoint associated with the runway (e.g., at the start of the runway) to allow for navigation of the runway (e.g., alignment). In one or more aspects, the aircraft route calculation process 1600 can be performed to determine and/or analyze a route in view of predefined characteristics (e.g., distance, terrain characteristics, weather characteristics, etc.).

The route to the FAF is loaded to the flight plan (Block 3406). The published MAP to the runway endpoint is then loaded to the flight plan (Block 3408). In embodiments, adjustments can be made to determine if the runway is viable for routing. It is understood that other suitable adjustment procedures can be utilized in accordance with the present disclosure as well.

In some aspects, weather data is received (Block 3410). The weather data can include at least one weather intensity characteristic and the terrain data can include at least one terrain characteristic. For example, the processor 2502 can operate on the aircraft route calculation process to analyze weather data (e.g., weather radar, XM, datalink weather, icing data) and/or forecast data (e.g., Winds and Temperatures Aloft Forecast data, turbulence data, windshear data, NEXRAD data, etc.) for weather intensity characteristics. Weather intensity characteristics can include, but are not necessarily limited to: precipitation level, precipitation type (e.g., rain, snow, sleet, etc.), atmospheric conditions (e.g., wind speed, wind direction, temperature, etc.), storm attributes (e.g., storm top elevation, reflectivity, vertically integrated water, probability of hail, probability of severe hail, maximum hail stone diameter size, speed and/or direction of storm movement, tornadic activity, etc.), and so forth.

In some aspects, the weather intensity characteristic is compared to a predefined condition along the route (Block 3412). For example, the autoland module 2514 can cause the processor 2502 to compare whether intensity characteristics to a predefined severity and/or intensity threshold. In some aspects, the system determines if the route can be re-created to avoid weather characteristics that exceed the predefined condition (Decision Block 3414). If the route cannot be re-created (NO to Decision Block 3414), then the parameters defining the predefined condition are modified until the route can be re-created (Block 3416). For example, the processor 2502 can modify the tolerance for the predefined condition (e.g., expand the tolerance for weather severity) until a route can be determined. If the route can be re-created (YES to Decision Block 3414), then the route is re-created to avoid weather intensity characteristics that exceed the predefined condition (Block 3418). The autoland module 2514 can cause the processor 2502 to create one or more waypoints associated with the weather intensity characteristics. For example, the processor 2502 can create one or more waypoints to avoid severe weather areas and/or predicted severe weather areas, as described above. As the aircraft passes a waypoint, the processor 2502 can operate on the aircraft route calculation process to dynamically analyze weather data and/or forecasting data of the re-created course and create waypoints until no weather intensity characteristics exceeding the predefined condition remain on the route to the FAF. Once the route is re-created, the system 2400 can return to Block 3406 to load the re-created route in order to traverse the re-created route.

The subject matter of the present disclosure can be implemented as a system, method, apparatus, or article of manufacture using standard programming and/or engineering techniques to produce software, firmware, hardware, or any combination thereof. The term “article of manufacture” (or alternatively, “computer program product”) as used herein is intended to encompass a computer program accessible from any computer-readable device or media. For example, computer-readable media can include but are not limited to magnetic storage devices (e.g., hard disk, floppy disk, magnetic strips), optical disks (e.g., CD, DVD), smart cards, and flash memory devices (e.g., card, stick, key drive).

Aspects can be implemented in computer software (e.g., programs and/or other executable instructions), firmware, hardware, and/or any combination thereof. The software can be implemented as part of a computer program product, which can include computer-readable media for carrying or having computer-executable instructions or data structures stored thereon. Such computer-readable media can be any available media that can be accessed by a general purpose or special purpose computer or other machine with a processor.

It should be noted that although certain examples described herein employ an aircraft with a gas turbine engine, the techniques disclosed are applicable to aircraft with other propulsion systems as well, including turboprop, hybrid-electric, and electric propulsion configurations. The system and methods described herein can also be applied to both manned and unmanned aircraft.

Further, while many of the aspects have been described in the context of emergency autoland, the routing logic, threat avoidance, destination selection, and user interface enhancements can be useful in other automated flight control applications, such as route planning, terrain avoidance, or decision aids for situational awareness enhancement during normal operation.

As mentioned above, a hybrid electric aircraft can include at least one turboprop, turbofan, or turboshaft engine having an electric machine. An autoland can optimize way points for both terrain and energy usage for hybrid electric aircraft having at least one turboprop, turbofan, or turboshaft engine having an electric machine, controlling engine thrust, electric machine output, and propeller angle.

Routes for autoland can be analyzed to limit waste and manage an electrical power source (e.g., battery power, fuel cell, etc.), for example, such that sufficient power remains to be used during landing. In various embodiments, power from the electric machine can be prioritized over the turbomachine during landing, providing, for example, additional power, reducing required braking, and reducing noise pollution.

In various aspects of the present disclosure, energy usage can be optimized between the turbomachine and electric machine for cruise, landing, and any go-arounds.

In various aspects of the present disclosure, a plurality of routes can each include a navigation profile and an altitude profile, for which energy usage is analyzed.

In various aspects of the present disclosure, management of passenger comfort can be affected (e.g., avoiding aircraft noise oscillations and avoiding steep descents). As used herein, ‘noise oscillations’ refer to rapid or perceptible variations in acoustic energy output from the aircraft, such as fluctuations in sound pressure levels caused by transitions between propulsion sources, changes in propeller pitch, or abrupt thrust modulations. Reducing such oscillations can improve passenger comfort and reduce environmental noise footprint.

In various aspects of the present disclosure, minimization of maintenance costs can be affected (e.g., minimizing work on wheels brakes due to high-speed landings, etc.).

In various aspects of the present disclosure, an autoland method can accommodate loss of a propulsor in multi-propulsor aircraft. For example, if the electric machine fails on one propulsion system, electric power can be prioritized on the second propulsion system, to conserve fuel for the turbomachine on the first system. Conversely if the turbomachine on the first system fails, the turbomachine can be prioritized on the second system to conserve electric power for the first propulsion system.

In various aspects of the present disclosure, an autoland method can analyze weather and adapt energy usage between a turbomachine and an electric machine (e.g., manage cold effect on electric machine).

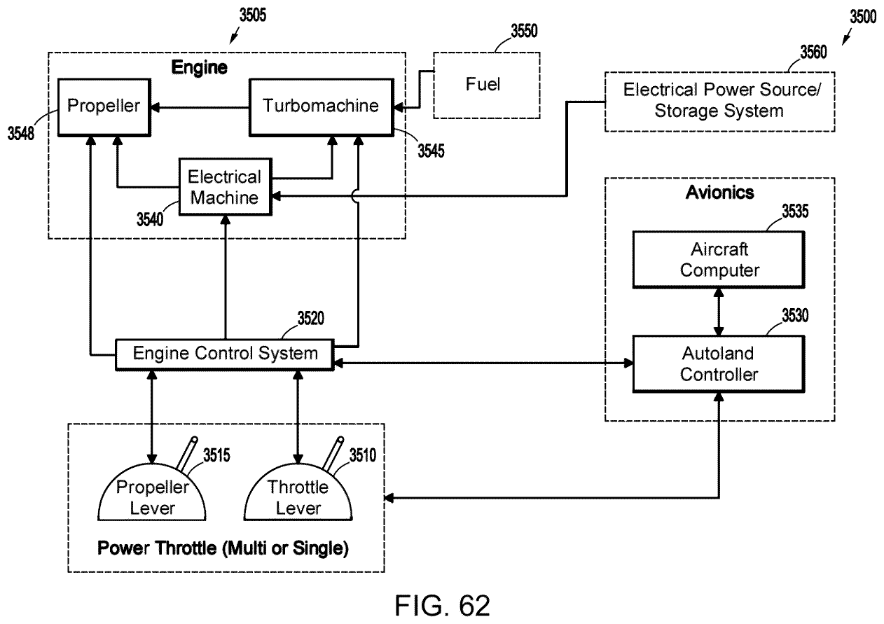

FIG. 62 illustrates an example autoland control for hybrid electric aircraft system 3500 including a gas turbine engine having a turbomachine in accordance with an exemplary aspect of the present disclosure. The turbomachine of hybrid electric aircraft system 3500 is similar to turbomachine 616 detailed above with respect to FIG. 33 such that gas turbine engine of hybrid electric aircraft system 3500 likewise defines a maximum exhaust gas temperature (EGT) in degrees Celsius, a maximum drive turbine shaft torque (TOUT) in Newton meters, a high pressure compressor exit area (AHPCExit) in square inches and a drive turbine exit area (ADTExit) in square inches, and a corrected specific power (CSP) in Newtons squared times degrees Celsius over meters squared.

The corrected specific power of the gas turbine engine is determined as follows:

$${( \frac{{T}_{OUT}}{\sqrt{{A}_{DTExit}}} )}^{2} * \frac{EGT}{{A}_{HPCExit}} * {10}^{- 11} ;$$

wherein CSP is greater than 0.0001194×EGT2−0.103×EGT+22.14 and less than 0.0003294×EGT2−0.3061×EGT+77.91; wherein EGT is greater than 525 degrees Celsius and less than 1250 degrees Celsius; wherein a maximum EGT is greater than 600 degrees Celsius and less than 1000 degrees Celsius, and/or wherein CSP is greater than 3.3 and less than 101.

The system 3500 includes a throttle lever 3510 and a propeller lever 3515, which in some aspects can be collectively a power throttle for a multi or single engine aircraft. The throttle lever 3510 can control thrust to the engine and the propeller lever 3515 can control the pitch of blades 3547 on a propeller 3546. In various aspects, a single lever can control both power/speed and pitch of the propeller.

The system 3500 also includes an engine control system 3520, an autoland controller 3530, an aircraft computer 3535, an electric machine 3540, a turbomachine 3545, the propeller 3546, a fuel control system 3550 and an electrical power source/storage system 3560.

As shown in FIG. 62, the autoland controller 3530 provides control to the engine control system 3520 by receiving input from the power throttle (e.g., throttle lever 3510 and propeller lever 3515), in addition to data received from the aircraft computer 3535, which in various aspects, can include information to aid the autoland controller 3530 to select a thrust mode such as fuel, electrical or a hybrid fuel/electric thrust.

The engine control system 3520 controls the electric machine 3540 and the turbomachine 3545 to provide power to the propeller 3546 (e.g., to rotate the shaft of the propeller 3546 and/or to adjust the pitch of blades 3547 of the propeller 3546). The fuel control system 3550 provides fuel to the turbomachine 3545, while the electrical power source/storage system 3560 provides electrical power/energy to the electric machine 3540.

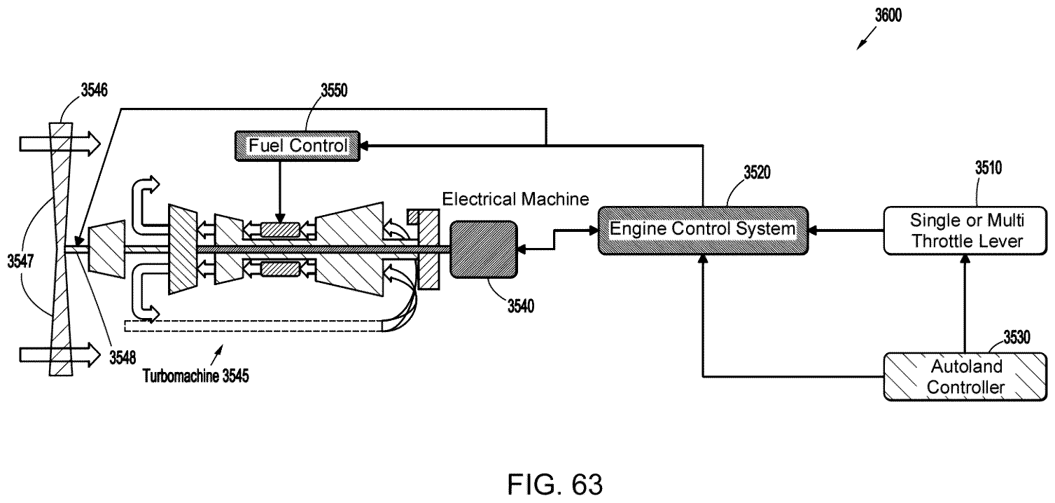

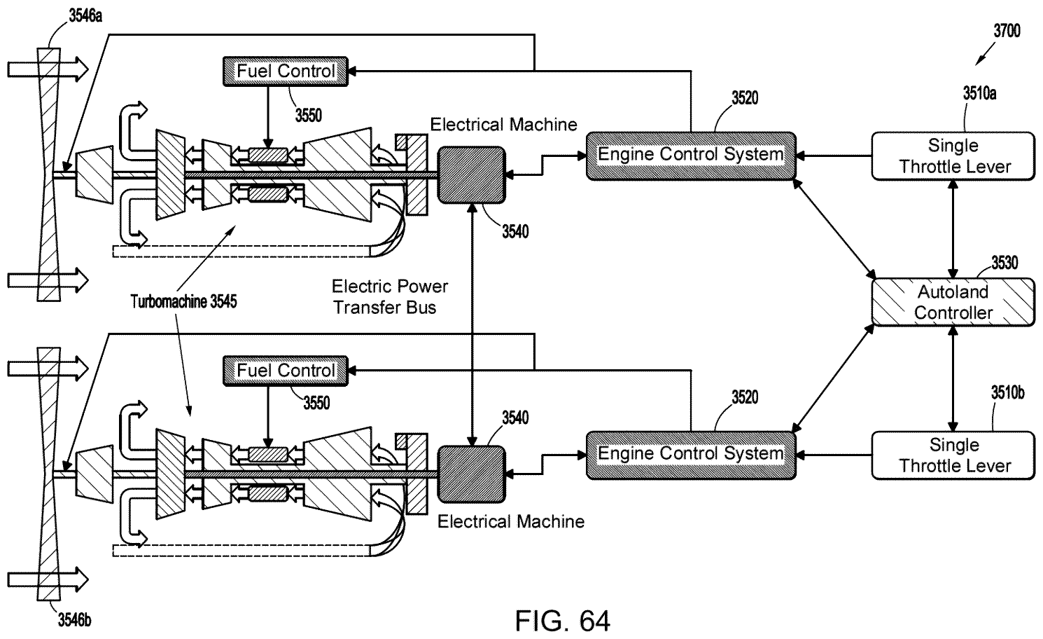

FIG. 63 is a schematic diagram of an example implementation of the autoland controller 3530 for hybrid electric aircraft system 3600 in a single engine aircraft, in accordance with an exemplary aspect. In various aspects, the components shown in FIG. 63 can correspond to the components described above in FIG. 62. The system 3600 includes a turbomachine 3545 and an electric machine 3540 operatively coupled to a common shaft for driving a propeller 3546 (such as propellers 3546a and 3546b seen in FIG. 64), which enables coordinated or independent thrust generation from either the turbomachine 3545 or the electric machine 3540. The turbomachine 3545 receives fuel from a fuel control system 3550, while the electric machine 3540 receives electrical energy from an electrical power source or storage system 3560 (e.g., a battery, APU, or fuel cell). The throttle lever 3510 provides pilot or autopilot input to the engine control system 3520 and the autoland controller 3530. In various aspects, the autoland controller 3530 receives additional data from the aircraft computer 3535, such as navigation data, environmental inputs (e.g., wind or terrain), aircraft configuration, and system health status. Based on these inputs, the autoland controller 3530 selects an energy-optimal thrust mode (fuel-based, electric-based, or hybrid) and sends control signals to the engine control system 3520. The engine control system 3520, in turn, manages actuation of the turbomachine 3545 and electric machine 3540 to produce a targeted propulsive output and, where applicable, modulates the propeller pitch angle to improve aerodynamic performance.

In the aspect shown in FIG. 63, the electric machine 3540 is mechanically coupled to a propeller shaft 3548 and can operate in either a motoring mode (e.g., driving the shaft 3548 to produce thrust) or a regenerative mode (e.g., extracting energy from the shaft 3548—when the shaft 3548 is rotating—to recharge a battery or electrical storage system not explicitly shown), depending on the phase of flight and the logic implemented by the autoland controller 3530. During descent and landing, the autoland controller 3530 can prioritize use of the electric machine 3540 to reduce acoustic signature (e.g., lower noise emissions from propeller and engine operation), decrease braking load (e.g., reduce wear on wheel brakes by using reverse thrust or regenerative drag), or conserve fuel (e.g., minimize turbomachine operation). The autoland controller 3530 is configured to operate autonomously, including selection of targeted descent profiles (e.g., vertical flight path from cruise altitude to landing), adherence to glide slopes (e.g., a defined angular path for approach, such as that provided by an Instrument Landing System), initiation of flare (e.g., raising the aircraft nose just before touchdown to reduce descent rate), and touchdown sequencing (e.g., timing and control adjustments made during the transition from descent to ground roll), all without requiring pilot intervention. The system architecture also supports energy-aware go-around logic, wherein the autoland controller 3530 dynamically allocates propulsion source usage (e.g., toggling between or combining electrical and fuel-based thrust) based on real-time power availability (e.g., battery state-of-charge, fuel reserves) and mission constraints (e.g., terrain avoidance, airspace separation, or runway conditions). In various aspects, the autoland controller 3530 coordinates thrust control with flight control systems (e.g., control surfaces such as ailerons, elevators, and rudder) to maintain a stable and precise trajectory along either predefined or dynamically computed landing paths.

FIG. 64 is a schematic diagram of an example implementation of the autoland controller 3530 for hybrid electric aircraft system 3700 in a multiengine aircraft, in accordance with an exemplary aspect. In various aspects, the components shown in FIG. 64 can correspond to the components described above in FIG. 62.

In the aspect shown in FIG. 64, a first electric machine 3540 is shown as being connected to the shaft driving the propeller 3546A, while a second electric machine 3540 is shown as being connected to the shaft driving the propeller 3546B. Similarly, a first fuel control system 3550 is shown providing fuel to a first engine that provides power to propeller 3546A, while a second fuel control system 3550 is shown providing fuel to a second engine that provides power to propeller 3546B.

In various aspects, a single throttle lever 3510a provides input from a pilot that is communicated to the engine control system 3520 and the autoland controller 3530 to provide thrust by fuel, electric, or a hybrid fuel/electric energy for propeller 3546A, while a second single throttle lever 3510b provides input from a pilot that is communicated to the engine control system 3520 and the autoland controller 3530 to provide thrust by fuel, electric, or a hybrid fuel/electric energy for propeller 3546B.

In various aspects, either single throttle lever 3510a or 3510b can be utilized to provide control for both propellers 3546A and 3546B.

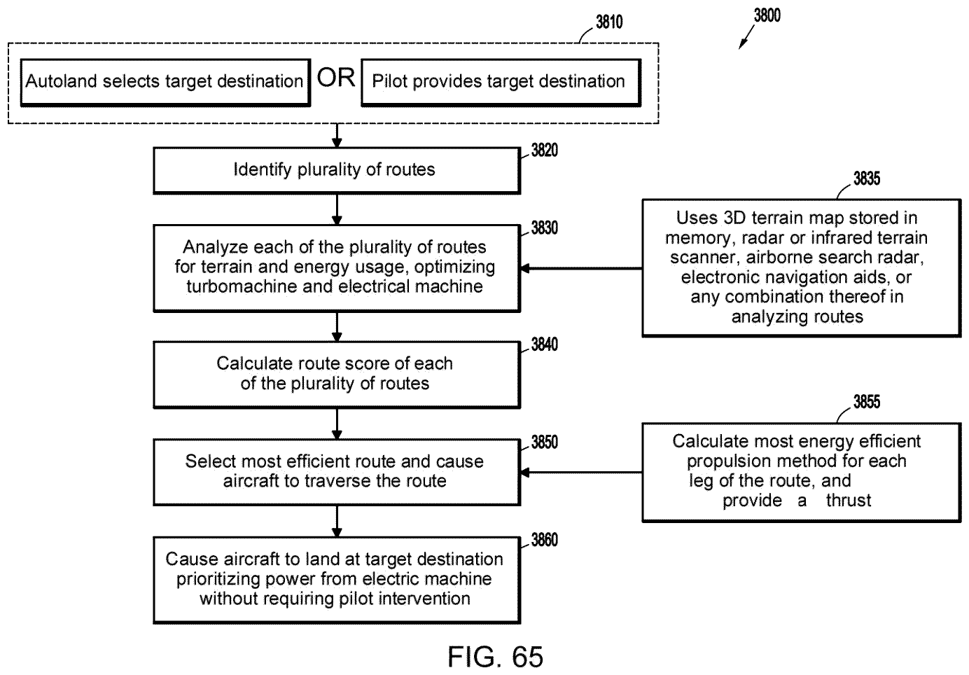

FIG. 65 is a flow diagram of an example method 3800 of autoland control for hybrid electric aircraft system, in accordance with an exemplary aspect.

At block 3810, the autoland controller 3530 selects a target destination or the target destination is provided by the pilot. In various aspects, the target destination can be selected based on factors described above (e.g., routes that limit waste, energy usage, or fuel consumption). For example, if the aircraft experiences a partial propulsion system fault or is operating under constrained battery reserves, the autoland controller 3530 can evaluate multiple viable landing sites within range and select the destination that enables the most energy-efficient descent profile. This could include, for instance, choosing an airport with a lower elevation relative to the aircraft's current position to minimize required engine thrust during descent, or selecting a runway that enables a direct approach aligned with prevailing winds to reduce maneuvering and throttle changes. In some aspects, the controller 3530 can also prioritize destinations equipped with ground charging infrastructure or maintenance facilities, particularly when electrical power reserves are low or a hybrid system fault is detected. These factors can be evaluated individually or in combination as part of the route score determination process described further below.

At block 3820, a plurality of routes is identified. In various aspects, once a target destination is selected, the autoland controller 3530 accesses onboard or external navigation databases (e.g., flight management system (FMS) data, terrain databases, and airway structures) to generate or retrieve multiple candidate routes to the selected destination. These routes can include standard approach procedures (e.g., STARs or published instrument approaches), dynamically computed descent paths, or alternate emergency approaches based on current aircraft state, weather, and terrain. In some aspects, the controller 3530 uses a real-time path-planning algorithm that considers flight constraints such as no-fly zones, terrain clearance, glide slope availability, wind conditions, and aircraft configuration (e.g., weight, remaining battery/fuel, engine status). Each of the plurality of routes can include a navigation profile (e.g., lateral waypoints, headings, turn points) and/or an altitude profile (e.g., top-of-descent point, intermediate descent steps, and minimum safe altitudes), as described above.

At block 3830, each of the plurality of routes is analyzed for terrain and energy usage, optimizing between the turbomachine and electric machine as described above. In various aspects, at block 3835, a three-dimensional (3D) terrain map stored in memory, radar or infrared terrain scanner, airborne search radar, electronic navigation aids or a combination thereof can be used in order to analyze the routes at block 3830.

At block 3840, a route score is calculated for each of the plurality of routes. In various aspects, the route score is a composite evaluation based on multiple factors, each of which can be assigned a relative weight or priority depending on aircraft configuration and mission context. In some aspects, the autoland controller 3530 employs a machine learning model to estimate predicted energy usage and passenger comfort levels for candidate routes. The model can be trained on historical flight data, environmental conditions, aircraft performance logs, or simulated trajectories to improve scoring accuracy and route selection in varying operational contexts.

This written description uses examples to disclose the present disclosure, including the best mode, and also to enable any person skilled in the art to practice the disclosure, including making and using any devices or systems and performing any incorporated methods. The patentable scope of the disclosure is defined by the claims, and can include other examples that occur to those skilled in the art. Such other examples are intended to be within the scope of the claims if they include structural elements that do not differ from the literal language of the claims, or if they include equivalent structural elements with insubstantial differences from the literal languages of the claims.

Factors contributing to the route score can include predicted energy consumption (e.g., estimated battery and/or fuel usage along the route), time required to reach the destination, terrain clearance and avoidance, weather conditions, and proximity to no-fly or restricted zones. The route score can also incorporate criteria related to passenger comfort, which can be inferred from predicted flight characteristics. For example, the autoland controller 3530 can estimate comfort using metrics such as descent rate, the number and severity of turns along the route, anticipated vertical acceleration (e.g., due to turbulence or steep glide angles), or expected in-flight noise levels based on propulsion source and power setting. In some aspects, the controller uses these values to penalize routes that would cause excessive maneuvering, steep descents, or louder engine operation, thereby promoting smoother and quieter approaches. The controller 3530 can access stored models, safety margins, or threshold values to quantify comfort-related effects and incorporate them into the overall route score. In some aspects, the autoland controller 3530 considers a descent to be “steep” if the descent angle exceeds a predefined threshold (e.g., greater than 3 degrees relative to horizontal) or if the rate of descent exceeds a vertical speed threshold (e.g., greater than 1,000 feet per minute during final approach). These values can be configurable based on aircraft type, weight, or mission profile.

Accordingly, at block 3850, the autoland controller 3530 selects the most efficient route to the target destination based on the previously calculated route scores. In this context, efficiency can be defined according to mission priorities, such as minimizing energy consumption, avoiding complex terrain or weather, preserving battery life, or maintaining system redundancy. Once a route is selected, the autoland controller generates and issues a sequence of control commands to the engine control system and other avionics components to initiate traversal of the selected route. This can include adjusting throttle settings, propeller pitch, aircraft attitude, and flight control surface deflections to align with the planned navigation and altitude profiles. In various aspects, the controller 3530 continuously monitors real-time aircraft state data (e.g., position, airspeed, heading, altitude) and updates the control commands to ensure the aircraft remains on the selected path. If deviations occur—such as from wind shear, navigation drift, or unexpected aircraft behavior—the controller 3530 can adjust the flight trajectory dynamically to maintain conformance with the route, or re-evaluate route options if needed.

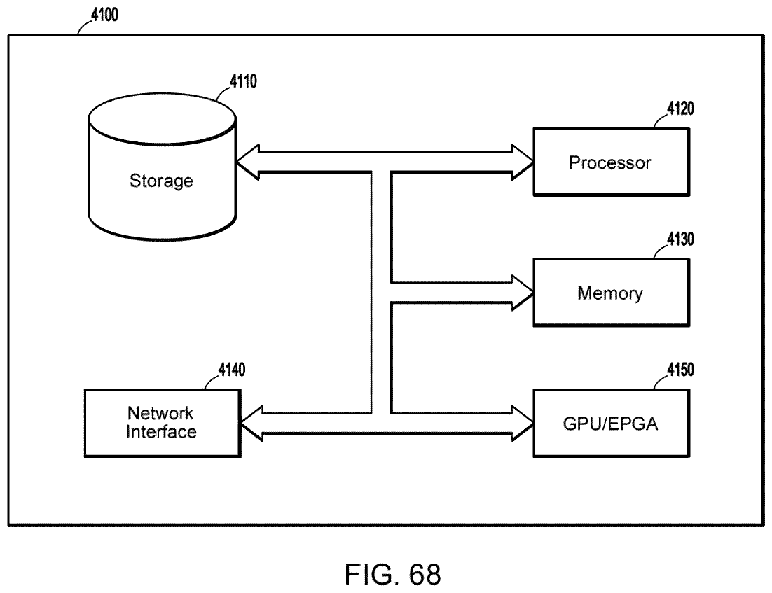

In various aspects, the autoland controller 3530 can incorporate or be operatively coupled to one or more machine learning models to improve or optimize route scoring and selection. For example, historical flight data, sensor data, environmental conditions, and energy usage profiles can be used to train a model (e.g., a neural network, decision tree, or regression ensemble) that predicts a preferred route score for a given set of conditions. These models can be executed by a GPU or FPGA (e.g., device 4100 of FIG. 68), allowing the system to dynamically adjust or weight factors such as comfort, terrain avoidance, or propulsion efficiency in response to mission-specific goals or learned behavior over time. In some aspects, the autoland controller 3530 uses these models to refine or override manually defined scoring logic, enhancing decision-making under complex or uncertain conditions.

At block 3855, in various aspects, the most efficient route can also include a segmented analysis of propulsion requirements for each leg of the route—such as cruise descent, intermediate approach, final approach, and flare. For each segment, the autoland controller 3530 calculates the most energy-efficient propulsion method by comparing predicted fuel burn and electrical power consumption under various configurations (e.g., electrical-only, turbomachine-only, or hybrid operation). The controller 3530 can consider factors such as required thrust level, airspeed, engine thermal efficiency, electrical state-of-charge, and system health status to make this determination. Based on this analysis, the controller selects and configures the propulsion system that delivers the optimal combination of thrust and efficiency for that segment. For instance, the controller can use electrical propulsion for a low-power, noise-sensitive final approach leg, while retaining turbomachine thrust for segments requiring greater climb capability or sustained output. Transitions between propulsion modes can be seamlessly coordinated by the engine control system under command of the autoland controller 3530.

At block 3860, the autoland controller causes the aircraft to land at the target destination, executing the final phase of the selected route without requiring pilot intervention. During this phase, the controller 3530 can prioritize power from the electrical machine 3540 over the turbomachine 3545 for benefits such as noise reduction, lower emissions, or reduced braking demand. For example, the electrical machine 3540 can provide fine-grained thrust control during flare and touchdown, helping achieve smoother landings and reduced runway overrun risk. The autoland controller 3530 also manages associated systems such as flap settings, landing gear deployment, and engine idle transitions to maintain optimal aircraft configuration throughout the landing. In various aspects, the system continuously monitors altitude, descent rate, and ground proximity using radar altimeters, inertial sensors, and navigation systems to control the final descent profile with high precision. Upon touchdown, the system transitions to rollout and post-landing procedures.

Although various blocks of the method 3800 are shown in an order, it should be noted that not all blocks can be implemented and any order can be implemented to the blocks of method 3800.

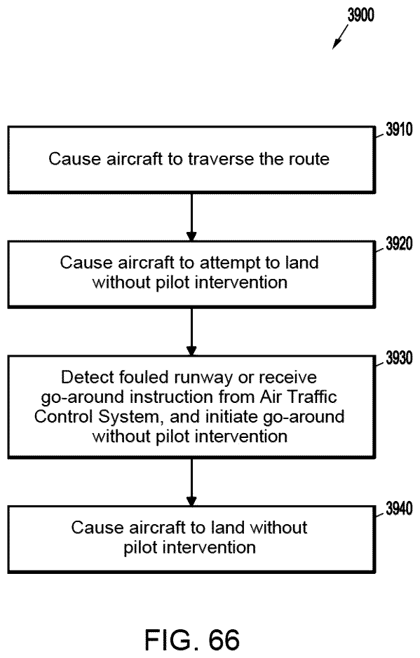

FIG. 66 is a flow diagram of an example method 3900 of autoland control for hybrid electric aircraft system up to and including approach, in accordance with an exemplary aspect. In various aspects, method 3900 represents a more detailed implementation of a portion of the higher-level method 3800 described in FIG. 65—specifically expanding upon operations performed during route traversal and approach, such as those illustrated in blocks 3850 through 3860. While method 3800 provides a generalized overview of route selection and autoland sequencing, method 3900 elaborates on intermediate steps during the descent and approach phases, including configuration changes (e.g., flap settings and landing gear deployment), airspeed management, and automated course corrections during final approach. In this regard, method 3900 serves as an illustrative aspect of the execution logic within the autoland controller 3530 during the final legs of the selected route prior to landing. In some aspects, steps from method 3900 can be integrated directly into or executed concurrently with blocks 3850 through 3860 of method 3800.

At block 3910, the autoland controller 3530 causes the aircraft to traverse the route for landing. In various aspects, this involves commanding the aircraft to follow a predetermined or dynamically generated sequence of navigation waypoints and altitude targets, including approach legs such as initial, intermediate, final, and missed approach segments. These legs can align with published instrument approach procedures (e.g., ILS or RNAV approaches) or be constructed in real time based on aircraft state, terrain, and weather data. As the aircraft progresses along the route, the autoland controller 3530 continuously monitors position, speed, altitude, and heading, making real-time adjustments to throttle, pitch, and flight control surfaces to ensure conformance with the expected flight path. The controller 3530 can also manage transitions between flight phases, such as initiating descent from cruise altitude or leveling off at intermediate altitudes. Additionally, the route can include navigational markers or fixes (e.g., final approach fix (FAF), decision altitude (DA), or minimum descent altitude (MDA)) that define key decision points or configuration changes during approach. In some aspects, the autoland controller 3530 uses this information to coordinate aircraft configuration changes such as extending landing gear, adjusting flap settings, and preparing for flare and touchdown.

At block 3920, the autoland controller 3530 causes the aircraft to attempt to land on the runway without pilot intervention. In various aspects, this includes executing the final approach by keeping the aircraft aligned both vertically and horizontally with the planned landing path. The autoland controller 3530 adjusts the aircraft's airspeed, descent rate, and heading to stay on a defined descent profile—such as a glideslope provided by an Instrument Landing System (ILS) or a GPS-based glidepath—and to remain centered along the runway's extended centerline. This can include using signals from a localizer (a guidance component that emits a radio signal aligned with the centerline of the runway to stay laterally aligned with the runway during approach) or GPS data to ensure the aircraft does not drift left or right during approach. The controller 3530 commands real-time control surface adjustments (e.g., elevators, ailerons, rudder), throttle or electrical output changes, and propeller pitch modifications to maintain this alignment. Concurrently, the controller 3530 configures the aircraft for landing by deploying flaps to increase lift at lower speeds, applying trim adjustments to stabilize pitch, and lowering the landing gear at the appropriate point. These actions are informed by live aircraft state data such as airspeed, altitude, and descent rate, as well as current environmental conditions. In some aspects, the controller 3530 can further adjust its descent and configuration in response to runway surface conditions or atmospheric turbulence to ensure a safe and stable touchdown.

At block 3930, in various aspects, the autoland controller 3530 can detect a fouled runway (e.g., an obstruction, debris, or other aircraft on the landing path) and/or receive go-around instructions from an air traffic controller (ATC) or ATC system. A go-around refers to an aborted landing maneuver in which the aircraft discontinues its descent and initiates a climb to either reattempt the approach or divert to an alternate airport. This procedure can be triggered manually by the pilot or automatically by the autoland controller based on sensor data or received instructions. In response, the autoland controller can initiate a go-around sequence without pilot intervention, including reconfiguring aircraft flaps and gear, adjusting pitch attitude, and commanding increased thrust to achieve climb-out. In various aspects, the autoland controller 3530 can adjust the turbomachine to an idle mode to maintain the go-around airspeed, and/or make adjustments to both the turbomachine 3545 and electric machine 3540 to maintain capability for acceleration for climb out, etc., during the go-around. In various aspects, the controller 3530 can modulate the turbomachine 3545 and/or electric machine 3540 outputs to maintain airspeed and altitude appropriate for the missed approach procedure or alternate routing.

In various aspects, at block 3930, the autoland controller 3530 can initiate missed approach procedures upon the aircraft reaching a missed approach point (MAP) during final approach. The missed approach point is a predefined location—typically associated with an altitude or distance threshold—beyond which the aircraft must not continue descending unless sufficient visual or sensor-based confirmation of a safe landing environment has been made (e.g., the runway is in sight and clear). If, at the MAP, the autoland controller 3530 determines that landing conditions are not satisfactory—due to factors such as a fouled runway, unstable approach, degraded sensor input, or failure to acquire required landing guidance—the system will automatically transition to a missed approach maneuver. This includes commanding an increase in thrust (e.g., turbomachine and/or electrical machine output), adjusting aircraft pitch and climb angle, and reconfiguring the aircraft (e.g., retracting landing gear, adjusting flaps) to initiate a safe climb-out. The autoland controller 3530 can then direct the aircraft to fly a predefined missed approach route, which can be based on published procedures, dynamic terrain avoidance paths, or alternate approach paths. Once safely established on the missed approach path, the controller 3530 can evaluate whether to reattempt landing at the original destination, divert to an alternate airfield, or remain in a holding pattern while awaiting new instructions or improved conditions.

Accordingly, at block 3940, the autoland controller 3530 causes the aircraft to land without pilot intervention. In various aspects, this includes executing the final descent segment by managing pitch, roll, and thrust to precisely follow the vertical and lateral approach profiles down to the runway threshold. As the aircraft nears the runway surface, the controller 3530 initiates the flare maneuver, where the aircraft's nose is gently raised to reduce descent rate and achieve a smooth touchdown. This maneuver is executed based on real-time altitude, descent rate, and airspeed measurements, often using radar or laser altimeters to detect ground proximity. The controller 3530 modulates thrust from the turbomachine 3545 and/or electrical machine 3540 during this phase to maintain the target landing speed and to avoid over- or under-shooting the touchdown zone. Upon runway contact, the controller 3530 can also coordinate additional landing behaviors such as holding elevator position to maintain aerodynamic braking or managing pitch-down for nosewheel touchdown, if applicable. In some aspects, touchdown detection can trigger an automatic transition into rollout control, as described further in method 4000.

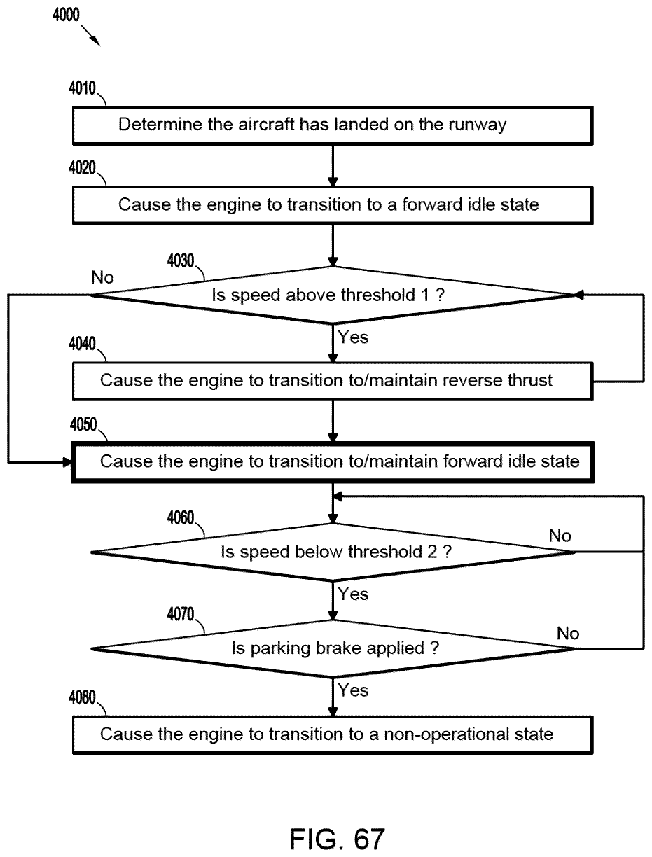

FIG. 67 is a flow diagram of an example method 4000 of autoland control for hybrid electric aircraft after touchdown, in accordance with an exemplary aspect. In various aspects, method 4000 continues from the final phase of method 3900 (FIG. 66), expanding specifically on the actions taken by the autoland controller 3530 once the aircraft has physically contacted the runway. Whereas FIG. 65 provides a high-level overview of route selection and automated landing, and FIG. 66 details approach and descent operations, FIG. 67 focuses on the autonomous rollout and shutdown sequence that follows touchdown. The steps in method 4000 illustrate how the autoland controller 3530 manages aircraft deceleration, transitions between thrust states (e.g., forward idle to reverse thrust), monitors rollout speed, and determines when to shut down the propulsion system after the aircraft has safely come to a stop. This includes decision points based on measured ground speed thresholds and system status indicators, and can also involve integration with aircraft braking systems, taxiing logic, and parking brake sensors. Method 4000 therefore represents the final phase of the fully automated landing cycle and ensures safe completion of the landing process without pilot input.

At block 4010, the autoland controller determines that the aircraft has landed—that is, it has made physical contact with the runway surface and has fully transitioned from flight to ground roll. This determination can be made based on a combination of sensor inputs, including signals from weight-on-wheels (WoW) sensors that detect compression of the landing gear, radar or laser altimeters indicating zero altitude above ground, and a rapid change in vertical acceleration captured by onboard inertial measurement units (IMUs). In some aspects, the controller 3530 can also correlate airspeed decay, sudden reduction in descent rate, or a shift in aerodynamic control authority to confirm touchdown. Once touchdown is verified, at block 4020, the autoland controller 3530 transitions the propulsion system into a forward idle state to allow the aircraft to decelerate along the runway. This throttle adjustment reduces propulsive force while maintaining sufficient engine or motor output to power essential systems such as hydraulics, avionics, or braking support. The “idle state” of the turbomachine, as used herein, refers to a low-thrust operational condition in which fuel flow is maintained at a minimal level sufficient to keep the engine running, but without producing significant forward propulsion. In hybrid aspects, the controller 3530 can choose to idle the turbomachine 3545 while allowing the electrical machine 3540 to provide residual power for taxi or braking support. This forward idle state provides a safe baseline configuration for controlled rollout, reducing speed in preparation for either reverse thrust engagement or taxi phase handover.

At block 4030, the autoland controller 3530 determines if the rollout speed is above a first threshold (e.g., threshold 1) which represents the speed above which active deceleration—such as reverse thrust—can be required to ensure safe stopping within the available runway length. To make this determination, the autoland controller 3530 monitors ground speed data from onboard systems such as the air data computer (ADC), GPS receivers, or wheel speed sensors. In some aspects, the controller 3530 cross-checks these sources for consistency to validate the measured speed. The threshold itself can be fixed (e.g., based on aircraft type and runway length) or dynamically calculated based on real-time conditions such as runway surface friction (e.g., wet vs. dry), wind direction and speed, aircraft weight, or the length of remaining runway. If the measured rollout speed exceeds this threshold, the controller 3530 determines that additional deceleration is needed to reduce the risk of runway overrun or excessive brake wear, and proceeds to engage reverse thrust logic, as described in the following block.

If the rollout speed is above threshold 1 at block 4030, then the autoland controller 3530 causes the engine to transition to reverse thrust (or maintain reverse thrust if already in reverse thrust) as indicated at block 4040. In various aspects, the autoland controller 3530 deploys thrust reversers to initiate/maintain reverse thrust (e.g., altering the pitch of the propellers), which provides additional aerodynamic braking to decelerate the aircraft more rapidly than brakes alone, particularly during high-speed rollout or on slippery runway surfaces.

The method then reverts to block 4030 to monitor whether or not the rollout speed is above threshold 1. If the rollout speed is not above threshold 1, then the autoland controller 3530 causes the engine to transition to the forward idle state if in reverse thrust state as indicated at block 4050, or maintain the forward idle state if not in the reverse thrust state. This loop ensures the controller 3530 maintains continuous evaluation of speed conditions and adjusts engine state in real-time to match the required deceleration strategy.

At block 4060, the autoland controller 3530 determines if the aircraft speed is below a second threshold (e.g., threshold 2), which corresponds to a low-speed condition typically associated with taxiing or near-stop scenarios. If the speed is above threshold 2, then the autoland controller 3530 maintains the forward idle state and continues to monitor the rollout speed with respect to threshold 2.

If, at block 4060, the rollout speed is below threshold 2, then, at block 4070, the autoland controller 3530 determines whether or not the parking brake is applied, which is interpreted as an indication that the aircraft has reached its final stop (e.g., arrived at the gate or designated parking area). If the parking brake is not applied, then the method continues to monitor the speed in comparison to threshold 2 at block 4060, and whether the parking brake has been applied at block 4070. In various aspects, this can allow the autoland controller 3530 to determine whether or not the aircraft has been taxied to a parking area.

In some aspects, the controller 3530 can use machine-learned models trained on landing and rollout behavior to refine or validate threshold decisions or braking control logic.

If, at block 4070, the parking brake is applied (e.g., the aircraft has been parked), then the autoland controller 3530 can cause the engine to transition to a non-operational state at block 4080. The term “non-operational state” refers to a complete shutdown of the turbomachine, including cessation of fuel delivery, rotor spin-down, and disabling of associated mechanical subsystems (e.g., compressors, turbines), while optionally allowing electrical systems to remain powered by an auxiliary power unit (APU) or battery backup. In various aspects, this can include turning the turbomachine 3545 off, disabling fuel flow, and/or powering down associated subsystems, while allowing electrical systems to remain active via the electrical power source or auxiliary power unit (APU), if necessary.

Accordingly, method 4000, in various aspects, provides for the autoland controller 3530 to autonomously manage post-touchdown propulsion states: transitioning from forward to reverse thrust to aid in deceleration, reverting to forward idle once safe rollout speed is achieved to maintain necessary onboard power, and finally shutting down the engine once the aircraft has stopped and is secured with the parking brake applied. This sequence enables fully automated rollout and post-landing control without pilot input.

Although various blocks of methods 3900 and 4000 are shown in an order, it should be noted that not all blocks are implemented and any order can be implemented to the blocks of methods 3900 and/or 4000.

FIG. 68 is a block diagram of a device 4100 of the system of FIG. 62, in accordance with one aspect. In various aspects, device 4100 can be implemented in the engine control system 3520 and/or the autoland controller 3530 of FIG. 62. Referring now to FIG. 68, exemplary components in the device 4100 in accordance with aspects of the present disclosure include, for example, a database 4110, one or more processors 4120, at least one memory 4130, and a network interface 4140. In aspects, the device 4100 can include a graphical processing unit (GPU) 4150, which can be used for processing machine learning network models. Various components of device 4100 can be utilized to carry out instructions to perform the operations described in blocks 3810-3860 of FIG. 65, blocks 3910-3940 of FIG. 66, and/or blocks 4010-4080 of FIG. 67.

Database 4110 can be located in storage. The term “storage” can refer to any device or material from which information can be capable of being accessed, reproduced, and/or held in an electromagnetic or optical form for access by a computer processor. Storage can be, for example, volatile memory such as RAM, non-volatile memory, which permanently holds digital data until purposely erased, such as flash memory, magnetic devices such as hard disk drives, and optical media such as a CD, DVD, Blu-ray Disc™, or the like.

In various aspects, data can be stored on device 4100, including, for example, user preferences, historical data, and/or other data. The data can be stored in database 4110 and sent via the system bus to processor 4120.

As described above, processor 4120 can execute various processes based on instructions that can be stored in the server memory 4130 and utilizing the data from database 4110. The illustration of FIG. 68 is exemplary, and persons skilled in the art will be understood by other components that can exist in the device 4100. Such other components are not illustrated in FIG. 68 for clarity of illustration.

Accordingly, described above in various aspects is an autoland method that optimizes way points for both terrain and energy usage for hybrid electric aircraft having at least one turboprop or turboshaft engine having an electric machine, controlling engine thrust, electric machine output, and propeller angle.

In various aspects, routes are analyzed to limit waste and manage battery power, (e.g., such that sufficient power remains to be used during landing). Power from an electric machine can be prioritized over a turbomachine during landing, providing additional power, reducing required braking, and reducing noise pollution.

In various aspects, energy usage is optimized between the turbomachine and electric machine for cruise, landing, and any go-arounds.

The technical challenge addressed by the present disclosure lies in the need to dynamically and efficiently manage multiple propulsion sources (specifically a turbomachine and an electric machine) across varying flight phases, while ensuring the reliability, safety, and autonomy required for an automated landing. Traditional autoland systems are typically optimized for single-mode propulsion architectures and do not account for the energy trade-offs or mission constraints unique to hybrid-electric configurations.

The disclosed system provides a technological solution by integrating real-time route evaluation, adaptive propulsion control, and automated descent and landing logic that optimizes energy usage across both propulsion sources. This enables the aircraft to conserve critical resources (e.g., battery power or fuel), reduce noise and emissions during sensitive phases like landing, and maintain thrust continuity even in the event of partial propulsion system failure.

The result is a more efficient, resilient, and environmentally responsive autoland capability tailored to the operational characteristics of hybrid electric aircraft.

Unless otherwise indicated, references to a “controller” or “control system” as used herein include hardware, software, or firmware modules operable to perform the functions described.

As used herein, regulation of “performance” of the gas turbine engine can include, without limitation, regulation of thrust output, fuel consumption, energy efficiency, propulsive energy source selection, engine temperature management, response to commanded flight profiles, and engine operational states during different phases of flight.

In various aspects, the controller is configured to monitor or predict flight profile conditions, including climb, cruise, descent, approach, landing, and go-around phases, and autonomously adjust engine operating parameters in response.

As used herein, “autonomously” refers to the ability of the controller to regulate engine performance without requiring active pilot commands during the regulation event, based on sensed parameters, predefined operational targets, or preprogrammed logic.

In various aspects, the controller can autonomously regulate engine performance without requiring pilot input, based on sensed conditions, commanded thrust levels, energy optimization targets, or predefined operational profiles.

As used herein, the term “controller” can refer to a standalone unit or a combination of modules such as an autoland controller, engine controller, or energy management controller, operable to regulate thrust output, energy source allocation, and operational phase transitions. Regulation of performance includes, without limitation, selection of propulsive sources, adjustment of thrust levels, energy optimization, temperature control, and compliance with commanded or predicted flight profiles, including climb, cruise, descent, approach, landing, go-around, and taxi phases. References to an “energy efficiency target” include minimizing energy consumption, optimizing energy source usage, or prioritizing energy conservation during different phases of flight.

In various aspects, the controller can be physically coupled to the gas turbine engine, operatively interfaced with engine components, and/or integrated as part of the engine assembly itself. Coupling or integration can include mechanical mounting to the engine structure, electrical connection to engine sensors and actuators, or housing of controller modules within an engine-mounted control unit. Integration of the controller with the engine can facilitate real-time regulation of engine parameters, reduce communication latency, enhance reliability, and support autonomous operation across various phases of flight as described herein.

Further aspects are provided by the subject matter of the following clauses:

A gas turbine engine comprising: a turbomachine comprising a compressor section, a combustion section, and a turbine section arranged in serial flow order, the compressor section having a high pressure compressor defining a high pressure compressor exit area (A_{HPCExit}) in square inches; wherein the gas turbine engine defines a maximum exhaust gas temperature (EGT) in degrees Celsius, a total sea level static thrust output (Fn_{Total}) in pounds, and a corrected specific thrust, wherein the corrected specific thrust is greater than or equal to 42 and less than or equal to 90, the corrected specific determined as follows: Fn_{Total}λEGT/(A_{HPCExit}²×1000).

The gas turbine engine of the preceding clauses wherein the corrected specific thrust is from 42 to 90, such as from 45 to 80, such as from 50 to 80.

The gas turbine engine of the preceding clauses, wherein the EGT is greater than 1000 degrees Celsius and less than 1300 degrees Celsius.

The gas turbine engine of any preceding clause, wherein the EGT is greater than 1100 degree Celsius and less than 1250 degrees Celsius.

The gas turbine engine of any preceding clause, wherein the EGT is greater than 1150 degree Celsius and less than 1250 degrees Celsius.

The gas turbine engine of any preceding clause, wherein the EGT is greater than 1000 degree Celsius and less than 1300 degrees Celsius, and wherein the corrected specific thrust is greater than or equal to 45.

The gas turbine engine of any preceding clause, wherein the EGT is greater than 1000 degree Celsius and less than 1300 degrees Celsius, and wherein the corrected specific thrust is greater than or equal to 50.

The gas turbine engine of any preceding clause, wherein the turbine section comprises a high pressure turbine having a first stage of high pressure turbine rotor blades, and wherein the gas turbine engine further comprises: a cooled cooling air system in fluid communication with the first stage of high pressure turbine rotor blades.

The gas turbine engine of one or more of the preceding clause, wherein the cooled cooling air system is further in fluid communication with the high pressure compressor for receiving an airflow from the high pressure compressor, and wherein the cooled cooling air system further comprises a heat exchanger in thermal communication with the airflow for cooling the airflow.

The gas turbine engine of any preceding clause, wherein when the gas turbine engine is operated at a takeoff power level, the cooled cooling air system is configured to provide a temperature reduction of a cooling airflow equal to at least 15% of the EGT and up to 45% of the EGT.

The gas turbine engine of any preceding clause, wherein when the gas turbine engine is operated at a takeoff power level, the cooled cooling air system is configured to receive between 2.5% and 35% of an airflow through a working gas flowpath of the turbomachine at an inlet to a compressor of the compressor section.

The gas turbine engine of any preceding clause, further comprising a primary fan driven by the turbomachine.

The gas turbine engine of any preceding clause, further comprising an inlet duct downstream of the primary fan and upstream of the compressor section of the turbomachine; and a secondary fan located within the inlet duct.

The gas turbine engine of any preceding clause, wherein the gas turbine engine defines a bypass passage over the turbomachine, and wherein the gas turbine engine defines a third stream extending from a location downstream of the secondary fan to the bypass passage.

The gas turbine engine of any preceding clause, wherein the secondary fan is a single stage secondary fan.

A method of operating a gas turbine engine, comprising: operating the gas turbine engine at a takeoff power level, the gas turbine engine having a turbomachine with a high pressure compressor defining a high pressure compressor exit area (A_{HPCExit}) in square inches, the gas turbine engine defining a maximum exhaust gas temperature (EGT) in degrees Celsius, a total sea level static thrust output (Fn_{Total}) in pounds, and a corrected specific thrust; wherein the corrected specific thrust is greater than or equal to 42 and less than or equal to 90, the corrected specific thrust determined as follows: Fn_{Total}×EGT/(A_{HPCExit} 2×1000).

The method of any preceding clause, wherein the EGT defined by the gas turbine engine is greater than 1000 degree Celsius and less than 1300 degrees Celsius.

The method of any preceding clause, wherein the EGT defined by the gas turbine engine is greater than 1100 degree Celsius and less than 1300 degrees Celsius.

The method of any preceding clause, wherein the EGT defined by the gas turbine engine is greater than 1000 degree Celsius and less than 1300 degrees Celsius, and wherein the corrected specific thrust defined by the gas turbine engine is greater than or equal to 45.

The method of any preceding clause, wherein operating the gas turbine engine at the takeoff power level further comprises reducing a temperature of a cooling airflow provided to a high pressure turbine of the gas turbine engine with a cooled cooling air system.

The method of any preceding clause, wherein reducing the temperature of the cooling airflow provided to the high pressure turbine of the gas turbine engine with the cooled cooling air system comprises providing a temperature reduction of the cooling airflow equal to at least 15% of the EGT and up to 45% of the EGT.

The gas turbine engine of any preceding clause, wherein the cooled cooling air systems includes a thermal bus cooled cooling air system (see, e.g., FIGS. 4 and 5).

The gas turbine engine of any preceding clause, wherein the cooled cooling air systems includes a dedicated heat exchanger cooled cooling air system (i.e., a cooled cooling air system including a heat exchanger dedicated to the cooled cooling air system).

The gas turbine engine of any preceding clause, wherein the cooled cooling air systems includes a bypass heat exchanger cooled cooling air system having a heat sink heat exchanger thermally coupled to an airflow through a bypass passage (see, e.g., FIG. 9).

The gas turbine engine of any preceding clause, wherein the cooled cooling air systems includes an air-to-air cooled cooling air system (a cooled cooling air system having a heat sink heat exchanger configured to transfer heat to an airflow; see, e.g., FIG. 9).

The gas turbine engine of any preceding clause, wherein the cooled cooling air systems includes an oil-to-air cooled cooling air system (a cooled cooling air system having a heat sink heat exchanger configured to transfer heat to an oil flow).

The gas turbine engine of any preceding clause, wherein the cooled cooling air systems includes a fuel-to-air cooled cooling air system (a cooled cooling air system having a heat sink heat exchanger configured to transfer heat to a fuel flow, such as a Jet A fuel flow, a liquid hydrogen or hydrogen gas fuel flow, etc.; see, e.g., FIG. 4) or a combination thereof.

The gas turbine engine of any preceding clause, wherein the cooled cooling air systems is configured to receive the cooling air from a downstream end of a high pressure compressor.

The gas turbine engine of any preceding clause, wherein the cooled cooling air systems is configured to receive the cooling air from an upstream end of the high pressure compressor.

The gas turbine engine of any preceding clause, wherein the cooled cooling air systems is configured to receive the cooling air from a downstream end of a low pressure compressor.

The gas turbine engine of any preceding clause, wherein the cooled cooling air systems is configured to receive the cooling air from an upstream end of the low pressure compressor.

The gas turbine engine of any preceding clause, wherein the cooled cooling air systems is configured to receive the cooling air from a location between compressors.

The gas turbine engine of any preceding clause, wherein the cooled cooling air systems is configured to receive the cooling air from a bypass passage.

A gas turbine engine comprising: a turbomachine comprising a compressor section, a combustion section, and a turbine section arranged in serial flow order, the compressor section having a high pressure compressor defining a high pressure compressor exit area (A_{HPCExit}) in square inches and the turbine section having a drive turbine defining a drive turbine exit area (A_{DTExit}) in square inches, the turbomachine further comprising a drive turbine shaft coupled to the drive turbine; wherein the gas turbine engine defines a maximum exhaust gas temperature (EGT) in degrees Celsius, a maximum drive turbine shaft torque (T_{OUT}) in Newton meters, and a corrected specific power (CSP) in Newtons squared times degrees Celsius over meters squared, wherein the corrected specific power is determined as follows:

$${( \frac{{T}_{OUT}}{\sqrt{{A}_{DTExit}}} )}^{2} * \frac{EGT}{{A}_{HPCExit}} * {10}^{- 11} ;$$

wherein CSP is greater than 0.0001194×EGT²−0.103×EGT+22.14 and less than 0.0003294×EGT²−0.3061×EGT+77.91; and wherein EGT is greater than 525 degrees Celsius and less than 1250 degrees Celsius.

The gas turbine engine of any preceding clause, wherein CSP is less than 210 and greater than 1.

The gas turbine engine of any preceding clause, wherein the EGT is greater than 750 degree Celsius and less than 1100 degrees Celsius, and wherein CSP is less than 140 and greater than 12.1.

The gas turbine engine of any preceding clause, wherein the T_{OUT} is greater than 530 Newton-meters and less than 4740 Newton-meters.

The gas turbine engine of any preceding clause, further comprising: an intercooler assembly comprising a heat exchanger, the heat exchanger in thermal communication with the compressor section.

The gas turbine engine of any preceding clause, wherein the compressor section defines in part a working gas flowpath through the turbomachine, and wherein heat exchanger is in direct thermal communication with the working gas flowpath through the compressor section.

The gas turbine engine of any preceding clause, wherein the compressor section defines in part a working gas flowpath through the turbomachine, wherein the compressor section comprises a first compressor and a second compressor, and wherein the heat exchanger is in thermal communication with the working gas flowpath through the compressor section at a location between the first compressor and the second compressor.

The gas turbine engine of any preceding clause, wherein the compressor section defines in part a working gas flowpath through the turbomachine, wherein the compressor section comprises a compressor defining an upstream end and a downstream end, and wherein the heat exchanger is in thermal communication with the working gas flowpath through the compressor at a location between the upstream end and the downstream end of the compressor.

The gas turbine engine of any preceding clause, wherein the heat exchanger is located externally of the turbomachine.

The gas turbine engine of any preceding clause, further comprising a fuel system configured as a liquid hydrogen fuel system, and wherein the heat exchanger is in thermal communication with the liquid hydrogen fuel system.

The gas turbine engine of any preceding clause, wherein the compressor section comprises a first compressor, and wherein the first compressor is configured as an axial compressor, a centrifugal compressor, or an axial-centrifugal compressor.

The gas turbine engine of any preceding clause, wherein the compressor section further comprises a second compressor, and wherein the second compressor is configured as an axial compressor, a centrifugal compressor, or an axial-centrifugal compressor.

The gas turbine engine of any preceding clause, wherein the turbine section comprises a high pressure turbine having a first stage of high pressure turbine rotor blades, and wherein the gas turbine engine further comprises: a cooled cooling air system in fluid communication with the first stage of high pressure turbine rotor blades.

The gas turbine engine of any preceding clause, wherein the cooled cooling air system is further in fluid communication with the high pressure compressor for receiving an airflow from the high pressure compressor, and wherein the cooled cooling air system further comprises a heat exchanger in thermal communication with the airflow for cooling the airflow.

The gas turbine engine of any preceding clause, wherein when the gas turbine engine is operated at a takeoff power level, the cooled cooling air system is configured to provide a temperature reduction of a cooling airflow equal to at least 15% of the EGT and up to 45% of the EGT.

The gas turbine engine of any preceding clause, wherein when the gas turbine engine is operated at a takeoff power level, the cooled cooling air system is configured to receive between 2.5% and 35% of an airflow through a working gas flowpath of the turbomachine at an inlet to a compressor of the compressor section.

The gas turbine engine of any preceding clause, wherein the gas turbine engine is a turboprop engine further comprising: a propeller assembly, wherein the propeller assembly comprises a propeller driven by the drive turbine shaft.

The gas turbine engine of any preceding clause, further comprising: a power gearbox, wherein the drive turbine shaft is driven by the turbomachine across the power gearbox.

The gas turbine engine of any preceding clause, wherein the gas turbine engine is a turboshaft engine.

A gas turbine engine comprising: a turbomachine comprising a compressor section, a combustion section, and a turbine section arranged in serial flow order, the compressor section having a high pressure compressor defining a high pressure compressor exit area (A_{HPCExit}) in square inches and the turbine section having a drive turbine defining a drive turbine exit area (A_{DTExit}) in square inches, the turbomachine further comprising a drive turbine shaft coupled to the drive turbine and defining an overall pressure ratio greater than 14:1 and less than or equal to 22:1; and wherein the gas turbine engine defines a maximum exhaust gas temperature (EGT) greater than 600 degrees Celsius and less than 1000 degrees Celsius, an output power of at least 550 horsepower and up to 2,000 horsepower when operated at a rated speed, a maximum drive turbine shaft torque (T_{OUT}) in Newton meters, and a corrected specific power (CSP) in Newtons squared times degrees Celsius over meters squared, wherein CSP is greater than 3.3 and less than 101 and is determined as follows:

$${( \frac{{T}_{OUT}}{\sqrt{{A}_{DTExit}}} )}^{2} * \frac{EGT}{{A}_{HPCExit}} * {10}^{- 11} .$$

The gas turbine engine of any preceding clause, wherein the turbomachine defines an overall pressure ratio greater than 15:1 and less than or equal to 20:1.

The gas turbine engine of any preceding clause, wherein the turbomachine comprises a stage of variable inlet guide vanes upstream of the compressor section and a stage of variable stator vanes within the compressor section.

The gas turbine engine of any preceding clause, wherein the turbine section further comprises a high pressure turbine having a first stage of high pressure turbine rotor blades and a second stage of high pressure turbine rotor blades, wherein the first and second stages of high pressure turbine rotor blades each include air cooled high pressure turbine rotor blades.

The gas turbine engine of any preceding clause, wherein the drive turbine is a low pressure turbine comprising three stages of low pressure turbine rotor blades.

The gas turbine engine of any preceding clause, wherein the compressor section includes an airflow of less than 10.5 pounds per second therethrough when the gas turbine engine is operated at a takeoff power level.

The gas turbine engine of any preceding clause, wherein the gas turbine engine defines a maximum exhaust gas temperature (EGT) greater than 700 degrees Celsius and less than 900 degrees Celsius, and wherein CSP is greater than or equal to 4 and less than or equal to 69.

A method of operating a gas turbine engine, comprising: operating the gas turbine engine at a takeoff power level, wherein operating the gas turbine engine at the takeoff power level comprises driving a propeller of a propeller assembly across a propeller shaft of the propeller assembly, the gas turbine engine further comprising a turbomachine with a high pressure compressor defining a high pressure compressor exit area (A_{HPCExit}) in square inches and a drive turbine defining a drive turbine exit area (A_{DTExit}) in square inches, the gas turbine engine defining a maximum exhaust gas temperature (EGT) in degrees Celsius, a maximum drive turbine shaft torque (T_{OUT}) in Newton meters, and a corrected specific power in Newtons squared times degrees Celsius over meters squared; wherein the corrected specific power (CSP) is determined as follows:

$${( \frac{{T}_{OUT}}{\sqrt{{A}_{DTExit}}} )}^{2} * \frac{EGT}{{A}_{HPCExit}} * {10}^{- 11} ;$$

wherein CSP is greater than 0.0001194×EGT²−0.103×EGT+22.14 and less than 0.0003294×EGT²−0.3061×EGT+77.91; and wherein EGT is greater than 525 degrees Celsius and less than 1250 degrees Celsius.

A gas turbine engine comprises a turbomachine. The turbomachine comprises a compressor section, a combustion section, and a turbine section arranged in serial flow order. The compressor section has a high pressure compressor defining a high pressure compressor exit area (A_{HPCExit}) in square inches and the turbine section has a drive turbine defining a drive turbine exit area (A_{DTExit}) in square inches. The turbomachine further comprises a drive turbine shaft coupled to the drive turbine. The gas turbine engine defines a maximum exhaust gas temperature (EGT) in degrees Celsius, a maximum drive turbine shaft torque (T_{OUT}) in Newton meters, and a corrected specific power (CSP) in Newtons squared times degrees Celsius over meters squared. The corrected specific power is determined as follows:

$${( \frac{{T}_{OUT}}{\sqrt{{A}_{DTExit}}} )}^{2} * \frac{EGT}{{A}_{HPCExit}} * {10}^{- 11} ;$$

wherein CSP is greater than 0.0001194×EGT²−0.103×EGT+22.14 and less than 0.0003294×EGT²−0.3061×EGT+77.91; and wherein EGT is greater than 525 degrees Celsius and less than 1250 degrees Celsius. The gas turbine engine includes a controller configured to autonomously regulate performance of the gas turbine engine in response to at least one of: a thrust demand, an energy efficiency target, or a flight profile condition.

The gas turbine engine system according to the preceding clause, wherein the controller is configured to regulate a fuel flow rate supplied to the turbomachine based on the thrust demand.

The gas turbine engine according to any preceding clause, wherein the controller is configured to determine a thrust error between an actual thrust and a desired thrust, and to convert the thrust error into a commanded change in power.

The gas turbine engine according to any preceding clause, wherein the controller is configured to determine a thrust error between a desired thrust and an actual thrust, and adjust a commanded power output of the turbomachine based on the thrust error.

The gas turbine engine according to any preceding clause, wherein the controller is configured to allocate power delivery between the turbomachine and an electric machine operatively coupled to a propeller shaft.

The gas turbine engine according to any preceding clause, wherein the controller is configured to prioritize thrust generation from the electric machine during at least one of a descent, landing approach, or go-around procedure.

The gas turbine engine according to any preceding clause, wherein the controller is configured to select a descent route to a landing destination based at least in part on terrain data, energy usage estimates, and weather conditions.

The gas turbine engine according to any preceding clause, wherein the controller is configured to evaluate passenger comfort based on predicted vertical acceleration or descent rate, and to modify thrust commands to improve passenger comfort.

The gas turbine engine according to any preceding clause, wherein the controller is configured to autonomously command forward thrust and reverse thrust during landing rollout based on aircraft ground speed.

The gas turbine engine according to any preceding clause, wherein the controller is further configured to autonomously select among a fuel-only propulsion mode, an electric-only propulsion mode, and a hybrid fuel-electric propulsion mode based on available energy reserves and a current flight phase.

A gas turbine engine comprises a turbomachine. The turbomachine comprises a compressor section, a combustion section, and a turbine section arranged in serial flow order. The compressor section has a high pressure compressor defining a high pressure compressor exit area (A_{HPCExit}) in square inches and the turbine section has a drive turbine defining a drive turbine exit area (A_{DTExit}) in square inches. The turbomachine further comprises a drive turbine shaft coupled to the drive turbine and defines an overall pressure ratio greater than 14:1 and less than or equal to 22:1. The gas turbine engine defines a maximum exhaust gas temperature (EGT) greater than 600 degrees Celsius and less than 1000 degrees Celsius, an output power of at least 550 horsepower and up to 2,000 horsepower when operated at a rated speed, a maximum drive turbine shaft torque (T_{OUT}) in Newton meters, and a corrected specific power (CSP) in Newtons squared times degrees Celsius over meters squared. CSP is greater than 3.3 and less than 101 and is determined as follows:

$${( \frac{{T}_{OUT}}{\sqrt{{A}_{DTExit}}} )}^{2} * \frac{EGT}{{A}_{HPCExit}} * {10}^{- 11} .$$

The gas turbine engine includes a controller configured to autonomously regulate performance of the gas turbine engine in response to at least one of: a thrust demand, an energy efficiency target, or a flight profile condition.

A method of operating a gas turbine engine, comprises operating the gas turbine engine at a takeoff power level, wherein operating the gas turbine engine at the takeoff power level comprises driving a propeller of a propeller assembly across a propeller shaft of the propeller assembly, the gas turbine engine further comprising a turbomachine with a high pressure compressor defining a high pressure compressor exit area (A_{HPCExit}) in square inches and a drive turbine defining a drive turbine exit area (A_{DTExit}) in square inches, the gas turbine engine defining a maximum exhaust gas temperature (EGT) in degrees Celsius, a maximum drive turbine shaft torque (T_{OUT}) in Newton meters, and a corrected specific power in Newtons squared times degrees Celsius over meters squared, wherein the corrected specific power (CSP) is determined as follows:

$${( \frac{{T}_{OUT}}{\sqrt{{A}_{DTExit}}} )}^{2} * \frac{EGT}{{A}_{HPCExit}} * {10}^{- 11} ;$$

wherein CSP is greater than 0.0001194×EGT²−0.103×EGT+22.14 and less than 0.0003294×EGT²−0.3061×EGT+77.91; and wherein EGT is greater than 525 degrees Celsius and less than 1250 degrees Celsius. The method further includes autonomously regulating performance of the gas turbine engine in response to at least one of: a thrust demand, an energy efficiency target, or a flight profile condition.

Persons skilled in the art will understand that the structures and methods specifically described herein and shown in the accompanying figures are non-limiting exemplary aspects, and that the description, disclosure, and figures should be construed merely as exemplary of aspects. It is to be understood, therefore, that the disclosure is not limited to the precise aspects described, and that various other changes and modifications can be affected by one skilled in the art without departing from the scope or spirit of the disclosure. Additionally, the elements and features shown or described in connection with certain aspects can be combined with the elements and features of certain other aspects without departing from the scope of the disclosure, and that such modifications and variations are also included within the scope of the disclosure. Accordingly, the subject matter of the disclosure is not limited by what has been particularly shown and described.

What is claimed is:

1. A gas turbine engine comprising:
a turbomachine comprising a compressor section, a combustion section, and a turbine section arranged in serial flow order, the compressor section having a high pressure compressor defining a high pressure compressor exit area (A_{HPCExit}) in square inches and the turbine section having a drive turbine defining a drive turbine exit area (A_{DTExit}) in square inches, the turbomachine further comprising a drive turbine shaft coupled to the drive turbine;
wherein the gas turbine engine defines a maximum exhaust gas temperature (EGT) in degrees Celsius, a maximum drive turbine shaft torque (T_{OUT}) in Newton meters, and a corrected specific power (CSP) in Newtons squared times degrees Celsius over meters squared, wherein the corrected specific power is determined as follows:
$${( \frac{{T}_{OUT}}{\sqrt{{A}_{DTExit}}} )}^{2} * \frac{EGT}{{A}_{HPCExit}} * {10}^{- 11} ;$$
wherein CSP is greater than 0.0001194×EGT²−0.103×EGT+22.14 and less than 0.0003294×EGT²−0.3061×EGT+77.91; and
wherein EGT is greater than 525 degrees Celsius and less than 1250 degrees Celsius; and
a controller configured to autonomously regulate performance of the gas turbine engine in response to at least one of: a thrust demand, an energy efficiency target, or a flight profile condition.

2. The gas turbine engine of claim 1, wherein the controller is configured to regulate a fuel flow rate supplied to the turbomachine based on the thrust demand.

3. The gas turbine engine of claim 1, wherein the controller is configured to determine a thrust error between an actual thrust and a desired thrust, and to convert the thrust error into a commanded change in power.

4. The gas turbine engine of claim 1, wherein the controller is configured to determine a thrust error between a desired thrust and an actual thrust, and adjust a commanded power output of the turbomachine based on the thrust error.

5. The gas turbine engine of claim 1, wherein the controller is configured to allocate power delivery between the turbomachine and an electric machine operatively coupled to a propeller shaft.

6. The gas turbine engine of claim 1, wherein the controller is configured to prioritize thrust generation from the electric machine during at least one of a descent, landing approach, or go-around procedure.

7. The gas turbine engine of claim 1, wherein the controller is configured to select a descent route to a landing destination based at least in part on terrain data, energy usage estimates, and weather conditions.

8. The gas turbine engine of claim 1, wherein the controller is configured to evaluate passenger comfort based on predicted vertical acceleration or descent rate, and to modify thrust commands to improve passenger comfort.

9. The gas turbine engine of claim 1, wherein the controller is configured to autonomously command forward thrust and reverse thrust during landing rollout based on aircraft ground speed.

10. The gas turbine engine of claim 1, wherein the controller is further configured to autonomously select among a fuel-only propulsion mode, an electric-only propulsion mode, and a hybrid fuel-electric propulsion mode based on available energy reserves and a current flight phase.

11. A gas turbine engine comprising:
a turbomachine comprising a compressor section, a combustion section, and a turbine section arranged in serial flow order, the compressor section having a high pressure compressor defining a high pressure compressor exit area (A_{HPCExit}) in square inches and the turbine section having a drive turbine defining a drive turbine exit area (A_{DTExit}) in square inches, the turbomachine further comprising a drive turbine shaft coupled to the drive turbine and defining an overall pressure ratio greater than 14:1 and less than or equal to 22:1;
wherein the gas turbine engine defines a maximum exhaust gas temperature (EGT) greater than 600 degrees Celsius and less than 1000 degrees Celsius, an output power of at least 550 horsepower and up to 2,000 horsepower when operated at a rated speed, a maximum drive turbine shaft torque (T_{OUT}) in Newton meters, and a corrected specific power (CSP) in Newtons squared times degrees Celsius over meters squared, wherein CSP is greater than 3.3 and less than 101 and is determined as follows:
$${( \frac{{T}_{OUT}}{\sqrt{{A}_{DTExit}}} )}^{2} * \frac{EGT}{{A}_{HPCExit}} * {10}^{- 11} ;$$
and
a controller configured to autonomously regulate performance of the gas turbine engine in response to at least one of: a thrust demand, an energy efficiency target, or a flight profile condition.

12. The gas turbine engine of claim 11, wherein the controller is configured to regulate a fuel flow rate supplied to the turbomachine based on the thrust demand.

13. The gas turbine engine of claim 11, wherein the controller is configured to determine a thrust error between an actual thrust and a desired thrust, and to convert the thrust error into a commanded change in power.

14. The gas turbine engine of claim 11, wherein the controller is configured to determine a thrust error between a desired thrust and an actual thrust, and adjust a commanded power output of the turbomachine based on the thrust error.

15. The gas turbine engine of claim 11, wherein the controller is configured to allocate power delivery between the turbomachine and an electric machine operatively coupled to a propeller shaft.

16. The gas turbine engine of claim 11, wherein the controller is configured to prioritize thrust generation from the electric machine during at least one of a descent, landing approach, or go-around procedure.

17. The gas turbine engine of claim 11, wherein the controller is configured to select a descent route to a landing destination based at least in part on terrain data, energy usage estimates, and weather conditions.

18. The gas turbine engine of claim 11, wherein the controller is configured to evaluate passenger comfort based on predicted vertical acceleration or descent rate, and to modify thrust commands to improve passenger comfort.

19. The gas turbine engine of claim 11, wherein the controller is configured to autonomously command forward thrust and reverse thrust during landing rollout based on aircraft ground speed.

20. A method of operating a gas turbine engine, comprising:
operating the gas turbine engine at a takeoff power level, wherein operating the gas turbine engine at the takeoff power level comprises driving a propeller of a propeller assembly across a propeller shaft of the propeller assembly, the gas turbine engine further comprising a turbomachine with a high pressure compressor defining a high pressure compressor exit area (A_{HPCExit}) in square inches and a drive turbine defining a drive turbine exit area (A_{DTExit}) in square inches, the gas turbine engine defining a maximum exhaust gas temperature (EGT) in degrees Celsius, a maximum drive turbine shaft torque (T_{OUT}) in Newton meters, and a corrected specific power in Newtons squared times degrees Celsius over meters squared;
wherein the corrected specific power (CSP) is determined as follows:
$${( \frac{{T}_{OUT}}{\sqrt{{A}_{DTExit}}} )}^{2} * \frac{EGT}{{A}_{HPCExit}} * {10}^{- 11} ;$$
wherein CSP is greater than 0.0001194×EGT²−0.103×EGT+22.14 and less than 0.0003294×EGT²−0.3061×EGT+77.91; and
wherein EGT is greater than 525 degrees Celsius and less than 1250 degrees Celsius; and
autonomously regulating performance of the gas turbine engine in response to at least one of: a thrust demand, an energy efficiency target, or a flight profile condition.
